SEQUENCE LISTING (59 sequences)

SEQ ID NO: 1 - protein, 397 aa, Aspergillus fumigatus
MVHLSSLAAALAALPLVYGAGLNTAAKAKGLKYFGSATDNPELTDSAYVAQLSNTDDFGQITPGNSMKWDATEPSQNSFSFANGDAVVNLANKNGQLMRCHTLVWHSQLPNWVSSGSWTNATLLAAMKNHITNVVTHYKGKCYAWDVVNEALNEDGTFRNSVFYQIIGPAYIPIAFATAAAADPDVKLYYNDYNIEYSGAKATAAQNIVKMIKAYGAKIDGVGLQAHFIVGSTPSQSDLTTVLKGYTALGVEVAYTELDIRMQLPSTAAKLAQQSTDFQGVAAACVSTTGCVGVTIWDWTDKYSWVPSVFQGYGAPLPWDENYVKKPAYDGLMAGLGASGSGTTTTTTTTSTTTGGTDPTGVAQKWGQCGGIGWTGPTTCVSGTTCQKLNDWYSQCL

SEQ ID NO: 2 - protein, 405 aa, Talaromyces leycettanus
MVHLSSLALALAAGSQLAQAAGLNTAAKAIGKLYFGTATDNPELSDSTYMQETDNTDDFGQLTPANSMKWDATEPSQNTFTFTNGDQIANLAKSNGQMLRCHNLVWYNQLPSWVTSGSWTNATLLAAMKNHITNVVTHYKGQCYAWDVVNEALNDDGTYRSNVFYQYIGEAYIPIAFATAAAADPNAKLYYNDYNIEYPGAKATAAQNIVKMVKAYGAKIDGVGLQSHFIVGSTPSQSSQQSNMAAFTALGVEVAITELDIRMTLPSTSALLAQQSTDYQSTVSACVNTPKCIGITLWDWTDKYSWVPNTFSGQGDACPWDSNYQKKPAYYGILTALGGSASTSTTTTLVTSTRTSTTTSTSATSTSTGVAQHWGQCGGIGWTGPTTCASPYTCQELNPYYYQCL

SEQ ID NO: 3 - protein, 417 aa, Bacillus subtilis
MKKPLGKIVASTALLISVAFSSSIASAASDVTVNVSAEKQVIRGFGGMNHPAWAGDLTAAQRETAFGNGQNQLGFSILRIHVDENRNNWYKEVETAKSAVKHGAIVFASPWNPPSDMVETFNRNGDTSAKRLKYNKYAAYAQHLNDFVTFMKNNGVNLYAISVQNEPDYAHEWTWWTPQEILRFMRENAGSINARVIAPESFQYLKNLSDPILNDPQALANMDILGTHLYGTQVSQFPYPLFKQKGAGKDLWMTEVYYPNSDTNSADRWPEALDVSQHIHNAMVEGDFQAYVWWYIRRSYGPMKEDGTISKRGYNMAHFSKFVRPGYVRIDATKNPNANVYVSAYKGDNKVVIVAINKSNTGVNQNFVLQNGSASNVSRWITSSSSNLQPGTNLTVSGNHFWAHLPAQSVTTFVVNR

SEQ ID NO: 4 - protein, 417 aa, Bacillus subtilis
MKKPLGKIVASTALLISVAFSSSIASAASDVTVNVSAEKQVIRGFGGMNWPAWAGDLTAAQRETAFGNGQNQLGFSILRIHVDENRNNWYKEVETAKSALKLGAIVFASPWNPPSDMVETFNRNGDTSAKRLKYNKYAAYAQHLNDFVTFMKNNGVNLYAISVQNEPDYAHEWTWWTPQEMLRFMRENAGSINARVIAPESFQYLKNLSDPILNDPQALANMDILGTHLYGTQLSQFPYPLFKQKGAGKDLWMTEVYYPNSDTNSADRWPEALDVSQHIHNAMVEGDFQAYVWWYIRRSYGPMKEDGTISKRGYNMAHFSKFVRPGYVRIDATKNPNANVYVSAYKGDNKVVIVAINKSNTGVNQNFVLQNGSASNVSRWITSSSSNLQPGTNLTVSGNHFWAHLPAQSVTTFVVNR

SEQ ID NO: 5 - protein, 551 aa, Chryseobacterium sp-10696
MDEKNLLEDPDSNLSAGASARALAATPMLHVGGRYLKDPCDNNVVLHGVAITPSPWFNGCQYGANSGYCTWDNYNVQGALNYNKAVMNKLTSAADGWYLNYIRLHIDPYWTNDPGPAIPENDISRFNYNRLVTYTDQVIIPLINHARSLGMYVILRPPGVCPNRIAVNDAYHSYLKTVWTFLSQHPGLKNADNVMFELANEPVEILGTNGTWGSTGNEHFAALKNFFQPLVNIIRNNGANNVCWIPGTGWQSHYQGYVNNQITGGNIGYAVHIYPAYWGGLSNYQAFQNAWNINVKPIADIAPIAITETDWAPQGYGTFGIGTTGTAGGSGFGANLKYIVDQSGNVSWNVLAPDNLLHKGDPNAGTAYNNDWEACAAPVKQWFQQYASSNYPVGNCNTTSSLVNNGIYEIEFQTDANKVVDLKSGEDANGAVLRPWTRNGAAAQRWVAIDAGNGYWRFVSKASATNRCIDLASNSNTLGTSIRLWQNYGNDAQAWQVVAVSNGYYKILSKVDPTRGWDIPNCTMDGNSNLHLWDYYGTSCQLFKFKYIGMN

SEQ ID NO: 6 - protein, 551 aa, Chryseobacterium sp-10696
MDEKNLLEDPDSNLSAGASARALAATPMLHVGGRYLKDPCDNNVLLHGVAITPSPWFNGCQYGANSGYCTWDNYNVQGCLNYNKAVMNKLTSAADGWYLNYIRLHIDPYWTNDPGPSIPENDISRFNYNRLVTYTDQVIIPLINHARSRGMYVILRPPGVCPNRIAVNDAYHSYLKTVWTFLSQHPGLKNADNVMFELANEPVEILGTNGTWGQTGNEHFAALKNFFQPLVNIIRNNGANNVCWIPGTGWQSHYQGYPNNQITGGNIGYAVHIYPSYWGGLSNYQAFQNAWNINVKPIADIAPIAITETDWAPQGYGTFGIGTTGTAGGSGFGANLKYIVDQSGNVSWNVLAPDNLLHKGDPNGGTAYNNDWEACAAPVKQWFQQYAKSNYPVGNCNTTSSLVNNGIYEIEFQTDANKVVDLKSGEDANGAVLRPWTRNGAAAQRWVAIDAGNGYWRFVSKASATNRCITLASNSNTLGTSIVLWQNYGNDAQAWQVVAVSNGYYKILSKVDPTRGWDIPNCTMDGNSNLHLWDYYGTSCQLFKFKYIGMN

SEQ ID NO: 7 - protein, 620 aa, Acetivibrio cellulyticus
ADPQRGRPYLNSARTTFVGDNGQPLRGPYISTEWTSAAPYDQIARIKNLGFNAVHHYAECFDINYPNAGSKSPGYAATEIDKVVERTRELGLYLVMTIGNGANNGNHNTRYAKDFWSFYSSRYANETHVLYEIHNEPVAWGPPYSSTTATPTGAVEMNVDVYKTIRANAPKTPVLIFSYSVFGGTGGTTEALKDIQAFNSAVFGKQDAVWTNEAVAFHGYAGWEATSTAVDGLLKAGYPCFMTEYAGGAWGSGTGGFDIQLTSELERMGVSWLTFQYIPPSGVSDDVTKPEYFSALVENAGLSWKPDYGNWPAARGVHGNGGLPRKTSTWVNNFLTGTTRIEAEDFDWGGNDVSFYDKDSENKGAQYRLDEAVDIETTKDADGGYNVGWIEDGEWLEYTIWVQHPGYYNLALRVANNSGGSVQVNFGNQDKTGTWVLPVTGGVQTWKTDTRQVFLGSGRQKLRINALSGGFNLNWIELSPVSTGPIADGTYKFLNRANTMTLQEVTSNNSIVTSTYKGTADQHWKIQHIGGGQYRISSAGRGWNWNWWMGFGTVGWWGTGSGTCFIIRPTGDGYYRFVLVNDGTNLEISNNDSSKIEGKAYHEGANQQWAIQLPSAPVFP

SEQ ID NO: 8 - protein, 865 aa, Clostridium thermocellum
AIALSILSFIPNRAYASPQRGRPRLNAARTTFVGDNGQPLRGPYTSTEWTAAAPYDQIARVKELGFNAVHLYAECFDPRYPAPGSKAPGYAVNEIDKIVERTRELGLYLVITIGNGANNGNHNAQWARDFWKFYAPRYAKETHVLYEIHNEPVAWGPPYSSSTANPPGAVDMEIDVYRIIRTYAPETPVLLFSYAVFGGKGGAAEALKDIRAFNKAVFGNENAVWTNEAVAFHGYAGWQETTIAVEELLKAGYPCFMTEYAGGAWGSGMGGLDVELTYELERLGVSWLTFQYIPPTGVSDDVTKPEYFSALVENSGLSWTPDYGNWPAARGVYGNGGLARETATWINNFLTGTTRIEAEDFDWGGNGVSYYDTDSVNVGGQYRPDEGVDIEKTSDTGGGYNVGWISEGEWLEYTIRVRNPGYYNLSLRVAGISGSRVQVSFGNQDKTGVWELPATGGFQTWTTATRQVFLGAGLQKLRINALSGGFNLNWIELSPISTGTIPDGTYKFLNRANGKTLQEVTGNNSIITADYKGITEQHWKIQHIGGGQYRISSAGRGWNWNWWMGFGTVGWWGTGSSTCFIISPTGDGYYRIVLVGDGTNLQISSGDPSKIEGKAFHGGANQQWAILPVSAPAFPTGLSAVLDSSGNTANLTWNAAPGANSYNVKRSTKSGGPYTTIATNITSTNYTDTGVATGTKYYYVVSAVSNGVETLNSAEAILQYPKLTGTVIGTQGSWNNIGNTIHKAFDGDLNTFFDGPTANGCWLGLDFGEGVRNVITQIKFCPRSGYEQRMIGGIFQGANKEDFSDAVTLFTITSLPGSGTLTSVDVDNPTGFRYVRYLSPDGSNGNIAELQFFGTPAGEENDDVH

SEQ ID NO: 9 - protein, 573 aa, Paenibacillus illinoisensis
MKKPLGKIVASTALLISVAFSSSIASAHQHQHQHPRWVGMPMGKLHVSGKNLVNSNNQPVLLNGWHQPSGAYWTYQSSNYYLNLHGNNRHAATLAYLKDITDTFADTSPKYGSNHGWNMNQVRLFIDREDMGDVAAGTYNFAGVQTVTQNVIIPYIQYAKTKGVYVVLGLDFTLKDDQATTASNLQKFNQIWGYLASRPEIKSADNVHFELINEPVKSYANGHWGGYNGENDFVDHWNDLRNFQNSIISTIRSQGADNVIWAAGLGYNQFYSLTASHPLTDPLNNYGYAVHWYPGYGAYDNFSILQDQWNTNVKAAADKYPINITEVTWFKNKPGDSAYWNLFNGSNEGFGTNTKTIFNAAGNVSIAAHMNGFILEPGQRSSFADPTAGLKWDGDASRSAMGRFLFNWYHERAQSYPGGNGGGPTTGLVSGATYKIVARHSNKVIDVPGGQNQNNLQLQQWSDLGGNPQKWVLTSIGGGSYTLTSVNSPDKVIDIRNGTLTNGEAVQLMSNLNTTAQHFKVNDLGNGYWSIINVNSNKAIEVENASTSDGAKLQQNTYTGATNQQWKFIAVSN

SEQ ID NO: 10 - protein, 582 aa, Paenibacillus sp.
MKKPLGKIVASTALLISVAFSSSIASAHHHHHHPRLTVPPGAPAEAWSGMPTPKLHVSGNQLVNANGQPVLLSGWHQPSGSYWTYQSSSYYLDRNGGNRHAANLAYLKDITDTFTDTSPKYGNNHGWYMNQVRLFIDREDMGDVAEGTYNFAGLQAVTQNVIIPYINYARTKGLYVTLGLDFTLKDNQATTQANLDKFNQIWSYLASRPEIRSADNVMFEIINEPVLSYADGRWGGHPSDPHFIAFWNDLRSFQNSIISSIRAQGADNVIWAAGLGWDQYYQLCASHPLTDPLNNVGYAVHWYPGYGAGDNYSVLQQQWDTNIKPCADNYPINITETTWFKRLPGDSDYWNLFNGSSEGFGKNTKAIFTAAGNASIAVHMNGFLLAPGARSSFADPTAGLLYDGNTARDGMARFIFEWYYERAQFLPWNGIWNGLFTGSTYKFVNRATGKNMDVPGGQNNNNLQLNQWTDNGATAQRWVVDDMGTFNNIYRMKSVSSSDGKVMDVRNGTKNNGEAIQLMQDFSNTAQRFRIIRLSNGYWSIINVNSNKAVEVAGGASHDGALLQQNMYRGDHHQQWQLVQIQ

SEQ ID NO: 11 - protein, 325 aa, Talaromyces pinophilus
MHFLAALLAVLPLVSGSPVPEKRSGCALPSTYKWTSTGPLASPKSGLVALRDYSHVIYNGQHLVYGSTANTAGSYGSMNFGLFSDWSEMSSASQNTMSTGAVAPTIFYFAPKSVWILAYQWGPYAFSYRTSTDPSNANGWSSPQPLFTGTISGSSTGVIDQTVIGDSENMYLFFAGDNGHIYRASMPIGDFPGSFGSASTIVLSDSTNNLFEAVEVYTVEGQNQYLMIVEAIGANGRYFRSFTASSLGGTWTAQASTESNPFAGKANSGATWTNDISSGDLVRTNPDQTQTIDACNLQFLYQGRSTSSGGDYNLLPYQPGLLTLA

SEQ ID NO: 12 - protein, 792 aa, Aspergillus fumigatus
MAVAKSIAAVLVALLPGALAQANTSYVDYNVEANPDLTPQSVATIDLSFPDCENGPLSKTLVCDTSARPHDRAAALVSMFTFEELVNNTGNTSPGVPRLGLPPYQVWSEALHGLDRANFTNEGEYSWATSFPMPILTMSALNRTLINQIATIIATQGRAFNNVGRYGLDVYAPNINAFRSAMWGRGQETPGEDAYCLASAYAYEYITGIQGGVDPEHLKLVATAKHYAGYDLENWDGHSRLGNDMNITQQELSEYYTPQFLVAARDAKVHSVMCSYNAVNGVPSCANSFFLQTLLRDTFGFVEDGYVSSDCDSAYNVWNPHEFAANITGAAADSIRAGTDIDCGTTYQYYFGEAFDEQEVTRAEIERGVIRLYSNLVRLGYFDGNGSVYRDLTWNDVVTTDAWNISYEAAVEGIVLLKNDGTLPLAKSVRSVALIGPWMNVTTQLQGNYFGPAPYLISPLNAFQNSDFDVNYAFGTNISSHSTDGFSEALSAAKKSDVIIFAGGIDNTLEAEAMDRMNITWPGNQLQLIDQLSQLGKPLIVLQMGGGQVDSSSLKSNKNVNSLIWGGYPGQSGGQALLDIITGKRAPAGRLVVTQYPAEYATQFPATDMSLRPHGNNPGQTYMWYTGTPVYEFGHGLFYTTFHASLPGTGKDKTSFNIQDLLTQPHPGFANVEQMPLLNFTVTITNTGKVASDYTAMLFANTTAGPAPYPNKWLVGFDRLASLEPHRSQTMTIPVTIDSVARTDEAGNRVLYPGKYELALNNERSVVLQFVLTGREAVIFKWPVEQQQISSA

SEQ ID NO: 13 - protein, 780 aa, Trichoderma reesei
MVNNAALLAALSALLPTALAQNNQTYANYSAQGQPDLYPETLATLTLSFPDCEHGPLKNNLVCDSSAGYVERAQALISLFTLEELILNTQNSGPGVPRLGLPNYQVWNEALHGLDRANFATKGGQFEWATSFPMPILTTAALNRTLIHQIADIISTQARAFSNSGRYGLDVYAPNVNGFRSPLWGRGQETPGEDAFFLSSAYTYEYITGIQGGVDPEHLKVAATVKHFAGYDLENWNNQSRLGFDAIITQQDLSEYYTPQFLAAARYAKSRSLMCAYNSVNGVPSCANSFFLQTLLRESWGFPEWGYVSSDCDAVYNVFNPHDYASNQSSAAASSLRAGTDIDCGQTYPWHLNESFVAGEVSRGEIERSVTRLYANLVRLGYFDKKNQYRSLGWKDVVKTDAWNISYEAAVEGIVLLKNDGTLPLSKKVRSIALIGPWANATTQMQGNYYGPAPYLISPLEAAKKAGYHVNFELGTEIAGNSTTGFAKAIAAAKKSDAIIYLGGIDNTIEQEGADRTDIAWPGNQLDLIKQLSEVGKPLVVLQMGGGQVDSSSLKSNKKVNSLVWGGYPGQSGGVALFDILSGKRAPAGRLVTTQYPAEYVHQFPQNDMNLRPDGKSNPGQTYIWYTGKPVYEFGSGLFYTTFKETLASHPKSLKFNTSSILSAPHPGYTYSEQIPVFTFEANIKNSGKTESPYTAMLFVRTSNAGPAPYPNKWLVGFDRLADIKPGHSSKLSIPIPVSALARVDSHGNRIVYPGKYELALNTDESVKLEFELVGEEVTI

SEQ ID NO: 14 - protein, 413 aa, Rasamsonia byssochlamydoides
MKTVTTLSTLSALCGLATAWLPGVHKDIYSVDGQNHFNKTAGSADKRWLPASGKIRGVDLGSLFVFEPWIAENAWSQMGCGGKQSEFDCVSALGQSAANSAFASHWGSWITKDDITQMQSYGLNTVRIPVGYWLKEDIVYSDSEHFPQGGLSYLEQVCGWASDAGFYIIIDLHGAPGAQVPQNPDTGQYAPTAGFYVDYQYERALEFLEWMTTNIHTNNNFRNVGMLEIVNEPLQNPDQVATMRTSYYPNAFSRIRAAEQKLGITANNYLHIQMMNAKWGSGDPTQALTDTYFAAYDDHRYLKWDSSVPVSPQSYLSTSCNDDRGGNWPTIVGEFSLSPPDDVQWTAEWDPGTNQDFYKKWFAAQVMAYEKQQGWIFWTWKSQLGDYRWSYQDAVAAGVIPTDLDSVYNMGAC

SEQ ID NO: 15 - protein, 408 aa, Trichoderma atroviride
MLSAYAFSLLVASASAWTPQSNAKVFSRDTEGVMRWLPGNDKFRGVNLGSQFIIEPWMASDEFSGMGCGGLNDEWSCVQSLGQDAADAAFQKHWDSWITQDDITQIKNLGLNTVRIPVGFWIREDLVQQGEFFPRGGIQYLDRLVGWCNDAGIYVIMDLHGGPGAQFPNQQYTGHGVSQPGFYTEANYERAANFLEWMTERIHTNATYASVGMLEVINEPVHSGDFPSQAADMVNTYYPLAWNRIRDTESKLGVSDDKRLHIQFMASAWGSGDPTSALPSTDFAAFDDHRYLKWDTSVTATKDGYLNAACSDKRDDNVIVGEWSISVADNVQDNDELGIKNRSDQADWYQKFWAAQVLAFEKSAGWVFWTWKCNWITGYDDWRWCYQSAVAAGAIPKDAGSAASINPC

SEQ ID NO: 16 - protein, 429 aa, Trichoderma atroviride
MRYSFVAPALLAGTAYAWLPQERDLAAFNQTARFEQLGKRFEPTLASGVTKIRGVNFGGWLICEPWMMPTEWNSVMGCNNAASEFDCMLNNYMGNNRAAGNAKFKTHWSSWITPATVQSVHDVGLNTIRIPIGYWSYTAIVDTASEPFADGDAMLPYLDAVVQKAADLGIYVIIDLHGAPGGQQQDAFTGQNPNPAGFFNSYDFGRAEKWLTWMTNRIHTNPAYSTVGMIEVLNEPVSNHDANGRYPAPGENPGLTQTYYPAALKAVRDAESALNVASNKKLHVQFMSSKWGSGDPRSNSAVANDPMTGFDDHNYIGFAVSNNGDQYSLMHSACTDTRVVSGQNFEITGEWSMTSGVDWHDQAFFTKFWTAQQQLYESPGMDGWIYWTWKTELNDPRWTYSYATYLNYIPTNAAALEQNVYQDVCNGFR

SEQ ID NO: 17 - protein, 429 aa, Trichoderma harzianum
MKYSIVAPAILAGTGFAWLPQDRDLKAFNQTPRFEELGKRFEPALASGITKIRGVNFGGWLISEPWMMSNEWNNNMGCNGAASEFDCMRNNYMGSKRATGNTKFQNHYRDWINPATVQSVHDVGLNTIRIPIGYWSYNAIVDTASEPFADGNLQLPYLDAVVQKAADLGIYVIIDLHGAPGGQQQDAFTGQNPNPAGFYNTYDYGRAEKWLSWMTNRIHTNPAYSTVGMIEVLNEPVSRHDGGGRYPAPGQDPSMVQTYYPGALKAVRDAEAALNVPSNKKLHVQFMSSKWDSGDPRSNAAVKNDPMVGFDDHNYIGFALQNTGDQYSLMHSACTDSRVVSGQDFAITGEWSMTSGADWHDGNFFTKFFTAQQQLYESPGMDGWIYWTWKTELNDPRWTYSYATYLNYIPTNAAALQQNVYQDVCAGFR

SEQ ID NO: 18 - protein, 286 aa, Albifimbria verrucaria
MIPKQILAAIAALSSVSQAWEAPQYSGFNRVWQDTFAGAGGSLPDQGNWNIINGDLGVNNELQIYTTSTRNVQRSGGETVQLVPFRDGSALRGWTSGRLESKYTWTPQAGRLTRAEALIRFGTNSIGNKQGIWPAFWALGDILRRGGSWPSCGELDILETVNGQLTGYGTIHCDVYPGGICNEGNGIGASIGIPDQGWHTWRLEVDRRPGNWLDESITWYRDGQQFHRVTGARINNYNVWNALAHSPMFFILNVAVGGNWPGYPNGATQDGYGSMMEVAYVAHYST

SEQ ID NO: 19 - protein, 284 aa, Lecanicillium sp. WMM742
MVKAGFISSLLSLAAFTSAWDAPNYGGFNRVWQDNFGGNGGQLPNEGNWNIITGNLGVNNELEVYQRDTRNLQLSGGNTLQIVPWRNGNGWTSGRIESKYTFTPQGGKLTRVEAAIRFGGNSINNKQGIWPAWWMLGDGIRHNVQWPGCGELDILETVNGQLTGHGTMHCDTFPGGICNEGNGIGSSVNFPNQDWHTWRLEVDLRNGNWVDQSIVWYLDGREFHRITGSRINNYNVWRSVAQSPLFFILNVAVGGNWPGYPNGNTQDGYGSMMEVGYTAHYVTQ

SEQ ID NO: 20 - protein, 447 aa, Trichoderma harzianum
MRTLTILTTLIGAVAAAPSLIPRVSPFSIAKPGGVDDIVITANNTLNGTYHSSTTVSKNVIQTRAQAGHLPIQLVNNFSGSQVNAYISGLDTDNRVVFVRGDGSLVYPSSGGSSVPVAISTPINIALPAQGQSITVNVPIVISSARIYFSVGDLQFFMVKIPNGDGLVQPSQFNLQDPSAGLLWGFVELTYTTDLAVYANISYVDFVGMILSMSLSATDGSATQTTKGLGSSALTQICQGLVQQASVDGFPWSSMCIANSAGTLVRALSPGDYSVINAAAFQNYWSAYVDQVWSQYTNTPLTINTQTSAGSVNCQVSGDTLNCNGDNRGYAKPAAGDIWGCNSGPFAIQSGDNAVHSAVVPRLCAAFVRSTLLLAGGNVQPGLGQSSYYTVSPTNHYSRLVHQFEIDGRGYAFPYDDVNPDGNENASGTLASGAPNVLTVYVGAPPS

SEQ ID NO: 21 - protein, 532 aa, Aspergillus fumigatus
MLASTFSYRMYKTALILAALLGSGQAQQVGTSQAEVHPSMTWQSCTAGGSCTTNNGKVVIDANWRWVHKVGDYTNCYTGNTWDTTICPDDATCASNCALEGANYESTYGVTASGNSLRLNFVTTSQQKNIGSRLYMMKDDSTYEMFKLLNQEFTFDVDVSNLPCGLNGALYFVAMDADGGMSKYPTNKAGAKYGTGYCDSQCPRDLKFINGQANVEGWQPSSNDANAGTGNHGSCCAEMDIWEANSISTAFTPHPCDTPGQVMCTGDACGGTYSSDRYGGTCDPDGCDFNSFRQGNKTFYGPGMTVDTKSKFTVVTQFITDDGTSSGTLKEIKRFYVQNGKVIPNSESTWTGVSGNSITTEYCTAQKSLFQDQNVFEKHGGLEGMGAALAQGMVLVMSLWDDHSANMLWLDSNYPTTASSTTPGVARGTCDISSGVPADVEANHPDAYVVYSNIKVGPIGSTFNSGGSNPGGGTTTTTTTQPTTTTTTAGNPGGTGVAQHYGQCGGIGWTGPTTCASPYTCQKLNDYYSQCL

SEQ ID NO: 22 - protein, 454 aa, Aspergillus fumigatus
MKHLASSIALTLLLPAVQAQQTVWGQCGGQGWSGPTSCVAGAACSTLNPYYAQCIPGATATSTTLTTTTAATTTSQTTTKPTTTGPTTSAPTVTASGNPFSGYQLYANPYYSSEVHTLAMPSLPSSLQPKASAVAEVPSFVWLDVAAKVPTMGTYLADIQAKNKAGANPPIAGIFVVYDLPDRDCAALASNGEYSIANNGVANYKAYIDAIRAQLVKYSDVHTILVIEPDSLANLVTNLNVAKCANAQSAYLECVDYALKQLNLPNVAMYLDAGHAGWLGWPANLGPAATLFAKVYTDAGSPAAVRGLATNVANYNAWSLSTCPSYTQGDPNCDEKKYINAMAPLLKEAGFDAHFIMDTSRNGVQPTKQNAWGDWCNVIGTGFGVRPSTNTGDPLQDAFVWIKPGGESDGTSNSTSPRYDAHCGYSDALQPAPEAGTWFQAYFEQLLTNANPSF

SEQ ID NO: 23 - protein, 863 aa, Aspergillus fumigatus
MRFGWLEVAALTAASVANAQELAFSPPFYPSPWADGQGEWADAHRRAVEIVSQMTLAEKVNLTTGTGWEMDRCVGQTGSVPRLGINWGLCGQDSPLGIRFSDLNSAFPAGTNVAATWDKTLAYLRGKAMGEEFNDKGVDILLGPAAGPLGKYPDGGRIWEGFSPDPVLTGVLFAETIKGIQDAGVIATAKHYILNEQEHFRQVGEAQGYGYNITETISSNVDDKTMHELYLWPFADAVRAGVGAVMCSYNQINNSYGCQNSQTLNKLLKAELGFQGFVMSDWSAHHSGVGAALAGLDMSMPGDISFDDGLSFWGTNLTVSVLNGTVPAWRVDDMAVRIMTAYYKVGRDRLRIPPNFSSWTRDEYGWEHSAVSEGAWTKVNDFVNVQRSHSQIIREIGAASTVLLKNTGALPLTGKEVKVGVLGEDAGSNPWGANGCPDRGCDNGTLAMAWGSGTANFPYLVTPEQAIQREVISNGGNVFAVTDNGALSQMADVASQSSVSLVFVNADSGEGFISVDGNEGDRKNLTLWKNGEAVIDTVVSHCNNTIVVIHSVGPVLIDRWYDNPNVTAIIWAGLPGQESGNSLVDVLYGRVNPSAKTPFTWGKTRESYGAPLLTEPNNGNGAPQDDFNEGVFIDYRHFDKRNETPIYEFGHGLSYTTFGYSHLRVQALNSSSSAYVPTSGETKPAPTYGEIGSAADYLYPEGLKRITKFIYPWLNSTDLEDSSDDPNYGWEDSEYIPEGARDGSPQPLLKAGGAPGGNPTLYQDLVRVSATITNTGNVAGYEVPQLYVSLGGPNEPRVVLRKFDRIFLAPGEQKVWTTTLNRRDLANWDVEAQDWVITKYPKKVHVGSSSRKLPLRAPLPRVY

SEQ ID NO: 24 - protein, 253 aa, Penicillium emersonii
MLSSTTRTLAFTGLAGLLSAPLVKAHGFVQGIVIGDQFYSGYIVNSFPYESNPPPVIGWATTATDLGFVDGTGYQGPDIICHRNATPAPLTAPVAAGGTVELQWTPWPDSHHGPVITYLAPCNGNCSTVDKTTLEFFKIDQQGLIDDTSPPGTWASDNLIANNNSWTVTIPNSVAPGNYVLRHEIIALHSANNKDGAQNYPQCINIEVTGGGSDAPEGTLGEDLYHDTDPGILVDIYEPIATYTIPGPPEPTF

SEQ ID NO: 25 - protein, 515 aa, Bacillus stearothermophilus
AAPFNGTMMQYFEWYLPDDGTLWTKVANEANNLSSLGITALWLPPAYKGTSRSDVGYGVYDLYDLGEFNQKGTVRTKYGTKAQYLQAIQAAHAAGMQVYADVVFDHKGGADGTEWVDAVEVNPSDRNQEISGTYQIQAWTKFDFPGRGNTYSSFKWRWYHFDGVDWDESRKLSRIYKFRGIGKAWDWEVDTENGNYDYLMYADLDMDHPEVVTELKNWGKWYVNTTNIDGFRLDAVKHIKFSFFPDWLSYVRSQTGKPLFTVGEYWSYDINKLHNYITKTNGTMSLFDAPLHNKFYTASKSGGAFDMRTLMTNTLMKDQPTLAVTFVDNHDTEPGQALQSWVDPWFKPLAYAFILTRQEGYPCVFYGDYYGIPQYNIPSLKSKIDPLLIARRDYAYGTQHDYLDHSDIIGWTREGVTEKPGSGLAALITDGPGGSKWMYVGKQHAGKVFYDLTGNRSDTVTINSDGWGEFKVNGGSVSVWVPRKTTVSTIARPITTRPWTGEFVRWTEPRLVAWP

SEQ ID NO: 26 - protein, 356 aa, Dictyogllomus thermophilum
MKKPLGKIVASTALLISVAFSSSIASAKEEAKGMEIPSLKEVYKDYFTIGAAVSHLNIYHYENLLKKHFNSLTPENQMKWEVIHPKPYVYDFGPADEIVDFAMKNGMKVRGHTLVWHNQTPGWVYAGTKDEILARLKEHIKEVVGHYKGKVYAWDVVNEALSDNPNEFLRRAPWYDICGEEVIEKAFIWAHEVDPDAKLFYNDYNLEDPIKREKAYKLVKKLKDKGVPIHGIGIQGHWTLAWPTPKMLEDSIKRFAELGVEVQVTEFDISIYYDRNENNNFKVPPEDRLERQAQLYKEAFEILRKYKGIVTGVTFWGVADDYTWLYFWPVRGREDYPLLFDKNHNPKKAFWEIVKF

SEQ ID NO: 27 - protein, 203 aa, Dictyogllomus thermophilum
QTSITLTSNASGTFDGYYYELWKDTGNTTMTVYTQGRFSCQWSNINNALFRTGKKYNQNWQSLGTIRITYSATYNPNGNSYLCIYGWSTNPLVEFYIVESWGNWRPPGATSLGQVTIDGGTYDIYRTTRVNQPSIVGTATFDQYWSVRTSKRTSGTVTVTDHFRAWANRGLNLGTIDQITLCVEGYQSSGSANITQNTFSQGS

SEQ ID NO: 28 - protein, 383 aa, Rasomsonia byssochlamydoides
DGLNTAAKAIGKLYFGTATDNPELSDVAYETQLNNTQDFGQITPANSMKWDATEPEQNTFTFAAGDQIADLAEANGQILRCHNLVWYNQLPSWVTSGSWTNETLLAAMKNHITNVVTHYKGRCYAWDVVNEALNDDGTYRDNVFYQYIGEAYIPIAFETAAAADPNVKLYYNDYNIEYAGVKATAAQNIVKLVQSYGARIDGVGLQSHFIVGETPSTSTQASNMASFTALGVEVAITELDIRMQLPETTALLTQQSTDYQSTVQACVNTPGCVGITLWDWTDKYSWVPSTFSGYGDACPWDDNYQKKPAYYGILTALGGSASTTTVGTGTTTTSTATTSSTGSSGTGVAQHWGQCGGIGWTGPTVCASGYTCTVVNPYYSQCL

SEQ ID NO: 29 - protein, 385 aa, Talaromyces leycettanus
AGLNTAAKAIGKLYFGTATDNPELSDSTYMQETDNTDDFGQLTPANSMKWDATEPSQNTFTFTNGDQIANLAKSNGQMLRCHNLVWYNQLPSWVTSGSWTNATLLAAMKNHITNVVTHYKGQCYAWDVVNEALNDDGTYRSNVFYQYIGEAYIPIAFATAAAADPNAKLYYNDYNIEYPGAKATAAQNIVKMVKAYGAKIDGVGLQSHFIVGSTPSQSSQQSNMAAFTALGVEVAITELDIRMTLPSTSALLAQQSTDYQSTVSACVNTPKCIGITLWDWTDKYSWVPNTFSGQGDACPWDSNYQKKPAYYGILTALGGSASTSTTTTLVTSTRTSTTTSTSATSTSTGVAQHWGQCGGIGWTGPTTCASPYTCQELNPYYYQCL

SEQ ID NO: 30 - protein, 378 aa, Aspergillus fumigatus
AGLNTAAKAKGLKYFGSATDNPELTDSAYVAQLSNTDDFGQITPGNSMKWDATEPSQNSFSFANGDAVVNLANKNGQLMRCHTLVWHSQLPNWVSSGSWTNATLLAAMKNHITNVVTHYKGKCYAWDVVNEALNEDGTFRNSVFYQIIGPAYIPIAFATAAAADPDVKLYYNDYNIEYSGAKATAAQNIVKMIKAYGAKIDGVGLQAHFIVGSTPSQSDLTTVLKGYTALGVEVAYTELDIRMQLPSTAAKLAQQSTDFQGVAAACVSTTGCVGVTIWDWTDKYSWVPSVFQGYGAPLPWDENYVKKPAYDGLMAGLGASGSGTTTTTTTTSTTTGGTDPTGVAQKWGQCGGIGWTGPTTCVSGTTCQKLNDWYSQCL

SEQ ID NO: 31 - protein, 409 aa, Talaromyces leycettanus
MKFSNVILAASASSLVLAAPKSKTKRTSAFQWFGANESGAEFGNQNIPGTLGTDYTWPDTSTIQTLRNAGMNIFRVPFLMERLVPNQMTGSPDPTYLADLKSTVNFITGTGAYAVVDPHNYGRYYNNIITSTSDFAAFWTTVASQFASNPRVIFDTNNEYNNMDQTLVLNLNQAAINAIRAAGATSQYIFAEGNSWTGAWTWTSVNDNMKQLTDPSNKLVYEMHQYLDSDGSGTSDQCVNSTIGYDRIVSATQWLQANGKVAFLGEFAGGSNSVCEAAVTGMLDYMEQNSDVWLGAEWWAAGPWWGNYIYSMEPPSGIAYQNYLSILEPYFPGGSYSGGTGSGSGSTTTTATTTTTKVPPTSTTSSASSTGTGVAQHWGQCGGQGWTGPTTCVSPYTCQELNPYYYQCL

SEQ ID NO: 32 - protein, 334 aa, Penicillium capsulatum
MKFSNLVALAAAASSAMALPLTKKHAKRASSFEWFGSNESGAEFGSGNIPGVYGTDYIFPSTSAIQTLINNGMNIFRVTFMMERLVPNTMTGSFDAEYLSNLTSVVNYITEAGAHAVIDPHNYGRYYGSIISSTSDFQTFWKNVAGQFKSNSLVIFDTNNEYHDMDQTLVLNLNQAAINGIRAAGATSQYIFVEGNSYTGAWTWADVNDNLKNLTDPQNKIVYEMHQYLDSDGSGTSATCVSTTIGKERVTSATQWLQKNGKVGILGEFAGGVNDQCKTAITGMLSYLEDNSDVWRGAMWWAAGPWWGDYIFSLEPPSGTAYTGMWSTLKSYLA

SEQ ID NO: 33 - protein, 394 aa, Trichophaea saccata
MHSFFSLALAVAGLPALINAQQSAWGQCGGVGWTGATTCVSGYYCSKLNDYYSQCIPGTASTTTSAVSTTTTATSPTGSVCSGNRTKFKYFGVNESGAEFGNNVVPGTLGKDYTWPTTDSVDFFLGKGMNTFRIAFLMERLSPPAGGLTGTFDPTYLASLKNIASYITGKGGYAIIDPHNYGRYNGNIITDYTSFGTWCKNLASQFKSDSHIIFDTNNEYHDMDETLVFNLNQACINGIRAAGATSQLILIEGNSWTGAWTWISSGNAASLINLTDPNNNIAYEMHQYLDSDGSGTSPTCVSSTIGAERLAAATAWLQANNKKGFLGEIGAGSNDDCIAAVKGALCSMQEAGGVWLGALWWAAGPWWGDYYQSIEPPDGAAIARILPEALLPFL

SEQ ID NO: 34 - protein, 294 aa, Sordaria fimicola
MRSSTILQTGLVAVLPFAVQAASGSGKSTRYWDCCKPSCAWSGKASVNRPVLACDANNNPLNDANVKSGCDGGSAYTCANNSPWAVNDNLAYGFAATKLSGGTESSWCCACYALTFTSGPVSGKTLVVQSTSTGGDLGSNHFDLNMPGGGVGLFDGCKREFGGLPGAQYGGISSRSECDSFPAALKPGCQWRFDWFKNADNPEFTFKQVQCPSELTSRTGCKRNDDSQFPAFTPPSGGGSNPSTPTTPPSSGGGGSGCAAAMYAQCGGSGFSGCTNCPSGSTCKAINDYYHQCA

SEQ ID NO: 35 - protein, 278 aa, Thielavia terrestris [sequence omitted]

SEQ ID NO: 36 - protein, 595 aa, Penicillium oxalicum
RPDPKGGNLTPFIHKEGERSLQGILDNLGGRGKKTPGTAAGLFIASPNTENPNYYYTWTRDSALTAKCLIDLFEDSRAKFPIDRKYLETGIRDYKSSQAILQSVSNPSGTLKDGSGLGEPKFEIDLNPFSGAWGRPQRDGPALRATAMITYANYLISHGQKSDVSQVMWPIIANDLAYVGQYWNNTGFDLWEEVDGSSFFTIAVQHRALVEGSQLAKKLGKSCDACDSQPPQILCFLQSFWNGKYITSNINTQASRSGIDLDSVLGSIHTFDPEAACDDATFQPCSARALANHKVYVDSFRSIYKINAGLAEGSAANVGRYPEDVYQGGNPWYLATLGASELLYDALYQWDRLGKLEVSETSLSFFKDFDATVKIGSYSRNSKTYKKLTQSIKSYADGFIQLVQQYTPSNGSLAEQYDRNTAAPLSANDLTWSFASFLTATQRRDAVVPPSWGAKSANKVPTTCSASPVVGTYKAPTATFSSKTKCVPAKDIVPITFYLIENTYYGENVFMSGNITALGNWDAKKGFPLTANLYTQDQNLWFASVEFIPAGTPFEYKYYKVEPNGDITWEKGPNRVFVAPTGCPVQPHSNDVWQF

SEQ ID NO: 37 - protein, 412 aa, Pyrococcus furiosus
AELEGLDESAAQVMATYVWNLGYDGSGITIGIIDTGIDASHPDLQGKVIGWVDFVNGRSYPYDDHGHGTHVASIAAGTGAASNGKYKGMAPGAKLAGIKVLGADGSGSISTIIKGVEWAVDNKDKYGIKVINLSLGSSQSSDGTDALSQAVNAAWDAGLVVVVAAGNSGPNKYTIGSPAAASKVITVGAVDKYDVITSFSSRGPTADGRLKPEVVAPGNWIIAARASGTSMGQPINDYYTAAPGTSMATPHVAGIAALLLQAHPSWTPDKVKTALIETADIVKPDEIADIAYGAGRVNAYKAINYDNYAKLVFTGYVANKGSQTHQFVISGASFVTATLYWDNANSDLDLYLYDPNGNQVDYSYTAYYGFEKVGYYNPTDGTWTIKVVSYSGSANYQVDVVSDGSLSQPGSS

SEQ ID NO: 38 - protein, 177 aa, Thermoascus aurantiacus
TRISSCSGSRQSALTTALRNAASLANAAADAAQSGSASKFSEYFKTTSSSTRQTVAARLRAVAREASSSSSGATTYYCDDPYGYCSSNVLAYTLPSYNIIANCDIFYTYLPALTSTCHAQDQATTALHEFTHAPGVYSPGTDDLAYGYQAAMGLSSSQAVMNADTYALYANAIYLGC

SEQ ID NO: 39 - protein, 583 aa, Synthetic construct
ATSDDWKGKAIYQLLTDRFGRADDSTSNCSNLSNYCGGTYEGITKHLDYISGMGFDAIWISPIPKNSDGGYHGYWATDFYQLNSNFGDESQLKALIQAAHERDMYVMLDVVANHAGPTSNGYSGYTFGDASLYHPKCTIDYNDQTSIEQCWVADELPDIDTENSDNVAILNDIVSGWVGNYSFDGIRIDTVKHIRKDFWTGYAEAAGVFATGEVFNGDPAYVGPYQKYLPSLINYPMYYALNDVFVSKSKGFSRISEMLGSNRNAFEDTSVLTTFVDNHDNPRFLNSQSDKALFKNALTYVLLGEGIPIVYYGSEQGFSGGADPANREVLWTTNYDTSSDLYQFIKTVNSVRMKSNKAVYMDIYVGDNAYAFKHGDALVVLNNYGSGSTNQVSFSVSGKFDSGASLMDIVSNITTTVSSDGTVTFNLKDGLPAIFTSATGGTTTTATPTGSGSVTSTSKTTATASKTSTSTSSTSCTTPTAVAVTFDLTATTTYGENIYLVGSISQLGDWETSDGIALSADKYTSSDPLWYVTVTLPAGESFEYKFIRIESDDSVEWESDPNREYTVPQACGTSTATVTDTWR

SEQ ID NO: 40 - protein, 186 aa, Thermobifida cellulosilytica
ADVIGGNPYYFGGYRCSIGFSVRKGSDTGFATAGHCGETGTLTRSPEGVVAGSYFPGRDMGWVRLTGADTVTPLVNRYDGGTVTVTGSQEAVTGSSVCRSGSTTGWRCGIIQSKNQTVRYAEGTVTGLTRTTACAEAGDSGGPWLTGSQAQGVTSGGSGNCRTGGITYFQPINPLLSYFGLELVTG

SEQ ID NO: 41 - protein, 186 aa, Thermobifida fusca
AAIIGGNPYYFGNYRCSIGFSVRQGSQTGFATAGHCGSTGTRVSSPSGTVAGSYFPGRDMGWVRITSADTVTPLVNRYNGGTVTVTGSQEAATGSSVCRSGATTGWRCGTIQSKNQTVRYAEGTVTGLTRTTACAEGGDSGGPWLTGSQAQGVTSGGTGDCRSGGITFFQPINPLLSYFGLQLVTG

SEQ ID NO: 42 - protein, 186 aa, Thermobifida halotolerans
TDIIGGNPYYFDGYRCSIGFSVRRGSESGFATAGHCGEEGTETSDPEGTVAGAYFPGRDMGWVRITDADTVTPLVNRYNGENVTVAGSREAATGSSVCRSGSTTGWRCGTIRSKNQTVRYIEGTVTGLTRTTACAEGGDSGGPWLTGSQGQGVTSGGSGNCTLGGVTYFQPLNPLLSHFDLDLVTG

SEQ ID NO: 43 - protein, 325 aa, Thermococcus nautili
LVPEPTQPAQEIPWGIERVKAPDTWSITTGASNGVIEVAILDTGIDWDHPDLKDNIAWGVSTIGGEVSTDPADWYDGNGHGTHVAGTIAALNNDIGVVGVAPNVEIYAIKVLDDRGSGAYTDIAIGIEQALLGPDGILDKDGDGIIVGDPDDDAAEVISMSLGGPSDDEYLHDMIIKAYNYGVVIVAASGNEAADQPSYPAIYPEVIAVGATDSSDAVAYFSNLQPEVSAPGVDVLSTYPDDTYESLSGTSMATPHVSGVVALIQAAYYNKYGKVLPVGTFDDMNTNTVRGILHVTADDLGDPGWDIYYGYGIVRADLAVQAALG

SEQ ID NO: 44 - protein, 459 aa, Trichoderma reesei
MAPSVTLPLTTAILAIARLVAAQQPGTSTPEVHPKLTTYKCTKSGGCVAQDTSVVLDWNYRWMHDANYNSCTVNGGVNTTLCPDEATCGKNCFIEGVDYAASGVTTSGSSLTMNQYMPSSSGGYSSVSPRLYLLDSDGEYVMLKLNGQELSFDVDLSALPCGENGSLYLSQMDENGGANQYNTAGANYGSGYCDAQCPVQTWRNGTLNTSHQGFCCNEMDILEGNSRANALTPHSCTATACDSAGCGFNPYGSGYKSYYGPGDTVDTSKTFTIITQFNTDNGSPSGNLVSITRKYQQNGVDIPSAQPGGDTISSCPSASAYGGLATMGKALSSGMVLVFSIWNDNSQYMNWLDSGNAGPCSSTEGNPSNILANNPNTHVVFSNIRWGDIGSTTNSTAPPPPPASSTTFSTTRRSSTTSSSPSCTQTHWGQCGGIGYSGCKTCTSGTTCQYSNDYYSQCL

SEQ ID NO: 45 - protein, 390 aa, Penicillium funiculosus
QAQLNTAAKAAGLLYFGTAVDNPDLSDSKYLVNLETADFGQITPANAMKWQPTEPSQGSYTFTQGDQIASLAKSNNDYLRCHNLVWYNQLPSYITSGSWTNATLIAALKEHINGVVTHYKGQCYAWDVVNEALNEDGTYRQNVFYQHIGEAYIPIAFAAAAAADPNAKLYYNDYNIEYAGAKATGAQGIVKLIQAAGGRIDGVGLQSHFIVGQTPSLATQKANMAAFTALGVDVAITELDIRMTLPDTSALQTQQSTDYQTTTTACVQTKGCVGITLWDYTDKYSWVPGTFSGQGDACPWDSNYNKKPAYYGILAGLQSGSGSSSSTSSTTLITTTTPTASSSTTSATTTSATSGAAHWGQCGGIGWSGPTICVSPYTCQVLNPYYSQCL

SEQ ID NO: 46 - protein, 694 aa, Myceliophthora sepedonium
MALRHIAAAAIAGLASRTAALYINGSVTAPCDSPIYCQGELLKAVELARPFVDSKTFVDMPTIKPVDEVLAAFSKLSLPLSNNSELNAFLYENFAQAGHELEEVPDSELETDAKFLDKLEDRTIKEFVGKVIDIWPDLTRRYAGPSNCTECANSFIPVNRTFVVAGGRFREPYYWDSYWIVEGLLRTGGAFTHISKNIIENFLDFVDTIGFIPNGARIYYLNRSQPPLLTLMVKSYVDYTNDTSILDRALPLLIKEHEFFMNNRTVSITGSNGKEYTLNRYHVENNQPRPESFREDYITANNGSYYASSGIIYPVKTPLNETEKAALYSNLATGAESGWDYTSRWLGVPSDAARDVYFPLRSLNVRDIVPVDLNSILYQNEVIIAEYLEKAGNSSAAKRFATAAEQRSEAMYSLMWNATHWSYFDYNLTDNTQHIFVPADEDTAPQDRIEAPPGQQVFFHIAQLYPFWTGAAPASLKANPLAVQQAYARVARMLDIKKGAIPATNYRTGQQWDQPNVWPPLQHILMKGLLNTPATFGKSDPAYQSVQNLALRLAQRYLDSTFCTWYATGGSTSDFPQLEGVTPGATGVMFEKYADNATNVAGGGGEYEVVEGFGWTNGVLIWAADVFGNKLKRPDCGNITAAHTHSSAKRGLEENKLPRRAVELDPWDAAWTKMFGRSKLRRREAEDVRKRWMS

SEQ ID NO: 47 - protein, 1020 aa, Talaromyces funiculosus
LPFNERVDQVLRSYEVTSKLDSRSTKPSKHGHTYQTQFLGVTWDQRNWRLQSTVLDQGHYESRGSIANGYIGLNVAGAGPLFELDSPVDGDVINGWPLFSRRQTFAGLAGFYDLQPRTNGTNFPWLSQYGDDSAISGVPHWGGMVLDLGDGEYLDATVDNSTISDYTTTYDYKAGVLSWDYKWTPKNANGSFGISYKIFANKLDVNQAVVQLSITPSTNGSASVVNVIDGYAAVRTDFVSSGNESDVVYTAVKPNGVTNVTAWIYTALDGDDAFDISSAALVNDKPYVHQNDSSIAQSVNVTFTAGTTITINKFVGAASTDAFPDPQSTAREAALSARRRGFDDLFRSHISEWAQVMPDDSVDDFTLANGTLPNDTFIIESAVMAVVNPYYLLQNTVGPNALRRVNNAPVNDWSIPVGGLTSDSYAGQIFWDADVWMQPGLVAAFPESAKRITNYRAAKYSQALENAKTAYTSSQNQTWFSPDAAIYSWTSGRVGNCTATGPCWDYEYHLNGDIGISLVNEWVVSGDNETFKNKHFPIYNSIATLYGDLLKKNGSYYTLTNMTDPDEYANNVDAGGYTMTLISQTLSNANAFRKQFGMNENTTWTEMADNILLIRENDVTLEYTTMNNSVAVKQADVILSTFPLDYTKNYTTSAALNDLDYYALKQSPDGPGMTYAIFSIVANDVSPSGCSAYTYAQYSYDPYIRGPFFQFSEQLLDDYTINGGTHPAFPFLTGHGGANQVVLYGYLGLRLLPDDMLHIDPNLPPQIPSIKYRTFYWRGWPIQAASNYTHTTIQRATTVAPLSTADPTYANKSIHVSVGHNTVNSTTYSLSANGSALVVPNRQIGSINTVAGNVVQCKSVLSTDAYQKGQYPISAVDGAASTKWQPEFAANISSLTVDLTGSNVSSVSGFYFDWAQAPPTNITVLLHNSSSAALASSGDKPGSSAVTLNITISNPYNASTYNANIIALPSSNSTNYTFPAPVPKPRYATLFVQGNQALDETDTKSGNGTGATVAEWAILS

SEQ ID NO: 48 - protein, 556 aa, Trametes cingulate
QSSAADAYVASESPIAKAGVLANIGPSGSKSNGAKAGIVIASPSTSNPNYLYTWTRDSSLVFKALIDQFTTGEDTSLRTLIDEFTSAEAILQQVPNPSGTVSTGGLGEPKFNIDETAFTDAWGRPQRDGPALRATAIITYANWLLDNKNTTYVTNTLWPIIKLDLDYVASNWNQSTFDLWEEINSSSFFTTAVQHRALREGATFANRIGQTSVVSGYTTQANNLLCFLQSYWNPTGGYITANTGGGRSGKDANTVLTSIHTFDPAAGCDAVTFQPCSDKALSNLKVYVDAFRSIYSINSGIASNAAVATGRYPEDSYMGGNPWYLTTSAVAEQLYDALIVWNKLGALNVTSTSLPFFQQFSSGVTVGTYASSSSTFKTLTSAIKTFADGFLAVNAKYTPSNGGLAEQYSRSNGSPVSAVDLTWSYAAALTSFAARSGKTYASWGAAGLTVPTTCSGSGGAGTVAVTFNVQATTVFGENIYITGSVPALQNWSPDNALILSAANYPTWSITVNLPASTTIEYKYIRKFNGAVTWESDPNNSITTPASGTFTQNDTWR

SEQ ID NO: 49 - protein, 591 aa, Talaromyces emersonii
ATGSLDSFLATETPIALQGVLNNIGPNGADVAGASAGIVVASPSRSDPNYFYSWTRDAALTAKYLVDAFIAGNKDLEQTIQQYISAQAKVQTISNPSGDLSTGGLGEPKFNVNETAFTGPWGRPQRDGPALRATALIAYANYLIDNGEASTADEIIWPIVQNDLSYITQYWNSSTFDLWEEVEGSSFFTTAVQHRALVEGNALATRLNHTCSNCVSQAPQVLCFLQSYWTGSYVLANFGGSGRSGKDVNSILGSIHTFDPAGGCDDSTFQPCSARALANHKVVTDSFRSIYAINSGIAEGSAVAVGRYPEDVYQGGNPWYLATAAAAEQLYDAIYQWKKIGSISITDVSLPFFQDIYPSAAVGTYNSGSTTFNDIISAVQTYGDGYLSIVEKYTPSDGSLTEQFSRTDGTPLSASALTWSYASLLTASARRQSVVPASWGESSASSVPAVCSATSATGPYSTATNTVWPSSGSGSSTTTSSAPCTTPTSVAVTFDEIVSTSYGETIYLAGSIPELGNWSTASAIPLRADAYTNSNPLWYVTVNLPPGTSFEYKFFKNQTDGTIVWEDDPNRSYTVPAYCGQTTAILDDSWQ

SEQ ID NO: 50 - protein, 555 aa, Pycnoporus sanguineus
QSSAVDAYVASESPIAKQGVLNNIGPNGSKAHGAKAGIVVASPSTENPDYLYTWTRDSSLVFKLLIDQFTSGDDTSLRGLIDDFTSAEAILQQVSNPSGTVSTGGLGEPKFNIDETAFTGAWGRPQRDGPALRATSIIRYANWLLDNGNTTYVSNTLWPVIQLDLDYVADNWNQSTFDLWEEVDSSSFFTTAVQHRALREGATFASRIGQSSVVSGYTTQADNLLCFLQSYWNPSGGYVTANTGGGRSGKDSNTVLTSIHTFDPAAGCDAATFQPCSDKALSNLKVYVDAFRSIYTINNGIASNAAVATGRYPEDSYMGGNPWYLTTSAVAEQLYDALYVWDQLGGLNVTSTSLAFFQQFASGLSTGTYSASSSTYATLTSAIRSFADGFLAINAKYTPADGGLAEQYSRNDGTPLSAVDLTWSYAAALTAFAAREGKTYGSWGAAGLTVPASCSGGGGATVAVTFNVQATTVFGENIYITGSVAALQNWSPDNALILSAANYPTWSITVNLPANTVVQYKYIRKFNGQVTWESDPNNQITTPSGGSFTQNDVWR

SEQ ID NO: 51 - protein, 556 aa, Gloeophyllum sepiarium
QSVDSYVSSEGPIAKAGVLANIGPNGSKASGASAGVVVASPSTSDPDYWYTWTRDSSLVFKSLIDQYTTGIDSTSSLRTLIDDFVTAEANLQQVSNPSGTLTTGGLGEPKFNVDETAFTGAWGRPQRDGPALRSTALITYGNWLLSNGNTSYVTSNLWPIIQNDLGYVVSYWNQSTYDLWEEVDSSSFFTTAVQHRALREGAAFATAIGQTSQVSSYTTQADNLLCFLQSYWNPSGGYITANTGGGRSGKDANTLLASIHTYDPSAGCDAATFQPCSDKALSNLKVYVDSFRSVYSINSGVASNAAVATGRYPEDSYQGGNPWYLTTFAVAEQLYDALNVWESQGSLEVTSTSLAFFQQFSSGVTAGTYSSSSSTYSTLTSAIKNFADGFVAINAKYTPSNGGLAEQYSKSDGSPLSAVDLTWSYASALTAFEARNNTQFAGWGAAGLTVPSSCSGNSGGPTVAVTFNVNAETVWGENIYLTGSVDALENWSADNALLLSSANYPTWSITVNLPASTAIEYKYIRKNNGAVTWESDPNNSITTPASGSTTENDTWR

SEQ ID NO: 52 - protein, 559 aa, Gloeophyllum trabeum
QSVDSYVGSEGPIAKAGVLANIGPNGSKASGAAAGVVVASPSKSDPDYWYTWTRDSSLVFKSLIDQYTTGIDSTSSLRSLIDSFVIAEANIQQVSNPSGTLTTGGLGEPKFNVDETAFTGAWGRPQRDGPALRATALITYGNWLLSNGNTTWVTSTLWPIIQNDLNYVVQYWNQTTFDLWEEVNSSSFFTTAVQHRALREGAAFATKIGQTSSVSSYTTQAANLLCFLQSYWNPTSGYITANTGGGRSGKDANTLLASIHTYDPSAGCDATTFQPCSDKALSNLKVYVDSFRSVYSINSGIASNAAVATGRYPEDSYQGGNPWYLTTFAVAEQLYDALNVWAAQGSLNVTSISLPFFQQFSSSVTAGTYASSSTTYTTLTSAIKSFADGFVAINAQYTPSNGGLAEQFSRSNGAPVSAVDLTWSYASALTAFEARNNTQFAGWGAVGLTVPTSCSSNSGGGGGSTVAVTFNVNAQTVWGENIYITGSVDALSNWSPDNALLLSSANYPTWSITVNLPASTAIQYKYIRKNNGAVTWESDPNNSITTPASGSVTENDTWR

SEQ ID NO: 53 - protein, 337 aa, Gonapodya prolifera
MARLSSLIALVLAFVAVSAPALAARGRPRLNGKTFVADSGVPLRGPFTSTEWTPAVPAANIANMRNYNFNAIHLYAETFDPNYPAAGSQKPGYAATRVDQIVAATKAANMYVVIVLANGANNGKFNLNYAKDFWSFYAARYKNETHVIYEIHNEPVQWGPPYISSTQSPGAVSMNADCYKIIRAVAPDTPVLLFTYASIGGGSSAAGAVKDAQSFNTAVFGNANAQWTNEAIAIHGYWGAQGASDAAKALNAAGFSVVLTEFAAATSPTSPNGGQDTVLTGFMEQQGVSWLTFLHVPPTGVSGDVTDPNQYTNRMTAAGIGFDRDPGLNAVGGGQAA

SEQ ID NO: 54 - protein, 536 aa, Paenibacillus favisporus
WNGMPMSKLHVSGNQLVNSSGQPVLLSGWHQPSGSYWTYQSSSYYLDRNGGNRHAAILDYLKVITDTFTGTSAKYGSSHGWYMNQVRLFIDREDMGDVAAGTYNFAGLQSVTQDVIIPYIAYAKTKGLYVTLGLDFTLSNNQATTPSNLNKFNEIWGYLASQPAIKSADNVMFELINEPVLSDVNGQWGGNPSQPNFADYWNSLKKFQNSIISTIRSKGADNVIWAAGLGWDQYYQLCASSPLTDPLNNIGYSVHWYPGYGAHDDYATLQQQWDTNIKPCADHYPINITETTWFKTQPGDSSYWELFNGSNEGFGKNTKAIFTAAGNVSMTAHMNGFLLEPGTRSSFADPTAGLKYDGNTARDGMARFLFEWYYERAQLNPWNGIWNGVLSGSTYKIVNRASGKAIDVPGGQNTNGLQLQQWSDNNATAQQWVADDLGTYNNVYRLRSVSSADQKVMDIRNGTKNNGEAVQLMQDLGNTAQQFRLIKLSNGYWSILNVNSNKAVEVAGASSADGAKLQQNLYRGDLNQQWQLVKIN

SEQ ID NO: 55 - protein, 335 aa, Talaromyces pinophilus
MISLAPALLLLLPAVSGLALPTDEATQNTTVARSGCPLPSSYSWTSTGPLANPASGFLALKDFTHVPYNGQHLVYASDVNNAGSYGSLNFGLFSDWNSMGSVAQHTMSAGTVAPQLFYFTPKNIWVLAYEWGASPFSYRTSSDPTNANGWSSPQPLYTGSTGSSTGPIDPSLIGDSQNMYLFFAGDNGKIYRASMPIGNFPGNFGSSAQVVLSDSTVNLFEAVQVYSVQGQNQYLMIVEARDPSENRYFRSFTASSLSGSWAPQATSVSAPFAGKANSGASWTNDISSGDLIRASADQTMPVDACNLQLLYQGRATNSGGSYNDLPYRPGLLTHK

SEQ ID NO: 56 - protein, 558 aa, Humicola insolens
MLGLKVLCLSAVVGTAVSVPHAGNLPRQASTFTNPVLWEDHPDLEVFRVGSVFYYSSSTFAYSPGAPVLKSYDLVHWTPVTHSVPRLNFGSNYDLPSGTPGAYVKGIWASTLRYRRSNDRFYWYGCVEGRTYLWTSPGGNALANNGEVPPSAWNWQHTATIDNCYYDAGLLIDDDDTMYIAYGNPTINVAQLSPDGTRQVRVQQRVYAHPQGQTVEGARMYKIRGNYYILVTRPADAEYVLRSTTGSPFGPYEARTLVSRIQGPLANAGFAHQGGIVDAPDGTWHYVAFMDAYPGGRIPVVAPLRWTADGWPEVVTDSQGRWGTSYPIPVRGAKNATEGLASTDLDEFRGTRFSEHWEWNHNPDTSKFTLLGGNEGGLILRTATVTGDLFAARNTLTRRIAGPKASGIFRLDVRGMRDGDRAGAVLFRDRAAYIGVWKQGNEARIVMVDDLRLNEDGWRTASTGRVAANGPVIDTNAQQDIWLRIDADITPAFGTNTERTTTFYYSIDGGRTYTRLGPAFAMTNSWRYFTGYRFGVFNFSTKSLGGEVKVKGFKMNMI

SEQ ID NO: 57 - protein, 575 aa, Humicola insolens
MKPLAQLISSGLALLQGITMAAAAPPVPPTPRNSTFYNPVLPGWHSDPSCVYVSGLFYCVTSTFISFPGLPVYASRDLINWRLASHVWNRESQLPGYSWATTEQQLGMFAATLRHRDGVFYVICEYLGVEGKEAGVLFKTTDPFSEEAWSDPVFFHAEKIDPDLFWDDDGKVYVATQGIILQEMDIETGALTPAVELWNGTGGVWPEGPHIYKRDGWYYLMIAEGGTAEDHAITIARARNIYGPYEAYEKNPILTNRGTNEYFQTVGHGDLFQDANGNWWGMCLATRSGPAYKSYPMGRETVLFPVTWREGEWPILQPVKGVMEGWPLPPRSRDVPGDGPFNEDPDDYDFKDGKLPKHLVYWRVPRPGHIEAVRGKGLRVRLNRNNLAGTPGGPEPAARAISFIARRQTHSVFRFGVDLSFSPREDGQEAGVVAFLTQLANIHLGLVRLEGELKLRFNASGAVTTRAVPKSWGRAESVRLEITMEKPSEYIFSALRPGDRASRIELGRASAELLSGGSGSFVGTLLGVYATCNGSGSGLDCPKGTPDAYFTRWNYVGDGQYVTETQVVRTGKGGK

SEQ ID NO: 58 - protein, 663 aa, Colletotrichum graminicola
MVSLKSAFLAATYAVSAAAVDITVKSSGGNATSGHQYGFLHEDINNSGDGGIYAELIRNRAFQYSDEFPVSLAAWHPVNGAKLALKNLAQPLSSALPVSVQVSGGNSSGAIGLKNDGYWGMDVKVQKYTGSFWVKGAYDGVFTASLQSALTDDVFGSVEIQSKAKADEWVEHEVELVPEKNAPNSNNTFAITFDPAGTANGSLNFNLISLFPPTYKGRKNGLRIDIAEALAGLHPSLLRFPGGNMLEGLNNKTYWDWKDTLGPLKDRPGFQGVWGYQQTHGLGLVEYLEWAQDMNLDVVIGVWAGLALNGDVTAKEDLQPFIDDALDQIEFIRGPADSKWGARRAELGHPEPFTLEYVEVGNEDWLAGYPGGWESYKEYRFPMFMEAILAKYPDITVISSGATSDADGYDIPPPAIGDYHPYRTPDALVDEFDRFDNDIGHIVGEVAATHPNGGIGWEGNLMPFPWWIGTVGEAVSLIGYERNADRIPGTFYAPVLRNMNRWQWAVTIVQFAADPAITTRSTSWFVWELFAAHPMSETLPTVGEFGPAYWVAGKNEAKGSLIWKGAVYNTTDSADVPINVRFEGVAAGTTASLTVLTNPGGDPYAYNDPLAGTNVVASNTTTVTANEDGVFAFSLPELSVALLDTEGSAGAKQAARAVKSFRA

SEQ ID NO: 59 - protein, 643 aa, Trametes hirsuta
MKLLFLLGAFVAQCLAVTVTVNKNPSHTVPSTLYGLMFEDINHSGDGGLYAELLQNRAFQQVTPNTAAALAAWHPISNAKLAVIQDPSPVSNALPNSLQFSVPSGSSGRVGFTNEGFWGIKVDSTWTYKASLFFRFPTSSSFSGALTVGLQTNAGRVLAQNSTQIRGTTTKWTQINLELHPTASAPDVSNSFFVTIDGAAGAGQTINFAMFSLFPPTFKNRPNGLRADIAETLAEMGPSFFRFPGGNNLEGQTTATRWQWNATVGSLLDRPGRVGDWGYVNTDGLGLLEYLQFFEDTGMEPIMAVWAGYSLGGTSLAENQLAPYIQQAIDQINFVIGDPAKSAPAALRASLGHPEPFTLRFVEVGNEDFFAAGSYPYRWHDFVTALQAQFPQIRFIATTNAWNPVLSPVPQSYDVHVYQTPTWFYQNAFYYDGFQRNGTTYFEGEYAAISTNANDLFGTVADGRLAFPTVQSATGEAAFMTGLERNSDIVFAASYAPLLQHVNSTQWTPDLVSYDAGSVIKSTSFFAQKLFALNKGDQYLPSTLPTNGGTLHWSITRASSSGKTFIKIANAGSSAQSLTFQLTQFNSVSSTGTLQVLTGPETASNTPEAPQAIVPKTSTIGTGKTFTYNAPAFSVSVITVTTN

(19) United States
(12) Patent Application Publication
(10) Pub. No.: US 2026/0363273 A1
(43) Pub. Date: Nov. 19, 2026

(54) ENZYME BLENDS AND PROCESSES FOR PRODUCING A HIGH PROTEIN FEED INGREDIENT FROM A WHOLE STILLAGE BYPRODUCT

(71) Applicant: Novozymes A/S, Bagsvaerd (DK)

(72) Inventors: Kurt Creamer, Apex, NC (US); Kalpesh Parekh, Raleigh, NC (US); James Lavigne, Wake Forest, NC (US)

(73) Assignee: Novozymes A/S, Bagsvaerd (DK)

(21) Appl. No.: 19/757,758

(22) Filed: Jul. 29, 2026

Related U.S. Application Data
(62) Division of application No. 17/633,011, filed on Aug. 5, 2020.
(60) Provisional application No. 62/882,698, filed on Aug. 5, 2019.

(51) Int. Cl. A23K 10/14; A23K 10/38; A23K 20/147

(52) U.S. Cl. CPC A23K 10/14; A23K 10/38; A23K 20/147

(57) ABSTRACT

The present invention relates to a process for producing a high protein feed ingredient from a whole stillage byproduct produced in a starch-containing grain dry milling process for producing a fermentation product, as well as enzyme blends used in the processes for partitioning a greater amount of protein from the whole stillage byproduct into the high protein fraction, rather than being retained in the wet cake, to produce a high protein feed ingredient.

### CROSS-REFERENCE TO RELATED APPLICATIONS

This application is a divisional application of U.S. application Ser. No. 17/633,011 filed Feb. 4, 2022, which is a 35 U.S.C. 371 national application of international application no. PCT/US2020/044955 filed Aug. 5, 2020, which claims priority or the benefit under 35 U.S.C. 119 of U.S. provisional application No. 62/882,698 filed Aug. 5, 2019, the contents of which are fully incorporated herein by reference.

### REFERENCE TO SEQUENCE LISTING

This application contains a Sequence Listing that was submitted as an xml file named SQ_ST26.xml (created on Jul. 29, 2026, containing 78 bytes), which is incorporated herein by reference.

### FIELD OF THE INVENTION

The present invention relates to a process for producing a high protein feed ingredient from a whole stillage byproduct produced in a process for producing a fermentation product from a starch-containing or cellulosic-containing material, as well as enzyme blends used in the processes for partitioning a greater amount of protein from the whole stillage byproduct into the high protein fraction, rather than being retained in the wet cake, to produce a high protein feed ingredient.

### BACKGROUND OF THE INVENTION

Processes for producing fermentation products, such as ethanol, from a starch or lignocellulose containing material are well known in the art. The preparation of the starch containing material such as corn for utilization in such fermentation processes typically begins with grinding the corn in a dry-grind or wet-milling process. Wet-milling processes involve fractionating the corn into different components where only the starch fraction enters the fermentation process. Dry-grind processes involve grinding the corn kernels into meal and mixing the meal with water and enzymes. Generally, two different kinds of dry-grind processes are used. The most commonly used process, often referred to as a “conventional process,” includes grinding the starch-containing grain and then liquefying gelatinized starch at a high temperature using typically a bacterial alpha-amylase, followed by simultaneous saccharification and fermentation (SSF) carried out in the presence of a glucoamylase and a fermentation organism. Another well-known process, often referred to as a “raw starch hydrolysis” process (RSH process), includes grinding the starch-containing grain and then simultaneously saccharifying and fermenting granular starch below the initial gelatinization temperature typically in the presence of an acid fungal alpha-amylase and a glucoamylase.

In a process for producing ethanol from corn, following SSF or the RSH process, the liquid fermentation products are recovered from the fermented mash (often referred to as “beer mash”), e.g., by distillation, which separates the desired fermentation product, e.g. ethanol, from other liquids and/or solids. The remaining fraction is referred to as “whole stillage”. Whole stillage typically contains about 10 to 20% solids. The whole stillage is separated into a solid and a liquid fraction, e.g., by centrifugation. The separated solid fraction is referred to as “wet cake” (or “wet grains”) and the separated liquid fraction is referred to as “thin stillage”. Wet cake and thin stillage contain about 35 and 7% solids, respectively. Wet cake, with optional additional dewatering, is used as a component in animal feed or is dried to provide “Distillers Dried Grains” (DDG) used as a component in animal feed. Thin stillage is typically evaporated to provide evaporator condensate and syrup or may alternatively be recycled to the slurry tank as “backset”. Evaporator condensate may either be forwarded to a methanator before being discharged and/or may be recycled to the slurry tank as “cook water”. The syrup may be blended into DDG or added to the wet cake before or during the drying process, which can comprise one or more dryers in sequence, to produce DDGS (Distillers Dried Grain with Solubles). Syrup typically contains about 25% to 35% solids. Oil can also be extracted from the thin stillage and/or syrup as a by-product for use in biodiesel production, as a feed or food additive or product, or other biorenewable products.

WO 2010/138110 A1 (incorporated herein by reference in its entirety) is directed to a method for producing a high protein corn meal from a whole stillage byproduct produced in a corn dry-milling process for making ethanol and a system therefore. The method therein includes separating the whole stillage byproduct into an insoluble solids portion and a thin stillage portion. The thin stillage portion is separated into a protein portion and a water soluble solids portion. Then, the protein portion is dewatered and dried to define a high protein corn meal that includes at least 40 wt percent protein on a dry basis. However, the method and system therein suffer from the shortcoming that a significant amount of protein in the initial whole stillage byproduct is retained in the wet cake rather being partitioned to the protein portion that is dewatered and dried to define the high protein corn meal, resulting in a high protein corn meal with less protein than is theoretically possible based on the amount of protein in the initial whole stillage by product.

Therefore, there is a need for an improved method of producing a high protein feed ingredient from a whole stillage byproduct wherein greater amounts of protein from the whole stillage byproduct are partitioned into the high protein fraction, rather than being retained in the wet cake.

### SUMMARY OF THE INVENTION

The present invention provides a solution to the above problem by using a hemicellulase, beta-glucanase or an enzyme blend comprising a hemicellulase and/or beta-glucanase to improve the partitioning of protein into the high protein fraction, for example by adding the hemicellulase and/or beta-glucanase, or an enzyme blend comprising the hemicellulase and/or beta-glucanase upstream during the process for producing a fermentation product from a starch-containing and/or cellulosic-containing material, for example during the saccharification, fermentation, or simultaneous saccharification and fermentation step.

The present invention more particularly relates to the addition of a hemicellulase, beta-glucanase or hemicellulase and/or beta-glucanase containing enzyme blends during the SSF process to produce a high protein feed ingredient.

The present invention contemplates using hemicellulases or beta-glucanases alone, as well as in enzyme blends comprising hemicellulase(s) and/or beta-glucanase(s) and preferably at least one additional enzyme, such as a cellulolytic composition, in saccharification, fermentation, or simultaneous saccharification and fermentation, to produce a high protein feed ingredient downstream in conventional, raw-starch hydrolysis (RSH), and cellulosic ethanol production processes.

The present invention contemplates treating whole stillage (e.g., a whole stillage byproduct of an ethanol production process) with hemicellulases or beta-glucanases alone, as well as in enzyme blends comprising hemicellulase(s) and/or beta-glucanase(s) and preferably at least one additional enzyme, such as a cellulolytic composition, to produce a high protein feed ingredient.

In an aspect, the present invention provides a method for producing a high protein feed ingredient from a whole stillage byproduct produced in a starch-containing grain dry milling process for producing a fermentation product, the method comprising:
a) optionally performing a starch-containing grain dry milling process for producing a fermentation product to produce a fermentation product and a whole stillage byproduct;
b) separating the whole stillage byproduct into an insoluble solids portion and a thin stillage portion;
c) separating the thin stillage portion into at least a first separated water-soluble solids portion, and at least a first separated protein portion;
d) optionally separating at least the first separated protein portion into at least a second separated water-soluble solids portion, and at least a second separated protein portion;
e) drying at least the first separated protein portion, and/or optionally at least the second separated protein portion, to define a protein product, wherein the protein product is a high protein feed ingredient;
wherein a hemicellulase, beta-glucanase, or an enzyme blend comprising a hemicellulase and/or beta-glucanase is added prior to or during production of the whole stillage byproduct, and/or separating the whole stillage byproduct.

In an embodiment, separating step b) is performed by subjecting the whole stillage byproduct to a filtration centrifuge, a decanter centrifuge, a pressure screen, or a paddle screen. In an embodiment, separating step c) is performed by subjecting the thin stillage portion to a centrifuge or a cyclone apparatus. In an embodiment, optional separating step d) is performed by subjecting the first separated protein portion to a centrifuge or a cyclone apparatus. In an embodiment, drying step e) is performed by subjecting at least the first separated protein portion and/or optionally the at least the second separated protein portion to a decanter centrifuge to dewater the first and/or optionally the second separated protein portions to define the high protein feed ingredient. In an embodiment, the high protein feed ingredient includes at least 40 wt percent protein on a dry basis. In an embodiment, the starch-containing grain comprises maize, corn, wheat, rye, barley, triticale, sorghum, switchgrass, millet, pearl millet, foxtail millet. In an embodiment, the high protein feed ingredient is a high protein corn-based animal feed. In an embodiment, the method further includes, after separating the whole stillage byproduct into an insoluble solids portion and a thin stillage portion and before separating the thin stillage portion into a first separated protein portion and a first separated water-soluble solids portion, separating fine fiber from the thin stillage portion. In an embodiment, separating fine fiber from the thin stillage portion comprises separating the fine fiber via a pressure screen, paddle screen, decanter, or filtration centrifuge. In an embodiment, the method further includes separating soluble solids from the first separated water-soluble solids portion to provide a first soluble solids portion, and optionally separating soluble solids from the second separated water-soluble solids portion to provide a second soluble solids portion. In an embodiment, the method further includes separating free oil from the first separated water-soluble solids portion to provide a first oil portion, and optionally separating free oil from the second separated water-soluble solids portion to provide a second oil portion.

In an embodiment, the hemicellulase and/or beta-glucanase, or the enzyme blend comprising at least one hemicellulase and/or beta-glucanase is added prior to separation of the whole stillage into insoluble solids and thin stillage. In an embodiment, the hemicellulase, beta-glucanase, or the enzyme blend comprising at least one hemicellulase and/or at least one beta-glucanase is added during the separation of the whole stillage byproduct into the insoluble solids portion and the thin stillage portion. In an embodiment, the hemicellulase and/or beta-glucanase, or the enzyme blend comprising at least one hemicellulase and/or beta-glucanase is added to the whole stillage prior to separation into insoluble solids and thin stillage.

In an embodiment, step a) is performed and performing step a) comprises:
(ii) saccharifying a starch-containing grain at a temperature below the initial gelatinization temperature with an alpha-amylase and a glucoamylase; and
(iii) fermenting using a fermentation organism to produce the fermentation product.

In an embodiment, step a) is performed and performing step a) comprises:
(i) liquefying a starch-containing grain with an alpha-amylase;
(ii) saccharifying the liquefied material obtained in step (i) with a glucoamylase; and
(iii) fermenting the saccharified material obtained in step (ii) using a fermenting organism.

In an embodiment, the hemicellulase and/or beta-glucanase, or enzyme blend comprising at least one hemicellulase and/or beta-glucanase is added during saccharifying step (ii) and/or fermenting step (iii). In an embodiment, saccharification and fermentation is performed simultaneously. In an embodiment, the fermentation product is alcohol, particularly ethanol, more particularly fuel ethanol. In an embodiment, the fermenting organism is yeast, particularly Saccharomyces sp., more particularly Saccharomyces cerevisiae. In an embodiment, the yeast is a recombinant cell comprising a heterologous polynucleotide expressing the hemicellulase and/or beta-glucanase and the enzymes are expressed in situ by the fermenting organism during fermentation or simultaneous saccharification and fermentation. In an embodiment, the hemicellulase and/or beta-glucanase are added exogenously during saccharification, fermentation, or simultaneous saccharification and fermentation. In some instances, at least some of the hemicellulase(s) and/or beta-glucanase(s) are exogenously added during saccharification, fermentation, or simultaneous saccharification and fermentation, and at least some of the hemicellulase(s) and/or beta-glucanase(s) are expressed in situ during fermentation or simultaneous saccharification and fermentation by the fermenting organism. In an embodiment, the hemicellulase is selected from the group consisting of an acetylxylan esterase, a α-glucuronidases, a α-L-arabinofuranosidases, a α-L-galactosidase, a beta-xylosidase, a feruloyl esterase, a α-D-galactosidase, a pectin-degrading enzyme, a xylanase, and any combination thereof. In an embodiment, the xylanase is from a glycoside hydrolase family selected from the group consisting of a GH3 family xylanase, GH5 family xylanase, a GH8 family xylanase, a GH10 family xylanase, a GH11 family xylanase, a GH30 family xylanase, a GH43 family xylanase, and a GH98 family xylanase. In an embodiment, the GH5 family xylanase is from a GH family selected from the group consisting of GH5_21, GH5_34 and GH5_35. In an embodiment, the GH5_21 xylanase is from the genus Chryseobacterium, for example Chryseobacterium sp-10696, such as the xylanase shown in amino acids 25 to 551 of SEQ ID NO: 5 or amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 or amino acids 25 to 551 of SEQ ID NO: 6. In an embodiment, the G5_34 xylanase is from the genus Acetivibrio, for example Acetivibrio cellulyticus, such as the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7. In an embodiment, the G5_34 xylanase is from the genus Clostridium, for example Clostridium thermocellum, such as the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8. In an embodiment, the GH5_35 xylanase is from the genus Paenibacillus, for example Paenibacillus illinoisensis, such as the xylanase shown in amino acids 37 to 573 of SEQ ID NO: 9, or for example Paenibacillus sp., such as the xylanase shown in amino acids 36 to 582 of SEQ ID NO: 10, or for example Paenibacillus favisporus, such as the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9, amino acids 36 to 582 of SEQ ID NO: 10, or amino acids 1 to 536 of SEQ ID NO: 54.

In an embodiment, the GH30 family xylanase is a GH30_8 xylanase. In an embodiment, the GH30_8 family xylanase is from the genus Bacillus, for example Bacillus subtilis, such as the xylanase shown in amino acids 28 to 417 of SEQ ID NO: 3 or amino acids 28 to 417 of SEQ ID NO: 4, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4.

In an embodiment, the GH10 xylanase is from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1.In an embodiment, the GH10 family xylanase is from the genus Talaromyces, for example Talaromyces leycettanus, such as the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2. In an embodiment, the GH10 family xylanase is from the genus Penicillium, for example, Penicillium funiculosum, such as the xylanase shown in amino acids 20 to 407 of SEQ ID NO: 45 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 407 of SEQ ID NO: 45. In an embodiment, the xylanase is from the genus Aspergillus, for example Aspergillus fumigatus, such as the xylanase shown in SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 373 of SEQ ID NO: 1. In an embodiment, the beta-xylosidase is from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12. In an embodiment, the hemicellulase comprises: (i) a xylanase from the genus Aspergillus, for example Aspergillus fumigatus, such as the xylanase shown in SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 373 of SEQ ID NO: 1; and (ii) a beta-xylosidase from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12. In an embodiment, the α-glucuronidase is selected from the group consisting of a GH115 α-glucuronidase having xylan a-1,2-glucuronidase activity, a GH4 α-glucuronidase having α-glucuronidase activity, and a GH67 α-glucuronidase having xylan α-1,2-glucuronidase activity. In an embodiment, the acetylxylan esterase is from a family selected from the group consisting of CE1, CE2, CE3, CE4, CE5, CE6, CE7, CE12, CE15 and PF05448. In an embodiment, the α-L-arabinofuranosidase (also referred to herein as arabinofuranosidase) is from a glycoside hydrolase family selected from the group consisting of GH43, GH51 and GH62. In an embodiment, the GH43 α-L-arabinofuranosidase is from a subfamily selected from the group consisting of 1, 10, 11, 12, 19 21, 26, 27, 29, 35 and 36. In an embodiment, the GH43 arainofuranosidase is from the genus Humicola, for example Humicola insolens, such as the arabinofuranosidase shown in amino acids 19 to 558 of SEQ ID NO: 56 or the arabinofuranosidase shown in amino acids 24 to 575 of SEQ ID NO: 57, or one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57. In an embodiment, the GH51 arainofuranosidase is from the genus Colletotrichum, for example Colletotrichum graminicola, such as the arabinofuranosidase shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58. In an embodiment, the GH51 arainofuranosidase is from the genus Trametes, for example Trametes hirsuta, such as the arabinofuranosidase shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59. In an embodiment, the GH62_1 α-L-arabinofuranosidase is from the genus Talaromyces, for example Talaromyces pinophilus, such as the α-L-arabinofuranosidase (arabinofuranosidase) shown in amino acids 17 to 325 of SEQ ID NO: 11, or shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or amino acids 18 to 335 of SEQ ID NO: 55.

In an embodiment, the α-D-galactosidase and/or α-L-galactosidase are from a glycoside hydrolase family selected from the group consisting of GH27, GH36, GH4 and GH57_A. In an embodiment, the pectin-degrading enzyme is selected from the group consisting of an arabinase (e.g., GH43 family), a galactanase (e.g., GH53 family), a pectin acetylesterase/rhamnogalacturonan acetylesterase (e.g., CE12 family), a pectate lyase (e.g., PL1 family), a pectin lyase (e.g., PL1 family), a pectin metylesterase (e.g., CE12 family), a polygalacturonase (e.g., GH28 family), a rhamnogalacturonan hydrolase (e.g., GH28 family), a rhamnogalacturonan lyase (e.g., PL4 family), a xylogalacturonan hydrolase (e.g., GH28 family), and any combination thereof.

In an embodiment, the beta-glucanase is a GH5_15 family beta-glucanase. In an embodiment, the GH5_15 family beta-glucanase is from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14. In an embodiment, the GH5_15 family beta-glucanase is from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17.

In an embodiment, the beta-glucanase is a GH16 family beta-glucanase. In an embodiment, the GH16 family beta-glucanase is from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19.

In an embodiment, the beta-glucanase is a GH64 family beta-glucanase. In an embodiment, the GH64 beta-glucanase is from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20. The beta-glucanase(s) increases the percent protein on a dry basis of the high protein feed ingredient.

In an embodiment, the enzyme blend further comprises a cellulolytic composition. In an embodiment, the cellulolytic composition is present in the blend in a ratio of hemicellulase and cellulolytic composition from about 5:95 to about 95:5, such as from 5:95, 10:90, 20:80, 25:75, 50:50, 80:20, 75:25, 90:10, and 95:5. In an embodiment, the cellulolytic composition comprises at least one, at least two, at least three, or at least four enzymes selected from the group consisting of:
(i) a cellobiohydrolase I;
(ii) a cellobiohydrolase II;
(iii) a beta-glucosidase; and
(iv) a GH61 polypeptide having cellulolytic enhancing activity. In an embodiment, the cellulolytic composition comprises at least one, at least two, at least three, or at least four enzymes selected from the group consisting of:
(i) an Aspergillus fumigatus cellobiohydrolase I;
(ii) an Aspergillus fumigatus cellobiohydrolase II;
(iii) an Aspergillus fumigatus beta-glucosidase; and
(iv) a Penicillium emersonii GH61A polypeptide having cellulolytic enhancing activity. In an embodiment, the cellulolytic composition comprises:
(i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
(iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or
(iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24. In an embodiment, the cellulolytic composition further comprises an endoglucanase. In an embodiment, the cellulolytic composition comprises a cellobiohydrolase, a beta-glucosidase, and an endoglucanase. In an embodiment, the cellulolytic composition comprises: a cellobiohydrolase I; a beta-glucosidase; and an endoglucanase I. In an embodiment, the cellulolytic composition comprises: an Aspergillus cellobiohydrolase I; an Aspergillus beta-glucosidase; and a Trichoderma endoglucanase I. In an embodiment, the cellulolytic composition comprises: an Aspergillus fumigatus cellobiohydrolase I; an Aspergillus fumigatus beta-glucosidase; and a Trichoderma reesei endoglucanase I. In an embodiment, the cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

In an embodiment, the cellulolytic composition is derived from a strain selected from the group consisting of Aspergillus, Penicilium, Talaromyces, and Trichoderma, optionally wherein: (i) the Aspergillus strain is selected from the group consisting of Aspergillus aurantiacus, Aspergillus niger and Aspergillus oryzae; (ii) the Penicillium strain is selected from the group consisting of Penicillium emersonii and Penicillium oxalicum; (iii) the Talaromyces strain is selected from the group consisting of Talaromyces aurantiacus and Talaromyces emersonii; and (iv) the Trichoderma strain is Trichoderma reesei. In an embodiment, the cellulolytic composition comprises a Trichoderma reesei cellulolytic composition.

In an aspect, the present invention provides an enzyme blend comprising a hemicellulase for producing a high protein feed ingredient from a whole stillage byproduct produced in a process for producing a fermentation product (e.g., from a starch-containing or a cellulosic-containing material).

In an aspect, the present invention relates to the use of the enzyme blend comprising a hemicellulase for producing a high protein feed ingredient from a whole stillage byproduct produced in a process for producing a fermentation product (e.g., from a starch-containing or a cellulosic-containing material).

In an aspect, the present invention provides an enzyme blend comprising a beta-glucanase for producing a high protein feed ingredient from a whole stillage byproduct produced in a process for producing a fermentation product (e.g., from a starch-containing or a cellulosic-containing material).

In an aspect, the present invention relates to the use of the enzyme blend comprising a beta-glucanase for producing a high protein feed ingredient from a whole stillage byproduct produced in a process for producing a fermentation product (e.g., from a starch-containing or a cellulosic-containing material).

In an aspect, the present invention provides an enzyme blend comprising at least one hemicellulase and/or at least one beta-glucanase for producing a high protein feed ingredient from a whole stillage byproduct produced in a process for producing a fermentation product (e.g., from a starch-containing or a cellulosic-containing material).

In an aspect, the present invention relates to the use of the enzyme blend comprising at least one hemicellulase and/or at least one beta-glucanase for producing a high protein feed ingredient from a whole stillage byproduct produced in a process for producing a fermentation product (e.g., from a starch-containing or a cellulosic-containing material).

In an aspect, the present invention provides an enzyme blend comprising at least one hemicellulase and/or at least one beta-glucanase, and a cellulolytic composition for producing a high protein feed ingredient from a whole stillage byproduct produced in a process for producing a fermentation product (e.g., from a starch-containing or a cellulosic-containing material).

In any of the aspects described above, the at least one hemicellulase may be selected from the group consisting of the mature polypeptide of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, SEQ ID NO: 59 and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, or SEQ ID NO: 59; and the at least one beta-glucanase may be selected from the group consisting of the mature polypeptide of SEQ ID NO: 14, SEQ ID NO: 15, SEQ ID NO: 16, SEQ ID NO: 17, SEQ ID NO: 18, SEQ ID NO: 19, SEQ ID NO: 20, and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 14, SEQ ID NO: 15, SEQ ID NO: 16, SEQ ID NO: 17, SEQ ID NO: 18, SEQ ID NO: 19, or SEQ ID NO: 20.

In an aspect, the present invention relates to the use of the enzyme blend comprising at least one hemicellulase and/or at least one beta-glucanase, and a cellulolytic composition for producing a high protein feed ingredient from a whole stillage byproduct produced in a process for producing a fermentation product (e.g., from a starch-containing or a cellulosic-containing material).

In an aspect, the present invention relates to a composition comprising;
(a) a recombinant yeast host cell comprising a heterologous polynucleotide encoding a glucoamylase, an alpha-amylase, protease, and/or cellulase; and
(b) at least one hemicellulase and/or at least one beta-glucanase.

In one embodiment, the composition is a fermenting or fermented mash composition comprising the recombinant yeast host cell and the at least one hemicellulase and/or at least one beta-glucanase. In another embodiment, the composition is a whole stillage composition comprising the recombinant yeast host cell and the at least one hemicellulase and/or at least one beta-glucanase.

In an embodiment, the fermenting or fermented mash composition or whole stillage composition comprises:
(a) a recombinant yeast host cell comprising a heterologous polynucleotide encoding a glucoamylase, an alpha-amylase, protease, and/or cellulase; and
(b) at least one hemicellulase and/or at least one beta-glucanase,
wherein the at least one hemicellulase is selected from the group consisting of the mature polypeptide of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, SEQ ID NO: 59 and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, or SEQ ID NO: 59; and
wherein the at least one beta-glucanase is selected from the group consisting of the mature polypeptide of SEQ ID NO: 14, SEQ ID NO: 15, SEQ ID NO: 16, SEQ ID NO: 17, SEQ ID NO: 18, SEQ ID NO: 19, SEQ ID NO: 20, and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 14, SEQ ID NO: 15, SEQ ID NO: 16, SEQ ID NO: 17, SEQ ID NO: 18, SEQ ID NO: 19, or SEQ ID NO: 20.

### BRIEF DESCRIPTION OF THE DRAWING

FIG. 1 is a flow diagram of an exemplary laboratory procedure used to obtain the results of the experiment described in Example 1, the results of which are shown in FIG. 2, FIG. 3 and FIG. 4.

FIG. 2 is a graph showing the percentage protein content partitioned into a high protein feed ingredient upon treatment of whole stillage with low, medium, and high doses of an enzyme blend comprising a hemicellulase and cellulolytic composition, demonstrating that enzyme-treated whole stillage results in a higher protein content being partitioned into the high protein feed ingredient compared to a control whole stillage sample not treated with the enzyme blend.

FIG. 3 is a graph showing the percentage mass fraction on a dry basis that is partitioned into a high protein feed ingredient upon treatment of whole stillage with low, medium, and high doses of an enzyme blend comprising a hemicellulase and cellulolytic composition, demonstrating that enzyme-treated whole stillage results in a higher fraction of the starting mass of the whole stillage being partitioned into the high protein feed ingredient compared to a control whole stillage sample not treated with the enzyme blend.

FIG. 4 is a graph showing the percentage of the fraction of the initial protein in the high protein feed ingredient after treatment of whole stillage with low, medium, and high doses of an enzyme blend comprising a hemicellulase and cellulolytic composition, demonstrating that the enzyme blend increases both the mass fraction and protein content of the high protein feed ingredient due to a greater partitioning of the initial protein in the whole stillage byproduct to the high protein feed ingredient.

FIG. 5 is a flow diagram of an exemplary laboratory procedure used to obtain the results of the experiment described in Example 2, the results of which are shown in FIG. 6, FIG. 7, FIG. 8 and FIG. 9.

FIG. 6 is a graph demonstrating that a cellulolytic composition increases the amount of initial protein from the whole stillage byproduct that is partitioned to the high protein feed ingredient instead of being retained in the wet cake fraction, and that an enzyme blend comprising a hemicellulase and cellulolytic composition increases the amount of partitioned protein beyond that of the cellulolytic composition alone.

FIG. 7 is a graph demonstrating that a cellulolytic composition increases the mass fraction of the high protein feed ingredient, and that an enzyme blend comprising a hemicellulase and cellulolytic composition increases the mass fraction beyond that of the cellulolytic composition alone.

FIG. 8 is a graph demonstrating that a cellulolytic composition increases both the mass fraction and protein content of the high protein feed ingredient due to a greater partitioning of the initial protein in the whole stillage byproduct to the high protein feed ingredient, and that an enzyme blend comprising a hemicellulase and cellulolytic composition increases the mass fraction and the protein content beyond that of the cellulolytic composition alone.

FIG. 9 is a graph demonstrating that the increase in protein in the high protein feed ingredient is primarily coming from a decrease in the protein that is retained in the wet cake fraction, whereas the fraction of protein in the thin stillage is relatively constant.

FIG. 10 is a graph showing the results of the experiments described in Example 7, which demonstrates that the addition of various beta-glucanases to the enzyme blend results in a significantly higher protein content in the high protein feed ingredient than the control (blend of only cellulase and xylanase). All the beta-glucanases tested in this experiment significantly improved the protein content of the high protein feed ingredient.

FIG. 11 is a graph showing the results of the experiments described in Example 8, which demonstrates that the addition of xylanase, for example a GH5_21 xylanase, to a background of cellulase results in a significantly higher protein content in the high protein feed ingredient than the cellulase-only control. The treatment with cellulase-only and the treatment with the blend of cellulase and xylanase both outperformed the second control, which was treated with neither cellulase nor xylanase.

FIG. 12 is a graph showing the results of the experiments described in Example 9 which demonstrates that the addition of a GH43 or GH51 arabinofuranosidase to a background of cellulase, xylanase, and beta-glucanase results in a significantly higher protein content in the high protein feed ingredient than the control with only cellulase, xylanase, and beta-glucanase.

FIG. 13 and FIG. 14 are graphs showing the results of the experiments described in Example 10, which demonstrate that treatment with Cellulase 2 results in a significantly higher fraction of the mass diverted to the high protein feed ingredient as compared to the control (no enzyme treatment) (FIG. 13); and treatment with Cellulase 2 results in a significantly higher protein content in the high protein feed ingredient as compared to the control (no enzyme treatment) (FIG. 14).

FIG. 15 and FIG. 16 are graphs showing the results of the experiments described in Example 11, which demonstrate that the addition of GH5 family xylanases to a background of cellulase results in a significantly higher diversion of mass (designated as the mass fraction in the figure) to the high protein feed ingredient than the cellulase-only control (FIG. 15); and the addition of GH5 family xylanases to a background of cellulase results in a significantly higher protein content in the high protein feed ingredient than the cellulase-only control (FIG. 16).

FIG. 17 and FIG. 18 are graphs showing the results of the experiments described in Example 12, which demonstrate that the addition of GH62 arabinofuranosidase to a background of cellulase and GH10 xylanase results in a significantly higher diversion of mass (designated as the mass fraction in the figure) to the high protein feed ingredient than the control (blend of cellulase and GH10 xylanase) (FIG. 17); and the addition of GH43, GH51, and GH62 arabinofuranosidases result in a significantly higher protein content in the high protein feed ingredient than the control (blend of cellulase and GH10 xylanase) (FIG. 18).

### OVERVIEW OF SEQUENCE LISTING

SEQ ID NO: 1 is the amino acid sequence of a mature GH10 xylanase from Aspergillus fumigatus.

SEQ ID NO: 2 is the amino acid sequence of a full-length GH10 xylanase from Talaromyces leycettanus.

SEQ ID NO: 3 is the amino acid sequence of a full-length GH30_8 xylanase from Bacillus subtilis.

SEQ ID NO: 4 is the amino acid sequence of a full-length GH30_8 xylanase from Bacillus subtilis.

SEQ ID NO: 5 is the amino acid sequence of a full-length GH5_21 xylanase from Chryseobacterium sp-10696.

SEQ ID NO: 6 is the amino acid sequence of a full-length GH5_21 xylanase from Chryseobacterium sp-10696.

SEQ ID NO: 7 is the amino acid sequence of a full-length GH5_34 xylanase from Acetivibrio cellulyticus.

SEQ ID NO: 8 is the amino acid sequence of a full-length GH5_34 xylanase from Clostridium thermocellum.

SEQ ID NO: 9 is the amino acid sequence of a full-length GH5_35 xylanase from Paenibacillus illinoisensis.

SEQ ID NO: 10 is the amino acid sequence of a full-length GH5_35 xylanase from Paenibacillus sp.

SEQ ID NO: 11 is the amino acid sequence of a full-length GH62 arabinofuranosidase from Talaromyces pinophilus.

SEQ ID NO: 12 is the amino acid sequence of a full-length Aspergillus fumigatus beta-xylosidase.

SEQ ID NO: 13 is the amino acid sequence of a full-length Trichoderma reesei beta-xylosidase.

SEQ ID NO: 14 is the amino acid sequence of a full-length Rasamsonia byssochlamydoides beta-glucanase.

SEQ ID NO: 15 is the amino acid sequence of a full-length Trichoderma atroviride beta-glucanase.

SEQ ID NO: 16 is the amino acid sequence of a full-length Trichoderma atroviride beta-glucanase.

SEQ ID NO: 17 is the amino acid sequence of a full-length Trichoderma harzianum beta-glucanase.

SEQ ID NO: 18 is the amino acid sequence of a full-length Albifimbria verrucaria beta-glucanase.

SEQ ID NO: 19 is the amino acid sequence of a full-length Lecanicillium sp. VMM742 beta-glucanase.

SEQ ID NO: 20 is the amino acid sequence of a full-length Trichoderma harzianum beta-glucanase.

SEQ ID NO: 21 is the amino acid sequence of a full-length cellobiohydrolase I from Aspergillus fumigatus.

SEQ ID NO: 22 is the amino acid sequence of a full-length cellobiohydrolase II from Aspergillus fumigatus.

SEQ ID NO: 23 is the amino acid sequence of a full-length beta-glucosidase from Aspergillus fumigatus.

SEQ ID NO: 24 is the amino acid sequence of a full-length GH61 polypeptide from Penicillium emersonii.

SEQ ID NO: 25 is the amino acid sequence of a full-length alpha-amylase from Bacillus stearothermophilus.

SEQ ID NO: 26 is the amino acid sequence of a full-length GH10 xylanase from Dictyogllomus thermophilum.

SEQ ID NO: 27 is the amino acid sequence of a full-length GH11 xylanase from Dictyogllomus thermophilum.

SEQ ID NO: 28 is the amino acid sequence of a full-length GH10 xylanase from Rasamsonia byssochlamydoides.

SEQ ID NO: 29 is the amino acid sequence of a full-length GH10 xylanase from Talaromyces leycettanus.

SEQ ID NO: 30 is the amino acid sequence of a full-length GH10 xylanase from Aspergillus fumigatus.

SEQ ID NO: 31 is the amino acid sequence of a full-length endoglucanase from Talaromyces leycettanus.

SEQ ID NO: 32 is the amino acid sequence of a full-length endoglucanase from Penicillium capsulatum.

SEQ ID NO: 33 is the amino acid sequence of a full-length endoglucanase from Trichophaea saccata.

SEQ ID NO: 34 is the amino acid sequence of a full-length GH45 endoglucanase from Sordaria fimicola.

SEQ ID NO: 35 is the amino acid sequence of a full-length GH45 endoglucanase from Thielavia terrestris.

SEQ ID NO: 36 is the amino acid sequence of a full-length glucoamylase from Penicillium oxalicum.

SEQ ID NO: 37 is the amino acid sequence of a full-length protease from Pyrococcus furiosus.

SEQ ID NO: 38 is the amino acid sequence of a full-length protease from Thermoascus aurantiacus.

SEQ ID NO: 39 is the amino acid sequence of the Rhizomucor pusillus alpha-amylase with Aspergillus niger glucoamylase linker and starch binding domain (SBD) having the following substitutions G128D+D143N.

SEQ ID NO: 40 is the amino acid sequence of a full-length protease from Thermobifida cellulosilytica.

SEQ ID NO: 41 is the amino acid sequence of a full-length protease from Thermobifida fusca.

SEQ ID NO: 42 is the amino acid sequence of a full-length protease from Thermobifida halotolerans.

SEQ ID NO: 43 is the amino acid sequence of a full-length protease from Thermococcus nautili.

SEQ ID NO: 44 is the amino acid sequence of a full-length endoglucanase from Trichoderma reesei.

SEQ ID NO: 45 is the amino acid sequence of a full-length xylanase from Penicillium funiculosum.

SEQ ID NO: 46 is the amino acid sequence of a trehalase from Myceliophthora sepedonium.

SEQ ID NO: 47 is the amino acid sequence of a trehalase from Talaromyces funiculosus.

SEQ ID NO: 48 is the amino acid sequence of a glucoamylase from Trametes cingulate.

SEQ ID NO: 49 is the amino acid sequence of a glucoamylase from Talaromyces emersonii.

SEQ ID NO: 50 is the amino acid sequence of a glucoamylase from Pycnoporus sanguineus.

SEQ ID NO: 51 is the amino acid sequence of a glucoamylase from Gloeophyllum sepiarium.

SEQ ID NO: 52 is the amino acid sequence of a glucoamylase from Gloeophyllum trabeum.

SEQ ID NO: 53 is the amino acid sequence of a GH5_34 family xylanase from Gonapodya prolifera.

SEQ ID NO: 54 is the amino acid sequence of a mature GH5_35 xylanase from Paenibacillus favisporus.

SEQ ID NO: 55 is the amino acid sequence of a full-length GH62 arabinofuranosidase from Talaromyces pinophilus.

SEQ ID NO: 56 is the amino acid sequence of a full-length GH43 arabinofuranosidase from Humicola insolens.

SEQ ID NO: 57 is the amino acid sequence of a full-length GH43 arabinofuranosidase from Humicola insolens.

SEQ ID NO: 58 is the amino acid sequence of a full-length GH51 arabinofuranosidase from Colletotrichum graminicola

SEQ ID NO: 59 is the amino acid sequence of a full-length GH51 arabinofuranosidase from Trametes hirsute

### DEFINITIONS

Allelic variant: The term “allelic variant” means any of two or more alternative forms of a gene occupying the same chromosomal locus. Allelic variation arises naturally through mutation, and may result in polymorphism within populations. Gene mutations can be silent (no change in the encoded polypeptide) or may encode polypeptides having altered amino acid sequences. An allelic variant of a polypeptide is a polypeptide encoded by an allelic variant of a gene.

Acetylxylan esterase: The term “acetylxylan esterase” means a carboxylesterase (EC 3.1.1.72) that catalyzes the hydrolysis of acetyl groups from polymeric xylan, acetylated xylose, acetylated glucose, alpha-napthyl acetate, and p-nitrophenyl acetate. For purposes of the present invention, acetylxylan esterase activity is determined using 0.5 mM p-nitrophenylacetate as substrate in 50 mM sodium acetate pH 5.0 containing 0.01 percent TWEEN™ 20 (polyoxyethylene sorbitan monolaurate). One unit of acetylxylan esterase is defined as the amount of enzyme capable of releasing 1 pmole of p-nitrophenolate anion per minute at pH 5, 25 degrees centigrade.

Alpha-L-arabinofuranosidase: The term “alpha-L-arabinofuranosidase” means an alpha-L-arabinofuranoside arabinofuranohydrolase (EC 3.2.1.55) that catalyzes the hydrolysis of terminal non-reducing alpha-L-arabinofuranoside residues in alpha-L-arabinosides. The enzyme acts on alpha-L-arabinofuranosides, alpha-L-arabinans containing (1,3)- and/or (1,5)-linkages, arabinoxylans, and arabinogalactans. Alpha-L-arabinofuranosidase is also known as arabinofuranosidase, alpha-arabinofuranosidase, alpha-L-arabinofuranosidase, alpha-arabinofuranosidase, polysaccharide alpha-L-arabinofuranosidase, alpha-L-arabinofuranoside hydrolase, L-arabinofuranosidase, or alpha-L-arabinanase. For purposes of the present invention, alpha-L-arabinofuranosidase activity is determined using 5 mg of medium viscosity wheat arabinoxylan (Megazyme International Ireland, Ltd., Bray, Co. Wicklow, Ireland) per ml of 100 mM sodium acetate pH 5 in a total volume of 200 micro ? for 30 minutes at 40 degrees centigrade followed by arabinose analysis by AMINEX® HPX-87H column chromatography (Bio-Rad Laboratories, Inc., Hercules, CA, USA).

Alpha-galactosidase: The term “alpha-galactosidase”, also called a-D-galactoside galactohydrolase (E.C. 3.2.1.22), means an enzyme that catalyses the hydrolysis of terminal, non-reducing a-D-galactose residues in a-D-galactosides, such as galactose oligosaccharides, galactomannans and galactolipids. Alpha-galactosidase activity can be determined using 4-nitrophenyl oD-galactopyranoside (available from Megazyme International, Bray, Co. Wicklow, Ireland) as substrate in 100 mM MES (Sigma) buffer pH 7.0 plus or minus 0.05 at room temperature. The enzyme is diluted in 2-fold dilutions and then the 4-nitrophenyl oD-galactopyranoside substrate is dissolved in the solution containing the enzyme. The alpha-galactosidase activity is followed directly in the buffer by measuring the absorbance of released pNP at 405 nm as function of time. A detailed assay can be found in the alpha-galactosidase assay as described in WO17202966A1 (incorporated herein by reference in its entirety).

Alpha-glucuronidase: The term “alpha-glucuronidase” means an alpha-D-glucosiduronate glucuronohydrolase (EC 3.2.1.139) that catalyzes the hydrolysis of an alpha-D-glucuronoside to D-glucuronate and an alcohol. For purposes of the present invention, alpha-glucuronidase activity is determined according to de Vries, 1998, J. Bacteriol. 180: 243-249. One unit of alpha-glucuronidase equals the amount of enzyme capable of releasing 1 pmole of glucuronic or 4-0-methylglucuronic acid per minute at pH 5, 40 degrees centigrade Beta-glucosidase:

Alpha-Amylases (alpha-1,4-glucan-4-glucanohydrolases, EC 3.2.1.1) are a group of enzymes, which catalyze the hydrolysis of starch and other linear and branched 1,4-glucosidic oligo- and polysaccharides.

Animal: The term “animal” refers to all animals except humans. Examples of animals are non-ruminants, and ruminants. Ruminant animals include, for example, animals such as sheep, goats, cattle, e.g., beef cattle, cows, and young calves, deer, yank, camel, llama and kangaroo. Non-ruminant animals include mono-gastric animals, e.g., pigs or swine (including, but not limited to, piglets, growing pigs, and sows); poultry such as turkeys, ducks and chicken (including but not limited to broiler chicks, layers); horses (including but not limited to hotbloods, coldbloods and warm bloods), young calves; fish (including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish); and crustaceans (including but not limited to shrimps and prawns).

Animal feed: The term “animal feed” refers to any compound, preparation, or mixture suitable for, or intended for intake by an animal. Animal feed for a mono-gastric animal typically comprises concentrates as well as vitamins, minerals, enzymes, direct fed microbial, amino acids and/or other feed ingredients (such as in a premix) whereas animal feed for ruminants generally comprises forage (including roughage and silage) and may further comprise concentrates as well as vitamins, minerals, enzymes direct fed microbial, amino acid and/or other feed ingredients (such as in a premix).

Beta-glucanase: The term “beta-glucanase” encompasses polypeptides having beta-1,6-glucanase activity and/or exo- and/or -endo beta-1,3-glucanase activity. As used herein, “polypeptide having beta-1,6-glucanase activity and/or exo- and/or -endo beta-1,3-glucanase activity” means that the polypeptide exhibits at least one of these activities, but may also possess any combination of these activities, including all the activities. The term “exo- and/or -endo beta-1,3-glucanase” encompasses polypeptides that have either exo- and/or -endo beta-1,3-glucanase activity, both exo- and/or -endo beta-1,3-glucanase activities, as well as polypeptides having mixed beta-1,3(4) and/or beta 1,4(3)-glucanase activities. Preferably, the polypeptides having beta-1,6-glucanase activity and/or exo- and/or -endo beta-1,3-glucanase activity are members of a glycoside hydrolase family selected from GH5, for instance GH5_15, GH16, and GH64.

In one aspect, “beta-glucanase” means polypeptides having beta-1,6-glucanase activity referred to as 6-β-D-glucan glucanohydrolase (EC 3.2.1.75) that catalyze the random hydrolysis of (1→6)-linkages in (1→6)-β-D-glucans. In addition to acting on 1,6-oligo-beta-D-glucosides, members of this family of enzymes also act on lutean and pustulan. These beta-glucanases include members of the GH5_15 family. For purposes of the present invention, beta-1,6-glucanase activity is determined according to the procedure described in the Examples. In another aspect, “beta-glucanase” means polypeptides having beta-1,3-glucanase referred to as 3-β-D-glucan glucanohydrolases (EC 3.2.1.39), endo-1,3(4)-beta-glucanases (EC 3.2.1.6), or 3-β-D-glucan glucohydrolases (EC 3.2.1.58). 3-β-D-glucan glucanohydrolases (EC 3.2.1.39) catalyze the hydrolysis of (1→3)-β-D-glucosidic linkages in (1→3)-β-D-glucans. In addition to having some activity on mixed-link (1→3,1→4)-β-D-glucans, members of this family of enzymes also act on laminarin, paramylon and pachyman. Endo-1,3(4)-beta-glucanases (EC 3.2.1.6) catalyze the endohydrolysis of (1→3)- or (1→4)-linkages in β-D-glucans when the glucose residue whose reducing group is involved in the linkage to be hydrolysed is itself substituted at C-3. Members of this class may act laminarin, lichenin and cereal D-glucans. 3-β-D-glucan glucohydrolases (EC 3.2.1.58) catalyze the successive hydrolysis of beta-D-glucose units from the non-reducing ends of (1→3)-β-D-glucans, releasing alpha-glucose. Members of this class act on oligosaccharides, and on laminaribiose. These beta-glucanases include members of the GH16 and GH64 families. For purposes of the present invention, beta-1,3-glucanase activity is determined according to the procedure described in the Materials & Methods section.

Beta-glucosidase: The term “beta-glucosidase” means a beta-D-glucoside glucohydrolase (E.C. 3.2.1.21) that catalyzes the hydrolysis of terminal non-reducing beta-D-glucose residues with the release of beta-D-glucose. For purposes of the present invention, beta-glucosidase activity is determined using p-nitrophenyl-beta-D-glucopyranoside as substrate according to the procedure of Venturi et al., 2002, Extracellular beta-D-glucosidase from Chaetomium thermophilum var. coprophilum: production, purification and some biochemical properties, J. Basic Microbiol. 42: 55-66. One unit of beta-glucosidase is defined as 1.0 pmole of p-nitrophenolate anion produced per minute at 25 °C, pH 4.8 from 1 mM p-nitrophenyl-beta-D-glucopyranoside as substrate in 50 mM sodium citrate containing 0.01% TWEEN® 20 (polyoxyethylene sorbitan monolaurate).

Beta-xylosidase: The term “beta-xylosidase” means a beta-D-xyloside xylohydrolase (E.C. 3.2.1.37) that catalyzes the exo-hydrolysis of short beta (1-4)-xylooligosaccharides to remove successive D-xylose residues from non-reducing termini. For purposes of the present invention, one unit of beta-xylosidase is defined as 1.0 pmole of p-nitrophenolate anion produced per minute at 40 degrees centigrade, pH 5 from 1 mM p-nitrophenyl-beta-D-xyloside as substrate in 100 mM sodium citrate containing 0.01 percent TWEEN® 20. cDNA: The term “cDNA” means a DNA molecule that can be prepared by reverse transcription from a mature, spliced, mRNA molecule obtained from a eukaryotic or prokaryotic cell. cDNA lacks intron sequences that may be present in the corresponding genomic DNA. The initial, primary RNA transcript is a precursor to mRNA that is processed through a series of steps, including splicing, before appearing as mature spliced mRNA.

Cellobiohydrolase: The term “cellobiohydrolase” means a 1,4-beta-D-glucan cellobiohydrolase (E.C. 3.2.1.91) that catalyzes the hydrolysis of 1,4-beta-D-glucosidic linkages in cellulose, cellooligosaccharides, or any beta-1,4-linked glucose containing polymer, releasing cellobiose from the reducing or non-reducing ends of the chain (Teeri, 1997, Crystalline cellulose degradation: New insight into the function of cellobiohydrolases, Trends in Biotechnology 15: 160-167; Teeri et al., 1998, Trichoderma reesei cellobiohydrolases: why so efficient on crystalline cellulose?, Biochem. Soc. Trans. 26: 173-178).

Cellobiohydrolase activity is determined according to the procedures described by Lever et al., 1972, Anal. Biochem. 47: 273-279; van Tilbeurgh et al., 1982, FEBS Letters, 149: 152-156; van Tilbeurgh and Claeyssens, 1985, FEBS Letters, 187: 283-288; and Tomme et al., 1988, Eur. J. Biochem. 170: 575-581. In the present invention, the Tomme et al. method can be used to determine cellobiohydrolase activity.

Cellulolytic enzyme, cellulolytic composition, or cellulase: The term “cellulolytic enzyme”, “cellulolytic composition”, or “cellulase” means one or more (e.g., several) enzymes that hydrolyze a cellulosic material. Such enzymes include endoglucanase(s), cellobiohydrolase(s), beta-glucosidase(s), or combinations thereof. The two basic approaches for measuring cellulolytic activity include: (1) measuring the total cellulolytic activity, and (2) measuring the individual cellulolytic activities (endoglucanases, cellobiohydrolases, and beta-glucosidases) as reviewed in Zhang et al., Outlook for cellulase improvement: Screening and selection strategies, 2006, Biotechnology Advances 24: 452-481. Total cellulolytic activity is usually measured using insoluble substrates, including Whatman No 1 filter paper, microcrystalline cellulose, bacterial cellulose, algal cellulose, cotton, pretreated lignocellulose, etc. The most common total cellulolytic activity assay is the filter paper assay using Whatman N51 filter paper as the substrate. The assay was established by the International Union of Pure and Applied Chemistry (IUPAC) (Ghose, 1987, Measurement of cellulase activities, Pure Appl. Chem. 59: 257-68).

Cellulolytic enzyme activity is determined by measuring the increase in hydrolysis of a cellulosic material by cellulolytic enzyme(s) under the following conditions: 1-50 mg of cellulolytic enzyme protein/g of cellulose in Pretreated Corn Stover (“PCS”) (or other pretreated cellulosic material) for 3-7 days at a suitable temperature, e.g., 50 °C, 55 °C, or 60 °C, compared to a control hydrolysis without addition of cellulolytic enzyme protein. Typical conditions are 1 ml reactions, washed or unwashed PCS, 5% insoluble solids, 50 mM sodium acetate pH 5, 1 mM MnSO₄, 50 °C, 55 °C, or 60 °C, 72 hours, sugar analysis by AMINEX® HPX-87H column (Bio-Rad Laboratories, Inc., Hercules, CA, USA).

Coding sequence: The term “coding sequence” means a polynucleotide, which directly specifies the amino acid sequence of a variant. The boundaries of the coding sequence are generally determined by an open reading frame, which begins with a start codon such as ATG, GTG or TTG and ends with a stop codon such as TAA, TAG, or TGA. The coding sequence may be a genomic DNA, cDNA, synthetic DNA, or a combination thereof.

Control sequences: The term “control sequences” means nucleic acid sequences necessary for expression of a polynucleotide encoding a variant of the present invention. Each control sequence may be native (i.e., from the same gene) or foreign (i.e., from a different gene) to the polynucleotide encoding the variant or native or foreign to each other. Such control sequences include, but are not limited to, a leader, polyadenylation sequence, propeptide sequence, promoter, signal peptide sequence, and transcription terminator. At a minimum, the control sequences include a promoter, and transcriptional and translational stop signals. The control sequences may be provided with linkers for the purpose of introducing specific restriction sites facilitating ligation of the control sequences with the coding region of the polynucleotide encoding a variant.

Endoglucanase: The term “endoglucanase” means an endo-1,4-(1,3;1,4)-beta-D-glucan 4-glucanohydrolase (E.C. 3.2.1.4) that catalyzes endohydrolysis of 1,4-beta-D-glycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans or xyloglucans, and other plant material containing cellulosic components.

Endoglucanase activity can be determined by measuring reduction in substrate viscosity or increase in reducing ends determined by a reducing sugar assay (Zhang et al., 2006, Biotechnology Advances 24: 452-481). For purposes of the present invention, endoglucanase activity is determined using carboxymethyl cellulose (CMC) as substrate according to the procedure of Ghose, 1987, Pure and Appl. Chem. 59: 257-268, at pH 5, 40 °C.

Expression: The term “expression” includes any step involved in the production of a variant including, but not limited to, transcription, post-transcriptional modification, translation, post-translational modification, and secretion.

Expression vector: The term “expression vector” means a linear or circular DNA molecule that comprises a polynucleotide encoding a variant and is operably linked to control sequences that provide for its expression.

Family 61 glycoside hydrolase: The term “Family 61 glycoside hydrolase” or “Family GH61” or “GH61” means a polypeptide falling into the glycoside hydrolase Family 61 according to Henrissat B., 1991, A classification of glycosyl hydrolases based on amino-acid sequence similarities, Biochem. J. 280: 309-316, and Henrissat B., and Bairoch A., 1996, Updating the sequence-based classification of glycosyl hydrolases, Biochem. J. 316: 695-696. The enzymes in this family were originally classified as a glycoside hydrolase family based on measurement of very weak endo-1,4-beta-D-glucanase activity in one family member. The structure and mode of action of these enzymes are non-canonical and they cannot be considered as bona fide glycosidases. However, they are kept in the CAZy classification on the basis of their capacity to enhance the breakdown of lignocellulose when used in conjunction with a cellulase or a mixture of cellulases.

Fragment: The term “fragment” means a polypeptide having one or more (e.g., several) amino acids absent from the amino and/or carboxyl terminus of a mature polypeptide main; wherein the fragment has enzyme activity. In one aspect, a fragment contains at least 85%, e.g., at least 90% or at least 95% of the amino acid residues of the mature polypeptide of an enzyme.

Glucoamylases (glucan 1,4-alpha-glucosidase, EC 3.2.1.3) are a group of enzymes, which catalyze the hydrolysis of terminal (1→4)-linked α-D-glucose residues successively from non-reducing ends of the chains with release of beta-D-glucose.

Hemicellulolytic enzyme or hemicellulase: The term “hemicellulolytic enzyme” or “hemicellulase” means one or more (e.g., several) enzymes that hydrolyze a hemicellulosic material. See, for example, Shallom and Shoham, 2003, Microbial hemicellulases, Current Opinion in Microbiology 6(3): 219-228. Hemicellulases are key components in the degradation of plant biomass. Examples of hemicellulases include, but are not limited to, an acetylmannan esterase, an acetyxylan esterase, an arabinanase, an arabinofuranosidase, a coumaric acid esterase, a feruloyl esterase, a galactosidase, a glucuronidase, a glucuronoyl esterase, a mannanase, a mannosidase, a xylanase, and a xylosidase. The substrates of these enzymes, the hemicelluloses, are a heterogeneous group of branched and linear polysaccharides that are bound via hydrogen bonds to the cellulose microfibrils in the plant cell wall, crosslinking them into a robust network. Hemicelluloses are also covalently attached to lignin, forming together with cellulose a highly complex structure. The variable structure and organization of hemicelluloses require the concerted action of many enzymes for its complete degradation. The catalytic modules of hemicellulases are either glycoside hydrolases (GHs) that hydrolyze glycosidic bonds, or carbohydrate esterases (CEs), which hydrolyze ester linkages of acetate or ferulic acid side groups. These catalytic modules, based on homology of their primary sequence, can be assigned into GH and CE families marked by numbers. Some families, with overall similar fold, can be further grouped into clans, marked alphabetically (e.g., GH-A). An informative and updated classification of these and other carbohydrate active enzymes is available on the Carbohydrate-Active Enzymes (CAZy) database. Hemicellulolytic enzyme activities can be measured according to Ghose and Bisaria, 1987, Pure & Appl. Chem. 59: 1739-1752, at a suitable temperature, e.g., 50 °C, 55 °C, or 60 °C.

In one embodiment, the hemicellulase comprises a commercial hemicellulolytic enzyme preparation. Examples of commercial hemicellulolytic enzyme preparations suitable for use in the present invention include, for example, SHEARZYME™ (Novozymes A/S), CELLIC® HTec (Novozymes A/S), CELLIC® HTec2 (Novozymes A/S), VISCOZYME® (Novozymes A S), ULTRAFLO® (Novozymes A/S), PULPZYME® HC (Novozymes A/S), MULTIFECT® Xylanase (Genencor), ACCELLERASE® XY (Genencor), ACCELLERASE® XC (Genencor), ECOPULP® TX-200A (AB Enzymes), HSP 6000 Xylanase (DSM), DEPOL™ 333P (Biocatalysts Limit, Wales, UK), DEPOL™ 740L. (Biocatalysts Limit, Wales, UK), and DEPOL™ 762P (Biocatalysts Limit, Wales, UK).

Host cell: The term “host cell” means any cell type that is susceptible to transformation, transfection, transduction, or the like with a nucleic acid construct or expression vector comprising a polynucleotide of the present invention. The term “host cell” encompasses any progeny of a parent cell that is not identical to the parent cell due to mutations that occur during replication.

Isolated: The term “isolated” means a substance in a form or environment which does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., multiple copies of a gene encoding the substance; use of a stronger promoter than the promoter naturally associated with the gene encoding the substance). An isolated substance may be present in a fermentation broth sample.

Mature polypeptide: The term “mature polypeptide” means a polypeptide in its final form following translation and any post-translational modifications, such as N-terminal processing, C-terminal truncation, glycosylation, phosphorylation, etc. In one aspect, the mature polypeptide of an Aspergillus fumigatus xylanase is amino acids 20 to 397 of SEQ ID NO: 1. Amino acids 1 to 19 of SEQ ID NO: 1 are a signal peptide. In one aspect, the mature polypeptide of a Talaromyces leycettanus xylanase is amino acids 21 to 405 of SEQ ID NO: 2. Amino acids 1 to 20 of SEQ ID NO: 2 are a signal peptide. In one aspect, the mature polypeptide of a Bacillus subtilis xylanase is amino acids 28 to 417 of SEQ ID NO: 3. Amino acids 1 to 27 of SEQ ID NO: 3 are a signal peptide. In one aspect, the mature polypeptide of a Bacillus subtilis xylanase is amino acids 28 to 417 of SEQ ID NO: 4. Amino acids 1 to 27 of SEQ ID NO: 4 are a signal peptide. In one aspect, the mature polypeptide of a Chryseobacterium sp-10696 xylanase is amino acids 25 to 551 of SEQ ID NO: 5. Amino acids 1 to 19 of SEQ ID NO: 5 are a signal peptide. In one aspect, the mature polypeptide of a Chryseobacterium sp-10696 xylanase is amino acids 25 to 551 of SEQ ID NO: 6. Amino acids 1 to 24 of SEQ ID NO: 6 are a signal peptide. In one aspect, the mature polypeptide of an Acetivibrio cellulyticus xylanase is SEQ ID NO: 7. In one aspect, the mature polypeptide of a Clostridium thermocellum xylanase is SEQ ID NO: 8. In one aspect, the mature polypeptide of a Paenibacillus illinoisensis xylanase is amino acids 37 to 573 of SEQ ID NO: 9. Amino acids 1 to 36 of SEQ ID NO: 9 are a signal peptide. In one aspect, the mature polypeptide of a Paenibacillus sp. xylanase is amino acids 36 to 582 of SEQ ID NO: 10. Amino acids 1 to 35 of SEQ ID NO: 10 are a signal peptide. In one aspect, the mature polypeptide of a Talaromyces pinophilus arabinofuranosidase is amino acids 17 to 325 of SEQ ID NO: 11. Amino acids 1 to 16 of SEQ ID NO: 11 are a signal peptide. In one aspect, the mature polypeptide of an Aspergillus fumigatus beta-xylosidase is amino acids 21 to 792 of SEQ ID NO: 12. Amino acids 1 to 20 of SEQ ID NO: 12 are a signal peptide. In one aspect, the mature polypeptide of a Trichoderma reesei beta-xylosidase is amino acids 20 to 780 of SEQ ID NO: 13. Amino acids 1 to 19 of SEQ ID NO: 13 are a signal peptide. In one aspect, the mature polypeptide of a Rasamsonia byssochlamydoides beta-glucanase is amino acids 20 to 413 of SEQ ID NO: 14. Amino acids 1 to 19 of SEQ ID NO: 14 are a signal peptide. In one aspect, the mature polypeptide of a Trichoderma atroviride beta-glucanase is amino acids 17 to 408 of SEQ ID NO: 15. Amino acids 1 to 16 of SEQ ID NO: 15 are a signal peptide. In one aspect, the mature polypeptide of a Trichoderma atroviride beta-glucanase is amino acids 18 to 429 of SEQ ID NO: 16. Amino acids 1 to 17 of SEQ ID NO: 16 are a signal peptide. In one aspect, the mature polypeptide of a Trichoderma harzianum beta-glucanase is amino acids 18 to 429 of SEQ ID NO: 17. Amino acids 1 to 17 of SEQ ID NO: 17 are a signal peptide. In one aspect, the mature polypeptide of an Albifimbria verrucaria beta-glucanase is amino acids 20 to 286 of SEQ ID NO: 18. Amino acids 1 to 19 of SEQ ID NO: 18 are a signal peptide. In one aspect, the mature polypeptide of a Lecanicillium sp. WMM742 beta-glucanase is amino acids 20 to 284 of SEQ ID NO: 19. Amino acids 1 to 19 of SEQ ID NO: 19 are a signal peptide. In one aspect, the mature polypeptide of a Trichoderma harzianum beta-glucanase is amino acids 64 to 447 of SEQ ID NO: 20. Amino acids 1 to 16 of SEQ ID NO: 20 are a signal peptide. In one aspect, the mature polypeptide of an A. fumigatus cellobiohydrolase I is amino acids 27 to 532 of SEQ ID NO: 21. Amino acids 1 to 26 of SEQ ID NO: 21 are a signal peptide. In another aspect, the mature polypeptide of an A. fumigates cellobiohydrolase II is amino acids 20 to 454 of SEQ ID NO: 22. Amino acids 1 to 19 of SEQ ID NO: 22 are a signal peptide. In another aspect, the mature polypeptide of an A. fumigatus beta-glucosidase is amino acids 20 to 863 of SEQ ID NO: 23. Amino acids 1 to 19 of SEQ ID NO: 23 are a signal peptide. In another aspect, the mature polypeptide of a Penicillium sp. GH61 polypeptide is amino acids 26 to 253 of SEQ ID NO: 24. Amino acids 1 to 25 of SEQ ID NO: 24 are a signal peptide. In another aspect, the mature polypeptide of a Gonapodya porlifera polypeptide is amino acids 24 to 337 of SEQ ID NO: 53. Amino acids 1 to 23 of SEQ ID NO: 53 are a signal peptide. In another aspect, the mature polypeptide of a Paenibacillus favisporus polypeptide is amino acids 1 to 536 of SEQ ID NO: 54. In another aspect, the mature polypeptide of a Talaromyces pinophilus polypeptide is amino acids 18 to 335 of SEQ ID NO: 55. Amino acids 1 to 17 of SEQ ID NO: 55 are a signal peptide. In another aspect, the mature polypeptide of a Humicola insolens arabinofuranosidase is amino acids 19 to 558 of SEQ ID NO: 56. Amino acids 1 to 18 of SEQ ID NO: 56 are a signal peptide. In another aspect, the mature polypeptide of a Humicola insolens arabinofuranosidase is amino acids 24 to 575 of SEQ ID NO: 57. Amino acids 1 to 23 of SEQ ID NO: 57 are a signal peptide. In another aspect, the mature polypeptide of a Colletotrichum graminicola arabinofuranosidase is amino acids 20 to 663 of SEQ ID NO: 58. Amino acids 1 to 19 of SEQ ID NO: 58 are a signal peptide. In another aspect, the mature polypeptide of a Trametes hirsuta arabinofuranosidase is amino acids 17 to 643 of SEQ ID NO: 59. Amino acids 1 to 16 of SEQ ID NO: 59 are a signal peptide.

It is known in the art that a host cell may produce a mixture of two of more different mature polypeptides (i.e., with a different C-terminal and/or N-terminal amino acid) expressed by the same polynucleotide. It is also known in the art that different host cells process polypeptides differently, and thus, one host cell expressing a polynucleotide may produce a different mature polypeptide (e.g., having a different C-terminal and/or N-terminal amino acid) as compared to another host cell expressing the same polynucleotide.

Mature polypeptide coding sequence: The term “mature polypeptide coding sequence” means a polynucleotide that encodes a mature polypeptide.

Mutant: The term “mutant” means a polynucleotide encoding a variant.

Nucleic acid construct: The term “nucleic acid construct” means a nucleic acid molecule, either single- or double-stranded, which is isolated from a naturally occurring gene or is modified to contain segments of nucleic acids in a manner that would not otherwise exist in nature or which is synthetic, which comprises one or more control sequences.

Operably linked: The term “operably linked” means a configuration in which a control sequence is placed at an appropriate position relative to the coding sequence of a polynucleotide such that the control sequence directs expression of the coding sequence.

Polypeptide having cellulolytic enhancing activity: The term “polypeptide having cellulolytic enhancing activity” means a GH61 polypeptide that catalyzes the enhancement of the hydrolysis of a cellulosic material by enzyme having cellulolytic activity. For purposes of the present invention, cellulolytic enhancing activity is determined by measuring the increase in reducing sugars or the increase of the total of cellobiose and glucose from the hydrolysis of a cellulosic material by cellulolytic enzyme under the following conditions: 1-50 mg of total protein/g of cellulose in PCS, wherein total protein is comprised of 50-99.5% w/w cellulolytic enzyme protein and 0.5-50% w/w protein of a GH61 polypeptide having cellulolytic enhancing activity for 1-7 days at a suitable temperature, e.g., 50 °C, 55 °C, or 60 °C, and pH, e.g., 5.0 or 5.5, compared to a control hydrolysis with equal total protein loading without cellulolytic enhancing activity (1-50 mg of cellulolytic protein/g of cellulose in PCS). In an aspect, a mixture of CELLUCLAST® 1.5L (Novozymes A/S, Bagsværd, Denmark) in the presence of 2-3% of total protein weight Aspergillus oryzae beta-glucosidase (recombinantly produced in Aspergillus oryzae according to WO 02/095014) or 2-3% of total protein weight Aspergillus fumigatus beta-glucosidase (recombinantly produced in Aspergillus oryzae as described in WO 2002/095014) of cellulase protein loading is used as the source of the cellulolytic activity.

The GH61 polypeptide having cellulolytic enhancing activity enhance the hydrolysis of a cellulosic material catalyzed by enzyme having cellulolytic activity by reducing the amount of cellulolytic enzyme required to reach the same degree of hydrolysis preferably at least 1.01-fold, e.g., at least 1.05-fold, at least 1.10-fold, at least 1.25-fold, at least 1.5-fold, at least 2-fold, at least 3-fold, at least 4-fold, at least 5-fold, at least 10-fold, or at least 20-fold.

Pretreated corn stover: The term “Pretreated Corn Stover” or “PCS” means a cellulosic-containing material derived from corn stover by treatment with heat and dilute sulfuric acid, alkaline pretreatment, neutral pretreatment, or any pretreatment known in the art.

Sequence identity: The relatedness between two amino acid sequences or between two nucleotide sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), e.g., version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), e.g., version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment)

Trehalase: The term “trehalase” means an enzyme which degrades trehalose into its unit monosaccharides (i.e., glucose). Trehalases are classified in EC 3.2.1.28 (alpha,alpha-trehalase) and EC. 3.2.1.93 (alpha,alpha-phosphotrehalase). The EC classes are based on recommendations of the Nomenclature Committee of the International Union of Biochemistry and Molecular Biology (IUBMB). Description of EC classes can be found on the internet, e.g., on www.expasy.orq/enzyme/”. Trehalases are enzymes that catalyze the following reactions:
EC 3.2.1.28:
Alpha,alpha-trehalose+H₂O⇔2 D-glucose;
EC 3.2.1. 93:
Alpha,alpha-trehalose 6-phosphate+H₂O⇔D-glucose+D-glucose 6-phosphate.

For purposes of the present invention, trehalase activity may be determined according to the trehalase assay procedure described below.

### Principle:

Trehalose+H₂O^{Trehalase}>2 Glucose
T=37 °C, pH=5.7, A340 nm, Light path=1 cm
Spectrophotometric Stop Rate Determination

### Unit Definition:

One unit will convert 1.0 mmole of trehalose to 2.0 mmoles of glucose per minute at pH 5.7 at 37 °C (liberated glucose determined at pH 7.5).
(See Dahlqvist, A. (1968) Analytical Biochemistry 22, 99-107)

Variant: The term “variant” means a polypeptide having enzyme or enzyme enhancing activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position. As used herein, a “variant thereof,” when used in reference to a presently disclosed enzyme, refers to a variant enzyme having an amino acid sequence that is at least 60%, at least 65%, at least 70%, at least 75%, at least 80%, at least 85%, at least 90%, at least 95%, at least 96%, at least 97%, at least 98%, or at least 99% identical to the amino acid sequence of that enzyme.

Wild-type xylanase: The term “wild-type” xylanase means a xylanase expressed by a naturally occurring microorganism, such as a bacterium, yeast, or filamentous fungus found in nature.

Xylanase: The term “xylanase” means a glucuronoarabinoxylan endo-1,4-beta-xylanase (E.C. 3.2.1.136) that catalyses the endohydrolysis of 1,4-beta-D-xylosyl links in some glucuronoarabinoxylans. Xylanase activity can be determined with 0.2% AZCL-glucuronoxylan as substrate in 0.01% TRITON® X-100 and 200 mM sodium phosphate pH 6 at 37 °C. One unit of xylanase activity is defined as 1.0 pmole of azurine produced per minute at 37 °C, pH 6 from 0.2% AZCL-glucuronoxylan as substrate in 200 mM sodium phosphate pH 6. Xylanase activity can also be measured using the xylose solubility assay described in the Materials & Methods section.

### Conventions for Designation of Variants

For purposes of the present invention, any starting enzyme sequence can be used to determine the corresponding amino acid residue in another sequence (e.g., variant thereof). The amino acid sequence of a second sequence is aligned with the sequence of the first sequence, and based on the alignment, the amino acid position number corresponding to any amino acid residue in the first sequence is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), e.g., version 5.0.0 or later. The parameters used are gap open penalty of 10, gap extension penalty of 0.5, and the EBLOSUM62 (EMBOSS version of BLOSUM62) substitution matrix.

Identification of the corresponding amino acid residue in another xylanase can be determined by an alignment of multiple polypeptide sequences using several computer programs including, but not limited to, MUSCLE (multiple sequence comparison by log-expectation; version 3.5 or later; Edgar, 2004, Nucleic Acids Research 32: 1792-1794), MAFFT (version 6.857 or later; Katoh and Kuma, 2002, Nucleic Acids Research 30: 3059-3066; Katoh et al., 2005, Nucleic Acids Research 33: 511-518; Katoh and Toh, 2007, Bioinformatics 23: 372-374; Katoh et al., 2009, Methods in Molecular Biology 537: 39-64; Katoh and Toh, 2010, Bioinformatics 26: 1899-1900), and EMBOSS EMMA employing ClustalW (1.83 or later; Thompson et al., 1994, Nucleic Acids Research 22: 4673-4680), using their respective default parameters.

When the other enzyme has diverged from the polypeptide of the first sequence such that traditional sequence-based comparison fails to detect their relationship (Lindahl and Elofsson, 2000, J. Mol. Biol. 295: 613-615), other pairwise sequence comparison algorithms can be used. Greater sensitivity in sequence-based searching can be attained using search programs that utilize probabilistic representations of polypeptide families (profiles) to search databases. For example, the PSI-BLAST program generates profiles through an iterative database search process and is capable of detecting remote homologs (Atschul et al., 1997, Nucleic Acids Res. 25: 3389-3402). Even greater sensitivity can be achieved if the family or superfamily for the polypeptide has one or more representatives in the protein structure databases. Programs such as GenTHREADER (Jones, 1999, J. Mol. Biol. 287: 797-815; McGuffin and Jones, 2003, Bioinformatics 19: 874-881) utilize information from a variety of sources (PSI-BLAST, secondary structure prediction, structural alignment profiles, and solvation potentials) as input to a neural network that predicts the structural fold for a query sequence. Similarly, the method of Gough et al., 2000, J. Mol. Biol. 313: 903-919, can be used to align a sequence of unknown structure with the superfamily models present in the SCOP database. These alignments can in turn be used to generate homology models for the polypeptide, and such models can be assessed for accuracy using a variety of tools developed for that purpose.

For proteins of known structure, several tools and resources are available for retrieving and generating structural alignments. For example the SCOP superfamilies of proteins have been structurally aligned, and those alignments are accessible and downloadable. Two or more protein structures can be aligned using a variety of algorithms such as the distance alignment matrix (Holm and Sander, 1998, Proteins 33: 88-96) or combinatorial extension (Shindyalov and Bourne, 1998, Protein Engineering 11: 739-747), and implementation of these algorithms can additionally be utilized to query structure databases with a structure of interest in order to discover possible structural homologs (e.g., Holm and Park, 2000, Bioinformatics 16: 566-567).

In describing the variants of the present invention, the nomenclature described below is adapted for ease of reference. The accepted IUPAC single letter or three letter amino acid abbreviation is employed.

Substitutions. For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”), e.g., “Gly205Arg+Ser411 Phe” or “G205R+S411F”, representing substitutions at positions 205 and 411 of glycine (G) with arginine (R) and serine (S) with phenylalanine (F), respectively.

Deletions. For an amino acid deletion, the following nomenclature is used: Original amino acid, position, *. Accordingly, the deletion of glycine at position 195 is designated as “Gly195*” or “G195*”. Multiple deletions are separated by addition marks (“+”), e.g., “Gly195*+Ser411*” or “G195*+S411*”.

Insertions. For an amino acid insertion, the following nomenclature is used: Original amino acid, position, original amino acid, inserted amino acid. Accordingly the insertion of lysine after glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases the inserted amino acid residue(s) are numbered by the addition of lower case letters to the position number of the amino acid residue preceding the inserted amino acid residue(s). In the above example, the sequence would thus be:

| Parent: | Variant: |
|---|---|
| 195 | 195 195a 195b |
| G | G-K-A |

Multiple alterations. Variants comprising multiple alterations are separated by a plus sign (“+”), e.g., “Arg170Tyr+Gly195Glu” or “R170Y+G195E” representing a substitution of arginine and glycine at positions 170 and 195 with tyrosine and glutamic acid, respectively.

Different alterations. Where different alterations can be introduced at a position, the different alterations are separated by a comma, e.g., “Arg170Tyr,Glu” represents a substitution of arginine at position 170 with tyrosine or glutamic acid. Thus, “Tyr167Gly,Ala+Arg170Gly,Ala” designates the following variants:
“Tyr167Gly+Arg170Gly”, “Tyr167Gly+Arg170Ala”, “Tyr167Ala+Arg170Gly”, and “Tyr167Ala+Arg170Ala”.

### DESCRIPTION OF THE INVENTION

The present invention relates to a process for producing a high protein feed ingredient from a whole stillage byproduct produced in a starch-containing grain dry milling process for producing a fermentation product, as well as enzyme blends used in the processes for partitioning a greater amount of protein from the whole stillage byproduct into the high protein fraction, rather than being retained in the wet cake, to produce a high protein feed ingredient.

Existing techniques for producing high protein corn meal from a whole stillage byproduct suffer from the shortcoming that a significant amount of protein in the initial whole stillage byproduct is retained in the wet cake rather being partitioned to the protein portion that is dewatered and dried to define the high protein corn meal, resulting in a high protein corn meal with less protein than is theoretically possible based on the amount of protein in the initial whole stillage by product. Therefore, there is a need for an improved method of producing a high protein feed ingredient from a whole stillage byproduct wherein greater amounts of protein from the whole stillage byproduct are partitioned into the high protein fraction, rather than being retained in the wet cake.

The work described herein unexpectedly demonstrates that the addition of a presently disclosed hemicellulase, beta-glucanase, or enzyme blend comprising hemicellulase and/or beta-glucanase upstream during the fermentation product production process (e.g., during saccharification, fermentation, or simultaneous saccharification and fermentation) significantly improves the partitioning of protein from the initial whole stillage byproduct into the high protein fraction instead of into wet cake. Thus, the present invention more particularly relates to the addition of a hemicellulase, beta-glucanase or hemicellulase and/or beta-glucanase containing enzyme blends during the SSF process to produce a high protein feed ingredient.

The work described herein further unexpectedly demonstrates that the addition of a presently disclosed hemicellulase, beta-glucanase, or enzyme blend comprising hemicellulase and/or beta-glucanase directly to the whole stillage byproduct significantly improves the partitioning of protein from the initial whole stillage byproduct into the high protein fraction instead of into wet cake. Thus, the present invention more particularly relates to the addition of a hemicellulase, beta-glucanase or hemicellulase and/or beta-glucanase containing enzyme blends to whole stillage to produce a high protein feed ingredient.

The present invention contemplates using hemicellulases or beta-glucanases alone, as well as in enzyme blends comprising hemicellulase(s) and/or beta-glucanase(s) and at least one addition enzyme, such as a cellulolytic composition, in saccharification, fermentation, or simultaneous saccharification and fermentation, or in whole stillage, to produce a high protein feed ingredient downstream in both conventional and raw-starch hydrolysis (RSH) ethanol production processes.

### I. Enzyme Blends

The present invention contemplates using hemicellulases or beta-glucanases alone, as well as in enzyme blends comprising a hemicellulase and/or beta-glucanase and at least one additional enzyme, such as a cellulolytic composition, in saccharification, fermentation, or simultaneous saccharification and fermentation, to improve the partitioning of protein downstream in both conventional and raw-starch hydrolysis (RSH) ethanol production processes. The present invention also contemplates using hemicellulases or beta-glucanases alone, as well as in enzyme blends comprising a hemicellulase and/or beta-glucanase and at least one additional enzyme, such as a cellulolytic composition, in whole stillage, to improve the partitioning of protein downstream in both conventional and raw-starch hydrolysis (RSH) ethanol production processes.

Thus, the enzyme blends of the present invention are useful for increasing the percentage of protein in the high protein feed ingredient resulting from the separation of the whole stillage into protein-rich and fiber-rich (wet cake) fractions. When the cellulolytic composition is included in the blend, the ratio of the hemicellulase and/or beta-glucanase and the cellulolytic composition can be optimized to further increase the amount of protein that is partitioned into the high protein fraction rather than the wet cake, as well as further increase the mass of the high protein fraction that ends up in the high protein feed ingredient.

In one aspect the present invention relates to hemicellulase, beta-glucanase, or an enzyme blend comprising a hemicellulase and/or beta-glucanase. The hemicellulase, for example xylanase, increases the mass fraction of the high protein feed ingredient. The beta-glucanase increases the protein content on a dry wt % basis of the high protein feed ingredient. The enzyme blend is useful for producing a high protein feed ingredient from a whole stillage byproduct produced in a starch-containing grain dry milling process for producing a fermentation product.

In an aspect, the enzyme blend comprises at least two hemicellulases. In one embodiment, the enzyme blend comprises at least two hemicellulases, wherein the ratio of the at least two hemicellulases in the blend is from about 5:95 to about 95:5. In an embodiment, the at least two hemicellulases comprises at least one xylanase and at least one α-L-arabinofuranosidase. In an embodiment, the at least two hemicellulases comprises at least one xylanase from a family selected from the group consisting of a GH3 family xylanase, GH5 family xylanase, a GH8 family xylanase, a GH10 family xylanase, a GH11 family xylanase, a GH30 family xylanase, a GH43 family xylanase, and a GH98 family xylanase, and at least one α-L-arabinofuranosidase from a GH family selected from the group consisting of GH43, GH51 and GH62. In an embodiment, the least two hemicellulases comprises a GH5_21 xylanase and an α-L-arabinofuranosidase selected from a GH family selected the group consisting of GH43, GH51 and GH62.

In an embodiment, the at least two hemicellulases comprises a GH5_21 xylanase and a GH43 arabinofuranosidase. In an embodiment, the GH5_21 xylanase is selected from the group consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6, and wherein the GH43 arabinofuranosidase is selected from the group consisting of the one shown in amino acids 19 to 558 of SEQ ID NO: 56 or the one shown in amino acids 24 to 575 of SEQ ID NO: 57, or one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57.

In an embodiment, the at least two hemicellulases comprises a GH5_21 xylanase and a Gh51 arabinofuranosidase. In an embodiment, the GH521 xylanase is selected from the group consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6, and wherein the GH51 arabinofuranosidase is selected from the group consisting of the one shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58, and the one shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59.

In an embodiment, the at least two hemicellulases comprises a GH5_21 xylanase and a GH62 α-L-arabinofuranosidase. In an embodiment, the GH5_21 xylanase is selected from the group consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6, and wherein the GH62 α-L-arabinofuranosidase is the one shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or the one shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55.

In an embodiment, the at least two hemicellulases comprise a GH30_8 xylanase and a GH43 arabinofuranosidase. In an embodiment, the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH43 arabinofuranosidase is selected from the group consisting of the one shown in shown in amino acids 19 to 558 of SEQ ID NO: 56 or the one shown in amino acids 24 to 575 of SEQ ID NO: 57, or one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57.

In an embodiment, the at least two hemicellulases comprise a GH30_8 xylanase and a GH51 arabinofuranosidase. In an embodiment, the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH51 arabinofuranosidase is selected from the group consisting of the one shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58, and the one shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59.

In an embodiment, the at least two hemicellulases comprises a GH30_8 xylanase and an α-L-arabinofuranosidase selected from a GH family selected the group consisting of GH43, GH51 and GH62. In an embodiment, the at least two hemicellulases comprises a GH30_8 xylanase and a GH62 α-L-arabinofuranosidase. In an embodiment, the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH62 α-L-arabinofuranosidase is the one shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or the one shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55.

In an embodiment, the at least two hemicellulases comprises a GH10 xylanase and an α-L-arabinofuranosidase selected from a GH family selected the group consisting of GH43, GH51 and GH62. In an embodiment, the at least two hemicellulases comprise a GH10 xylanase and a GH43 arabinofuranosidase. In an embodiment, the GH10 xylanase is selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1, and the one shown in amino acids 21 to 405 of SEQ ID NO: 2 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2, and wherein the GH43 arabinofuranosidase is selected from the group consisting of the one shown in shown in amino acids 19 to 558 of SEQ ID NO: 56 or the one shown in amino acids 24 to 575 of SEQ ID NO: 57, or one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57.

In an embodiment, the at least two hemicellulases comprise a GH10 xylanase and a GH51 arabinofuranosidase. In an embodiment, the GH10 xylanase is selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1, and the one shown in amino acids 21 to 405 of SEQ ID NO: 2 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2, and wherein the GH51 arabinofuranosidase is selected from the group consisting of the one shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58, and the one shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59.

In an embodiment, the at least two hemicellulases comprises a GH10 xylanase and GH62 α-L-arabinofuranosidase. In an embodiment, the GH10 xylanase is selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1 and amino acids 21 to 405 of SEQ ID NO: 2 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2, and wherein the GH62 α-L-arabinofuranosidase is the one shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55.

In an embodiment, the GH10 xylanase is the one shown in amino acids 21 to 405 of SEQ ID NO: 2 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2, and wherein the GH62 α-L-arabinofuranosidase is the one shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11.

The at least one xylanase and the at least one α-L-arabinofuranosidase increases the mass fraction of the high protein feed ingredient.

In an embodiment, at least two hemicellulases comprises a xylanase and a beta-xylosidase. In an embodiment, at least two hemicellulases comprise: (i) a xylanase from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; and (ii) a beta-xylosidase from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12. The at least one xylanase and at least one beta-xylosidase increases the mass fraction of the high protein feed ingredient.

In an embodiment, the ratio of the at least two hemicellulases is 10:90. In an embodiment, the ratio of the at least two hemicellulases is 15:85. In an embodiment, the ratio of the at least two hemicellulases is 25:75. In an embodiment, the ratio of the hemicellulases is 30:70. In an embodiment, the ratio of the at least two hemicellulases is 35:65. In an embodiment, the ratio of the at least two hemicellulases is 40:60. In an embodiment, the ratio of the at least two hemicellulases is 45:55. In an embodiment, the ratio of the at least two hemicellulases is 50:50. In an embodiment, the ratio of the at least two hemicellulases is 55:45. In an embodiment, the ratio of the at least two hemicellulases is 60:40. In an embodiment, the ratio of the at least two hemicellulases is 65:35. In an embodiment, the ratio of the at least two hemicellulases is 70:30. In an embodiment, the ratio of the at least two hemicellulases is 75:25. In an embodiment, the ratio of the at least two hemicellulases is 80:20. In an embodiment, the ratio of the at least two hemicellulases is 85:15. In an embodiment, the ratio of the at least two hemicellulases is 90:10.

Aspects of the present invention relate to hemicellulase or an enzyme blend comprising at least one hemicellulase and a cellulolytic composition. In an embodiment, the enzyme blend comprises at least one hemicellulase and a cellulolytic composition, wherein: (i) the at least one hemicellulase is selected from the group consisting of an acetylxylan esterase, a α-glucuronidases, a α-L-arabinofuranosidases, a α-L-galactosidase, a beta-xylosidase, a feruloyl esterase, a α-D-galactosidase, a pectin-degrading enzyme, a xylanase, and any combination thereof; and (ii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I. In an embodiment, the enzyme blend comprises at least one hemicellulase and a cellulolytic composition, wherein: (i) the at least one hemicellulase is at least one xylanase selected from the group consisting of a GH3 xylanase, a GH5 xylanase, a GH8 xylanase, GH10 xylanase, a GH11 xylanase, a GH30 xylanase, a GH43 xylanase, and a GH 98 xylanase; and (ii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I. In an embodiment, the enzyme blend comprises at least one xylanase and a cellulolytic composition, wherein: (i) the at least one xylanase is selected from the group consisting of an Aspergillus GH10 xylanase, a Talaromyces GH10 xylanase, a Bacillus GH30_8 xylanase, a Chryseobacterium GH5_21 xylanase, an Acetivibrio GH5_34 xylanase, a Clostridium GH5_34 xylanase, a Gonapodya prolifera GH5_34 xylanase, a Paenibacillus GH5_35 xylanase, and any combination of at least two, at least three, at least four, at least five or at least six thereof; and (ii) the cellulolytic composition comprises at least three enzymes selected from the group consisting of an Aspergillus cellobiohydrolase I, an Aspergillus cellobiohydrolase II, an Aspergillus beta-glucosidase, a Penicillium GH61 polypeptide having cellulolytic enhancing activity, and a Trichoderma endoglucanase I. In an embodiment, the enzyme blend comprises at least one xylanase and a cellulolytic composition, wherein: (i) the at least one xylanase is selected from the group consisting of an Aspergillus fumigatus GH10 xylanase, a Talaromyces leycettanus GH10 xylanase, a Bacillus subtilis GH30_8 xylanase, a Chryseobacterium sp-10696 GH5_21 xylanase, an Acetivibrio cellulyticusGH5_34 xylanase, a Clostridium thermocellum GH5_34 xylanase, a Gonapodya prolifera GH5_34 xylanase, a Paenibacillus genus GH5_35 xylanase (e.g., Paenibacillus illinoisensis, Paenibacillus favisporus, or Penicillium sp. GH5_35 xylanase, and any combination of at least two, at least three, at least four, at least five or at least six thereof; and (ii) the cellulolytic composition comprises at least three enzymes selected from the group consisting of an Aspergillus fumigatus cellobiohydrolase I, an Aspergillus fumigatus cellobiohydrolase II, an Aspergillus fumigatus beta-glucosidase, a Penicillium emersonii GH61 polypeptide having cellulolytic enhancing activity, and a Trichoderma reesei endoglucanase I. In an embodiment, the enzyme blend comprises at least one xylanase and a cellulolytic composition, wherein the at least one xylanase is selected from the group consisting of:
(i) the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; (ii) the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2; (iii) the xylanase shown in amino acids 28 to 417 of SEQ ID NO: 3, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; (iv) the xylanase shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; (v) the xylanase shown in amino acids 25 to 551 of SEQ ID NO: 5, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5; (vi) the xylanase shown in amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; (vii) the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7; (viii) the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8; (ix) the xylanase shown in amino acids 37 to 573 of SEQ ID NO: 9, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9; (x) the xylanase shown in amino acids 36 to 582 of SEQ ID NO: 10 or one having at least 60%, at least 65%, at least 70%, at least 75%, at least 80%, at least 85%, at least 90%, at least 95%, at least 96%, at least 97%, at least 98%, or at least 99% sequence identity to amino acids 36 to 582 of SEQ ID NO: 10; (xi) the xylanase shown in amino acids 24 to 337 of SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to amino acids 24 to 337 of SEQ ID NO: 53; (xii) the xylanase shown in amino acids 1 to 536 of SEQ ID NO: 54 or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 536 of SEQ ID NO: 54; and wherein the cellulolytic composition comprises at least three enzymes selected from the group consisting of: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24; and (v) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 to of SEQ ID NO: 44.

In an embodiment, the enzyme blend comprises: (a) a GH5_34 xylanase selected from the group consisting of the one shown in SEQ ID NO: 7, the one shown in SEQ ID NO: 8, the one shown in amino acids 24 to 337 of SEQ ID NO: 53, and one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7, SEQ ID NO: 8, or amino acids 24 to 337 of SEQ ID NO: 53; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 2; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.

In an embodiment, the enzyme blend comprises: (a) a GH5_35 xylanase selected from the group consisting of the one shown in amino acids 37 to 573 of SEQ ID NO: 9, the one shown in amino acids 36 to 582 of SEQ ID NO: 10, the one shown in amino acids 1 to 536 of SEQ ID NO: 54, and one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9, the amino acids 36 to 582 of SEQ ID NO: 10, or amino acids 1 to 536 of SEQ ID NO: 54; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 2; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.

In an embodiment, the enzyme blend comprises: (a) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the enzyme blend comprises: (a) a GH30_8 xylanase selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; (b) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and (c) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the enzyme blend comprises: (a) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 2; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.

In an embodiment, the enzyme blend comprises: (a) a GH30_8 xylanase selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; (b) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and (c) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 2; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.

Preferably, the GH30_8 xylanase and the GH521 xylanase are present in the blend in a ratio of 1:1, 1.1:1, 1.2:1, 1.3:1, 1.4:1, 1.5:1, 1:1.5, 1:1.4, 1:1.3, 1:1.2, or 1:1.1 of GH30_8 xylanase to GH521 xylanase.

In an embodiment, the enzyme blend comprises at least two hemicellulases and a cellulolytic composition. In an embodiment, the at least two hemicellulases comprise at least one xylanase and at least one arabinofuranosidase. In an embodiment, the enzyme blend comprises: (a) at least one xylanase from a family selected from the group consisting of a GH3 family xylanase, GH5 family xylanase, a GH8 family xylanase, a GH10 family xylanase, a GH11 family xylanase, a GH30 family xylanase, a GH43 family xylanase, and a GH98 family xylanase; (b) at least one α-L-arabinofuranosidase from a GH family selected from the group consisting of GH43, GH51 and GH62; and; (c) a cellulolytic composition comprising at least three enzymes selected from the group consisting of a cellobiohydrolase I, cellobiohydrolase II, a beta-glucosidase, a GH61A polypeptide having cellulolytic enhancing activity, and an endoglucanase I.

In an embodiment, the enzyme blend comprises: (a) at least one GH10 xylanase selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1 and amino acids 21 to 405 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2; (b) the GH62 α-L-arabinofuranosidase shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55; and (c) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 2; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24. In an embodiment, the enzyme blend comprises: (a) at least one GH10 xylanase selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1 and amino acids 21 to 405 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2; (b) the GH62 α-L-arabinofuranosidase shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55; and (c) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 2; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.

In an embodiment, the at least two hemicellulases in the blend with the cellulolytic composition comprise at least one xylanase and at least one beta-xylosidase. In an embodiment, the enzyme blend comprises: (a) a xylanase selected from the group consisting of: (i) a xylanase from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; and (ii) a xylanase from the genus Talaromyces, for example Talaromyces leycettanus, such as the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2; (b) a beta-xylosidase from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12; and (c) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the enzyme blend comprises: (a) a xylanase selected from the group consisting of: (i) a xylanase from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; and (ii) a xylanase from the genus Talaromyces, for example Talaromyces leycettanus, such as the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2; (b) a beta-xylosidase from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12; and (c) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.

In one embodiment, the ratio of the hemicellulase(s) and cellulolytic composition in the blend is from about 5:95 to about 95:5. In an embodiment, the ratio of the hemicellulase(s) and cellulolytic composition is 10:90. In an embodiment, the ratio of the hemicellulase(s) and cellulolytic composition is 15:85. In an embodiment, the ratio of the hemicellulase(s) and cellulolytic composition is 20:80. In an embodiment, the ratio of the hemicellulase(s) and cellulolytic composition is 25:75. In an embodiment, the ratio of the hemicellulase(s) and cellulolytic composition is 30:70. In an embodiment, the ratio of the hemicellulase(s) and cellulolytic composition is 35:65. In an embodiment, the ratio of the hemicellulase(s) and cellulolytic composition is 40:60. In an embodiment, the ratio of the hemicellulase(s) and cellulolytic composition is 45:55. In an embodiment, the ratio of the hemicellulase(s) and cellulolytic composition is 50:50. In an embodiment, the ratio of the hemicellulase(s) and cellulolytic composition is 55:45. In an embodiment, the ratio of the hemicellulase(s) and cellulolytic composition is 60:40. In an embodiment, the ratio of the hemicellulase(s) and cellulolytic composition is 65:35. In an embodiment, the ratio of the hemicellulase(s) and cellulolytic composition is 70:30. In an embodiment, the ratio of the hemicellulase(s) and cellulolytic composition is 75:25. In an embodiment, the ratio of the hemicellulase(s) and cellulolytic composition is 80:20. In an embodiment, the ratio of the hemicellulase(s) and cellulolytic composition is 85:15. In an embodiment, the ratio of the hemicellulase(s) and cellulolytic composition is 90:10.

In an aspect, the at least two hemicellulases comprises at least two xylanases. In one embodiment, the enzyme blend comprises at least two xylanases, wherein the ratio of the at least two xylanases in the blend is from about 5:95 to about 95:5. In an embodiment, the at least two xylanases comprise a GH5 family xylanase and a GH10 family xylanase. In an embodiment, the at least two xylanases comprise a GH10 family xylanase and a GH30 family xylanase. In an embodiment, the at least two xylanases comprise a GH30 family xylanase and a GH5 family xylanase.

In an embodiment, the at least two xylanases comprise a GH30_8 xylanase and a GH5_21 family xylanase. In an embodiment, the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH5_21 xylanase is selected from the group consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6.

In an embodiment, the at least two xylanases comprise a GH30_8 xylanase and a GH5_34 family xylanase. In an embodiment, the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH5_34 xylanase is selected from the group consisting of the one shown in SEQ ID NO: 7, the one shown in SEQ ID NO: 8, the one shown in amino acids 24 to 337 of SEQ ID NO: 53, and one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7, SEQ ID NO: 8, or amino acids 24 to 337 of SEQ ID NO: 53.

In an embodiment, the at least two xylanases comprise a GH30_8 xylanase and a GH535 family xylanase. In an embodiment, the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH5_35 xylanase is selected from the group consisting of the one shown in amino acids 37 to 573 of SEQ ID NO: 9, the one shown in amino acids 36 to 582 of SEQ ID NO: 10, the one shown in amino acids 1 to 536 of SEQ ID NO: 54, and one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9, the amino acids 36 to 582 of SEQ ID NO: 10, or amino acids 1 to 536 of SEQ ID NO: 54.

In an embodiment, the at least two xylanases are present in the blend in a ratio of 1:1, 1.1:1, 1.2:1, 1.3:1, 1.4:1, 1.5:1, 1:1.5, 1:1.4, 1:1.3, 1:1.2, or 1:1.1 of GH30_8 xylanase to GH5_21 xylanase. The xylanase(s) increase the mass fraction of the high protein feed ingredient compared to the mass of the high protein feed ingredient in the absence of the xylanase(s). In an embodiment, the ratio of the at least two xylanases is 10:90. In an embodiment, the ratio of the at least two xylanases is 15:85. In an embodiment, the ratio of the at least two xylanases is 25:75. In an embodiment, the ratio of the xylanases is 30:70. In an embodiment, the ratio of the at least two xylanases is 35:65. In an embodiment, the ratio of the at least two xylanases is 40:60. In an embodiment, the ratio of the at least two xylanases is 45:55. In an embodiment, the ratio of the at least two xylanases is 50:50. In an embodiment, the ratio of the at least two xylanases is 55:45. In an embodiment, the ratio of the at least two xylanases is 60:40. In an embodiment, the ratio of the at least two xylanases is 65:35. In an embodiment, the ratio of the at least two xylanases is 70:30. In an embodiment, the ratio of the at least two xylanases is 75:25. In an embodiment, the ratio of the at least two xylanases is 80:20. In an embodiment, the ratio of the at least two xylanases is 85:15. In an embodiment, the ratio of the at least two xylanases is 90:10.

In one aspect the present invention relates to xylanases or an enzyme blend comprising at least one xylanase and a cellulolytic composition, wherein the ratio of the xylanases and cellulolytic composition in the blend is from about 5:95 to about 95:5. In an embodiment, the ratio of the xylanases and cellulolytic composition is 10:90. In an embodiment, the ratio of the xylanases and cellulolytic composition is 15:85. In an embodiment, the ratio of the xylanases and cellulolytic composition is 20:80. In an embodiment, the ratio of the xylanases and cellulolytic composition is 25:75. In an embodiment, the ratio of the xylanases and cellulolytic composition is 30:70. In an embodiment, the ratio of the xylanases and cellulolytic composition is 35:65. In an embodiment, the ratio of the xylanases and cellulolytic composition is 40:60. In an embodiment, the ratio of the xylanases and cellulolytic composition is 45:55. In an embodiment, the ratio of the xylanases and cellulolytic composition is 50:50. In an embodiment, the ratio of the xylanases and cellulolytic composition is 55:45. In an embodiment, the ratio of the xylanases and cellulolytic composition is 60:40. In an embodiment, the ratio of the xylanases and cellulolytic composition is 65:35. In an embodiment, the ratio of the xylanases and cellulolytic composition is 70:30. In an embodiment, the ratio of the xylanases and cellulolytic composition is 75:25. In an embodiment, the ratio of the xylanases and cellulolytic composition is 80:20. In an embodiment, the ratio of the xylanases and cellulolytic composition is 85:15. In an embodiment, the ratio of the xylanases and cellulolytic composition is 90:10.

In one aspect the present invention relates to beta-glucanase or an enzyme blend comprising a beta-glucanase. The beta-glucanase increases the protein content on a dry wt % basis of the high protein feed ingredient. The enzyme blend is useful for producing a high protein feed ingredient from a whole stillage byproduct produced in a starch-containing grain dry milling process for producing a fermentation product.

In one aspect the present invention relates to an enzyme blend comprising at least two beta-glucanases, wherein the ratio of the at least two beta-glucanases in the blend is from about 5:95 to about 95:5. In an embodiment, the ratio of the at least two beta-glucanases is 10:90. In an embodiment, the ratio of the at least two beta-glucanases is 15:85. In an embodiment, the ratio of the at least two beta-glucanases is 25:75. In an embodiment, the ratio of the at least two beta-glucanases is 30:70. In an embodiment, the ratio of the at least two beta-glucanases is 35:65. In an embodiment, the ratio of the at least two beta-glucanases is 40:60. In an embodiment, the ratio of the at least two beta-glucanases is 45:55. In an embodiment, the ratio of the at least two beta-glucanases is 50:50. In an embodiment, the ratio of the at least two beta-glucanases is 55:45. In an embodiment, the ratio of the at least two beta-glucanases is 60:40. In an embodiment, the ratio of the at least two beta-glucanases is 65:35. In an embodiment, the ratio of the at least two beta-glucanases is 70:30. In an embodiment, the ratio of the at least two beta-glucanases is 75:25. In an embodiment, the ratio of the at least two beta-glucanases is 80:20. In an embodiment, the ratio of the at least two beta-glucanases is 85:15. In an embodiment, the ratio of the at least two beta-glucanases is 90:10.

In one aspect the present invention relates to an enzyme blend comprising a beta-glucanase and a cellulolytic composition. The enzyme blend increases the protein content on a dry wt % basis of the high protein feed ingredient.

In an embodiment, the enzyme blend comprises at least one beta-glucanase and a cellulolytic composition, wherein: (i) the at least one beta-glucanase is from a glycoside hydrolase family selected from the group consisting of a GH5_15 family beta-glucanase, a GH16 family beta-glucanase, and a GH64 family beta-glucanase, and (ii the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I. In an embodiment, the enzyme blend comprises: (a) at least one beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24. In an embodiment, the enzyme blend comprises: (a) at least one beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44. In an embodiment, the enzyme blend comprises: (a) at least one beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24. In an embodiment, the enzyme blend comprises: (a) at least one beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44. In an embodiment, the enzyme blend comprises: (a) at least one beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 19, or amino acids 20 to 284 of SEQ ID NO: 18; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24. In an embodiment, the enzyme blend comprises: (a) at least one beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44 to 459 of 44. In an embodiment, the enzyme blend comprises: (a) at least one beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24. In an embodiment, the enzyme blend comprises: (a) at least one beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and (b) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.

The ratio of the beta-glucanase or beta-glucanases and the cellulolytic composition in the enzyme blend can be adjusted to optimize the protein content on a dry wt % basis of the high protein feed ingredient. In an embodiment, the ratio of the beta-glucanase and cellulolytic composition in the blend is from about 5:95 to about 95:5. In an embodiment, the cellulolytic composition is present in the blend in a ratio of beta-glucanase and cellulolytic composition from about 5:95 to about 95:5, such as from 5:95, 10:90, 20:80, 25:75, 50:50, 80:20, 75:25, 90:10, and 95:5. In an embodiment, the ratio of the beta-glucanase and cellulolytic composition is 10:90. In an embodiment, the ratio of the beta-glucanase and cellulolytic composition is 15:85. In an embodiment, the ratio of the beta-glucanase and cellulolytic composition is 20:80. In an embodiment, the ratio of the beta-glucanase and cellulolytic composition is 25:75. In an embodiment, the ratio of the beta-glucanase and cellulolytic composition is 30:70. In an embodiment, the ratio of the beta-glucanase and cellulolytic composition is 35:65. In an embodiment, the ratio of the beta-glucanase and cellulolytic composition is 40:60. In an embodiment, the ratio of the beta-glucanase and cellulolytic composition is 45:55. In an embodiment, the ratio of the beta-glucanase and cellulolytic composition is 50:50. In an embodiment, the ratio of the beta-glucanase and cellulolytic composition is 55:45. In an embodiment, the ratio of the beta-glucanase and cellulolytic composition is 60:40. In an embodiment, the ratio of the beta-glucanase and cellulolytic composition is 65:35. In an embodiment, the ratio of the beta-glucanase and cellulolytic composition is 70:30. In an embodiment, the ratio of the beta-glucanase and cellulolytic composition is 75:25. In an embodiment, the ratio of the beta-glucanase and cellulolytic composition is 80:20. In an embodiment, the ratio of the beta-glucanase and cellulolytic composition is 85:15. In an embodiment, the ratio of the beta-glucanase and cellulolytic composition is 90:10.

In one aspect the present invention relates to an enzyme blend comprising a hemicellulase, beta-glucanase, and a cellulolytic composition. The enzyme blend is useful for producing a high protein feed ingredient from a whole stillage byproduct produced in a starch-containing grain dry milling process for producing a fermentation product. The enzyme blend optimizes the mass fraction and the protein content on a dry wt % basis of the high protein feed ingredient.

In one aspect the present invention relates to an enzyme blend comprising a hemicellulase, a beta-glucanase, and a cellulolytic composition. In an embodiment, the enzyme blend comprises at least one hemicellulase, at least one beta-glucanase, and a cellulolytic composition, wherein: (i) the at least one hemicellulase is selected from the group consisting of an acetylxylan esterase, a α-glucuronidases, a α-L-arabinofuranosidases, a α-L-galactosidase, a beta-xylosidase, a feruloyl esterase, a α-D-galactosidase, a pectin-degrading enzyme, a xylanase, and any combination thereof; (ii) the at least one beta-glucanase is from a glycoside hydrolase family selected from the group consisting of a GH5_15 family beta-glucanase, a GH16 family beta-glucanase, and a GH64 family beta-glucanase; and (iii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I. The ratio of the hemicellulase, beta-glucanase, and cellulolytic composition in the blend can be adjusted to optimize the mass fraction and the protein content on a dry wt % basis of the high protein feed ingredient. In an embodiment, the ratio of the hemicellulase, beta-glucanase, and cellulolytic composition in the blend is from about 5:5:90 to about 35:35:30. In an embodiment, the ratio of the hemicellulase, beta-glucanase and cellulolytic composition is 5:5:90. In an embodiment, the ratio of the hemicellulase, beta-glucanase and cellulolytic composition is between 5:5:90 and 10:10:80. In an embodiment, the ratio of the hemicellulase, beta-glucanase, and cellulolytic composition is 10:10:80. In an embodiment, the ratio of the hemicellulase, beta-glucanase and cellulolytic composition is 15:15:70. In an embodiment, the ratio of the hemicellulase, beta-glucanase, and cellulolytic composition is 20:20:60. In an embodiment, the ratio of the hemicellulase, beta-glucanase, and cellulolytic composition is 19:21:60. In an embodiment, the ratio of the hemicellulase, beta-glucanase, and cellulolytic composition is 18:22:60. In an embodiment, the ratio of the hemicellulase, beta-glucanase, and cellulolytic composition is 17:23:60. In an embodiment, the ratio of the hemicellulase, beta-glucanase, and cellulolytic composition is 16:24:60. In an embodiment, the ratio of the hemicellulase, beta-glucanase, and cellulolytic composition is 15:25:60. In an embodiment, the ratio of the hemicellulase, beta-glucanase and cellulolytic composition is 21:19:60. In an embodiment, the ratio of the hemicellulase, beta-glucanase, and cellulolytic composition is 22:18:60. In an embodiment, the ratio of the hemicellulase, beta-glucanase, and cellulolytic composition is 23:17:60. In an embodiment, the ratio of the hemicellulase, beta-glucanase, and cellulolytic composition is 24:16:60. In an embodiment, the ratio of the hemicellulase, beta-glucanase, and cellulolytic composition is 25:15:60. In an embodiment, the ratio of the hemicellulase, beta-glucanase, and cellulolytic composition is 20:21:59. In an embodiment, the ratio of the hemicellulase, beta-glucanase, and cellulolytic composition is 20:22:58. In an embodiment, the ratio of the hemicellulase, beta-glucanase, and cellulolytic composition is 20:23:57. In an embodiment, the ratio of the hemicellulase, beta-glucanase, and cellulolytic composition is 20:24:56. In an embodiment, the ratio of the hemicellulase, beta-glucanase, and cellulolytic composition is 20:25:55. In an embodiment, the ratio of the hemicellulase, beta-glucanase, and cellulolytic composition is 21:20:59. In an embodiment, the ratio of the hemicellulase, beta-glucanase, and cellulolytic composition is 22:20:58. In an embodiment, the ratio of the hemicellulase, beta-glucanase, and cellulolytic composition is 23:20:57. In an embodiment, the ratio of the hemicellulase, beta-glucanase, and cellulolytic composition is 24:20:56. In an embodiment, the ratio of the hemicellulase, beta-glucanase, and cellulolytic composition is 25:20:55. In an embodiment, the ratio of the hemicellulase, beta-glucanase, and cellulolytic composition is 21:21:58. In an embodiment, the ratio of the hemicellulase, beta-glucanase, and cellulolytic composition is 22:22:56. In an embodiment, the ratio of the hemicellulase, beta-glucanase, and cellulolytic composition is 23:23:54. In an embodiment, the ratio of the hemicellulase, beta-glucanase, and cellulolytic composition is 24:24:52. In an embodiment, the ratio of the hemicellulase, beta-glucanase, and cellulolytic composition is 25:25:50. In an embodiment, the ratio of the hemicellulase, beta-glucanase, and cellulolytic composition is 20-25:20:25:40-50. In an embodiment, the ratio of the hemicellulase, beta-glucanase, and cellulolytic composition is 15-20:15-20:60-70. In an embodiment, the ratio of the hemicellulase, beta-glucanase, and cellulolytic composition is 10-15:10-15:70-80. In an embodiment, the ratio of the hemicellulase, beta-glucanase, and cellulolytic composition is 5-10:5-10:80-90.

In one aspect the present invention relates to an enzyme blend comprising a xylanase, beta-glucanase, and a cellulolytic composition. The enzyme blend is useful for producing a high protein feed ingredient from a whole stillage byproduct produced in a starch-containing grain dry milling process for producing a fermentation product. The enzyme blend optimizes the mass fraction and the protein content on a dry wt % basis of the high protein feed ingredient.

In one aspect the present invention relates to an enzyme blend comprising a xylanase, a beta-glucanase, and a cellulolytic composition. In an embodiment, the enzyme blend comprises at least one hemicellulase, at least one beta-glucanase, and a cellulolytic composition, wherein: (i) the at least one hemicellulase is at least one xylanase selected from the group consisting of a GH3 xylanase, a GH5 xylanase, a GH8 xylanase, GH10 xylanase, a GH11 xylanase, a GH30 xylanase, a GH43 xylanase, and a GH 98 xylanase;
(ii) the at least one beta-glucanase is from a glycoside hydrolase family selected from the group consisting of a GH5_15 family beta-glucanase, a GH16 family beta-glucanase, and a GH64 family beta-glucanase; and (iii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I. In an embodiment, the enzyme blend comprises at least one xylanase, at least one beta-glucanase, and a cellulolytic composition, wherein: (i) the at least one xylanase is selected from the group consisting of an Aspergillus GH10 xylanase, a Talaromyces GH10 xylanase, a Bacillus GH30_8 xylanase, a Chryseobacterium GH5_21 xylanase, an Acetivibrio GH5_34 xylanase, a Clostridium GH5_34 xylanase, a Gonapodya prolifera GH5_34 xylanase, a Paenibacillus GH5_35 xylanase, and any combination of at least two, at least three, at least four, at least five or at least six thereof; (ii) the at least one beta-glucanase is selected from the group consisting of a Rasamsonia GH5_15 beta-glucanase, a Trichoderma GH5_15 beta-glucanase, an Albifimbria GH16 beta-glucanase, a Lecanicillium GH16 beta-glucanase, and a Trichoderma GH64 family beta-glucanase; and (iii) the cellulolytic composition comprises at least three enzymes selected from the group consisting of an Aspergillus cellobiohydrolase I, an Aspergillus cellobiohydrolase II, an Aspergillus beta-glucosidase, a Penicillium GH61 polypeptide having cellulolytic enhancing activity, and a Trichoderma endoglucanase I. In an embodiment, the enzyme blend comprises at least one xylanase, at least one beta-glucanase, and a cellulolytic composition, wherein: (i) the at least one xylanase is selected from the group consisting of an Aspergillus fumigatus GH10 xylanase, a Talaromyces leycettanus GH10 xylanase, a Bacillus subtilis GH30_8 xylanase, a Chryseobacterium sp-10696 GH5_21 xylanase, an Acetivibrio cellulyticus GH5_34 xylanase, a Clostridium thermocellum GH5_34 xylanase, a Gonapodya prolifera GH5_34 xylanase, a Paenibacillus favisporus, Paenibacillus illinoisensis or Penicillium sp. GH5_35 xylanase, and any combination of at least two, at least three, at least four, at least five or at least six thereof; and (ii) the at least one beta-glucanase is selected from the group consisting of a Rasamsonia byssochlamydoides GH5_15 beta-glucanase, a Trichoderma atroviride GH5_15 beta-glucanase, a Trichoderma harzianum GH5_15 beta-glucanase, an Albifimbria verrucaria GH16 beta-glucanase, a Lecanicillium sp. WMM742 GH16 beta-glucanase, and a Trichoderma harzianum GH64 family beta-glucanase; (iii) the cellulolytic composition comprises at least three enzymes selected from the group consisting of an Aspergillus fumigatus cellobiohydrolase I, an Aspergillus fumigatus cellobiohydrolase II, an Aspergillus fumigatus beta-glucosidase, a Penicillium emersonii GH61 polypeptide having cellulolytic enhancing activity, and a Trichoderma reesei endoglucanase I. In an embodiment, the enzyme blend comprises: (a) at least one xylanase selected from the group consisting of: (i) the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; (ii) the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2; (iii) the xylanase shown in amino acids 28 to 417 of SEQ ID NO: 3, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; (iv) the xylanase shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; (v) the xylanase shown in amino acids 25 to 551 of SEQ ID NO: 5, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5; (vi) the xylanase shown in amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; (vii) the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7; (viii) the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8; (ix) the xylanase shown in amino acids 37 to 573 of SEQ ID NO: 9, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9; (x) the xylanase shown in amino acids 36 to 582 of SEQ ID NO: 10 or one having at least 60%, at least 65%, at least 70%, at least 75%, at least 80%, at least 85%, at least 90%, at least 95%, at least 96%, at least 97%, at least 98%, or at least 99% sequence identity to amino acids 36 to 582 of SEQ ID NO: 10; (xi) the xylanase shown in amino acids 24 to 337 of SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to amino acids 24 to 337 of SEQ ID NO: 53; (xii) the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 536 of SEQ ID NO: 54;
(b) at least one beta-glucanase selected from the group consisting of: (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14; (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and (c) and a cellulolytic composition comprising at least three enzymes selected from the group consisting of: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24; and (v) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44. In an embodiment, the enzyme blend comprises: (a) at least one xylanase selected from the group consisting of: (i) the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; (ii) the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2; (iii) the xylanase shown in amino acids 28 to 417 of SEQ ID NO: 3, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; (iv) the xylanase shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; (v) the xylanase shown in amino acids 25 to 551 of SEQ ID NO: 5, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5; (vi) the xylanase shown in amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; (vii) the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7; (viii) the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8; (ix) the xylanase shown in amino acids 37 to 573 of SEQ ID NO: 9, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9; (x) the xylanase shown in amino acids 36 to 582 of SEQ ID NO: 10 or one having at least 60%, at least 65%, at least 70%, at least 75%, at least 80%, at least 85%, at least 90%, at least 95%, at least 96%, at least 97%, at least 98%, or at least 99% sequence identity to amino acids 36 to 582 of SEQ ID NO: 10; (xi) the xylanase shown in amino acids 24 to 337 of SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to amino acids 24 to 337 of SEQ ID NO: 53; (xii) the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 536 of SEQ ID NO: 54;
(b) at least one beta-glucanase selected from the group consisting of: (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14; (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and (c) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 2; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24. In an embodiment, the enzyme blend comprises: (a) at least one xylanase selected from the group consisting of: (i) the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; (ii) the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2; (iii) the xylanase shown in amino acids 28 to 417 of SEQ ID NO: 3, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; (iv) the xylanase shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; (v) the xylanase shown in amino acids 25 to 551 of SEQ ID NO: 5, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5; (vi) the xylanase shown in amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; (vii) the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7; (viii) the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8; (ix) the xylanase shown in amino acids 37 to 573 of SEQ ID NO: 9, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9; (x) the xylanase shown in amino acids 36 to 582 of SEQ ID NO: 10 or one having at least 60%, at least 65%, at least 70%, at least 75%, at least 80%, at least 85%, at least 90%, at least 95%, at least 96%, at least 97%, at least 98%, or at least 99% sequence identity to amino acids 36 to 582 of SEQ ID NO: 10; (xi) the xylanase shown in amino acids 24 to 337 of SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to amino acids 24 to 337 of SEQ ID NO: 53; (xii) the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 536 of SEQ ID NO: 54; (b) at least one beta-glucanase selected from the group consisting of: (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14; (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and (c) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44. In an embodiment, the enzyme blend comprises: (a) a GH30_8 xylanase selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; and/or (b) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and (c) at least one beta-glucanase selected from the group consisting of: (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14; (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and (d) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24. In an embodiment, the enzyme blend comprises: (a) a GH30_8 xylanase selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; and/or (b) a GH521 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and (c) at least one beta-glucanase selected from the group consisting of: (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14; (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and (d) a cellulolytic composition comprising: (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.

The ratio of the xylanase, beta-glucanase, and cellulolytic composition in the blend can be adjusted to optimize the mass fraction and the protein content on a dry wt % basis of the high protein feed ingredient. In an embodiment, the ratio of the xylanase, beta-glucanase, and cellulolytic composition in the blend is from about 5:5:90 to about 35:35:30. In an embodiment, the ratio of the xylanase, beta-glucanase and cellulolytic composition is 5:5:90. In an embodiment, the ratio of the xylanase, beta-glucanase and cellulolytic composition is between 5:5:90 and 10:10:80. In an embodiment, the ratio of the xylanase, beta-glucanase, and cellulolytic composition is 10:10:80. In an embodiment, the ratio of the xylanase, beta-glucanase and cellulolytic composition is 15:15:70. In an embodiment, the ratio of the xylanase, beta-glucanase, and cellulolytic composition is 20:20:60.

In an embodiment, the ratio of the xylanase, beta-glucanase, and cellulolytic composition is 19:21:60. In an embodiment, the ratio of the xylanase, beta-glucanase, and cellulolytic composition is 18:22:60. In an embodiment, the ratio of the xylanase, beta-glucanase, and cellulolytic composition is 17:23:60. In an embodiment, the ratio of the xylanase, beta-glucanase, and cellulolytic composition is 16:24:60. In an embodiment, the ratio of the xylanase, beta-glucanase, and cellulolytic composition is 15:25:60.

In an embodiment, the ratio of the xylanase, beta-glucanase and cellulolytic composition is 21:19:60. In an embodiment, the ratio of the xylanase, beta-glucanase, and cellulolytic composition is 22:18:60. In an embodiment, the ratio of the xylanase, beta-glucanase, and cellulolytic composition is 23:17:60. In an embodiment, the ratio of the xylanase, beta-glucanase, and cellulolytic composition is 24:16:60. In an embodiment, the ratio of the xylanase, beta-glucanase, and cellulolytic composition is 25:15:60. In an embodiment, the ratio of the xylanase, beta-glucanase, and cellulolytic composition is 20:21:59. In an embodiment, the ratio of the xylanase, beta-glucanase, and cellulolytic composition is 20:22:58. In an embodiment, the ratio of the xylanase, beta-glucanase, and cellulolytic composition is 20:23:57.

In an embodiment, the ratio of the xylanase, beta-glucanase, and cellulolytic composition is 20:24:56. In an embodiment, the ratio of the xylanase, beta-glucanase, and cellulolytic composition is 20:25:55. In an embodiment, the ratio of the xylanase, beta-glucanase, and cellulolytic composition is 21:20:59. In an embodiment, the ratio of the xylanase, beta-glucanase, and cellulolytic composition is 22:20:58. In an embodiment, the ratio of the xylanase, beta-glucanase, and cellulolytic composition is 23:20:57. In an embodiment, the ratio of the xylanase, beta-glucanase, and cellulolytic composition is 24:20:56. In an embodiment, the ratio of the xylanase, beta-glucanase, and cellulolytic composition is 25:20:55. In an embodiment, the ratio of the xylanase, beta-glucanase, and cellulolytic composition is 21:21:58.

In an embodiment, the ratio of the xylanase, beta-glucanase, and cellulolytic composition is 22:22:56. In an embodiment, the ratio of the xylanase, beta-glucanase, and cellulolytic composition is 23:23:54. In an embodiment, the ratio of the xylanase, beta-glucanase, and cellulolytic composition is 24:24:52. In an embodiment, the ratio of the xylanase, beta-glucanase, and cellulolytic composition is 25:25:50. In an embodiment, the ratio of the xylanase, beta-glucanase, and cellulolytic composition is 20-25:20:25:40-50. In an embodiment, the ratio of the xylanase, beta-glucanase, and cellulolytic composition is 15-20:15-20:60-70. In an embodiment, the ratio of the xylanase, beta-glucanase, and cellulolytic composition is 10-15:10-15:70-80. In an embodiment, the ratio of the xylanase, beta-glucanase, and cellulolytic composition is 5-10:5-10:80-90.

In an embodiment, the cellulolytic composition is present in the blend in a ratio of cellulolytic composition, beta-glucanase, and hemicellulase from about 80:10:10 to about 40:30:30, such as from 80:10:10, 75:20:5, 75:15:10, 75:13:12, 75:12:13, 75:10:15, 75:5:20, 70:25:5, 70:20:10, 70:15:15, 70:10:20, 70:5:25, 65:30:5, 65:25:10, 65:20:15, 65:18:17, 65:17:18, 65:15:20, 65:10:25, 65:5:35, 60:35:5, 60:30:10, 60:25:15, 60:20:20, 60:15:25, 60:10:30, 60:5:35, 55:40:5, 55:35:10, 55:30:15, 55:25:20, 55:23:22, 55:22:23, 55:20:25, 55:15:30, 55:10:35, 55:5:40; 50:45:5, 50:40:10, 50:35:15, 50:30:20, 50:25:25, 50:20:30, 50:15:35, 50:10:40, 50:5:45, 45:50:5, 45:45:10, 45:40:15, 45:35:20, 45:30:25, 45:28:27, 45:27:28, 45:25:30, 45:20:35, 45:15:40, 45:10:45, 45:5:40, 40:55:5, 40:50:10, 40:45:15, 40:40:20, 40:35:25, 40:30:30, 40:25:35, 40:20:40, 40:15:45, 40:10:50, and 40: 5:55, preferably from about 50-70:15-25:15-25, or most preferably about 55-60:18-23:18-23.

In an embodiment, the cellulolytic composition is present in the blend in a ratio of cellulolytic composition, beta-glucanase, and xylanase from about 80:10:10 to about 40:30:30, such as from 80:10:10, 75:20:5, 75:15:10, 75:13:12, 75:12:13, 75:10:15, 75:5:20, 70:25:5, 70:20:10, 70:15:15, 70:10:20, 70:5:25, 65:30:5, 65:25:10, 65:20:15, 65:18:17, 65:17:18, 65:15:20, 65:10:25, 65:5:35, 60:35:5, 60:30:10, 60:25:15, 60:20:20, 60:15:25, 60:10:30, 60:5:35, 55:40:5, 55:35:10, 55:30:15, 55:25:20, 55:23:22, 55:22:23, 55:20:25, 55:15:30, 55:10:35, 55:5:40; 50:45:5, 50:40:10, 50:35:15, 50:30:20, 50:25:25, 50:20:30, 50:15:35, 50:10:40, 50:5:45, 45:50:5, 45:45:10, 45:40:15, 45:35:20, 45:30:25, 45:28:27, 45:27:28, 45:25:30, 45:20:35, 45:15:40, 45:10:45, 45:5:40, 40:55:5, 40:50:10, 40:45:15, 40:40:20, 40:35:25, 40:30:30, 40:25:35, 40:20:40, 40:15:45, 40:10:50, and 40: 5:55, preferably from about 50-70:15-25:15-25, or most preferably about 55-60:18-23:18-23.

### Hemicellulase

The present invention contemplates using any hemicellulase that, when optionally blended together with a beta-glucanase and/or cellulolytic composition various ratios, partitions a greater amount of protein from the whole stillage byproduct into the high protein fraction, rather than being retained in the wet cake, to produce a high protein feed ingredient. Exemplary hemicellulases include, without limitation, acetylxylan esterases, α-glucuronidases, α-L-arabinofuranosidases, feruloyl esterases, galactosidases (α-L-galactosidases or α-D-galactosidases), pectin-degrading enzymes, xylanases, and any combination thereof. In one embodiment, the hemicellulase is selected from the group consisting of an acetylxylan esterase, a α-glucuronidase, a α-L-arabinofuranosidase, a α-L-galactosidase, a feruloyl esterase, a α-D-galactosidase, a pectin-degrading enzyme, a xylanase, and any combination thereof.

### Acetylxylan Esterase

The present invention contemplates using any acetylxylan esterase that, when optionally blended together with a xylanase, beta-glucanase, and/or cellulolytic composition in various ratios, is capable of partitioning a greater amount of protein from the whole stillage byproduct into the high protein fraction, rather than being retained in the wet cake, to produce a high protein feed ingredient.

An acetyl xylan esterase may be a member of Carbohydrate Esterase Family 1, 2, 3, 4, 5, 6, 7, 12 or 15 and PF05448. In an embodiment, the hemicellulase is an acetylxylan esterase from a Carbohydrate Esterase Family selected from the group consisting of CE1, CE2, CE3, CE4, CE5, CE6, CE7, CE12, CE15, and PF05448.

Examples of acetylxylan esterases useful in the processes and enzyme blends of the present invention include, but are not limited to, acetylxylan esterases from Aspergillus aculeatus (WO 2010/108918), Chaetomium globosum (UniProt:Q2GWX4), Chaetomium gracile (GeneSeqP:AAB82124), Humicola insolens DSM 1800 (WO 2009/073709), Hypocrea jecorina (WO 2005/001036), Myceliophtera thermophila (WO 2010/014880), Neurospora crassa (UniProt:q7s259), Phaeosphaeria nodorum (UniProt:QOUHJ1), and Thielavia terrestris NRRL 8126 (WO 2009/042846). In an embodiment, the acetylxylan esterase is from Aspergillus aculeatus (WO 2010/108918) or a variant thereof. In an embodiment, the acetylxylan esterase is from Chaetomium globosum (UniProt:Q2GWX4) or a variant thereof. In an embodiment, the acetylxylan esterase is from Chaetomium gracile (GeneSeqP:AAB82124) or a variant thereof. In an embodiment, the acetylxylan esterase is from Humicola insolens DSM 1800 (WO 2009/073709) or a variant thereof. Hypocrea jecorina (WO 2005/001036) or a variant thereof. In an embodiment, the acetylxylan esterase is from Myceliophtera thermophila (WO 2010/014880) or a variant thereof. In an embodiment, the acetylxylan esterase is from Neurospora crassa (UniProt:q7s259) or a variant thereof. In an embodiment, the acetylxylan esterase is from Phaeosphaeria nodorum (UniProt:QOUHJ1) or a variant thereof. In an embodiment, the acetylxylan esterase is from Thielavia terrestris NRRL 8126 (WO 2009/042846) or a variant thereof.

α-glucuronidase

The present invention contemplates using any α-glucuronidase that, when optionally blended together with a xylanase, beta-glucanase, and/or cellulolytic composition in various ratios, partitions a greater amount of protein from the whole stillage byproduct into the high protein fraction, rather than being retained in the wet cake, to produce a high protein feed ingredient.

An alpha-glucuronidase may comprise a catalytic domain of GH Family 4, 67, or 115. In an embodiment, the α-glucuronidase is selected from the group consisting of a GH115 α-glucuronidase having xylan α-1,2-glucuronidase activity, a GH4 α-glucuronidase having α-glucuronidase activity, and a GH67 α-glucuronidase having xylan α-1,2-glucuronidase activity.

Examples of alpha-glucuronidases useful in the processes and enzyme blends of the present invention include, but are not limited to, alpha-glucuronidases from Aspergillus clavatus (UniProt:alcc12), Aspergillus fumigatus (SwissProt:Q4WW45), Aspergillus niger (UniProt:Q96WX9), Aspergillus terreus (SwissProt:QOCJP9), Humicola insolens (WO 2010/014706), Penicillium aurantiogriseum (WO 2009/068565), Talaromyces emersonii (UniProt:Q8X21 1), and Trichoderma reesei (UniProt:Q99024).

In an embodiment, the hemicellulase is an alpha-glucuronidase is an Aspergillus clavatus alpha-glucuronidase (UniProt:alcc12) or a variant thereof. In an embodiment, the hemicellulase is an alpha-glucuronidase is an Aspergillus fumigatus alpha-glucuronidase (SwissProt:Q4WW45) or a variant thereof. In an embodiment, the hemicellulase is an alpha-glucuronidase is an Aspergillus niger alpha-glucuronidase (UniProt:Q96WX9) or a variant thereof. In an embodiment, the hemicellulase is an alpha-glucuronidase is an Aspergillus terreus alpha-glucuronidase (SwissProt:QOCJP9) or a variant thereof. In an embodiment, the hemicellulase is an alpha-glucuronidase is an Humicola insolens alpha-glucuronidase (WO 2010/014706) or a variant thereof. In an embodiment, the hemicellulase is an alpha-glucuronidase is an Penicillium aurantiogriseum alpha-glucuronidase (WO 2009/068565) or a variant thereof. In an embodiment, the hemicellulase is an alpha-glucuronidase is an Talaromyces emersonii alpha-glucuronidase (UniProt:Q8X21 1) or a variant thereof. In an embodiment, the hemicellulase is an alpha-glucuronidase is an Trichoderma reesei alpha-glucuronidase (UniProt:Q99024) or a variant thereof.

### α-L-arabinofuranosidase

The present invention contemplates using any alpha-L-arabinofuranosidase that, when optionally blended together with a xylanase, beta-glucanase, and/or cellulolytic composition in various ratios, partitions a greater amount of protein from the whole stillage byproduct into the high protein fraction, rather than being retained in the wet cake, to produce a high protein feed ingredient.

An alpha-L-arabinofuranosidase may comprise a catalytic domain of GH Family 3, 10, 43, 51, 54, or 62. In an embodiment, the α-L-arabinofuranosidase is from a Glycoside Hydrolase Family selected from the group consisting of GH3, GH10, GH43, GH51 and GH62. In an embodiment, the GH43 α-L-arabinofuranosidase is from a subfamily selected from the group consisting of 1, 10, 11, 12, 19 21, 26, 27, 29, 35 and 36.

In an embodiment, the GH43 arainofuranosidase is from the genus Humicola, for example Humicola insolens, such as the arabinofuranosidase shown in amino acids 19 to 558 of SEQ ID NO: 56 or the arabinofuranosidase shown in amino acids 24 to 575 of SEQ ID NO: 57, or one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57.

Examples of arabinofuranosidases useful in the processes of the present invention include, but are not limited to, arabinofuranosidases from Aspergillus niger (GeneSeqP:AAR94170), Humicola insolens DSM 1800 (WO 2006/114094 and WO 2009/073383), and M. giganteus (WO 2006/114094).

In an embodiment, the hemicellulase is a Aspergillus niger arabinofuranosidase (GeneSeqP:AAR94170) or a variant thereof. In an embodiment, the hemicellulase is a Humicola insolens DSM 1800 arabinofuranosidase (WO 2006/114094 and WO 2009/073383) or a variant thereof. In an embodiment, the hemicellulase is a M. giganteus arabinofuranosidase (WO 2006/114094) or a variant thereof.

In an embodiment, the GH51 arainofuranosidase is from the genus Colletotrichum, for example Colletotrichum graminicola, such as the arabinofuranosidase shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58.

In an embodiment, the GH51 arainofuranosidase is from the genus Trametes, for example Trametes hirsuta, such as the arabinofuranosidase shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59.

In an embodiment, the GH62 family α-L-arabinofuranosidase is a GH62_1 α-L-arabinofuranosidase.

In an embodiment, the GH62_1 α-L-arabinofuranosidase is from the genus Talaromyces, for example Talaromyces pinophilus, such as the α-L-arabinofuranosidase (arabinofuranosidase) shown in amino acids 17 to 325 of SEQ ID NO: 11, or shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or amino acids 18 to 335 of SEQ ID NO: 55.

### Galactosidase

The present invention contemplates using any galactosidase that, when optionally blended together with a xylanase, beta-glucanase, and/or cellulolytic composition in various ratios, partitions a greater amount of protein from the whole stillage byproduct into the high protein fraction, rather than being retained in the wet cake, to produce a high protein feed ingredient.

Alpha-galactosidase (EC 3.2.1.22) is a glycoside hydrolase enzyme that hydrolyses the terminal alpha-galactosyl moieties from glycolipids and glycoproteins that is present in, e.g. legumes, vegetables, grains, cereals and the like. Alpha-galactosidase are produced by various microorganisms, plants and animals.

Alpha-galactosidases (α-D-galactosidase and/or α-L-galactosidase) of use in the processes and enzyme blends of the present invention may be from a Glycoside Hydrolase family selected from the group consisting of GH27, GH36, GH4 and GH57_A.

Examples of suitable GH36 Family alpha-galactosidases include, without limitation, GH36 alpha-galactosidase as isolated from Bacillus deramificans. Bacillus acidopullulyticus, Anoxybacillus bogrovensis, Aspergillus sydowii, Aspergillus sydowii, Sac///tvs sp-19140, Aspergillus puniceus, Parageobacillus thermoglucosidans (each of which is described in detail in WO17202966A1 (which is incorporated herein by reference in its entirety). In an embodiment, the hemicellulase is a Bacillus deramificans alpha-galactosidase or a variant thereof. In an embodiment, the hemicellulase is a Bacillus acidopullulyticus alpha-galactosidase or a variant thereof. In an embodiment, the hemicellulase is a Anoxybacillus bogrovensis alpha-galactosidase or a variant thereof. In an embodiment, the hemicellulase is an Aspergillus sydowii alpha-galactosidase or a variant thereof. In an embodiment, the hemicellulase is a Aspergillus sydowii alpha-galactosidase or a variant thereof. In an embodiment, the hemicellulase is a Sac///tvs sp-19140 alpha-galactosidase or a variant thereof. In an embodiment, the hemicellulase is a Aspergillus puniceus alpha-galactosidase or a variant thereof. In an embodiment, the alpha-galactosidase is a Parageobacillus thermoglucosidans alpha-galactosidase or a variant thereof. In an embodiment, the hemicellulase is the alpha-galactosidase disclosed in W01994/23022 (incorporated herein by reference in its entirety) or a variant thereof.

### Ferulic Acid (Feruloyl) Esterase

The present invention contemplates using any ferulic acid esterase that, when optionally blended together with a xylanase, beta-glucanase and/or cellulolytic composition in various ratios, partitions a greater amount of protein from the whole stillage byproduct into the high protein fraction, rather than being retained in the wet cake, to produce a high protein feed ingredient.

Examples of ferulic acid esterases useful in the processes and blends of the present invention include, but are not limited to Humicola insolens DSM 1800 (WO 2009/076122), Neosartorya fischeri (UniProt:A1 D9T4), Neurospora crassa (UniProt:Q9HGR3), Penicillium aurantiogriseum (WO 2009/127729), and Thielavia terrestris (WO 2010/053838 and WO 2010/065448).

In an embodiment, the hemicellulase is a Humicola insolens DSM 1800 ferulic acid esterase (WO 2009/076122) or variant thereof. In an embodiment, the hemicellulase is a Neosartorya fischeri ferulic acid esterase (UniProt:A1 D9T4) or variant thereof. In an embodiment, the hemicellulase is a Neurospora crassa ferulic acid esterase (UniProt:Q9HGR3) or a variant thereof. In an embodiment, the hemicellulase is a Penicillium aurantiogriseum ferulic acid esterase (WO 2009/127729) or a variant thereof. In an embodiment, the hemicellulase is a Thielavia terrestris ferulic acid esterase (WO 2010/053838 and WO 2010/065448) or a variant thereof.

### Pectin-Degrading Enzymes

The present invention contemplates using any pectin-degrading enzyme that, when optionally blended together with a xylanase, beta-glucanase and/or a cellulolytic composition in various ratios, partitions a greater amount of protein from the whole stillage byproduct into the high protein fraction, rather than being retained in the wet cake, to produce a high protein feed ingredient.

Exemplary pectin-degrading enzymes of use in the processes and enzyme blends of the present invention include, without limitation an arabinase (e.g., GH43 family), a galactanase (e.g., GH53 family), a pectin acetylesterase/rhamnogalacturonan acetylesterase (e.g., CE12 family), a pectate lyase (e.g., PL1 family), a pectin lyase (e.g., PL1 family), a pectin metylesterase (e.g., CE12 family), a pectine transeliminase, a polygalacturonase (e.g., GH28 family), a rhamnogalacturonan hydrolase (e.g., GH28 family), a rhamnogalacturonan lyase (e.g., PL4 family), a xylogalacturonan hydrolase (e.g., GH28 family), and any combination thereof.

Any pectinolytic enzyme with the ability to degrade pectin may be used in practicing the present invention. Suitable pectinases include, without limitation, those of fungal or bacteria lorigin. Chemically or genetically modified pectinases are also encompassed. Pectinases can be classified according to their preferential substrate, highly methyl-esterified pectin or low methyl-esterified pectin and polygalacturonic acid(pectate), and their reaction mechanism, beta-elimination or hydrolysis. Pectinases can be mainly endo-acting, cutting the polymer at random sites within the chain to give a mixture of oligomers, or they may be exo-acting, attacking from one end of the polymer and producing monomers or dimers. Several pectinase activities acting on the smooth regions of pectin are included in the classification of enzymes provided by Enzyme Nomenclature (1992), e. g., pectate lyase (EC 4.2.2.2), pectin lyase (EC 4.2.2.10), polygalacturonase (EC 3.2.1.15), exo-polygalacturonase (EC 3.2.1.67), exo-polygalacturonate lyase (EC 4.2.2.9) and exo-poly-alpha-galacturonosidase (EC 3.2.1.82). In preferred embodiments, the methods of the invention utilize pectate lyases.

Pectate lyase enzymatic activity as used herein refers to catalysis of the random cleavage of −1,4-glycosidic linkages in pectic acid (also called polygalcturonic acid) by transelimination. Pectate lyases are also termed polygalacturonate lyases and poly (1,4-D-galacturonide) lyases. For purposes of the present invention, pectate lyase enzymatic activity is the activity determined by measuring the increase in absorbance at 235 nm of a 0.1% w/v solution of sodium polygalacturonate in 0.1M glycine buffer at pH 10. Enzyme activity is typically expressed as x mol/min, i. e., the amount of enzyme that catalyzes the formation of x mole product/min. An alternative assay measures the decrease in viscosity of a 5% w/v solution of sodiumpolygalacturonate in 0.1M glycine buffer at pH 10, as measured by vibration viscometry (APSU units).

It will be understood that any pectate lyase may be used in practicing the present invention. Non-limiting examples of pectate lyases whose use is encompassed by the present invention include pectate lyases that have been cloned from different bacterial genera such as Erwinia, Pseudomonas, Klebsiella and Xanthomonas, as well as from Bacillus subtilis (Nasser et al. (1993) FEBS Letts. 335: 319-326) and Bacillus sp. YA-14 (Kim et al. (1994) Biosci. Biotech. Biochem. 58: 947-949). In some embodiments, the pectate lyase comprises the amino acid sequence of a pectate lyase disclosed in Heffron et al., (1995) Mol. Plant-Microbe Interact. 8:331-334 and Henrissat et al., (1995) Plant Physiol. 107: 963-976.

Commercially available enzymes useful in the methods of the present invention include, but are not limited to, PECTINEX™ (an Aspergillus niger pectinase preparation containing mainly pectinase, hemicellulase, and cellulase, available from Novo Nordisk A/S, Bagsvaerd, Denmark); CITROZYM™ (an Aspergillus niger enzyme preparation containing pectinase, hemicellulase and arabinase, available from Novo Nordisk A/S, Bagsvaerd, Denmark); OLIVEX™ (an Aspergillus aculeatus enzyme preparation containing pectinase, hemicellulase, and cellulase, available from Novo Nordisk A/S, Bagsvaerd, Denmark); PEELZYME™ (a mixture of Aspergillus niger and Trichoderma reesei pectinase, hemicellulase, cellulase, and arabinase, available from Novo Nordisk A/S, Bagsvaerd, Denmark); ULTRAZYM™ (an Aspergillus niger enzyme preparation containing polygalacturonase, pectin transeliminase, pectin esterase, and hemicellulase, available from Novo Nordisk A/S, Bagsvaerd, Denmark).

### Xylanase

In preferred embodiments of the present invention, the hemicellulase is a xylanase. The present invention contemplates using any xylanase that, when optionally blended together with a beta-glucanase, and/or a cellulolytic composition in various ratios, partitions a greater amount of protein from the whole stillage byproduct into the high protein fraction, rather than being retained in the wet cake, to produce a high protein feed ingredient.

Exemplary xylanases of use in the processes and enzyme blends of the present invention include, without limitation, xylanases from a Glycoside Hydrolase Family selected from the group consisting of a GH3 family xylanase, GH5 family xylanase, a GH7 family xylanase, a GH8 family xylanase, a GH10 family xylanase, a GH11 family xylanase, a GH30 family xylanase, a GH43 family xylanase, and a GH98 family xylanase. GH families 5, 7, 8, 10, 11 and 43 have been reviewed by Collins et al. (FEMS Microbiology Reviews 29 (2005) 3-23, which is incorporated herein in its entirety for its teachings related to the classification, structure, and mechanism of action of the GH family 5, 8, 10, 11 and 43 xylanases described therein). The production, purification, and application of microbial xylanases has been reviewed by Malhotra and Chapadgaonkar 2018 (Biotechnologia 99(1) (2018) 59-72, which is incorporated herein in its entirety).

GH3 family xylanases consist primarily of xylan 1,4-β-xylosidases (EC 3.2.1.37), which catalyze the hydrolysis of (1→4)-β-D-xylans, to remove successive D-xylose residues from the non-reducing termini. In an embodiment, the xylanase is a GH3 family xylanase. In an embodiment, the xylanase is a GH3 family xylanase belonging to EC 3.2.1.37. In an embodiment, the xylanase is a GH3 family xylanase that catalyzes the hydrolysis of (1→4)-β-D-xylans, to remove successive D-xylose residues from the non-reducing termini.

GH5 family xylanases consist primarily of endo-1,4-β-xylanases (EC 3.2.1.8), which catalyze the endohydrolysis of (1→4)-β-D-xylosidic linkages in xylans. In an embodiment, the xylanase is a GH5 family xylanase. In an embodiment, the xylanase is a GH5 family xylanase belonging to EC 3.2.1.8. In an embodiment, the xylanase is a GH5 family xylanase that catalyzes the endohydrolysis of (1→4)-β-D-xylosidic linkages in xylans. In an embodiment, the GH5 family xylanase is from a GH family selected from the group consisting of GH5_21, GH5_34 and GH5_35.

In an embodiment, the GH5_21 xylanase is from the genus Chryseobacterium, for example Chryseobacterium sp-10696, such as the xylanase shown in amino acids 25 to 551 of SEQ ID NO: 5 or amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 or amino acids 25 to 551 of SEQ ID NO: 6.

In an embodiment, the G5_34 xylanase is from the genus Acetivibrio, for example Acetivibrio cellulyticus, such as the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7.

In an embodiment, the G5_34 xylanase is from the genus Clostridium, for example Clostridium thermocellum, such as the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8.

In an embodiment, the G5_34 xylanase is from the genus Gonapodya, for example Gonapodya prolifera, such as the xylanase shown in SEQ ID NO: 53, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 53.

In an embodiment, the GH5_35 xylanase is from the genus Paenibacillus, for example Paenibacillus illinoisensis, such as the xylanase shown in amino acids 37 to 573 of SEQ ID NO: 9, or for example Paenibacillus sp., such as the xylanase shown in amino acids 36 to 582 of SEQ ID NO: 10, or for example Paenibacillus favisporus, such as the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9, amino acids 36 to 582 of SEQ ID NO: 10, or amino acids 1 to 536 of SEQ ID NO: 54.

GH10 family xylanases consists of a several endo-1, 3-β-xylanases (EC 3.2.1.32), though the majority are endo-1, 4-β-xylanases (EC 3.2.1.8). Endo-1,3-β-xylanases catalyze the random endohydrolysis of (1→3)-β-D-glycosidic linkages in (1→3)-β-D-xylans. The reaction of endo-1, 4-β-xylanases (EC 3.2.1.8) is noted above. In an embodiment, the xylanase is a GH10 family xylanase. In an embodiment, the xylanase is a GH10 family xylanase belonging to EC 3.2.1.32. In an embodiment, the xylanase is a GH10 family xylanase belonging to EC 3.2.1.8. In an embodiment, the xylanase is a GH10 family xylanase that catalyzes the random endohydrolysis of (1→3)-β-D-glycosidic linkages in (1→3)-β-D-xylans. In an embodiment, the GH10 family xylanase is a xylanase that catalyzes the endohydrolysis of (1→4)-β-D-xylosidic linkages in xylans.

In an embodiment, the GH10 xylanase is from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1.

In an embodiment, the GH10 family xylanase is from the genus Talaromyces, for example Talaromyces leycettanus, such as the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2.

In an embodiment, the GH10 family xylanase is from the genus Penicillium, for example, Penicillium funiculosum, such as the xylanase shown in amino acids 20 to 407 of SEQ ID NO: 45 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 407 of SEQ ID NO: 45.

GH11 family xylanases include endo-β-1,4-xylanases (EC 3.2.1.8) and endo-β-1,3-xylanase (EC 3.2.1.32). In an embodiment, the xylanase is a GH11 family xylanase. In an embodiment, the xylanase is a GH11 family xylanase belonging to EC 3.2.1.32. In an embodiment, the xylanase is a GH11 family xylanase belonging to EC 3.2.1.8. In an embodiment, the xylanase is a GH11 family xylanase that catalyzes the random endohydrolysis of (1→3)-β-D-glycosidic linkages in (1→3)-β-D-xylans. In an embodiment, the GH11 family xylanase is a xylanase that catalyzes the endohydrolysis of (1→4)-β-D-xylosidic linkages in xylans.

GH30 family xylanases include endo-β-1,4-xylanase (EC 3.2.1.8), β-xylosidases (EC 3.2.1.37); and glucuronoarabinoxylan endo-β-1,4-xylanases (EC 3.2.1.136). The reactions of the former two xylanases are noted above. Glucuronoarabinoxylan endo-β-1,4-xylanases catalyse the endohydrolysis of (1→4)-β-D-xylosyl links in some glucuronoarabinoxylans. In an embodiment, the xylanase is a GH30 family xylanase. In an embodiment, the xylanase is a GH30 family xylanase belonging to EC 3.2.1.8. In an embodiment, the xylanase is a GH30 family xylanase belonging to EC 3.2.1.37. In an embodiment, the xylanase is a GH30 family xylanase belonging to EC 3.2.1.136. In an embodiment, the xylanase is a GH30 family xylanase that catalyzes the endohydrolysis of (1→4)-β-D-xylosidic linkages in xylans. In an embodiment, the xylanase is a GH30 family xylanase that catalyzes the hydrolysis of (1→4)-β-D-xylans, to remove successive D-xylose residues from the non-reducing termini. In an embodiment, the xylanase is a GH30 family xylanase that catalyzes the endohydrolysis of (1→4)-β-D-xylosyl links in some glucuronoarabinoxylans.

In an embodiment, the GH30 family xylanase is a GH30_8 family xylanase.

In an embodiment, the GH30_8 family xylanase is from the genus Bacillus, for example Bacillus subtilis, such as the xylanase shown in amino acids 28 to 417 of SEQ ID NO: 3 or amino acids 28 to 417 of SEQ ID NO: 4, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4.

Additional GH30_8 xylanases suitable for use in the processes, methods and enzyme blends of the present invention are described in International Patent Application Publication No. WO 20-9/055455 (incorporated herein by reference in its entirety).

Examples of xylanases useful in the processes and enzyme blends of the present invention include, but are not limited to, Aspergillus aculeatus xylanase (GeneSeqP: AAR63790; WO 94/21785); Aspergillus fumigatus xylanases (WO 2006/078256); Penicillium pinophilum (WO 201 1/041405); Penicillium sp. (WO 2010/126772); Thielavia terrestris NRRL 8126 (WO 2009/079210); and Trichophaea saccata GH 10 (WO 2011/057083).

In one embodiment, the xylanase is from the taxonomic order Bacillales, or preferably the taxonomic family Bacillaceae or Paenibacillaceae, or more preferably from the taxonomic genus Bacillus or Paenibacillus, or even more preferably from the taxonomic species Bacillus subtilis, Bacillus amyloliquefaciens, Bacillus licheniformis or Paenibacillus pabuli.

Other examples of suitable xylanases are the following GENESEQP accession numbers: BCM03690, BBY25441, BBD43833, AZG87760, BBW75090, BCM03682, BBW96675, BCM03671, ADJ35022, BBW83525, BCM03685, BBW88031, BCM03707, AZH70238, AZG87766, BBX36748, BCM03686, AZQ23477, BCM03677, BCM03691, BCM03681, BCM03676, BCM03688, AZG68558, ADJ35028, BCM03687, BBG80964, AZX66647, AZH70244, BCM03689, AZM95903, BBW79314, BBX47049, BCM03683, BCM03679, BBW95840, BBX52401, BBW92246, BBX42063 and AZG68552.

Other examples of suitable xylanases are following Uniprot accession numbers: A0A016QIT0, A0A024BEN2, A0A059N8P2, A0A060J1Q4, A0A060J3N3, A0A060MDP8, A0A063XEB2, A0A063Z3F5, A0A066ZQH2, A0A068QG80, A0A069DJA1, A0A074QA16, A0A076GH62, A0A076X095, A0A080UGI0, A0A081DRH7, A0A081L9P3, A0A085CCQ4, A0A086DRT4, A0A086SGC4, A0A086WWT9, A0A089JOT9, A0A089L7Q4, A0A089LS30, A0A089MA96, A0A089MMY5, A0A090ZY18, A0A093UG96, A0A097RET6, A0A097RT57, A0A0A0TJX0, A0A0A0TS05, A0A0A1STB1, A0A0A7GLZ8, A0A0A8C3V5, A0A0B0QGI0, A0A0B4S841, A0A0C2TMZ1, A0A0C5CYD2, A0A0D7XHL0, A0A0D7XPV8, A0A0D8JJW7, A0A0E1 LNG3, A0A0E1P2T5, A0A0F5MCQ0, A0A0F5YUV2, A0A0G2M1V3, A0A0G2Z099, A0A0G3VDP8, A0A0H1 RW51, A0A0H3DZC9, A0A0J1 HNE5, A0A0J118S6, A0A0J5XBB3, A0A0J6E3H1, A0A0J6ENY2, A0A0J6MZ81, A0A0J6PTT5, A0A0K0HYL4, A0A0K6JZ62, A0A0K6L1E5, A0A0K6L5C0, A0A0K6LRC5, A0A0K6MBZ9, A0A0K9E179, A0A0K9G2M8, A0A0L6C9N3, A0A0L7MT05, A0A0L7SGL4, A0A0M0HBT0, A0A0M2E136, A0A0M2S6E2, A0A0M9X369, A0A0P0TKN9, A0A0P7GC51, A0A0Q3W7T1, A0A0Q4R8I7, A0A0Q7SDS0, A0A0R3K873, A0A0T6LD54, A0A0U3M226, A0A0U5Q000, A0A0V8QN06, A0A0V8QPQ0, A0A0V8RCK0, A0A0W1Q0Y8, A0A0W7XI48, A0A0W8K830, A0A0X1TCR2, A0A0X8C7K8, A0A0X8DHN5, A0A0X8KDH2, A0A101YC92, A0A101YL97, A0A117SZP6, A0A124JQM2, A0A125UIF6, A0A127DQZ4, A0A132BP80, A0A132TGU4, A0A132TSQ5, A0A136AEB9, A0A142F586, A0A150L2Y6, A0A160EHD0, A0A164XMN2, A0A172HNW1, A0A172XIR5, A0A199N163, A0A199WHT5, A0A1A0CC44, A0A1A0G7Q3, A0A1A5VV23, A0A1A5YLD9, A0A1A7LKF3, A0A1B2AW76, A0A1C3SIT4, A0A1C4AHG6, A0A1D9PK78, A0A1E4Y0F1, A0A1G9MAD1, A0A1J0BBP6, A0A1JOC7I7, A0A1J5WRC5, A0A1J6F1D5, A0A1K1TBA7, A0A1L3PT45, A0A1L3QYI6, A0A1L3SH52, A0A1L4DM20, A0A1L5LNU4, A0A1L6CEM3, A0A1L6ZLN8, A0A1L6ZTD9, A0A1M7SMM4, A0A1N6S500, A0A1N7B930, A0A1N7E7E0, A0A1R1E8G3, A0A1R1ESJ7, A0A1R1FQ77, A0A1R1GBK8, A0A1R1GT02, A0A1R1HH77, A0A1S2F2R2, A0A1U3ULV5, A7Z5A1, A8FDV2, B3KF38, D1MEP8, D3EHO2, D4FXC2, E0RDU2, E1ACF9, E1UV03, E3E322, E8VJ45, F4E4B0, F4EKU6, G0IKW9, G4EVQ6, G4HGL4, G4P7F1, G7W2J1, H0FNN1, H1ACZ7, H2AJ54, H3K352, H6CPJ0, H6WCZ0, H8XMR3, 14XB64, J0X3V6, J7JVZ4, K2HJT3, K2P3H7, L0BLZ3, L0CY72, L8AKB2, M1KJT1, M1U2J5, M1XAU4, M2U9N8, N0DF18, Q45070, Q6YK37, Q70K02, R9TYN3, S6FS40, S6FXS9, U1T362, U1ZC44, U2TM90, U4PL99, U5X5B8, V5MRU9, V7Q6M1, V9REY3, W4AZH7, W4BXI4, W4C6X9, W4D801, W4DEL3, W81LG7 and W9TFT6.

In an embodiment, the xylanase comprises a variant xylanase having one or more substitutions described in EP Application No. 17177304.7 (incorporated herein by reference in its entirety).

In an embodiment, the xylanase comprises a variant xylanase having one or more substitutions described in International Patent Application No. PCT/EP2017/065336 (incorporated herein by reference in its entirety).

The xylanase may be obtained from microorganisms of any genus. For purposes of the present invention, the term “obtained from” as used herein in connection with a given source shall mean that the parent encoded by a polynucleotide is produced by the source or by a strain in which the polynucleotide from the source has been inserted. In one aspect, the parent is secreted extracellularly.

The polypeptide may be a bacterial polypeptide. For example, the polypeptide may be a Gram-positive bacterial polypeptide such as a Bacillus, Clostridium, Enterococcus, Geobacillus, Lactobacillus, Lactococcus, Oceanobacillus, Staphylococcus, Streptococcus, or Streptomyces polypeptide having xylanase activity. In one embodiment, the polypeptide is from a bacterium of the class Bacilli, such as from the order Bacillales, or preferably the taxonomic family Bacillaceae or Paenibacillaceae, or more preferably from the taxonomic genus Bacillus or Paenibacillus, or even more preferably from the taxonomic species Bacillus subtilis, Bacillus amyloliquefaciens, Bacillus licheniformis or Paenibacillus pabuli.

In one aspect, the xylanase is a Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, or Bacillus thuringiensis xylanase.

It will be understood that for the aforementioned species, the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen und Zellkulturen GmbH (DSMZ), Centraalbureau Voor Schimmelcultures (CBS), and Agricultural Research Service Patent Culture Collection, Northern Regional Research Center (NRRL).

The xylanase may be identified and obtained from other sources including microorganisms isolated from nature (e.g., soil, composts, water, etc.) or DNA samples obtained directly from natural materials (e.g., soil, composts, water, etc.) using the above-mentioned probes. Techniques for isolating microorganisms and DNA directly from natural habitats are well known in the art. A polynucleotide encoding a parent may then be obtained by similarly screening a genomic DNA or cDNA library of another microorganism or mixed DNA sample.

Once a polynucleotide encoding a parent has been detected with the probe(s), the polynucleotide can be isolated or cloned by utilizing techniques that are known to those of ordinary skill in the art (see, e.g., Sambrook et al., 1989, supra).

In an embodiment, the xylanase is a Bacillus GH30_8 xylanase. Exemplary GH30_8 xylanases of use in the enzyme blends and processes of the present invention include those from the taxonomic genera of Bacteroides, Cellvibrio, Clostridium, Cystobacter, Bacillus, Dickeya, Fibrobacter, Geobacillus, Meloidogyne, Micromonospora, Mucilaginibacter, Paenibacillus, Paludibacter, Radopholus, Ruminococcus, Serratia, Streptomyces, Verrucosispora, and Xanthomonas.

GH98 xylanases suitable for use in the enzyme blends, methods and processes of the present invention are described in PCT International Application No. PCT/US2020/015648 (incorporated herein by reference in its entirety).

In an embodiment, the xylanase is not a GH10 xylanase. In an embodiment, the xylanase is not a GH11 xylanase. In an embodiment, the hemicellulase is not a GH30 family xylanase. In an embodiment, the hemicellulase is not a GH30 subfamily 8 (GH30_8) xylanase.

In an embodiment, the xylanase is not a GH5 family xylanase. In an embodiment, the xylanase is not a GH3 family xylanase. In an embodiment, the xylanase is not a GH43 family xylanase. In an embodiment, the xylanase is not a GH5_21 family xylanase. In an embodiment, the xylanase is not a GH5_34 family xylanase. In an embodiment, the xylanase is not a GH5_34 family xylanase from the genus Acetivibrio, such as Acetivibrio cellulyticus, for instance the Acetivibrio cellulyticus GH5_34 xylanase of SEQ ID NO: 7. In an embodiment, the xylanase is not a GH5_34 family xylanase from the genus Clostridium, such as Clostridium thermocellum, for instance the Clostridium thermocellum GH5_34 xylanase of SEQ ID NO: 8. In an embodiment, the xylanase is not a GH5_34 family xylanase from the genus Gonapodya, such as Gonapodya prolifera, for instance the Gonapodya prolifera GH5_34 xylanase of SEQ ID NO: 53.

In an embodiment the xylanase is dosed in pre-saccharification, saccharification, and/or simultaneous saccharification and fermentation in a concentration of between 0.0001-1 mg EP (Enzyme Protein)/g DS, e.g., 0.0005-0.5 mg EP/g DS, such as 0.001-0.1 mg EP/g DS.

### Beta-Xylosidase

In preferred embodiments of the present invention, the hemicellulase includes a beta-xylosidase. The present invention contemplates using any beta-xylosidase that, when optionally blended together with a xylanase, beta-glucanase, and/or cellulolytic composition in various ratios, partitions a greater amount of protein from the whole stillage byproduct into the high protein fraction, rather than being retained in the wet cake, to produce a high protein feed ingredient.

In an embodiment, the beta-xylosidase is from glycosyl hydrolase (GH) family 3. In an embodiment, the beta-xylosidase is from the genus Aspergillus, for example an Aspergillus fumigatus beta-xylosidase, or a homolog thereof. In another aspect, the Aspergillus fumigatus beta-xylosidase or a homolog thereof is selected from the group consisting of: (i) a beta-xylosidase comprising or consisting of the mature polypeptide of SEQ ID NO: 12 and (ii) a beta-xylosidase comprising or consisting of an amino acid sequence having at least 70%, e.g., at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, or at least 99% sequence identity to the mature polypeptide of SEQ ID NO: 12.

In an embodiment, the beta-xylosidase is from the genus Trichoderma, for example a Trichoderma reesei beta-xylosidase, or a homolog thereof. In another aspect, the Trichoderma beta-xylosidase or a homolog thereof is selected from the group consisting of: (i) a beta-xylosidase comprising or consisting of the mature polypeptide of SEQ ID NO: 13; and (ii) a beta-xylosidase comprising or consisting of an amino acid sequence having at least 70%, e.g., at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, or at least 99% sequence identity to the mature polypeptide of SEQ ID NO: 13.

### Beta-Glucanases

The present invention contemplates using any beta-glucanase alone, or combination with a hemicellulase, for example xylanase, that, when optionally blended together with a cellulolytic composition various ratios, partitions a greater amount of protein from the whole stillage byproduct into the high protein fraction, rather than being retained in the wet cake, to produce a high protein feed ingredient. Unexpectedly, the present inventors found that beta-glucanases can be used alone in the processes of the invention (e.g., in saccharification, fermentation, or simultaneous saccharification and fermentation or in whole stillage) to increase the weight percentage of protein on a dry basis in the high protein feed ingredient, and can be used in combination with hemicellulases (e.g., xylanase) and/or a cellulolytic composition to optimize both the mass fraction and the weight percent protein on a dry basis of the high protein feed ingredient.

Exemplary beta-glucanases suitable for use in the processes and enzyme blends of the present invention include, without limitation, beta-glucanases from glycoside hydrolase families GH5_15, GH16 and GH64. In an embodiment, the beta-glucanase is a GH5_15 family beta-glucanase. In an embodiment, the GH5_15 family beta-glucanase is from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14. In an embodiment, the GH5_15 family beta-glucanase is from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17.

In an embodiment, the beta-glucanase is a GH16 family beta-glucanase. In an embodiment, the GH16 family beta-glucanase is from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19.

In an embodiment, the beta-glucanase is a GH64 family beta-glucanase. In an embodiment, the GH64 beta-glucanase is from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20. The beta-glucanase(s) increases the percent protein on a dry basis of the high protein feed ingredient.

### Cellulolytic Composition

The present invention contemplates using any cellulolytic composition that, when blended with at least one hemicellulase and/or at least one beta-glucanase in various ratios, partitions a greater amount of protein from the whole stillage byproduct into the high protein fraction, rather than being retained in the wet cake, to produce a high protein feed ingredient.

In an embodiment, the cellulolytic composition comprises a cellobiohydrolase, a beta-glucosidase, and an endoglucanase. In an embodiment, the cellulolytic composition comprises: a cellobiohydrolase I; a beta-glucosidase; and an endoglucanase I. In an embodiment, the cellulolytic composition comprises: an Aspergillus cellobiohydrolase I; an Aspergillus beta-glucosidase; and a Trichoderma endoglucanase I. In an embodiment, the cellulolytic composition comprises: an Aspergillus fumigatus cellobiohydrolase I; an Aspergillus fumigatus beta-glucosidase; and a Trichoderma reesei endoglucanase I. In an embodiment, the cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

The cellulolytic composition used in an enzyme blend or process of the invention may be derived from any microorganism. As used herein, “derived from any microorganism” means that the cellulolytic composition comprises one or more enzymes that were expressed in the microorganism. For instance, a cellulolytic composition derived from a strain of Trichoderma reesei means that the cellulolytic composition comprises one or more enzymes that were expressed in Trichoderma reesei.

In an embodiment, the cellulolytic composition is derived from a strain of Aspergillus, such as a strain of Aspergillus aurantiacus, Aspergillus niger or Aspergillus oryzae.

In an embodiment, the cellulolytic composition is derived from a strain of Chrysosporium, such as a strain of Chrysosporium lucknowense.

In an embodiment, the cellulolytic composition is derived from a strain of Humicola, such as a strain of Humicola insolens.

In an embodiment, the cellulolytic composition is derived from a strain of Penicilium, such as a strain of Penicilium emersonii or Penicilium oxalicum.

In an embodiment, the cellulolytic composition is derived from a strain of Talaromyces, such as a strain of Talaromyces aurantiacus or Talaromyces emersonii.

In an embodiment, the cellulolytic composition is derived from a strain of Trichoderma, such as a strain of Trichoderma reesei.

In a preferred embodiment, the cellulolytic composition is derived from a strain of Trichoderma reesei. In a preferred embodiment, the Trichoderma reesei cellulolytic composition comprises at least one, at least two, at least three, or at least four enzymes selected from the group consisting of: (i) a cellobiohydrolase I; (ii) a cellobiohydrolase II; (iii) a beta-glucosidase; and (iv) a GH61 polypeptide having cellulolytic enhancing activity. In another preferred embodiment, the Trichoderma reesei cellulolytic composition comprises at least one, at least two, at least three, or at least four enzymes selected from the group consisting of: (i) an Aspergillus fumigatus cellobiohydrolase I; (ii) an Aspergillus fumigatus cellobiohydrolase II; (iii) an Aspergillus fumigatus beta-glucosidase; and (iv) a Penicillium emersonii GH61A polypeptide having cellulolytic enhancing activity.

In another preferred embodiment, the Trichoderma reesei cellulolytic composition comprises at least one, at least two, or at least three enzymes selected from the group consisting of: (i) a cellobiohydrolase I; (ii) a beta-glucosidase; and (iii) an endoglucanase. In another preferred embodiment, the Trichoderma reesei cellulolytic composition comprises at least one, at least two, or at least three enzymes selected from the group consisting of: (i) an Aspergillus fumigatus cellobiohydrolase I; (ii) an Aspergillus fumigatus beta-glucosidase; and (iii) a Trichoderma reesei endoglucanase.

In yet another preferred embodiment, the Trichoderma reesei cellulolytic composition comprises at least one, at least two, at least three, or at least four enzymes selected from the group consisting of: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 220r a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the Trichoderma reesei cellulolytic composition further comprises an endoglucanase.

In an embodiment, the Trichoderma reesei cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

In a preferred embodiment, the cellulolytic composition is derived from a strain of Aspergillus aurantiacus. In a preferred embodiment, the Aspergillus aurantiacus cellulolytic composition comprises at least one, at least two, at least three, or at least four enzymes selected from the group consisting of: (i) a cellobiohydrolase I; (ii) a cellobiohydrolase II; (iii) a beta-glucosidase; and (iv) a GH61 polypeptide having cellulolytic enhancing activity. In another preferred embodiment, the Aspergillus aurantiacus cellulolytic composition comprises at least one, at least two, at least three, or at least four enzymes selected from the group consisting of: (i) an Aspergillus fumigatus cellobiohydrolase I; (ii) an Aspergillus fumigatus cellobiohydrolase II; (iii) an Aspergillus fumigatus beta-glucosidase; and (iv) a Penicillium emersonii GH61A polypeptide having cellulolytic enhancing activity.

In yet another preferred embodiment, the Aspergillus aurantiacus cellulolytic composition comprises at least one, at least two, at least three, or at least four enzymes selected from the group consisting of: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the Aspergillus aurantiacus cellulolytic composition further comprises an endoglucanase.

In an embodiment, the Aspergillus aurantiacus cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

In a preferred embodiment, the cellulolytic composition is derived from a strain of 20 Aspergillus niger. In a preferred embodiment, the Aspergillus niger cellulolytic composition comprises at least one, at least two, at least three, or at least four enzymes selected from the group consisting of: (i) a cellobiohydrolase I; (ii) a cellobiohydrolase II; (iii) a beta-glucosidase; and (iv) a GH61 polypeptide having cellulolytic enhancing activity. In another preferred embodiment, the Aspergillus niger cellulolytic composition comprises at least one, at least two, at least three, or at least four enzymes selected from the group consisting of: (i) an Aspergillus fumigatus cellobiohydrolase I; (ii) an Aspergillus fumigatus cellobiohydrolase II; (iii) an Aspergillus fumigatus beta-glucosidase; and (iv) a Penicillium emersonii GH61A polypeptide having cellulolytic enhancing activity.

In yet another preferred embodiment, the Aspergillus niger cellulolytic composition comprises at least one, at least two, at least three, or at least four enzymes selected from the group consisting of: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 2; (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the Aspergillus niger cellulolytic composition further comprises an endoglucanase. In an embodiment, the Aspergillus niger cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

In a preferred embodiment, the cellulolytic composition is derived from a strain of Aspergillus oryzae. In a preferred embodiment, the Aspergillus oryzae cellulolytic composition comprises at least one, at least two, at least three, or at least four enzymes selected from the group consisting of: (i) a cellobiohydrolase I; (ii) a cellobiohydrolase II; (iii) a beta-glucosidase; and (iv) a GH61 polypeptide having cellulolytic enhancing activity. In another preferred embodiment, the Aspergillus oryzae cellulolytic composition comprises at least one, at least two, at least three, or at least four enzymes selected from the group consisting of: (i) an Aspergillus fumigatus cellobiohydrolase I; (ii) an Aspergillus fumigatus cellobiohydrolase II; (iii) an Aspergillus fumigatus beta-glucosidase; and (iv) a Penicillium emersonii GH61A polypeptide having cellulolytic enhancing activity.

In yet another preferred embodiment, the Aspergillus oryzae cellulolytic composition comprises at least one, at least two, at least three, or at least four enzymes selected from the group consisting of: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the Aspergillus oryzae cellulolytic composition further comprises an endoglucanase. In an embodiment, the Aspergillus oryzae cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

In a preferred embodiment, the cellulolytic composition is derived from a strain of Penicilium emersonii. In a preferred embodiment, the Penicilium emersonii cellulolytic composition comprises at least one, at least two, at least three, or at least four enzymes selected from the group consisting of: (i) a cellobiohydrolase I; (ii) a cellobiohydrolase II; (iii) a beta-glucosidase; and (iv) a GH61 polypeptide having cellulolytic enhancing activity. In another preferred embodiment, the Penicilium emersonii cellulolytic composition comprises at least one, at least two, at least three, or at least four enzymes selected from the group consisting of: (i) an Aspergillus fumigatus cellobiohydrolase I; (ii) an Aspergillus fumigatus cellobiohydrolase II; (iii) an Aspergillus fumigatus beta-glucosidase; and (iv) a Penicillium emersonii GH61A polypeptide having cellulolytic enhancing activity.

In yet another preferred embodiment, the Penicilium emersonii cellulolytic composition comprises at least one, at least two, at least three, or at least four enzymes selected from the group consisting of: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the Penicilium emersonii cellulolytic composition further comprises an endoglucanase. In an embodiment, the Penicilium emersonii cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

In a preferred embodiment, the cellulolytic composition is derived from a strain of Penicilium oxalicum. In a preferred embodiment, the Penicilium oxalicum cellulolytic composition comprises at least one, at least two, at least three, or at least four enzymes selected from the group consisting of: (i) a cellobiohydrolase I; (ii) a cellobiohydrolase II; (iii) a beta-glucosidase; and (iv) a GH61 polypeptide having cellulolytic enhancing activity. In another preferred embodiment, the Penicilium oxalicum cellulolytic composition comprises at least one, at least two, at least three, or at least four enzymes selected from the group consisting of: (i) an Aspergillus fumigatus cellobiohydrolase I; (ii) an Aspergillus fumigatus cellobiohydrolase II; (iii) an Aspergillus fumigatus beta-glucosidase; and (iv) a Penicillium emersonii GH61A polypeptide having cellulolytic enhancing activity.

In yet another preferred embodiment, the Penicilium oxalicum cellulolytic composition comprises at least one, at least two, at least three, or at least four enzymes selected from the group consisting of: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the Penicilium oxalicum cellulolytic composition further comprises an endoglucanase. In an embodiment, the Penicilium oxalicum cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

In a preferred embodiment, the cellulolytic composition is derived from a strain of Talaromyces aurantiacus. In a preferred embodiment, the Talaromyces aurantiacus cellulolytic composition comprises at least one, at least two, at least three, or at least four enzymes selected from the group consisting of: (i) a cellobiohydrolase I; (ii) a cellobiohydrolase II; (iii) a beta-glucosidase; and (iv) a GH61 polypeptide having cellulolytic enhancing activity. In another preferred embodiment, the Talaromyces aurantiacus cellulolytic composition comprises at least one, at least two, at least three, or at least four enzymes selected from the group consisting of: (i) an Aspergillus fumigatus cellobiohydrolase I; (ii) an Aspergillus fumigatus cellobiohydrolase II; (iii) an Aspergillus fumigatus beta-glucosidase; and (iv) a Penicillium emersonii GH61A polypeptide having cellulolytic enhancing activity.

In yet another preferred embodiment, the Talaromyces aurantiacus cellulolytic composition comprises at least one, at least two, at least three, or at least four enzymes selected from the group consisting of: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the Talaromyces aurantiacus cellulolytic composition further comprises an endoglucanase. In an embodiment, the Talaromyces aurantiacus cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

In a preferred embodiment, the cellulolytic composition is derived from a strain of Talaromyces emersonii. In a preferred embodiment, the Talaromyces emersonii cellulolytic composition comprises at least one, at least two, at least three, or at least four enzymes selected from the group consisting of: (i) a cellobiohydrolase I; (ii) a cellobiohydrolase II; (iii) a beta-glucosidase; and (iv) a GH61 polypeptide having cellulolytic enhancing activity. In another preferred embodiment, the Talaromyces emersonii cellulolytic composition comprises at least one, at least two, at least three, or at least four enzymes selected from the group consisting of: (i) an Aspergillus fumigatus cellobiohydrolase I; (ii) an Aspergillus fumigatus cellobiohydrolase II; (iii) an Aspergillus fumigatus beta-glucosidase; and (iv) a Penicillium emersonii GH61A polypeptide having cellulolytic enhancing activity.

In yet another preferred embodiment, the Talaromyces emersonii cellulolytic composition comprises at least one, at least two, at least three, or at least four enzymes selected from the group consisting of: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22; (iii) a beta-glucosidase comprising amino acids 20 to 863 of SEQ ID NO: 230r a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the Talaromyces emersonii cellulolytic composition further comprises an endoglucanase. In an embodiment, the Talaromyces emersonii cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

The cellulolytic composition may further comprise multiple enzymatic activities, such as one or more (e.g., several) enzymes selected from the group consisting of acetylxylan esterase, acylglycerol lipase, amylase, alpha-amylase, beta-amylase, arabinofuranosidase, cellobiohydrolases, cellulase, feruloyl esterase, galactanase, alpha-galactosidase, beta-galactosidase, beta-glucanase, beta-glucosidase, glucan 1,4-a-glucosidase, glucan 1,4-alpha-maltohydrolase, glucan 1,4-a-glucosidase, glucan 1,4-alpha-maltohydrolase, lysophospholipase, lysozyme, alpha-mannosidase, beta-mannosidase (mannanase), phytase, phospholipase A1, phospholipase A2, phospholipase D, protease, pullulanase, pectinesterase, triacylglycerol lipase, xylanase, beta-xylosidase or any combination thereof.

In an embodiment, the cellulolytic composition comprises one or more formulating agents as disclosed herein, preferably one or more of the compounds selected from the list consisting of glycerol, ethylene glycol, 1, 2-propylene glycol or 1, 3-propylene glycol, sodium chloride, sodium benzoate, potassium sorbate, sodium sulfate, potassium sulfate, magnesium sulfate, sodium thiosulfate, calcium carbonate, sodium citrate, dextrin, glucose, sucrose, sorbitol, lactose, starch, kaolin and cellulose.

In an embodiment the cellulolytic composition, e.g., derived from a strain of Aspergillus, Penicilium, Talaromyces, or Trichoderma, such as a Trichoderma reesei cellulolytic composition, is dosed in pre-saccharification, saccharification, and/or simultaneous saccharification and fermentation in a concentration of 0.0001-3 mg EP/g DS, preferably 0.0005-2 mg EP/g DS, preferably 0.001-1 mg/g DS, more preferred from 0.005-0.5 mg EP/g DS, even more preferred 0.01-0.1 mg EP/g DS.

### II. Processes for Producing Fermentation Products

The invention also relates to processes for producing a fermentation product from starch-containing grain using a fermenting organism, wherein a hemicellulase, beta-glucanase, or an enzyme blend comprising a hemicellulase and/or beta-glucanase and optionally a cellulolytic composition (e.g., derived from Trichoderma reesei) is added before and/or during fermentation and/or to whole stillage. Those skilled in the art will appreciate that any of the hemicellulase, beta-glucanase, or enzyme blends described in Section I above, or otherwise described herein, can be used in the processes of the invention, including the processes of Section II.

Processes for Producing Fermentation Products from Un-Gelatinized Starch-Containing Grain

In an aspect, the invention relates to processes for producing fermentation products from starch-containing grain without gelatinization (i.e., without cooking) of the starch-containing grain (often referred to as a “raw starch hydrolysis” process), wherein a presently disclosed hemicellulase, beta-glucanase, or enzyme blend comprising a hemicellulase and/or a beta-glucanase, and optionally a cellulolytic composition (e.g., derived from Trichoderma reesei) is added. The fermentation product, such as ethanol, can be produced without liquefying the aqueous slurry containing the starch-containing grain and water. In one embodiment a process of the invention includes saccharifying (e.g., milled, e.g., dry-milling) starch-containing grain, e.g., granular starch, below the initial gelatinization temperature, preferably in the presence of alpha-amylase and/or carbohydrate-source generating enzyme(s) to produce sugars that can be fermented into the fermentation product by a suitable fermenting organism. In this embodiment, the desired fermentation product, e.g., ethanol, is produced from un-gelatinized (i.e., uncooked), preferably milled, cereal grains, such as corn.

Accordingly, in one aspect the invention relates to processes for producing a fermentation product from starch-containing grain comprising simultaneously saccharifying and fermenting starch-containing grain using a carbohydrate-source generating enzymes and a fermenting organism at a temperature below the initial gelatinization temperature of said starch-containing grain in the presence of a hemicellulase and/or a beta-glucanase, or an enzyme blend of the invention. Exemplary hemicellulases, beta-glucanases, and enzyme blends of use in the processes are described in Section I above entitled “Enzyme Blends”. Saccharification and fermentation may also be separate. Thus in another aspect the invention relates to processes of producing fermentation products, comprising the following steps:
(i) saccharifying a starch-containing grain at a temperature below the initial gelatinization temperature using a carbohydrate-source generating enzyme, e.g., a glucoamylase; and
(ii) fermenting using a fermentation organism;
wherein step (i) and/or (ii) is carried out using at least a glucoamylase and at least one hemicellulase and/or at least one beta-glucanase, or enzyme blend of the invention comprising at least one hemicellulase and/or at least one beta-glucanase.

In an embodiment, the hemicellulase, beta-glucanase, or at least one enzyme blend of the present invention is added during saccharifying step (i). In an embodiment, the hemicellulase, beta-glucanase, or at least one enzyme blend of the present invention is added during fermenting step (ii).

In one embodiment, an alpha amylase, in particular a fungal alpha-amylase, is also added in step (i). Steps (i) and (ii) may be performed simultaneously. In an embodiment, the hemicellulase, beta-glucanase, or at least one enzyme blend of the present invention is added during simultaneous saccharification and fermentation (SSF). In an embodiment, the fermenting organism is yeast and the hemicellulase, beta-glucanase, or at least one enzyme blend is added during yeast propagation (exogenously or via in situ expression from a recombinant yeast host cell).

Processes for Producing Fermentation Products from Gelatinized Starch-Containing Grain

In an aspect, the invention relates to processes for producing fermentation products, especially ethanol, from starch-containing grain, which process includes a liquefaction step and sequentially or simultaneously performed saccharification and fermentation steps. Consequently, the invention relates to a process for producing a fermentation product from starch-containing grain comprising the steps of:
(i) liquefying starch-containing grain in the presence of an alpha-amylase to form a liquefied mash;
(ii) saccharifying the liquefied mash using a carbohydrate-source generating enzyme to produce a fermentable sugar; and
(iii) fermenting the sugar using a fermenting organism under conditions suitable to produce the fermentation product;
wherein a hemicellulase and/or a beta-glucanase, or at least one enzyme blend of the present invention is added before or during step (iii).
   Processes for Producing Fermentation Products from Cellulosic-Containing Material

In this aspect, the invention relates to processes for producing fermentation products, especially ethanol, from cellulosic-containing material, which process may include a pretreatment step and sequentially or simultaneously performed saccharification and fermentation steps.

Consequently, the invention relates to processes for producing fermentation products from cellulosic-containing material comprising the steps of:
i) optionally pretreating a cellulosic-containing material;
ii) saccharifying a cellulosic-containing material and/or pretreated cellulosic-containing material using a carbohydrate-source generating enzyme; and
iii) fermenting using a fermenting organism;
wherein at least one hemicellulase and/or at least one beta-glucanase, or at least one enzyme blend comprising at least one hemicellulase and/or at least one beta-glucanase is present or added during saccharifying step ii) or fermenting step iii).

In some embodiments, at least two, at least three, at least four, or at least five hemicellulases and/or beta-glucanases are present and/or added during saccharifying step ii) or fermenting step iii).

The at least one hemicellulase and/or at least one beta-glucanase present or added in the above described processes for producing fermentation products from cellulosic-containing material may be added exogenously during saccharification, fermentation or simultaneous saccharification and fermentation as mono-components, as enzyme blends or compositions comprising the hemicellulases and/or beta-glucanases, and/or via in-situ expression and secretion of the hemicellulases and/or beta-glucanases by the fermenting organism, e.g., a recombinant host cell or fermenting organism described herein (e.g., yeast, such as from the genus Saccharomyces, preferably Saccharomyces cerevisiae).

Whether the process of the invention includes or does not include a liquefaction step or pretreatment step, the essential feature of the invention is that at least one hemicellulase and/or at least one beta-glucanase are present or added during fermentation or simultaneous saccharification and fermentation. The at least one hemicellulase and/or at least one beta-glucanase, and cellulolytic composition present or added in the above described processes for producing fermentation products from starch-containing material may be added exogenously during saccharification, fermentation or simultaneous saccharification and fermentation as mono-components, as enzyme blends or compositions comprising the hemicellulases and/or beta-glucanases, and/or via in-situ expression and secretion of the hemicellulases and/or beta-glucanases by the fermenting organism, e.g., a recombinant host cell or fermenting organism described herein (e.g., yeast, such as from the genus Saccharomyces, preferably Saccharomyces cerevisiae).

The present inventors have found that at least one hemicellulase and/or at least one beta-glucanase, and enzyme blends comprising at least one hemicellulase and/or at least one beta-glucanase of the present invention are useful for increasing the percentage of protein in the high protein feed ingredient resulting from the separation of the whole stillage into protein-rich and fiber-rich (wet cake) fractions, for example, by increasing the amount of protein that is partitioned into the high protein fraction rather than the wet cake, as well as increasing the mass of the high protein fraction that ends up in the high protein feed ingredient. Unexpectedly, the present inventors observed these effects when the hemicellulases and/or beta-glucanases, or the enzyme blends comprising the same were added upstream during fermentation or SSF, in addition to when they were added to whole stillage. Thus, the enzyme blends of the present invention are useful for increasing the percentage of protein in the high protein feed ingredient resulting from the separation of the whole stillage into protein-rich and fiber-rich (wet cake) fractions. When the cellulolytic composition is included in the blend, the ratio of the hemicellulase and/or beta-glucanase and the cellulolytic composition can be optimized to further increase the amount of protein that is partitioned into the high protein fraction rather than the wet cake, as well as further increase the mass of the high protein fraction that ends up in the high protein feed ingredient.

The present inventors further unexpectedly observed that the hemicellulase, for example xylanase, increases the mass fraction of the high protein feed ingredient, whereas the beta-glucanase increases the protein content on a dry wt % basis of the high protein feed ingredient.

The present invention contemplates: (i) embodiments in which all of the at least one hemicellulase and/or at least one beta-glucanase are added exogenously during fermentation or SSF; (ii) embodiments in which all of the at least one hemicellulase and/or at least one beta-glucanase are added via in-situ expression and secretion of the hemicellulases and/or beta-glucanases from a recombinant host cell or fermenting organism described herein (e.g., yeast); (iii) embodiments in which at least a portion of the least one hemicellulase and/or at least one beta-glucanase are added exogenously during fermentation or SSF and at least a portion of the at least one hemicellulase and/or at least one beta-glucanase are added via in-situ expression and secretion of the hemicellulases and/or beta-glucanases from a recombinant host cell or fermenting organism described herein (e.g., yeast).

An enzyme blend or composition of the invention may suitably be used in a process or method of the invention. A recombinant host cell or fermenting organism of the invention may suitably be used in a process or method of the invention. However, the enzymes may also be added separately.

The present invention further contemplates compositions comprising at least one hemicellulase and/or at least one beta-glucanase, and/or a cellulolytic composition, and a recombinant host cell or fermenting organism comprising at least one heterologous polynucleotide (e.g., a recombinant yeast host cell or fermenting organism engineered to optimize production of the fermentation product or a byproduct or co-product of the process for producing the fermentation product). The at least one heterologous polynucleotide may encode polypeptides that are expressed intracellularly to enhance performance of the yeast or fermenting organism itself, polypeptides that are secreted into the fermenting mash to exert their effects on the mash or components of the mash to improve fermentation results, or both.

In some embodiments, the recombinant yeast host cell or fermenting organism comprises nucleotide sequences encoding the hemicellulases and/or beta-glucanases of the present invention, in addition to at least one other heterologous polynucleotide that optimizes production of the fermentation product or a byproduct or co-product of the process for producing the fermentation product. In other embodiments, the recombinant yeast host cell or fermenting organism comprises nucleotides sequences encoding such at least one heterologous polynucleotide other than the hemiceullases and/or beta-glucanases, such as a fermentation alpha-amylase (e.g., fungal alpha-amylase, carbohydrate-source generating organism (e.g., glucoamylase), and/or protease).

In an embodiment, the process of the invention further comprises, prior to the step i), the steps of:
a) reducing the particle size of the starch-containing material, preferably by dry milling;
b) forming a slurry comprising the starch-containing material and water.

The starch-containing starting material, such as whole grains, may be reduced in particle size, e.g., by milling, in order to open up the structure, to increase surface area, and allowing for further processing. Generally, there are two types of processes: wet and dry milling. In dry milling whole kernels are milled and used. Wet milling gives a good separation of germ and meal (starch granules and protein). Wet milling is often applied at locations where the starch hydrolysate is used in production of, e.g., syrups. Both dry and wet milling are well known in the art of starch processing. According to the present invention dry milling is preferred. In an embodiment the particle size is reduced to between 0.05 to 3.0 mm, preferably 0.1-0.5 mm, or so that at least 30%, preferably at least 50%, more preferably at least 70%, even more preferably at least 90% of the starch-containing material fit through a sieve with a 0.05 to 3.0 mm screen, preferably 0.1-0.5 mm screen. In another embodiment at least 50%, preferably at least 70%, more preferably at least 80%, especially at least 90% of the starch-containing material fit through a sieve with #6 screen.

The aqueous slurry may contain from 10-55 w/w-% dry solids (DS), preferably 25-45 w/w-% dry solids (DS), more preferably 30-40 w/w-% dry solids (DS) of starch-containing material.

The slurry is heated to above the gelatinization temperature and an alpha-amylase variant may be added to initiate liquefaction (thinning). The slurry may be heated to above the initial gelatinization temperature, preferably to between 80-95 °C, between pH 4-7, preferably between 4.5-5.0 or 5.0 and 6.0, for 30 minutes to 5 hours, such as around 2 hours. The slurry may in an embodiment be jet-cooked to further gelatinize the slurry before being subjected to alpha-amylase in step (a). Liquefaction may in an embodiment be carried out as a three-step hot slurry process. The slurry may be heated to between 60-105 °C, preferably between 70-100 °C, such as preferably between 80-95 °C, more preferably between 88-92C at a pH of 4-6, in particular at a pH of 4.5-5.5, and alpha-amylase variant, optionally together with a protease, a carbohydrate-source generating enzyme, such as a glucoamylase, a phospholipase, a phytase, and/or pullulanase, are added to initiate liquefaction (thinning). In an embodiment the temperature during liquefaction step i) is in the range from 70-100 °C, such as between 75-95 °C, such as between 75-90 °C, preferably between 80-90 °C, such as between 82-88 °C, such as around 85 °C. In an embodiment the temperature during liquefaction step i) is in the range from 70-100 °C, such as between 75-100 °C, preferably between 80-100 °C, such as between 85-95 °C, such as around between 88 and 92 °C. In an embodiment, the temperature during liquefaction step i) is at least 80 °C. In an embodiment, the temperature during liquefaction step i) is at least 81 °C. In an embodiment, the temperature during liquefaction step i) is at least 82 °C. In an embodiment, the temperature during liquefaction step i) is at least 83 °C. In an embodiment, the temperature during liquefaction step i) is at least 84 °C. In an embodiment, the temperature during liquefaction step i) is at least 85 °C. In an embodiment, the temperature during liquefaction step i) is at least 86 °C. In an embodiment, the temperature during liquefaction step i) is at least 87 °C. In an embodiment, the temperature during liquefaction step i) is at least 88 °C. In an embodiment, the temperature during liquefaction step i) is at least 89 °C. In an embodiment, the temperature during liquefaction step i) is at least 90 °C. In an embodiment, the temperature during liquefaction step i) is at least 91 °C. In an embodiment, the temperature during liquefaction step i) is at least 92 °C. In an embodiment, the temperature during liquefaction step i) is at least 93 °C. In an embodiment, the temperature during liquefaction step i) is at least 94 °C. In an embodiment, the temperature during liquefaction step i) is at least 95 °C. In an embodiment, the temperature during liquefaction step i) is at least 96 °C. In an embodiment, the temperature during liquefaction step i) is at least 97 °C. In an embodiment, the temperature during liquefaction step i) is at least 97 °C. In an embodiment, the temperature during liquefaction step i) is at least 98 °C. In an embodiment, the temperature during liquefaction step i) is at least 99 °C. In an embodiment, the temperature during liquefaction step i) is at least 100 °C.

The liquefaction process is usually carried out at a pH of 4-6, in particular at a pH from 4.5 to 5.5. Saccharification step (b) may be carried out using conditions well known in the art. For instance, a full saccharification process may last up to from about 24 to about 72 hours, however, it is common only to do a pre-saccharification of typically 40-90 minutes at a temperature between 30-65 °C, typically about 60 °C, followed by complete saccharification during fermentation in a simultaneous saccharification and fermentation process (SSF process). Saccharification is typically carried out at a temperature from 20-75 °C, in particular 40-70 °C, typically around 60 °C, and at a pH between 4 and 5, normally at about pH 4.5. The most widely used process to produce a fermentation product, especially ethanol, is a simultaneous saccharification and fermentation (SSF) process, in which there is no holding stage for the saccharification, meaning that a fermenting organism, such as yeast, and enzyme(s), may be added together. SSF may typically be carried out at a temperature from 25 °C to 40 °C, such as from 28 °C to 35 °C, such as from 30 °C to 34 °C, preferably around about 32 °C. In an embodiment fermentation is ongoing for 6 to 120 hours, in particular 24 to 96 hours.

### Starch-Containing Grains

Any suitable starch-containing starting grain may be used in a process of the present invention. The starting material is generally selected based on the desired fermentation product. Examples of starch-containing starting grains, suitable for use in the processes of the present invention, include barley, beans, cassava, cereals, corn, milo, peas, potatoes, rice, rye, sago, sorghum, sweet potatoes, tapioca, wheat, and whole grains, or any mixture thereof. The starch-containing grain may also be a waxy or non-waxy type of corn and barley. In a preferred embodiment the starch-containing grain is corn. In a preferred embodiment the starch-containing grain is wheat.

### Fermentation Products

The term “fermentation product” means a product produced by a method or process including fermenting using a fermenting organism. Fermentation products include alcohols (e.g., ethanol, methanol, butanol); organic acids (e.g., citric acid, acetic acid, itaconic acid, lactic acid, succinic acid, gluconic acid); ketones (e.g., acetone); amino acids (e.g., glutamic acid); gases (e.g., H₂ and CO₂); antibiotics (e.g., penicillin and tetracycline); enzymes; vitamins (e.g., riboflavin, B₁₂, beta-carotene); and hormones. In a preferred embodiment the fermentation product is ethanol, e.g., fuel ethanol; drinking ethanol, i.e., potable neutral spirits; or industrial ethanol or products used in the consumable alcohol industry (e.g., beer and wine), dairy industry (e.g., fermented dairy products), leather industry and tobacco industry. Preferred beer types comprise ales, stouts, porters, lagers, bitters, malt liquors, happoushu, high-alcohol beer, low-alcohol beer, low-calorie beer or light beer. In an embodiment the fermentation product is ethanol.

### Fermenting Organisms

The term “Fermenting organism” refers to any organism, including bacterial and fungal organisms, especially yeast, suitable for use in a fermentation process and capable of producing the desired fermentation product. Especially suitable fermenting organisms are able to ferment, i.e., convert, sugars, such as glucose or maltose, directly or indirectly into the desired fermentation product, such as ethanol. Examples of fermenting organisms include fungal organisms, such as yeast. Preferred yeast includes strains of Saccharomyces spp., in particular, Saccharomyces cerevisiae.

Suitable concentrations of the viable fermenting organism during fermentation, such as SSF, are well known in the art or can easily be determined by the skilled person in the art. In one embodiment the fermenting organism, such as ethanol fermenting yeast, (e.g., Saccharomyces cerevisiae) is added to the fermentation medium so that the viable fermenting organism, such as yeast, count per mL of fermentation medium is in the range from 105 to 10¹², preferably from 107 to 10¹⁰, especially about 5×10⁷.

Examples of commercially available yeast includes, e.g., RED STAR™ and ETHANOL RED™ yeast (available from Fermentis/Lesaffre, USA), FALI (available from Fleischmann's Yeast, USA), SUPERSTART and THERMOSACC™ fresh yeast (available from Ethanol Technology, WI, USA), BIOFERM AFT and XR (available from NABC—North American Bioproducts Corporation, GA, USA), GERT STRAND (available from Gert Strand AB, Sweden), and FERMIOL (available from DSM Specialties). Other useful yeast strains are available from biological depositories such as the American Type Culture Collection (ATCC) or the Deutsche Sammlung von Mikroorganismen und Zellkulturen GmbH (DSMZ), such as, e.g., BY4741 (e.g., ATCC 201388); Y108-1 (ATCC PTA.10567) and NRRL YB-1952 (ARS Culture Collection). Still other S. cerevisiae strains suitable as host cells DBY746, [Alpha][Eta]22, S150-2B, GPY55-15Ba, CEN.PK, USM21, TMB3500, TMB3400, VTT-A-63015, VTT-A-85068, VTT-c-79093 and their derivatives as well as Saccharomyces sp. 1400, 424A (LNH-ST), 259A (LNH-ST) and derivatives thereof.

As used herein, a “derivative” of strain is derived from a referenced strain, such as through mutagenesis, recombinant DNA technology, mating, cell fusion, or cytoduction between yeast strains. Those skilled in the art will understand that the genetic alterations, including metabolic modifications exemplified herein, may be described with reference to a suitable host organism and their corresponding metabolic reactions or a suitable source organism for desired genetic material such as genes for a desired metabolic pathway. However, given the complete genome sequencing of a wide variety of organisms and the high level of skill in the area of genomics, those skilled in the art can apply the teachings and guidance provided herein to other organisms. For example, the metabolic alterations exemplified herein can readily be applied to other species by incorporating the same or analogous encoding nucleic acid from species other than the referenced species.

The host cell or fermenting organism may be Saccharomyces strain, e.g., Saccharomyces cerevisiae strain produced using the method described and concerned in U.S. Pat. No. 8,257,959-BB. In one embodiment, the recombinant cell is a derivative of a strain Saccharomyces cerevisiae CIBTS1260 (deposited under Accession No. NRRL Y-50973 at the Agricultural Research Service Culture Collection (NRRL), Illinois 61604 U.S.A.).

The strain may also be a derivative of Saccharomyces cerevisiae strain NMI V14/004037 (See, WO2015/143324 and WO2015/143317 each incorporated herein by reference), strain nos. V15/004035, V15/004036, and V15/004037 (See, WO 2016/153924 incorporated herein by reference), strain nos. V15/001459, V15/001460, V15/001461 (See, WO2016/138437 incorporated herein by reference), strain no. NRRL Y67342 (See, WO2018/098381 incorporated herein by reference), strain nos. NRRL Y67549 and NRRL Y67700 (See, PCT/US2019/018249 incorporated herein by reference), or any strain described in WO2017/087330 (incorporated herein by reference).

The fermenting organisms may be a host cell that expresses a heterologous hemicellulase (e.g., xylanase) and/or a heterologous beta-glucanase (e.g., any hemicellulase and/or beta-glucanase described herein). Any hemicellulase and/or beta-glucanase contemplated for a process, method, enzyme blend, or composition described herein is also contemplated for expression by a fermenting organism or host cell.

In one embodiment is a recombinant host cell comprising a heterologous polynucleotide encoding a polypeptide having beta-glucanase activity (e.g., beta-glucanase) (e.g., any beta-glucanase described herein).

In one embodiment is a recombinant host cell comprising a heterologous polynucleotide encoding a polypeptide having hemicellulase activity (e.g., xylanase) (e.g., any hemicellulase described herein).

The fermenting organisms may be a host cell that expresses heterologous polynucleotides encoding enzymes other than the hemicellulases and/or beta-glucanases of the present invention, or that expresses such enzymes in addition to the hemiceullases and/or beta-glucanases of the present invention.

In some embodiments, the host cells and/or fermenting organisms comprise one or more heterologous polynucleotides encoding an alpha-amylase, glucoamylase, protease and/or cellulase. Examples of alpha-amylase, glucoamylase, protease and cellulases suitable for expression in the host cells and/or fermenting organisms are described in more detail herein. Thus, the present invention contemplates compositions (e.g., fermenting mash) which comprise a recombinant host cell and/or fermenting organism comprising: (i) one or more heterologous polynucleotides encoding an alpha-amylase, glucoamylase, protease, and/or cellulase, and (ii) at least one hemicellulase and/or at least one beta-glucanase of the present invention.

The host cells and fermenting organisms described herein may utilize expression vectors comprising the coding sequence of one or more (e.g., two, several) heterologous genes linked to one or more control sequences that direct expression in a suitable cell under conditions compatible with the control sequence(s). Such expression vectors may be used in any of the cells and methods described herein. The polynucleotides described herein may be manipulated in a variety of ways to provide for expression of a desired polypeptide. Manipulation of the polynucleotide prior to its insertion into a vector may be desirable or necessary depending on the expression vector. The techniques for modifying polynucleotides utilizing recombinant DNA methods are well known in the art.

A construct or vector (or multiple constructs or vectors) comprising the one or more (e.g., two, several) heterologous genes may be introduced into a cell so that the construct or vector is maintained as a chromosomal integrant or as a self-replicating extra-chromosomal vector as described earlier.

The various nucleotide and control sequences may be joined together to produce a recombinant expression vector that may include one or more (e.g., two, several) convenient restriction sites to allow for insertion or substitution of the polynucleotide at such sites. Alternatively, the polynucleotide(s) may be expressed by inserting the polynucleotide(s) or a nucleic acid construct comprising the sequence into an appropriate vector for expression. In creating the expression vector, the coding sequence is located in the vector so that the coding sequence is operably linked with the appropriate control sequences for expression.

The recombinant expression vector may be any vector (e.g., a plasmid or virus) that can be conveniently subjected to recombinant DNA procedures and can bring about expression of the polynucleotide. The choice of the vector will typically depend on the compatibility of the vector with the host cell into which the vector is to be introduced. The vector may be a linear or closed circular plasmid.

The vector may be an autonomously replicating vector, i.e., a vector that exists as an extrachromosomal entity, the replication of which is independent of chromosomal replication, e.g., a plasmid, an extrachromosomal element, a minichromosome, or an artificial chromosome.

The vector may contain any means for assuring self-replication. Alternatively, the vector may be one that, when introduced into the host cell, is integrated into the genome and replicated together with the chromosome(s) into which it has been integrated. Furthermore, a single vector or plasmid or two or more vectors or plasmids that together contain the total DNA to be introduced into the genome of the cell, or a transposon, may be used.

The expression vector may contain any suitable promoter sequence that is recognized by a cell for expression of a gene described herein. The promoter sequence contains transcriptional control sequences that mediate the expression of the polypeptide. The promoter may be any polynucleotide that shows transcriptional activity in the cell of choice including mutant, truncated, and hybrid promoters, and may be obtained from genes encoding extracellular or intracellular polypeptides either homologous or heterologous to the cell.

Each heterologous polynucleotide described herein may be operably linked to a promoter that is foreign to the polynucleotide. For example, in one embodiment, the nucleic acid construct encoding the fusion protein is operably linked to a promoter foreign to the polynucleotide. The promoters may be identical to or share a high degree of sequence identity (e.g., at least about 80%, at least about 85%, at least about 90%, at least about 95%, at least about 96%, at least about 97%, at least about 98%, or at least about 99%) with a selected native promoter.

Examples of suitable promoters for directing the transcription of the nucleic acid constructs in a yeast cells, include, but are not limited to, the promoters obtained from the genes for enolase, (e.g., S. cerevisiae enolase or I. orientalis enolase (ENO1)), galactokinase (e.g., S. cerevisiae galactokinase or I. orientalis galactokinase (GAL1)), alcohol dehydrogenase/glyceraldehyde-3-phosphate dehydrogenase (e.g., S. cerevisiae alcohol dehydrogenase/glyceraldehyde-3-phosphate dehydrogenase or I. orientalis alcohol dehydrogenase/glyceraldehyde-3-phosphate dehydrogenase (ADH1, ADH2/GAP)), triose phosphate isomerase (e.g., S. cerevisiae triose phosphate isomerase or I. orientalis triose phosphate isomerase (TPI)), metallothionein (e.g., S. cerevisiae metallothionein or I. orientalis metallothionein (CUP1)), 3-phosphoglycerate kinase (e.g., S. cerevisiae 3-phosphoglycerate kinase or I. orientalis 3-phosphoglycerate kinase (PGK)), PDC1, xylose reductase (XR), xylitol dehydrogenase (XDH), L-(+)-lactate-cytochrome c oxidoreductase (CYB2), translation elongation factor-1 (TEF1), translation elongation factor-2 (TEF2), glyceraldehyde-3-phosphate dehydrogenase (GAPDH), and orotidine 5′-phosphate decarboxylase (URA3) genes. Other suitable promoters may be obtained from S. cerevisiae TDH3, HXT7, PGK1, RPL18B and CCW12 genes. Additional useful promoters for yeast host cells are described by Romanos et al., 1992, Yeast 8: 423-488.

The control sequence may also be a suitable transcription terminator sequence, which is recognized by a host cell to terminate transcription. The terminator sequence is operably linked to the 3′-terminus of the polynucleotide encoding the polypeptide. Any terminator that is functional in the yeast cell of choice may be used. The terminator may be identical to or share a high degree of sequence identity (e.g., at least about 80%, at least about 85%, at least about 90%, at least about 95%, at least about 96%, at least about 97%, at least about 98%, or at least about 99%) with the selected native terminator.

Suitable terminators for yeast host cells may be obtained from the genes for enolase (e.g., S. cerevisiae or I. orientalis enolase cytochrome C (e.g., S. cerevisiae or I. orientalis cytochrome (CYC1)), glyceraldehyde-3-phosphate dehydrogenase (e.g., S. cerevisiae or I. orientalis glyceraldehyde-3-phosphate dehydrogenase (gpd)), PDC1, XR, XDH, transaldolase (TAL), transketolase (TKL), ribose 5-phosphate ketol-isomerase (RKI), CYB2, and the galactose family of genes (especially the GAL10 terminator). Other suitable terminators may be obtained from S. cerevisiae ENO2 or TEF1 genes. Additional useful terminators for yeast host cells are described by Romanos et al., 1992, supra.

The control sequence may also be an mRNA stabilizer region downstream of a promoter and upstream of the coding sequence of a gene which increases expression of the gene.

Examples of suitable mRNA stabilizer regions are obtained from a Bacillus thuringiensis cryIIIA gene (WO 94/25612) and a Bacillus subtilis SP82 gene (Hue et al., 1995, Journal of Bacteriology 177: 3465-3471).

The control sequence may also be a suitable leader sequence, when transcribed is a non-translated region of an mRNA that is important for translation by the host cell. The leader sequence is operably linked to the 5′-terminus of the polynucleotide encoding the polypeptide. Any leader sequence that is functional in the yeast cell of choice may be used.

Suitable leaders for yeast host cells are obtained from the genes for enolase (e.g., S. cerevisiae or I. orientalis enolase (ENO-1)), 3-phosphoglycerate kinase (e.g., S. cerevisiae or I. orientalis 3-phosphoglycerate kinase), alpha-factor (e.g., S. cerevisiae or I. orientalis alpha-factor), and alcohol dehydrogenase/glyceraldehyde-3-phosphate dehydrogenase (e.g., S. cerevisiae or I. orientalis alcohol dehydrogenase/glyceraldehyde-3-phosphate dehydrogenase (ADH2/GAP)).

The control sequence may also be a polyadenylation sequence; a sequence operably linked to the 3′-terminus of the polynucleotide and, when transcribed, is recognized by the host cell as a signal to add polyadenosine residues to transcribed mRNA. Any polyadenylation sequence that is functional in the host cell of choice may be used. Useful polyadenylation sequences for yeast cells are described by Guo and Sherman, 1995, Mol. Cellular Biol. 15: 5983-5990.

The control sequence may also be a signal peptide coding region that encodes a signal peptide linked to the N-terminus of a polypeptide and directs the polypeptide into the cell's secretory pathway. The 5′-end of the coding sequence of the polynucleotide may inherently contain a signal peptide coding sequence naturally linked in translation reading frame with the segment of the coding sequence that encodes the polypeptide. Alternatively, the 5′-end of the coding sequence may contain a signal peptide coding sequence that is foreign to the coding sequence. A foreign signal peptide coding sequence may be required where the coding sequence does not naturally contain a signal peptide coding sequence. Alternatively, a foreign signal peptide coding sequence may simply replace the natural signal peptide coding sequence in order to enhance secretion of the polypeptide. However, any signal peptide coding sequence that directs the expressed polypeptide into the secretory pathway of a host cell may be used. Useful signal peptides for yeast host cells are obtained from the genes for Saccharomyces cerevisiae alpha-factor and Saccharomyces cerevisiae invertase. Other useful signal peptide coding sequences are described by Romanos et al., 1992, supra.

The control sequence may also be a propeptide coding sequence that encodes a propeptide positioned at the N-terminus of a polypeptide. The resultant polypeptide is known as a proenzyme or propolypeptide (or a zymogen in some cases). A propolypeptide is generally inactive and can be converted to an active polypeptide by catalytic or autocatalytic cleavage of the propeptide from the propolypeptide. The propeptide coding sequence may be obtained from the genes for Bacillus subtilis alkaline protease (aprE), Bacillus subtilis neutral protease (nprT), Myceliophthora thermophila laccase (WO 95/33836), Rhizomucor miehei aspartic proteinase, and Saccharomyces cerevisiae alpha-factor.

Where both signal peptide and propeptide sequences are present, the propeptide sequence is positioned next to the N-terminus of a polypeptide and the signal peptide sequence is positioned next to the N-terminus of the propeptide sequence.

It may also be desirable to add regulatory sequences that allow the regulation of the expression of the polypeptide relative to the growth of the host cell. Examples of regulatory systems are those that cause the expression of the gene to be turned on or off in response to a chemical or physical stimulus, including the presence of a regulatory compound. Regulatory systems in prokaryotic systems include the lac, tac, and trp operator systems. In yeast, the ADH2 system or GAL1 system may be used.

The vectors may contain one or more (e.g., two, several) selectable markers that permit easy selection of transformed, transfected, transduced, or the like cells. A selectable marker is a gene the product of which provides for biocide or viral resistance, resistance to heavy metals, prototrophy to auxotrophs, and the like. Suitable markers for yeast host cells include, but are not limited to, ADE2, HIS3, LEU2, LYS2, MET3, TRP1, and URA3.

The vectors may contain one or more (e.g., two, several) elements that permit integration of the vector into the host cell's genome or autonomous replication of the vector in the cell independent of the genome.

For integration into the host cell genome, the vector may rely on the polynucleotide's sequence encoding the polypeptide or any other element of the vector for integration into the genome by homologous or non-homologous recombination. Alternatively, the vector may contain additional polynucleotides for directing integration by homologous recombination into the genome of the host cell at a precise location(s) in the chromosome(s). To increase the likelihood of integration at a precise location, the integrational elements should contain a sufficient number of nucleic acids, such as 100 to 10,000 base pairs, 400 to 10,000 base pairs, and 800 to 10,000 base pairs, which have a high degree of sequence identity to the corresponding target sequence to enhance the probability of homologous recombination. The integrational elements may be any sequence that is homologous with the target sequence in the genome of the host cell. Furthermore, the integrational elements may be non-encoding or encoding polynucleotides. On the other hand, the vector may be integrated into the genome of the host cell by non-homologous recombination. Potential integration loci include those described in the art (e.g., See US2012/0135481).

For autonomous replication, the vector may further comprise an origin of replication enabling the vector to replicate autonomously in the yeast cell. The origin of replication may be any plasmid replicator mediating autonomous replication that functions in a cell. The term “origin of replication” or “plasmid replicator” means a polynucleotide that enables a plasmid or vector to replicate in vivo. Examples of origins of replication for use in a yeast host cell are the 2 micron origin of replication, ARS1, ARS4, the combination of ARS1 and CEN3, and the combination of ARS4 and CEN6.

More than one copy of a polynucleotide described herein may be inserted into a host cell to increase production of a polypeptide. An increase in the copy number of the polynucleotide can be obtained by integrating at least one additional copy of the sequence into the yeast cell genome or by including an amplifiable selectable marker gene with the polynucleotide where cells containing amplified copies of the selectable marker gene, and thereby additional copies of the polynucleotide, can be selected for by cultivating the cells in the presence of the appropriate selectable agent.

The procedures used to ligate the elements described above to construct the recombinant expression vectors described herein are well known to one skilled in the art (see, e.g., Sambrook et al., 1989, Molecular Cloning, A Laboratory Manual, 2d edition, Cold Spring Harbor, New York).

Additional procedures and techniques known in the art for the preparation of recombinant cells for ethanol fermentation, are described in, e.g., WO 2016/045569, the content of which is hereby incorporated by reference.

The host cell or fermenting organism may be in the form of a composition comprising a host cell or fermenting organism (e.g., a yeast strain described herein) and a naturally occurring and/or a non-naturally occurring component.

The host cell or fermenting organism described herein may be in any viable form, including crumbled, dry, including active dry and instant, compressed, cream (liquid) form etc. In one embodiment, the host cell or fermenting organism (e.g., a Saccharomyces cerevisiae yeast strain) is dry yeast, such as active dry yeast or instant yeast. In one embodiment, the host cell or fermenting organism (e.g., a Saccharomyces cerevisiae yeast strain) is crumbled yeast. In one embodiment, the host cell or fermenting organism (e.g., a Saccharomyces cerevisiae yeast strain) is compressed yeast. In one embodiment, the host cell or fermenting organism (e.g., a Saccharomyces cerevisiae yeast strain) is cream yeast.

In one embodiment is a composition comprising a host cell or fermenting organism described herein (e.g., a Saccharomyces cerevisiae yeast strain), and one or more of the component selected from the group consisting of: surfactants, emulsifiers, gums, swelling agent, and antioxidants and other processing aids.

The compositions described herein may comprise a host cell or fermenting organism described herein (e.g., a Saccharomyces cerevisiae yeast strain) and any suitable surfactants.

In one embodiment, the surfactant(s) is/are an anionic surfactant, cationic surfactant, and/or nonionic surfactant.

The compositions described herein may comprise a host cell or fermenting organism described herein (e.g., a Saccharomyces cerevisiae yeast strain) and any suitable emulsifier. In one embodiment, the emulsifier is a fatty-acid ester of sorbitan. In one embodiment, the emulsifier is selected from the group of sorbitan monostearate (SMS), citric acid esters of monodiglycerides, polyglycerolester, fatty acid esters of propylene glycol.

In one embodiment, the composition comprises a host cell or fermenting organism described herein (e.g., a Saccharomyces cerevisiae yeast strain), and Olindronal SMS, Olindronal SK, or Olindronal SPL including composition concerned in European Patent No. 1,724,336 (hereby incorporated by reference). These products are commercially available from Bussetti, Austria, for active dry yeast.

The compositions described herein may comprise a host cell or fermenting organism described herein (e.g., a Saccharomyces cerevisiae yeast strain) and any suitable gum. In one embodiment, the gum is selected from the group of carob, guar, tragacanth, arabic, xanthan and acacia gum, in particular for cream, compressed and dry yeast.

The compositions described herein may comprise a host cell or fermenting organism described herein (e.g., a Saccharomyces cerevisiae yeast strain) and any suitable swelling agent. In one embodiment, the swelling agent is methyl cellulose or carboxymethyl cellulose.

The compositions described herein may comprise a host cell or fermenting organism described herein (e.g., a Saccharomyces cerevisiae yeast strain) and any suitable anti-oxidant. In one embodiment, the antioxidant is butylated hydroxyanisol (BHA) and/or butylated hydroxytoluene (BHT), or ascorbic acid (vitamin C), particular for active dry yeast.

The compositions described herein may comprise a host cell or fermenting organism described herein (e.g., a Saccharomyces yeast strain) and any suitable fermentation enzyme (e.g., alpha-amylase (e.g., a fungal alpha-amyalse), glucoamylase, protease, and/or cellulase.

The compositions described herein may comprise a host cell or fermenting organism described herein (e.g., a Saccharomyces yeast strain) and at least one hemicellulase and/or at least one beta-glucanase of the present invention.

The compositions described herein may comprise a host cell or fermenting organism described herein (e.g., a Saccharomyces yeast strain), at least one hemicellulase and/or at least one beta-glucanase of the present invention, and any suitable fermentation enzyme (e.g., alpha-amylase (e.g., a fungal alpha-amyalse), glucoamylase, protease, and/or cellulase.

The host cells and fermenting organisms described herein may also comprise one or more (e.g., two, several) gene disruptions, e.g., to divert sugar metabolism from undesired products to ethanol. In some embodiments, the recombinant host cells produce a greater amount of ethanol compared to the cell without the one or more disruptions when cultivated under identical conditions. In some embodiments, one or more of the disrupted endogenous genes is inactivated.

In certain embodiments, the host cell or fermenting organism provided herein comprises a disruption of one or more endogenous genes encoding enzymes involved in producing alternate fermentative products such as glycerol or other byproducts such as acetate or diols. For example, the cells provided herein may comprise a disruption of one or more of glycerol 3-phosphate dehydrogenase (GPD, catalyzes reaction of dihydroxyacetone phosphate to glycerol 3-phosphate), glycerol 3-phosphatase (GPP, catalyzes conversion of glycerol-3 phosphate to glycerol), glycerol kinase (catalyzes conversion of glycerol 3-phosphate to glycerol), dihydroxyacetone kinase (catalyzes conversion of dihydroxyacetone phosphate to dihydroxyacetone), glycerol dehydrogenase (catalyzes conversion of dihydroxyacetone to glycerol), and aldehyde dehydrogenase (ALD, e.g., converts acetaldehyde to acetate).

Modeling analysis can be used to design gene disruptions that additionally optimize utilization of the pathway. One exemplary computational method for identifying and designing metabolic alterations favoring biosynthesis of a desired product is the OptKnock computational framework, Burgard et al., 2003, Biotechnol. Bioeng. 84: 647-657.

The host cells and fermenting organisms comprising a gene disruption may be constructed using methods well known in the art, including those methods described herein. A portion of the gene can be disrupted such as the coding region or a control sequence required for expression of the coding region. Such a control sequence of the gene may be a promoter sequence or a functional part thereof, i.e., a part that is sufficient for affecting expression of the gene. For example, a promoter sequence may be inactivated resulting in no expression or a weaker promoter may be substituted for the native promoter sequence to reduce expression of the coding sequence. Other control sequences for possible modification include, but are not limited to, a leader, propeptide sequence, signal sequence, transcription terminator, and transcriptional activator.

The host cells and fermenting organisms comprising a gene disruption may be constructed by gene deletion techniques to eliminate or reduce expression of the gene. Gene deletion techniques enable the partial or complete removal of the gene thereby eliminating their expression. In such methods, deletion of the gene is accomplished by homologous recombination using a plasmid that has been constructed to contiguously contain the 5′ and 3′ regions flanking the gene.

The host cells and fermenting organisms comprising a gene disruption may also be constructed by introducing, substituting, and/or removing one or more (e.g., two, several) nucleotides in the gene or a control sequence thereof required for the transcription or translation thereof. For example, nucleotides may be inserted or removed for the introduction of a stop codon, the removal of the start codon, or a frame-shift of the open reading frame. Such a modification may be accomplished by site-directed mutagenesis or PCR generated mutagenesis in accordance with methods known in the art. See, for example, Botstein and Shortle, 1985, Science 229: 4719; Lo et al., 1985, Proc. Natl. Acad. Sci. U.S.A. 81: 2285; Higuchi et al., 1988, Nucleic Acids Res 16: 7351; Shimada, 1996, Meth. Mol. Biol. 57: 157; Ho et al., 1989, Gene 77: 61; Horton et al., 1989, Gene 77: 61; and Sarkar and Sommer, 1990, BioTechniques 8: 404.

The host cells and fermenting organisms comprising a gene disruption may also be constructed by inserting into the gene a disruptive nucleic acid construct comprising a nucleic acid fragment homologous to the gene that will create a duplication of the region of homology and incorporate construct DNA between the duplicated regions. Such a gene disruption can eliminate gene expression if the inserted construct separates the promoter of the gene from the coding region or interrupts the coding sequence such that a non-functional gene product results. A disrupting construct may be simply a selectable marker gene accompanied by 5′ and 3′ regions homologous to the gene. The selectable marker enables identification of transformants containing the disrupted gene.

The host cells and fermenting organisms comprising a gene disruption may also be constructed by the process of gene conversion (see, for example, Iglesias and Trautner, 1983, Molecular General Genetics 189: 73-76). For example, in the gene conversion method, a nucleotide sequence corresponding to the gene is mutagenized in vitro to produce a defective nucleotide sequence, which is then transformed into the recombinant strain to produce a defective gene. By homologous recombination, the defective nucleotide sequence replaces the endogenous gene. It may be desirable that the defective nucleotide sequence also comprises a marker for selection of transformants containing the defective gene.

The host cells and fermenting organisms comprising a gene disruption may be further constructed by random or specific mutagenesis using methods well known in the art, including, but not limited to, chemical mutagenesis (see, for example, Hopwood, The Isolation of Mutants in Methods in Microbiology (J. R. Norris and D. W. Ribbons, eds.) pp. 363-433, Academic Press, New York, 1970). Modification of the gene may be performed by subjecting the parent strain to mutagenesis and screening for mutant strains in which expression of the gene has been reduced or inactivated. The mutagenesis, which may be specific or random, may be performed, for example, by use of a suitable physical or chemical mutagenizing agent, use of a suitable oligonucleotide, or subjecting the DNA sequence to PCR generated mutagenesis. Furthermore, the mutagenesis may be performed by use of any combination of these mutagenizing methods.

Examples of a physical or chemical mutagenizing agent suitable for the present purpose include ultraviolet (UV) irradiation, hydroxylamine, N-methyl-N′-nitro-N-nitrosoguanidine (MNNG), N-methyl-N′-nitrosogaunidine (NTG) O-methyl hydroxylamine, nitrous acid, ethyl methane sulphonate (EMS), sodium bisulphite, formic acid, and nucleotide analogues. When such agents are used, the mutagenesis is typically performed by incubating the parent strain to be mutagenized in the presence of the mutagenizing agent of choice under suitable conditions, and selecting for mutants exhibiting reduced or no expression of the gene.

A nucleotide sequence homologous or complementary to a gene described herein may be used from other microbial sources to disrupt the corresponding gene in a recombinant strain of choice.

In one embodiment, the modification of a gene in the recombinant cell is unmarked with a selectable marker. Removal of the selectable marker gene may be accomplished by culturing the mutants on a counter-selection medium. Where the selectable marker gene contains repeats flanking its 5′ and 3′ ends, the repeats will facilitate the looping out of the selectable marker gene by homologous recombination when the mutant strain is submitted to counter-selection. The selectable marker gene may also be removed by homologous recombination by introducing into the mutant strain a nucleic acid fragment comprising 5′ and 3′ regions of the defective gene, but lacking the selectable marker gene, followed by selecting on the counter-selection medium. By homologous recombination, the defective gene containing the selectable marker gene is replaced with the nucleic acid fragment lacking the selectable marker gene. Other methods known in the art may also be used.

### Fermentation

The fermentation conditions are determined based on, e.g., the kind of plant material, the available fermentable sugars, the fermenting organism(s) and/or the desired fermentation product. One skilled in the art can easily determine suitable fermentation conditions. The fermentation may be carried out at conventionally used conditions. Preferred fermentation processes are anaerobic processes.

For example, fermentations may be carried out at temperatures as high as 75 °C, e.g., between 40-70 °C, such as between 50-60 °C. However, bacteria with a significantly lower temperature optimum down to around room temperature (around 20 °C) are also known. Examples of suitable fermenting organisms can be found in the “Fermenting Organisms” section above.

For ethanol production using yeast, the fermentation may go on for 24 to 96 hours, in particular for 35 to 60 hours. In an embodiment the fermentation is carried out at a temperature between 20 to 40 °C, preferably 26 to 34 °C, in particular around 32 °C. In an embodiment the pH is from pH 3 to 6, preferably around pH 4 to 5.

### Saccharification and Fermentation

One or more carbohydrate-source generating enzymes, in particular glucoamylase, may be present and/or added during saccharification step ii) and/or fermentation step iii). The carbohydrate-source generating enzyme may preferably be a glucoamylase, but may also be an enzyme selected from the group consisting of: beta-amylase, maltogenic amylase and alpha-glucosidase. The carbohydrate-source generating enzyme added during saccharification step ii) and/or fermentation step iii) is typically different from the optional carbohydrate-source generating enzyme, in particular thermostable glucoamylase, optionally added during liquefaction step i). In a preferred embodiment the carbohydrate-source generating enzymes, in particular glucoamylase, is added together with a fungal alpha-amylase.

Examples of carbohydrate-source generating enzymes, including glucoamylases, can be found in the “Carbohydrate-Source Generating Enzyme Present and/or Added During Saccharification and/or Fermentation”-section below.

One or more alpha-amylases may be present and/or added during saccharification step ii) and/or fermentation step iii). In an embodiment, the alpha-amylase is the Rhizomucor pusillus alpha-amylase with Aspergillus niger glucoamylase linker and SBD disclosed as SEQ ID NO: 39 with the following substitutions: G128D+D143N (activity ratio AGU:AGU:FAU(F): approx. 30:7:1).

In an embodiment, the alpha-amylase is part of a blend comprising: (i) a glucoamylase from Trametes cingulate disclosed herein as SEQ ID NO: 48, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity; and (ii) a hybrid of the Rhizomucor pusillus alpha-amylase and Aspergillus niger glucoamylase linker and starch binding domain, which is disclosed in WO 2006/069290 or as SEQ ID NO: 39 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.

One or more trehalases may be present and/or added during saccharification step ii) and/or fermentation step iii). In an embodiment, the trehalase is the Myceliophthora sepedonium trehalase disclosed herein as SEQ ID NO: 46 or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 46, which has trehalase activity. In an embodiment, the trehalase is the Talaromyces funiculosus trehalase disclosed herein as SEQ ID NO: 47, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 47, which has trehalase activity.

In an embodiment, the trehalase is part of a blend comprising: (i) the Gloeophyllum sepiarium glucoamylase disclosed in SEQ ID NO: 51, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 51, which has glucoamylase activity; (ii) the Talaromyces funiculosus trehalase disclosed herein as SEQ ID NO: 47, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 47, which has trehalase activity; and (iii) Rhizomucor pusillus alpha-amylase with Aspergillus niger glucoamylase linker and SBD disclosed as SEQ ID NO: 39 with the following substitutions: G128D+D143N (activity ratio AGU:AGU:FAU(F): approx. 30:7:1), or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.

When doing sequential saccharification and fermentation, saccharification step ii) may be carried out at conditions well-known in the art. For instance, the saccharification step ii) may last up to from about 24 to about 72 hours. In an embodiment pre-saccharification is done. Pre-saccharification is typically done for 40-90 minutes at a temperature between 30-65 °C, typically at 60 °C. In an embodiment, pre-saccharification is done for 4 hours to 60 hours, at a temperature from 40-70 °C, and a pH between 4 and 5. In an embodiment, pre-saccharification is done for 8 hours to 48 hours at a temperature from 40-70 °C, and a pH between 4 and 5. Pre-saccharification is in an embodiment followed by saccharification during fermentation in simultaneous saccharification and fermentation (“SSF). Saccharification is typically carried out at temperatures from 20-75 °C, preferably from 40-70 °C, typically around 60 °C, and at a pH between 4 and 5, normally at about pH 4.5.

Simultaneous saccharification and fermentation (“SSF”) is widely used in industrial scale fermentation product production processes, especially ethanol production processes. When doing SSF the saccharification step ii) and the fermentation step iii) are carried out simultaneously. There is no holding stage for the saccharification, meaning that a fermenting organism, such as yeast, and enzyme(s), may be added together. However, it is also contemplated to add the fermenting organism and enzyme(s) separately. SSF is according to the invention typically carried out at a temperature from 25 °C to 40 °C, such as from 28 °C to 35 °C, such as from 30 °C to 34 °C, preferably around about 32 °C. In an embodiment fermentation is ongoing for 6 to 120 hours, in particular 24 to 96 hours. In an embodiment the pH is between 3.5-5, in particular between 3.8 and 4.3.

### Methods Using a Cellulosic-Containing Material

In some aspects, the methods described herein produce a fermentation product from a cellulosic-containing material. The predominant polysaccharide in the primary cell wall of biomass is cellulose, the second most abundant is hemicellulose, and the third is pectin. The secondary cell wall, produced after the cell has stopped growing, also contains polysaccharides and is strengthened by polymeric lignin covalently cross-linked to hemicellulose. Cellulose is a homopolymer of anhydrocellobiose and thus a linear beta-(1-4)-D-glucan, while hemicelluloses include a variety of compounds, such as xylans, xyloglucans, arabinoxylans, and mannans in complex branched structures with a spectrum of substituents. Although generally polymorphous, cellulose is found in plant tissue primarily as an insoluble crystalline matrix of parallel glucan chains. Hemicelluloses usually hydrogen bond to cellulose, as well as to other hemicelluloses, which help stabilize the cell wall matrix.

Cellulose is generally found, for example, in the stems, leaves, hulls, husks, and cobs of plants or leaves, branches, and wood of trees. The cellulosic-containing material can be, but is not limited to, agricultural residue, herbaceous material (including energy crops), municipal solid waste, pulp and paper mill residue, waste paper, and wood (including forestry residue) (see, for example, Wiselogel et al., 1995, in Handbook on Bioethanol (Charles E. Wyman, editor), pp. 105-118, Taylor & Francis, Washington D.C.; Wyman, 1994, Bioresource Technology 50: 3-16; Lynd, 1990, Applied Biochemistry and Biotechnology 24/25: 695-719; Mosier et al., 1999, Recent Progress in Bioconversion of Lignocellulosics, in Advances in Biochemical Engineering/Biotechnology, T. Scheper, managing editor, Volume 65, pp. 23-40, Springer-Verlag, New York). It is understood herein that the cellulose may be in the form of lignocellulose, a plant cell wall material containing lignin, cellulose, and hemicellulose in a mixed matrix. In one embodiment, the cellulosic-containing material is any biomass material. In another embodiment, the cellulosic-containing material is lignocellulose, which comprises cellulose, hemicelluloses, and lignin.

In one embodiment, the cellulosic-containing material is agricultural residue, herbaceous material (including energy crops), municipal solid waste, pulp and paper mill residue, waste paper, or wood (including forestry residue).

In another embodiment, the cellulosic-containing material is arundo, bagasse, bamboo, corn cob, corn fiber, corn stover, miscanthus, rice straw, switchgrass, or wheat straw.

In another embodiment, the cellulosic-containing material is aspen, eucalyptus, fir, pine, poplar, spruce, or willow.

In another embodiment, the cellulosic-containing material is algal cellulose, bacterial cellulose, cotton linter, filter paper, microcrystalline cellulose (e.g., AVICEL®), or phosphoric-acid treated cellulose.

In another embodiment, the cellulosic-containing material is an aquatic biomass. As used herein the term “aquatic biomass” means biomass produced in an aquatic environment by a photosynthesis process. The aquatic biomass can be algae, emergent plants, floating-leaf plants, or submerged plants.

In another embodiment, the cellulosic-containing material is a whole stillage byproduct from a process for producing a fermentation from a starch-containing material.

The cellulosic-containing material may be used as is or may be subjected to pretreatment, using conventional methods known in the art, as described herein. In a preferred embodiment, the cellulosic-containing material is pretreated.

The methods of using cellulosic-containing material can be accomplished using methods conventional in the art. Moreover, the methods of can be implemented using any conventional biomass processing apparatus configured to carry out the processes.

### Cellulosic Pretreatment

In one embodiment the cellulosic-containing material is pretreated before saccharification in step (ii).

In practicing the processes described herein, any pretreatment process known in the art can be used to disrupt plant cell wall components of the cellulosic-containing material (Chandra et al., 2007, Adv. Biochem. Engin./Biotechnol. 108: 67-93; Galbe and Zacchi, 2007, Adv. Biochem. Engin./Biotechnol. 108: 41-65; Hendriks and Zeeman, 2009, Bioresource Technology 100: 10-18; Mosier et al., 2005, Bioresource Technology 96: 673-686; Taherzadeh and Karimi, 2008, Int. J. Mol. Sci. 9: 1621-1651; Yang and Wyman, 2008, Biofuels Bioproducts and Biorefining-Biofpr. 2: 26-40).

The cellulosic-containing material can also be subjected to particle size reduction, sieving, pre-soaking, wetting, washing, and/or conditioning prior to pretreatment using methods known in the art.

Conventional pretreatments include, but are not limited to, steam pretreatment (with or without explosion), dilute acid pretreatment, hot water pretreatment, alkaline pretreatment, lime pretreatment, wet oxidation, wet explosion, ammonia fiber explosion, organosolv pretreatment, and biological pretreatment. Additional pretreatments include ammonia percolation, ultrasound, electroporation, microwave, supercritical CO₂, supercritical H₂O, ozone, ionic liquid, and gamma irradiation pretreatments.

In a one embodiment, the cellulosic-containing material is pretreated before saccharification (i.e., hydrolysis) and/or fermentation. Pretreatment is preferably performed prior to the hydrolysis. Alternatively, the pretreatment can be carried out simultaneously with enzyme hydrolysis to release fermentable sugars, such as glucose, xylose, and/or cellobiose. In most cases the pretreatment step itself results in some conversion of biomass to fermentable sugars (even in absence of enzymes).

In one embodiment, the cellulosic-containing material is pretreated with steam. In steam pretreatment, the cellulosic-containing material is heated to disrupt the plant cell wall components, including lignin, hemicellulose, and cellulose to make the cellulose and other fractions, e.g., hemicellulose, accessible to enzymes. The cellulosic-containing material is passed to or through a reaction vessel where steam is injected to increase the temperature to the required temperature and pressure and is retained therein for the desired reaction time. Steam pretreatment is preferably performed at 140-250 °C, e.g., 160-200 °C or 170-190 °C, where the optimal temperature range depends on optional addition of a chemical catalyst. Residence time for the steam pretreatment is preferably 1-60 minutes, e.g., 1-30 minutes, 1-20 minutes, 3-12 minutes, or 4-10 minutes, where the optimal residence time depends on the temperature and optional addition of a chemical catalyst. Steam pretreatment allows for relatively high solids loadings, so that the cellulosic-containing material is generally only moist during the pretreatment. The steam pretreatment is often combined with an explosive discharge of the material after the pretreatment, which is known as steam explosion, that is, rapid flashing to atmospheric pressure and turbulent flow of the material to increase the accessible surface area by fragmentation (Duff and Murray, 1996, Bioresource Technology 855: 1-33; Galbe and Zacchi, 2002, Appl. Microbiol. Biotechnol. 59: 618-628; U.S. Patent Application No. 2002/0164730). During steam pretreatment, hemicellulose acetyl groups are cleaved and the resulting acid autocatalyzes partial hydrolysis of the hemicellulose to monosaccharides and oligosaccharides. Lignin is removed to only a limited extent.

In one embodiment, the cellulosic-containing material is subjected to a chemical pretreatment. The term “chemical treatment” refers to any chemical pretreatment that promotes the separation and/or release of cellulose, hemicellulose, and/or lignin. Such a pretreatment can convert crystalline cellulose to amorphous cellulose. Examples of suitable chemical pretreatment processes include, for example, dilute acid pretreatment, lime pretreatment, wet oxidation, ammonia fiber/freeze expansion (AFEX), ammonia percolation (APR), ionic liquid, and organosolv pretreatments.

A chemical catalyst such as H₂SO₄ or SO₂ (typically 0.3 to 5% w/w) is sometimes added prior to steam pretreatment, which decreases the time and temperature, increases the recovery, and improves enzymatic hydrolysis (Ballesteros et al., 2006, Appl. Biochem. Biotechnol. 129-132: 496-508; Varga et al., 2004, Appl. Biochem. Biotechnol. 113-116: 509-523; Sassner et al., 2006, Enzyme Microb. Technol. 39: 756-762). In dilute acid pretreatment, the cellulosic-containing material is mixed with dilute acid, typically H₂SO₄, and water to form a slurry, heated by steam to the desired temperature, and after a residence time flashed to atmospheric pressure. The dilute acid pretreatment can be performed with a number of reactor designs, e.g., plug-flow reactors, counter-current reactors, or continuous counter-current shrinking bed reactors (Duff and Murray, 1996, Bioresource Technology 855: 1-33; Schell et al., 2004, Bioresource Technology 91: 179-188; Lee et al., 1999, Adv. Biochem. Eng. Biotechnol. 65: 93-115). In a specific embodiment the dilute acid pretreatment of cellulosic-containing material is carried out using 4% w/w sulfuric acid at 180 °C for 5 minutes.

Several methods of pretreatment under alkaline conditions can also be used. These alkaline pretreatments include, but are not limited to, sodium hydroxide, lime, wet oxidation, ammonia percolation (APR), and ammonia fiber/freeze expansion (AFEX) pretreatment. Lime pretreatment is performed with calcium oxide or calcium hydroxide at temperatures of 85-150 °C and residence times from one hour to several days (Wyman et al., 2005, Bioresource Technology 96: 1959-1966; Mosier et al., 2005, Bioresource Technology 96: 673-686). WO 2006/110891, WO 2006/110899, WO 2006/110900, and WO 2006/110901 disclose pretreatment methods using ammonia.

Wet oxidation is a thermal pretreatment performed typically at 180-200 °C for 5-15 minutes with addition of an oxidative agent such as hydrogen peroxide or over-pressure of oxygen (Schmidt and Thomsen, 1998, Bioresource Technology 64: 139-151; Palonen et al., 2004, Appl. Biochem. Biotechnol. 117: 1-17; Varga et al., 2004, Biotechnol. Bioeng. 88: 567-574; Martin et al., 2006, J. Chem. Technol. Biotechnol. 81: 1669-1677). The pretreatment is performed preferably at 1-40% dry matter, e.g., 2-30% dry matter or 5-20% dry matter, and often the initial pH is increased by the addition of alkali such as sodium carbonate.

A modification of the wet oxidation pretreatment method, known as wet explosion (combination of wet oxidation and steam explosion) can handle dry matter up to 30%. In wet explosion, the oxidizing agent is introduced during pretreatment after a certain residence time. The pretreatment is then ended by flashing to atmospheric pressure (WO2006/032282).

Ammonia fiber expansion (AFEX) involves treating the cellulosic-containing material with liquid or gaseous ammonia at moderate temperatures such as 90-150 °C and high pressure such as 17-20 bar for 5-10 minutes, where the dry matter content can be as high as 60% (Gollapalli et al., 2002, Appl. Biochem. Biotechnol. 98: 23-35; Chundawat et al., 2007, Biotechnol. Bioeng. 96: 219-231; Alizadeh et al., 2005, Appl. Biochem. Biotechnol. 121: 1133-1141; Teymouri et al., 2005, Bioresource Technology 96: 2014-2018). During AFEX pretreatment cellulose and hemicelluloses remain relatively intact. Lignin-carbohydrate complexes are cleaved.

Organosolv pretreatment delignifies the cellulosic-containing material by extraction using aqueous ethanol (40-60% ethanol) at 160-200 °C for 30-60 minutes (Pan et al., 2005, Biotechnol. Bioeng. 90: 473-481; Pan et al., 2006, Biotechnol. Bioeng. 94: 851-861; Kurabi et al., 2005, Appl. Biochem. Biotechnol. 121: 219-230). Sulphuric acid is usually added as a catalyst. In organosolv pretreatment, the majority of hemicellulose and lignin is removed.

Other examples of suitable pretreatment methods are described by Schell et al., 2003, Appl. Biochem. Biotechnol. 105-108: 69-85, and Mosier et al., 2005, Bioresource Technology 96: 673-686, and U.S. Published Application 2002/0164730.

In one embodiment, the chemical pretreatment is carried out as a dilute acid treatment, and more preferably as a continuous dilute acid treatment. The acid is typically sulfuric acid, but other acids can also be used, such as acetic acid, citric acid, nitric acid, phosphoric acid, tartaric acid, succinic acid, hydrogen chloride, or mixtures thereof. Mild acid treatment is conducted in the pH range of preferably 1-5, e.g., I-4 or 1-2.5. In one aspect, the acid concentration is in the range from preferably 0.01 to 10 wt. % acid, e.g., 0.05 to 5 wt. % acid or 0.1 to 2 wt. % acid. The acid is contacted with the cellulosic-containing material and held at a temperature in the range of preferably 140-200 °C, e.g., 165-190 °C, for periods ranging from 1 to 60 minutes.

In another embodiment, pretreatment takes place in an aqueous slurry. In preferred aspects, the cellulosic-containing material is present during pretreatment in amounts preferably between 10-80 wt. %, e.g., 20-70 wt. % or 30-60 wt. %, such as around 40 wt. %. The pretreated cellulosic-containing material can be unwashed or washed using any method known in the art, e.g., washed with water.

In one embodiment, the cellulosic-containing material is subjected to mechanical or physical pretreatment. The term “mechanical pretreatment” or “physical pretreatment” refers to any pretreatment that promotes size reduction of particles. For example, such pretreatment can involve various types of grinding or milling (e.g., dry milling, wet milling, or vibratory ball milling).

The cellulosic-containing material can be pretreated both physically (mechanically) and chemically. Mechanical or physical pretreatment can be coupled with steaming/steam explosion, hydrothermolysis, dilute or mild acid treatment, high temperature, high pressure treatment, irradiation (e.g., microwave irradiation), or combinations thereof. In one aspect, high pressure means pressure in the range of preferably about 100 to about 400 psi, e.g., about 150 to about 250 psi. In another aspect, high temperature means temperature in the range of about 100 to about 300 °C, e.g., about 140 to about 200 °C. In a preferred aspect, mechanical or physical pretreatment is performed in a batch-process using a steam gun hydrolyzer system that uses high pressure and high temperature as defined above, e.g., a Sunds Hydrolyzer available from Sunds Defibrator AB, Sweden. The physical and chemical pretreatments can be carried out sequentially or simultaneously, as desired.

Accordingly, in one embodiment, the cellulosic-containing material is subjected to physical (mechanical) or chemical pretreatment, or any combination thereof, to promote the separation and/or release of cellulose, hemicellulose, and/or lignin.

In one embodiment, the cellulosic-containing material is subjected to a biological pretreatment. The term “biological pretreatment” refers to any biological pretreatment that promotes the separation and/or release of cellulose, hemicellulose, and/or lignin from the cellulosic-containing material. Biological pretreatment techniques can involve applying lignin-solubilizing microorganisms and/or enzymes (see, for example, Hsu, T.-A., 1996, Pretreatment of biomass, in Handbook on Bioethanol: Production and Utilization, Wyman, C. E., ed., Taylor & Francis, Washington, DC, 179-212; Ghosh and Singh, 1993, Adv. Appl. Microbiol. 39: 295-333; McMillan, J. D., 1994, Pretreating lignocellulosic biomass: a review, in Enzymatic Conversion of Biomass for Fuels Production, Himmel, M. E., Baker, J. O., and Overend, R. P., eds., ACS Symposium Series 566, American Chemical Society, Washington, DC, chapter 15; Gong, C. S., Cao, N. J., Du, J., and Tsao, G. T., 1999, Ethanol production from renewable resources, in Advances in Biochemical Engineering/Biotechnology, Scheper, T., ed., Springer-Verlag Berlin Heidelberg, Germany, 65: 207-241; Olsson and Hahn-Hagerdal, 1996, Enz. Microb. Tech. 18: 312-331; and Vallander and Eriksson, 1990, Adv. Biochem. Eng./Biotechnol. 42: 63-95).

### Saccharification and Fermentation of Cellulosic-Containing Material

Saccharification (i.e., hydrolysis) and fermentation, separate or simultaneous, include, but are not limited to, separate hydrolysis and fermentation (SHF); simultaneous saccharification and fermentation (SSF); simultaneous saccharification and co-fermentation (SSCF); hybrid hydrolysis and fermentation (HHF); separate hydrolysis and co-fermentation (SHCF); hybrid hydrolysis and co-fermentation (HHCF).

SHF uses separate process steps to first enzymatically hydrolyze the cellulosic-containing material to fermentable sugars, e.g., glucose, cellobiose, and pentose monomers, and then ferment the fermentable sugars to ethanol. In SSF, the enzymatic hydrolysis of the cellulosic-containing material and the fermentation of sugars to ethanol are combined in one step (Philippidis, G. P., 1996, Cellulose bioconversion technology, in Handbook on Bioethanol: Production and Utilization, Wyman, C. E., ed., Taylor & Francis, Washington, DC, 179-212). SSCF involves the co-fermentation of multiple sugars (Sheehan and Himmel, 1999, Biotechnol. Prog. 15: 817-827). HHF involves a separate hydrolysis step, and in addition a simultaneous saccharification and hydrolysis step, which can be carried out in the same reactor. The steps in an HHF process can be carried out at different temperatures, i.e., high temperature enzymatic saccharification followed by SSF at a lower temperature that the fermentation organism can tolerate. It is understood herein that any method known in the art comprising pretreatment, enzymatic hydrolysis (saccharification), fermentation, or a combination thereof, can be used in the practicing the processes described herein.

A conventional apparatus can include a fed-batch stirred reactor, a batch stirred reactor, a continuous flow stirred reactor with ultrafiltration, and/or a continuous plug-flow column reactor (de Castilhos Corazza et al., 2003, Acta Scientiarum. Technology 25: 33-38; Gusakov and Sinitsyn, 1985, Enz. Microb. Technol. 7: 346-352), an attrition reactor (Ryu and Lee, 1983, Biotechnol. Bioeng. 25: 53-65). Additional reactor types include fluidized bed, upflow blanket, immobilized, and extruder type reactors for hydrolysis and/or fermentation.

In the saccharification step (i.e., hydrolysis step), the cellulosic and/or starch-containing material, e.g., pretreated or liquified, is hydrolyzed to break down cellulose, hemicellulose, and/or starch to fermentable sugars, such as glucose, cellobiose, xylose, xylulose, arabinose, mannose, galactose, and/or soluble oligosaccharides. The hydrolysis is performed enzymatically e.g., by a cellulolytic enzyme composition. The enzymes of the compositions can be added simultaneously or sequentially.

Enzymatic hydrolysis may be carried out in a suitable aqueous environment under conditions that can be readily determined by one skilled in the art. In one aspect, hydrolysis is performed under conditions suitable for the activity of the enzymes(s), i.e., optimal for the enzyme(s). The hydrolysis can be carried out as a fed batch or continuous process where the cellulosic and/or starch-containing material is fed gradually to, for example, an enzyme containing hydrolysis solution.

The saccharification is generally performed in stirred-tank reactors or fermentors under controlled pH, temperature, and mixing conditions. Suitable process time, temperature and pH conditions can readily be determined by one skilled in the art. For example, the saccharification can last up to 200 hours, but is typically performed for preferably about 12 to about 120 hours, e.g., about 16 to about 72 hours or about 24 to about 48 hours. The temperature is in the range of preferably about 25 °C to about 70 °C, e.g., about 30 °C to about 65 °C, about 40 °C to about 60 °C, or about 50 °C to about 55 °C. The pH is in the range of preferably about 3 to about 8, e.g., about 3.5 to about 7, about 4 to about 6, or about 4.5 to about 5.5. The dry solids content is in the range of preferably about 5 to about 50 wt. %, e.g., about 10 to about 40 wt. % or about 20 to about 30 wt. %.

Saccharification in step (ii) may be carried out using a cellulolytic enzyme composition. Such enzyme compositions are described below in the “Cellulolytic Enzyme Composition”-section below. The cellulolytic enzyme compositions can comprise any protein useful in degrading the cellulosic-containing material. In one aspect, the cellulolytic enzyme composition comprises or further comprises one or more (e.g., two, several) proteins selected from the group consisting of a cellulase, an AA9 (GH61) polypeptide, a hemicellulase, an esterase, an expansin, a ligninolytic enzyme, an oxidoreductase, a pectinase, a protease, and a swollenin.

In another embodiment, the cellulase is preferably one or more (e.g., two, several) enzymes selected from the group consisting of an endoglucanase, a cellobiohydrolase, and a beta-glucosidase.

In another embodiment, the hemicellulase is preferably one or more (e.g., two, several) enzymes selected from the group consisting of an acetylmannan esterase, an acetylxylan esterase, an arabinanase, an arabinofuranosidase, a coumaric acid esterase, a feruloyl esterase, a galactosidase, a glucuronidase, a glucuronoyl esterase, a mannanase, a mannosidase, a xylanase, and a xylosidase. In another embodiment, the oxidoreductase is one or more (e.g., two, several) enzymes selected from the group consisting of a catalase, a laccase, and a peroxidase.

The enzymes or enzyme compositions used in a processes of the present invention may be in any form suitable for use, such as, for example, a fermentation broth formulation or a cell composition, a cell lysate with or without cellular debris, a semi-purified or purified enzyme preparation, or a host cell as a source of the enzymes. The enzyme composition may be a dry powder or granulate, a non-dusting granulate, a liquid, a stabilized liquid, or a stabilized protected enzyme. Liquid enzyme preparations may, for instance, be stabilized by adding stabilizers such as a sugar, a sugar alcohol or another polyol, and/or lactic acid or another organic acid according to established processes.

In one embodiment, an effective amount of cellulolytic or hemicellulolytic enzyme composition to the cellulosic-containing material is about 0.5 to about 50 mg, e.g., about 0.5 to about 40 mg, about 0.5 to about 25 mg, about 0.75 to about 20 mg, about 0.75 to about 15 mg, about 0.5 to about 10 mg, or about 2.5 to about 10 mg per g of the cellulosic-containing material.

In one embodiment, such a compound is added at a molar ratio of the compound to glucosyl units of cellulose of about 10⁻⁶ to about 10, e.g., about 10⁻⁶ to about 7.5, about 10⁻⁶ to about 5, about 10⁻⁶ to about 2.5, about 10⁻⁶ to about 1, about 10⁻⁵ to about 1, about 10⁻⁵ to about 10⁻¹, about 10⁻⁴ to about 10⁻¹, about 10⁻³ to about 10⁻¹, or about 10⁻³ to about 10⁻². In another aspect, an effective amount of such a compound is about 0.1 μM to about 1 M, e.g., about 0.5 μM to about 0.75 M, about 0.75 μM to about 0.5 M, about 1 μM to about 0.25 M, about 1 μM to about 0.1 M, about 5 μM to about 50 mM, about 10 μM to about 25 mM, about 50 μM to about 25 mM, about 10 μM to about 10 mM, about 5 μM to about 5 mM, or about 0.1 mM to about 1 mM.

The term “liquor” means the solution phase, either aqueous, organic, or a combination thereof, arising from treatment of a lignocellulose and/or hemicellulose material in a slurry, or monosaccharides thereof, e.g., xylose, arabinose, mannose, etc., under conditions as described in WO 2012/021401, and the soluble contents thereof. A liquor for cellulolytic enhancement of an AA9 polypeptide (GH61 polypeptide) can be produced by treating a lignocellulose or hemicellulose material (or feedstock) by applying heat and/or pressure, optionally in the presence of a catalyst, e.g., acid, optionally in the presence of an organic solvent, and optionally in combination with physical disruption of the material, and then separating the solution from the residual solids. Such conditions determine the degree of cellulolytic enhancement obtainable through the combination of liquor and an AA9 polypeptide during hydrolysis of a cellulosic substrate by a cellulolytic enzyme preparation. The liquor can be separated from the treated material using a method standard in the art, such as filtration, sedimentation, or centrifugation.

In one embodiment, an effective amount of the liquor to cellulose is about 10⁻⁶ to about 10 g per g of cellulose, e.g., about 10⁻⁶ to about 7.5 g, about 10⁻⁶ to about 5 g, about 10⁻⁶ to about 2.5 g, about 10⁻⁶ to about 1 g, about 10⁻⁵ to about 1 g, about 10⁻⁵ to about 10⁻¹ g, about 10⁻⁴ to about 10⁻¹ g, about 10⁻³ to about 10⁻¹ g, or about 10⁻³ to about 10⁻² g per g of cellulose.

In the fermentation step, sugars, released from the cellulosic-containing material, e.g., as a result of the pretreatment and enzymatic hydrolysis steps, are fermented to ethanol, by a fermenting organism, such as yeast described herein. Hydrolysis (saccharification) and fermentation can be separate or simultaneous.

Any suitable hydrolyzed cellulosic-containing material can be used in the fermentation step in practicing the processes described herein. Such feedstocks include, but are not limited to carbohydrates (e.g., lignocellulose, xylans, cellulose, starch, etc.). The material is generally selected based on economics, i.e., costs per equivalent sugar potential, and recalcitrance to enzymatic conversion.

Production of ethanol by a fermenting organism using cellulosic-containing material results from the metabolism of sugars (monosaccharides). The sugar composition of the hydrolyzed cellulosic-containing material and the ability of the fermenting organism to utilize the different sugars has a direct impact in process yields.

Compositions of the fermentation media and fermentation conditions depend on the fermenting organism and can easily be determined by one skilled in the art. Typically, the fermentation takes place under conditions known to be suitable for generating the fermentation product. In some embodiments, the fermentation process is carried out under aerobic or microaerophilic (i.e., where the concentration of oxygen is less than that in air), or anaerobic conditions. In some embodiments, fermentation is conducted under anaerobic conditions (i.e., no detectable oxygen), or less than about 5, about 2.5, or about 1 mmol/L/h oxygen. In the absence of oxygen, the NADH produced in glycolysis cannot be oxidized by oxidative phosphorylation. Under anaerobic conditions, pyruvate or a derivative thereof may be utilized by the host cell as an electron and hydrogen acceptor in order to generate NAD+.

The fermentation process is typically run at a temperature that is optimal for the recombinant fungal cell. For example, in some embodiments, the fermentation process is performed at a temperature in the range of from about 25 °C to about 42 °C. Typically the process is carried out a temperature that is less than about 38 °C, less than about 35 °C, less than about 33 °C, or less than about 38 °C, but at least about 20 °C, 22 °C, or 25 °C.

A fermentation stimulator can be used in a process described herein to further improve the fermentation, and in particular, the performance of the fermenting organism, such as, rate enhancement and product yield (e.g., ethanol yield). A “fermentation stimulator” refers to stimulators for growth of the fermenting organisms, in particular, yeast. Preferred fermentation stimulators for growth include vitamins and minerals. Examples of vitamins include multivitamins, biotin, pantothenate, nicotinic acid, meso-inositol, thiamine, pyridoxine, para-aminobenzoic acid, folic acid, riboflavin, and Vitamins A, B, C, D, and E. See, for example, Alfenore et al., Improving ethanol production and viability of Saccharomyces cerevisiae by a vitamin feeding strategy during fed-batch process, Springer-Verlag (2002), which is hereby incorporated by reference. Examples of minerals include minerals and mineral salts that can supply nutrients comprising P, K, Mg, S, Ca, Fe, Zn, Mn, and Cu.

### Recovery

Subsequent to fermentation or SSF, the fermentation product may be separated from the fermentation medium. The fermentation product, e.g., ethanol, can optionally be recovered from the fermentation medium using any method known in the art including, but not limited to, chromatography, electrophoretic procedures, differential solubility, distillation, or extraction. For example, alcohol is separated from the fermented cellulosic material or fermented starch-containing material and purified by conventional methods of distillation.

Thus, in one embodiment, the method of the invention further comprises distillation to obtain the fermentation product, e.g., ethanol. The fermentation and the distillation may be carried out simultaneously and/or separately/sequentially; optionally followed by one or more process steps for further refinement of the fermentation product.

Following the completion of the distillation process, the material remaining is considered the whole stillage. As used herein, the term “whole stillage” includes the material that remains at the end of the distillation process after recovery of the fermentation product, e.g., ethanol.

As another example, the desired fermentation product may be extracted from the fermentation medium by micro or membrane filtration techniques. Ethanol with a purity of up to about 96 vol. % can be obtained, which can be used as, for example, fuel ethanol, drinking ethanol, i.e., potable neutral spirits, or industrial ethanol.

In some embodiments of the methods, the fermentation product after being recovered is substantially pure. With respect to the methods herein, “substantially pure” intends a recovered preparation that contains no more than 15% impurity, wherein impurity intends compounds other than the fermentation product (e.g., ethanol). In one variation, a substantially pure preparation is provided wherein the preparation contains no more than 25% impurity, or no more than 20% impurity, or no more than 10% impurity, or no more than 5% impurity, or no more than 3% impurity, or no more than 1% impurity, or no more than 0.5% impurity.

Suitable assays to test for the production of ethanol and contaminants, and sugar consumption can be performed using methods known in the art. For example, ethanol product, as well as other organic compounds, can be analyzed by methods such as HPLC (High Performance Liquid Chromatography), GC-MS (Gas Chromatography Mass Spectroscopy) and LC-MS (Liquid Chromatography-Mass Spectroscopy) or other suitable analytical methods using routine procedures well known in the art. The release of ethanol in the fermentation broth can also be tested with the culture supernatant. Byproducts and residual sugar in the fermentation medium (e.g., glucose or xylose) can be quantified by HPLC using, for example, a refractive index detector for glucose and alcohols, and a UV detector for organic acids (Lin et al., Biotechnol. Bioeng. 90:775-779 (2005)), or using other suitable assay and detection methods well known in the art.

Separating (Dewatering) Whole Stillage into Thin Stillage and Wet Cake

In one embodiment, the whole stillage is separated or partitioned into a solid and liquid phase by one or more methods for separating the thin stillage from the wet cake.

Separating whole stillage into thin stillage and wet cake in order to remove a significant portion of the liquid/water, may be done using any suitable separation technique, including centrifugation, pressing and filtration. In a preferred embodiment, the separation/dewatering is carried out by centrifugation. Preferred centrifuges in industry are decanter type centrifuges, preferably high speed decanter type centrifuges. An example of a suitable centrifuge is the NX 400 steep cone series from Alfa Laval which is a high-performance decanter. In another preferred embodiment, the separation is carried out using other conventional separation equipment such as a plate/frame filter presses, belt filter presses, screw presses, gravity thickeners and deckers, or similar equipment.

### Processing of Thin Stillage

Thin stillage is the term used for the supernatant of the centrifugation of the whole stillage. Typically, the thin stillage contains 4-6 percent dry solids (DS) (mainly proteins, soluble fiber, fine fibers, and cell wall components) and has a temperature of about 60-90 degrees centigrade. The thin stillage stream may be condensed by evaporation to provide two process streams including: (i) an evaporator condensate stream comprising condensed water removed from the thin stillage during evaporation, and (ii) a syrup stream, comprising a more concentrated stream of the non-volatile dissolved and non-dissolved solids, such as non-fermentable sugars and oil, remaining present from the thin stillage as the result of removing the evaporated water. Optionally, oil can be removed from the thin stillage or can be removed as an intermediate step to the evaporation process, which is typically carried out using a series of several evaporation stages. Syrup and/or de-oiled syrup may be introduced into a dryer together with the wet grains (from the whole stillage separation step) to provide a product referred to as distillers dried grain with solubles, which also can be used as animal feed.

In an embodiment, syrup and/or de-oiled syrup is sprayed into one or more dryers to combine the syrup and/or de-oiled syrup with the whole stillage to produce distillers dried grain with solubles.

Between 5-90 vol-%, such as between 10-80%, such as between 15-70%, such as between 20-60% of thin stillage (e.g., optionally hydrolyzed) may be recycled (as backset) to step (a). The recycled thin stillage (i.e., backset) may constitute from about 1-70 vol.-%, preferably 15-60% vol.-%, especially from about 30 to 50 vol.-% of the slurry formed in step (a).

In an embodiment, the process further comprises recycling at least a portion of the thin stillage stream to the slurry, optionally after oil has been extracted from the thin stillage stream.

Drying of Wet Cake and Producing Distillers Dried Grains and Distillers Dried Grains with Solubles

After the wet cake, containing about 25-40 wt-%, preferably 30-38 wt-% dry solids, has been separated from the thin stillage (e.g., dewatered) it may be dried in a drum dryer, spray dryer, ring drier, fluid bed drier or the like in order to produce “Distillers Dried Grains” (DDG). DDG is a valuable feed ingredient for animals, such as livestock, poultry and fish. It is preferred to provide DDG with a content of less than about 10-12 wt.-% moisture to avoid mold and microbial breakdown and increase the shelf life. Further, high moisture content also makes it more expensive to transport DDG. The wet cake is preferably dried under conditions that do not denature proteins in the wet cake. The wet cake may be blended with syrup separated from the thin stillage and dried into DDG with Solubles (DDGS). Partially dried intermediate products, such as are sometimes referred to as modified wet distillers grains, may be produced by partially drying wet cake, optionally with the addition of syrup before, during or after the drying process.

### III. Processes for Producing a High Protein Feed Ingredient from a Whole Stillage Byproduct

An aspect of the present invention relates to a process for producing a high protein feed ingredient from a whole stillage byproduct produced in a starch-containing grain dry milling process for producing a fermentation product, wherein at least one hemicellulase, at least one beta-glucanase, or an enzyme blend comprising at least one hemicellulase and/or at least one beta-glucanase is for partitioning a greater amount of protein from the whole stillage byproduct into the high protein fraction, rather than being retained in the wet cake, to produce a high protein feed ingredient.

In an embodiment, the present invention provides a method for producing a high protein feed ingredient from a whole stillage byproduct produced in a starch-containing grain dry milling process for producing a fermentation product, the method comprising:
a) performing a starch-containing grain dry milling process for producing a fermentation product to produce a fermentation product and a whole stillage byproduct;
b) separating the whole stillage byproduct into an insoluble solids portion and a thin stillage portion;
c) separating the thin stillage portion into at least a first separated water-soluble solids portion, and at least a first separated protein portion;
d) optionally separating at least the first separated protein portion into at least a second separated water-soluble solids portion, and at least a second separated protein portion;
e) drying at least the first separated protein portion, and/or optionally at least the second separated protein portion, to define a protein product, wherein the protein product is a high protein feed ingredient;
wherein at least one hemicellulase and/or at least one beta-glucanase, or an enzyme blend comprising at least one hemicellulase and/or at least one beta-glucanase added prior to or during production of the whole stillage byproduct and/or separating the whole stillage byproduct.

The at least one hemicellulase and/or at least one beta-glucanase, and cellulolytic composition present or added in the above method for producing a high protein feed ingredient from a whole stillage byproduct produced in a starch-containing grain dry milling process for producing a fermentation product may be added exogenously during saccharification, fermentation or simultaneous saccharification and fermentation as mono-components, as enzyme blends or compositions comprising the hemicellulases and/or beta-glucanases, and/or via in-situ expression and secretion of the hemicellulases and/or beta-glucanases by the fermenting organism, e.g., a recombinant host cell or fermenting organism described herein (e.g., yeast, such as from the genus Saccharomyces, preferably Saccharomyces cerevisiae).

An enzyme blend of the invention may suitably be used in a process or method of the invention. A recombinant host cell or fermenting organism of the invention may suitably be used in a process or method of the invention. However, the enzymes may also be added separately.

Those skilled in the art will appreciate that the “water-soluble” solids portion may include very fine particulates that are difficult to remove via separation (e.g., centrifugation).

As used herein, “protein portion” includes components other than protein. For example, the “protein portion” may include at least 40%, at least 45%, at least 50%, at least 55%, at least 60%, at least 65%, or at least 70% or more protein.

Separating step b) may be performed using a variety of techniques which are available to the ordinarily skilled artisan. In embodiment, separating step b) is performed by subjecting the whole stillage byproduct to a centrifuge. In an embodiment. The centrifuge is a filtration centrifuge. In an embodiment, the centrifuge is a decanter centrifuge. In an embodiment, separating step b) is performed using a screen. In an embodiment, the screen is a pressure screen. In an embodiment the screen is a paddle screen. In an embodiment, separating step b) is performed by subjecting the whole stillage byproduct to a filtration centrifuge, a decanter centrifuge, a pressure screen, or a paddle screen.

Separating step c) may be performed using a variety of techniques which are available to the ordinary skilled artisan. In an embodiment, separating step c) is performed by subjecting the thin stillage portion to a centrifuge or a cyclone apparatus. Optional separating step d) may be performed using a variety of techniques which are available to the ordinarily skilled artisan. In an embodiment, optional separating step d) is performed by subjecting the first separated protein portion to a centrifuge or a cyclone apparatus. Those skilled in the art will appreciate the first separated protein portion may be re-slurried prior to performing optional separating step d).

Drying step d) may be performed using a variety of techniques which are available to the ordinarily skilled artisan. In an embodiment, drying is performed by subjecting at least the first separated protein portion and/or optionally the at least the second separated protein portion to a temperature change that results in removal of water from the first and/or second separated protein portions. For example, drying may include freeze drying, or using a dryer (e.g., gas-fired) or an oven. In an embodiment, drying step e) is performed by subjecting at least the first separated protein portion and/or optionally the at least the second separated protein portion to a decanter centrifuge to dewater the first and/or optionally the second separated protein portions to define the high protein feed ingredient.

As used herein, “during production of the whole stillage byproduct” encompasses addition of the enzymes to the whole stillage byproduct itself, as well as addition of the enzymes during processing steps leading up to the production of the byproduct.

Those skilled in the art will appreciate that the whole stillage byproduct contains a slurry of soluble and insoluble solids, i.e., the spent grains from the distillation and dehydration step, which includes protein, fiber, oil, and sugars that are processed in accordance with embodiments of this invention to produce a high protein feed ingredient that can be sold, e.g., as an animal feed, at a higher cost per ton than typical DDGS or DWGS. In one embodiment, the resulting high protein feed ingredient includes at least 40% wt percent protein on a dry basis as compared to a protein content of about 29 percent typically found in DDGS. In an embodiment, the resulting high protein feed ingredient includes at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, or at least 80% wt percent protein on a dry basis as compared to a protein content of about 29 percent typically found in DDGS.

The work described herein demonstrates that the hemicellulase, when used alone or in combination with a cellulolytic composition, significantly increases the amount of protein in the high protein feed ingredient compared to high protein feed ingredient produced using the same process but without using hemicellulase and/or cellulolytic composition. In an embodiment, the hemicellulase, enzyme blend comprising hemicellulase, and processes of use thereof increase the amount of protein in the resulting high protein feed ingredient by least 1%, at least 2%, at least 3%, at least 4%, at least 5%, at least 6%, at least 7%, at least 8%, at least 9%, at least 10%, at 11%, at least 12%, at least 13%, at least 14%, at least 15%, at least 16%, at least 17%, at least 18%, at least 19%, at least 20%, at least 21%, at least 22%, at least 23%, at least 24%, or up to at least 25%, at least 27%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%,more protein compared to a high protein feed ingredient produced using the same process without the hemicellulase or enzyme blend comprising hemicellulase.

The work describe herein further demonstrates that the beta-glucanases, when used alone or in combination with a cellulolytic composition, significantly increases the weight percent protein on a dry basis of the high protein feed ingredient compared to a high protein feed ingredient produced using the same process but without using beta-glucanase(s) and/or the cellulolytic composition. In an embodiment, the beta-glucanase, enzyme blend comprising beta-glucanase, and processes of use thereof increase the weight percent protein on a dry basis in the resulting high protein feed ingredient by least 1%, at least 2%, at least 3%, at least 4%, at least 5%, at least 6%, at least 7%, at least 8%, at least 9%, at least 10%, at 11%, at least 12%, at least 13%, at least 14%, at least 15%, at least 16%, at least 17%, at least 18%, at least 19%, at least 20%, at least 21%, at least 22%, at least 23%, at least 24%, or up to at least 25%, at least 27%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70% or more protein compared to a high protein feed ingredient produced using the same process without the beta-glucanase, or enzyme blend comprising beta-glucanase.

Any starch-containing grain can be used as the starting material for producing a high protein feed ingredient in accordance with the processes described herein. In an embodiment, the starch-containing grain comprises maize, corn, wheat, rye, barley, triticale, sorghum, switchgrass, millet, pearl millet, foxtail millet.

The high protein feed ingredient can be incorporated into a feed and sold to feed any animal. In an embodiment, the high protein feed ingredient is a high protein corn-based animal feed. In an embodiment, the high protein feed ingredient is a high protein wheat-based animal feed. In an embodiment, the high protein feed ingredient is a high protein rye-based animal feed. In an embodiment, the high protein feed ingredient is a high protein barley-based animal feed. In an embodiment, the high protein feed ingredient is a high protein triticale-based animal feed. In an embodiment, the high protein feed ingredient is a high protein sorghum-based animal feed. In an embodiment, the high protein feed ingredient is a high protein millet-based animal feed. In an embodiment, the high protein millet-based animal feed comprises pearl millet. In an embodiment, the high protein millet-based animal feed ingredient comprises foxtail millet. In an embodiment, the high protein feed ingredient is a high protein switchgrass-based animal feed. In an embodiment, the high protein feed ingredient is a blended high protein animal feed comprising any two, three, four, or five high protein animal feed ingredients selected from the group consisting of a high protein maize feed ingredient, a high protein corn feed ingredient, a high protein wheat ingredient, a high protein rye ingredient, a high protein barley ingredient, a high protein triticale ingredient, a high protein sorghum ingredient, a high protein switchgrass ingredient, a high protein millet ingredient, a high protein pearl millet ingredient, and a high protein foxtail millet ingredient.

In an embodiment, the process further includes, after separating the whole stillage byproduct into an insoluble solids portion and a thin stillage portion and before separating the thin stillage portion into a first separated protein portion and a first separated water-soluble solids portion, separating fine fiber from the thin stillage portion. In an embodiment, separating fine fiber from the thin stillage portion comprises separating the fine fiber via a pressure screen, paddle screen, decanter, or filtration centrifuge.

In an embodiment, the process further includes separating soluble solids from the first separated water-soluble solids portion to provide a first soluble solids portion, and optionally separating soluble solids from the second separated water-soluble solids portion to provide a second soluble solids portion.

In an embodiment, the process further includes the step of separating free oil from the first separated water-soluble solids portion to provide a first oil portion, and optionally separating free oil from the second separated water-soluble solids portion to provide a second oil portion.

In an embodiment, the hemicellulase, beta-glucanase, or enzyme blend comprising hemicellulase and/or beta-glucanase is added during the production of the whole stillage byproduct.

In an embodiment, the hemicellulase, beta-glucanase, or enzyme blend comprising hemicellulase and/or beta-glucanase is added during the separation of the whole stillage byproduct into the insoluble solids portion and the thin stillage portion.

In an embodiment, the hemicellulase and/or beta-glucanase, or the enzyme blend comprising at least one hemicellulase and/or beta-glucanase is added to the whole stillage prior to separation into insoluble solids and thin stillage.

The hemicellulase and/or beta-glucanase, or enzyme blend comprising at least one hemicellulase and/or beta-glucanase added to the whole stillage as described in any of these embodiments may be incubated with the whole stillage for a period of time sufficient to increase and/or optimize the amount of protein that is portioned into the high protein fraction rather than the wetcake and/or increase the mass of the high protein fraction that ends up in the high protein feed ingredient (e.g., increase the weight percent protein on a dry basis of the high protein feed ingredient). The incubation period of the hemicellulase and/or beta-glucanase, or enzyme blend comprising the hemicellulase and/or beta-glucanase is at least 30 minutes, at least 45 minutes, at least 1 hour, at least 2 hours, at least 3 hours, at least 4 hours, at least 5 hours, at least 6 hours, at least 8 hours, at least 10 hours, at least 12 hours, at least 14 hours, at least 15 hours, at least 16 hours, at least 18 hours, at least 20 hours, at least 24 hours, at least 30 hours, at least 36 hours, at least 40 hours, at least 41 hours, at least 42 hours, at least 43 hours, at least 44 hours, at least 45 hours, at least 46 hours, at least 47 hours, at least 48 hours, at least 50 hours, at least 55 hours, at least 60 hours, at least 62 hours, at least 64 hours, at least 68 hours, at least 70 hours, or at least 72 hours. In an embodiment, the incubation period is 48 hours. In an embodiment, the incubation period is 64 hours, in an embodiment, the incubation period is 72 hours. Those skilled in the art will appreciate that to achieve longer incubation periods between the enzymes and the whole stillage, the whole stillage may be retained in a container (e.g., holding tank) for the desired time period (e.g., until the optimal amount of protein and/or optimal weight percent protein on a dry basis of the high protein feed ingredient is achieved).

Those skilled in the art will further appreciate that the conditions (e.g., temperature, pH, enzyme dosing, etc.) during incubation of the enzymes and whole stillage may be adjusted to further optimize the amount of protein and/or weight percent protein on a dry basis of the high protein feed ingredient. For example, the temperature may be adjusted in the holding tank to a set point or within a range that is optimal for the enzymes. The temperature range of the whole stillage treatment with the enzymes or enzyme blends of the present invention may be from 20 °C to 90 °C, preferably from 30 °C to 85 °C, inclusive. In an embodiment, the temperature of the whole stillage treatment is 32 °C. In an embodiment, the temperature of the whole stillage treatment is 34 °C. In an embodiment, the temperature of the whole stillage treatment is 36 °C. In an embodiment, the temperature of the whole stillage treatment is 38 °C. In an embodiment, the temperature of the whole stillage treatment is 40 °C. In an embodiment, the temperature of the whole stillage treatment is 42 °C. In an embodiment, the temperature of the whole stillage treatment is 44 °C. In an embodiment, the temperature of the whole stillage treatment is 46 °C. In an embodiment, the temperature of the whole stillage treatment is 48 °C. In an embodiment, the temperature of the whole stillage treatment is 50 °C. In an embodiment, the temperature of the whole stillage treatment is 52 °C. In an embodiment, the temperature of the whole stillage treatment is 54 °C. In an embodiment, the temperature of the whole stillage treatment is 56 °C. In an embodiment, the temperature of the whole stillage treatment is 58 °C. In an embodiment, the temperature of the whole stillage treatment is 60 °C. In an embodiment, the temperature of the whole stillage treatment is 65 °C. In an embodiment, the temperature of the whole stillage treatment is 70 °C. In an embodiment, the temperature of the whole stillage treatment is 75 °C. In an embodiment, the temperature of the whole stillage treatment is 80 °C. In an embodiment, the temperature of the whole stillage treatment is 85 °C.

The total solids of the whole stillage during the enzyme treatment may vary, for example, the total solids of the whole stillage may range from 5% to 40%. In an embodiment, the total solids is about 8%. In an embodiment, the total solids is about 9%. In an embodiment, the total solids is about 10%. In an embodiment, the total solids is about 11%. In an embodiment, the total solids is about 12%. In an embodiment, the total solids is about 13%. In an embodiment, the total solids is about 15%. In an embodiment, the total solids is about 18%. In an embodiment, the total solids is about 20%. In an embodiment, the total solids is about 24%.

In an embodiment, the total solids is about 26%. In an embodiment, the total solids is about 28%. In an embodiment, the total solids is about 29%. In an embodiment, the total solids is about 30%. In an embodiment, the total solids is about 31%. In an embodiment, the total solids is about 32%. In an embodiment, the total solids is about 33%. In an embodiment, the total solids is about 34%. In an embodiment, the total solids is about 35%. In an embodiment, the total solids is about 36%. In an embodiment, the total solids is about 37%. In an embodiment, the total solids is about 38%. In an embodiment, the total solids is about 39%. In an embodiment, the total solids is about 40%.

The pH of the whole stillage during the enzyme treatment may range from about 3.5 to about 7. In an embodiment, the pH is about 3.5. In an embodiment, the pH is about 3.6. In an embodiment, the pH is about 3.7. In an embodiment, the pH is about 3.8. In an embodiment, the pH is about 3.9. In an embodiment, the pH is about 4.0. In an embodiment, the pH is about 4.1. In an embodiment, the pH is about 4.2. In an embodiment, the pH is about 4.3. In an embodiment, the pH is about 4.4. In an embodiment, the pH is about 4.5. In an embodiment, the pH is about 4.6. In an embodiment, the pH is about 4.7. In an embodiment, the pH is about 4.8. In an embodiment, the pH is about 4.9. In an embodiment, the pH is about 5.0. In an embodiment, the pH is about 5.1. In an embodiment, the pH is about 5.2. In an embodiment, the pH is about 5.3. In an embodiment, the pH is about 5.4. In an embodiment, the pH is about 5.5. In an embodiment, the pH is about 5.6. In an embodiment, the pH is about 5.7. In an embodiment, the pH is about 5.8. In an embodiment, the pH is about 5.9. In an embodiment, the pH is about 6.0. In an embodiment, the pH is about 6.1. In an embodiment, the pH is about 6.2. In an embodiment, the pH is about 6.3. In an embodiment, the pH is about 6.4. In an embodiment, the pH is about 6.5. In an embodiment, the pH is about 6.6. In an embodiment, the pH is about 6.7. In an embodiment, the pH is about 6.8. In an embodiment, the pH is about 6.9. In an embodiment, the pH is about 7.0.

As used herein, “improving the partitioning of protein from the whole stillage byproduct” and “partitioning a greater amount of protein from the whole stillage byproduct” are used interchangeably herein to refer to at least a 5% increase in the amount of initial protein from the whole stillage byproduct that is partitioned to the high protein fraction using a presently disclosed hemicellulase, beta-glucanase, or enzyme blend comprising a hemicellulase and/or beta-glucanase as compared to the amount of initial protein from the whole stillage byproduct that is partitioned to the high protein fraction when not using a presently disclosed hemicellulase, beta-glucanase or enzyme blend. In some contexts, “improving the partitioning of protein from the whole stillage byproduct” and “partitioning a greater amount of protein from the whole stillage byproduct” are used interchangeably herein to refer to at least 5%, at least 6%, at least 7%, at least 8%, at least 9%, at least 9%, at least 10%, at least 11%, at least 12%, at least 13%, at least 14%, at least 15%, at least 16%, at least 17%, at least 18%, at least 19%, at least 20%, at least 25%, at least 26%, at least 27%, at least 28%, at least 29%, at least 30%, at least 33%, at least 34%, at least 35%, at least 36% at least 37%, at least 38%, at least 39%, or at least 40% decrease in the amount of initial protein from the whole stillage byproduct that is retained in the wet cake fraction. Such increase/decrease may result whether the hemicellulase, beta-glucanase or enzyme blend comprising hemicellulase and/or beta-glucanase is added during the production of the whole stillage byproduct, during the separation of the whole stillage byproduct into the insoluble solids portion and the thin stillage portion, or during pre-saccharification, saccharification, fermentation, and/or simultaneous saccharification and fermentation.

In an embodiment, the enzyme blends and processes of the present invention increase the amount of initial protein from the whole stillage byproduct that is partitioned to the high protein fraction by at least 5%, at least 6%, at least 7%, at least 8%, at least 9%, at least 9%, at least 10%, at least 11%, at least 12%, at least 13%, at least 14%, at least 15%, at least 16%, at least 17%, at least 18%, at least 19%, at least 20%, at least 25%, at least 26%, at least 27%, at least 28%, at least 29%, at least 30%, at least 33%, at least 34%, at least 35%, at least 36% at least 37%, at least 38%, at least 39%, or at least 40% as compared to the amount of initial protein from the whole stillage byproduct that is partitioned to the high protein fraction when not using a presently disclosed hemicellulase, beta-glucanase, or enzyme blend.

In an embodiment, the enzyme blends and processes of the present invention decrease the amount of initial protein from the whole stillage byproduct that is retained in the wet cake fraction by at least 5%, at least 6%, at least 7%, at least 8%, at least 9%, at least 9%, at least 10%, at least 11%, at least 12%, at least 13%, at least 14%, at least 15%, at least 16%, at least 17%, at least 18%, at least 19%, at least 20%, at least 25%, at least 26%, at least 27%, at least 28%, at least 29%, at least 30%, at least 33%, at least 34%, at least 35%, at least 36% at least 37%, at least 38%, at least 39%, or at least 40% as compared to the amount of initial protein from the whole stillage byproduct that is retained in the wet cake fraction not using a presently disclosed hemicellulase, beta-glucanase, or enzyme blend.

### IV. Enzymes

The enzyme(s) and polypeptides described below are to be used in an “effective amount” in blends or processes of the present invention. Below should be read in context of the enzyme disclosure in the “Definitions”-section above.

### Cellulolytic Compositions Used in an Enzyme Blend or Process and Method of the Invention

The cellulolytic composition used in a process of the invention may be derived from any microorganism. As used herein, “derived from any microorganism” means that the cellulolytic composition comprises one or more enzymes that were expressed in the microorganism. For instance, a cellulolytic composition derived from a strain of Trichoderma reesei means that the cellulolytic composition comprises one or more enzymes that were expressed in Trichoderma reesei.

In an embodiment, the cellulolytic composition is derived from a strain of Aspergillus, such as a strain of Aspergillus aurantiacus, Aspergillus niger or Aspergillus oryzae.

In an embodiment, the cellulolytic composition is derived from a strain of Chrysosporium, such as a strain of Chrysosporium lucknowense.

In an embodiment, the cellulolytic composition is derived from a strain of Humicola, such as a strain of Humicola insolens.

In an embodiment, the cellulolytic composition is derived from a strain of Penicilium, such as a strain of Penicilium emersonii or Penicilium oxalicum.

In an embodiment, the cellulolytic composition is derived from a strain of Talaromyces, such as a strain of Talaromyces aurantiacus or Talaromyces emersonii.

In an embodiment, the cellulolytic composition is derived from a strain of Trichoderma, such as a strain of Trichoderma reesei.

In a preferred embodiment, the cellulolytic composition is derived from a strain of Trichoderma reesei.

The cellulolytic composition may comprise one or more of the following polypeptides, including enzymes: GH61 polypeptide having cellulolytic enhancing activity, beta-glucosidase, CBHI and CBHII, or a mixture of two, three, or four thereof.

In a preferred embodiment, the cellulolytic composition comprising a beta-glucosidase having a Relative ED50 loading value of less than 1.00, preferably less than 0.80, such as preferably less than 0.60, such as between 0.1-0.9, such as between 0.2-0.8, such as 0.30-0.70.

The cellulolytic composition may comprise some hemicellulase, such as, e.g., xylanase and/or beta-xylosidase. The hemicellulase may come from the cellulolytic composition producing organism or from other sources, e.g., the hemicellulase may be foreign to the cellulolytic composition producing organism, such as, e.g., Trichoderma reesei.

In a preferred embodiment the hemicellulase content in the cellulolytic composition constitutes less than 10 wt. % such as less than 5 wt. % of the cellulolytic composition.

In an embodiment the cellulolytic composition comprises a beta-glucosidase.

In an embodiment the cellulolytic composition comprises a GH61 polypeptide having cellulolytic enhancing activity and a beta-glucosidase.

In another embodiment the cellulolytic composition comprises a beta-glucosidase and a CBH.

In another embodiment the cellulolytic composition comprises a GH61 polypeptide having cellulolytic enhancing activity, a beta-glucosidase, and a CBHI.

In another embodiment the cellulolytic composition comprises a beta-glucosidase and a CBHI.

In another embodiment the cellulolytic composition comprises a GH61 polypeptide having cellulolytic enhancing activity, a beta-glucosidase, a CBHI, and a CBHII.

In another embodiment the cellulolytic composition comprises a beta-glucosidase, a CBHI, and a CBHII.

The cellulolytic composition may further comprise one or more enzymes selected from the group consisting of a cellulase, a GH61 polypeptide having cellulolytic enhancing activity, an esterase, an expansin, a laccase, a ligninolytic enzyme, a pectinase, a peroxidase, a protease, and a swollenin.

In an embodiment the cellulase is one or more enzymes selected from the group consisting of an endoglucanase, a cellobiohydrolase, and a beta-glucosidase.

In an embodiment the endoglucanase is an endoglucanase I.

In an embodiment the endoglucanase is an endoglucanase II.

In an embodiment, the cellulolytic composition comprises a cellobiohydrolase, a beta-glucosidase, and an endoglucanase. In an embodiment, the cellulolytic composition comprises: a cellobiohydrolase I; a beta-glucosidase; and an endoglucanase I. In an embodiment, the cellulolytic composition comprises: an Aspergillus cellobiohydrolase I; an Aspergillus beta-glucosidase; and a Trichoderma endoglucanase I. In an embodiment, the cellulolytic composition comprises: an Aspergillus fumigatus cellobiohydrolase I; an Aspergillus fumigatus beta-glucosidase; and a Trichoderma reesei endoglucanase I. In an embodiment, the cellulolytic composition comprises: (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21; (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.

### Beta-Glucosidase

The cellulolytic composition used according to the invention may in one embodiment comprise one or more beta-glucosidase. The beta-glucosidase may in one embodiment be one derived from a strain of the genus Aspergillus, such as Aspergillus oryzae, such as the one disclosed in WO 2002/095014 or the fusion protein having beta-glucosidase activity disclosed in WO 2008/057637, or Aspergillus fumigatus, such as such as one disclosed in WO 2005/047499 or SEQ ID NO: 23 herein or an Aspergillus fumigatus beta-glucosidase variant, such as one disclosed in WO 2012/044915 or co-pending PCT application PCT/US11/054185 (or U.S. provisional application No. 61/388,997), such as one with the following substitutions: F100D, S283G, N456E, F512Y.

In another embodiment the beta-glucosidase is derived from a strain of the genus Penicillium, such as a strain of the Penicillium brasilianum disclosed in WO 2007/019442, or a strain of the genus Trichoderma, such as a strain of Trichoderma reesei.

In an embodiment betaglucosidase is an Aspergillus fumigatus beta-glucosidase or homolog thereof selected from the group consisting of:
(i) a beta-glucosidase comprising the mature polypeptide of SEQ ID NO: 23;
(ii) a beta-glucosidase comprising an amino acid sequence having at least 70%, e.g., 75%, 80%, 85%, 90%, 91%, 92%, 93%, 94%, 95%, 96%, 97%, 98%, or 99% identity to the mature polypeptide of SEQ ID NO: 23 herein;
(iii) a beta-glucosidase encoded by a polynucleotide comprising a nucleotide sequence having at least 70%, e.g., 75%, 80%, 85%, 90%, 91%, 92%, 93%, 94%, 95%, 96%, 97%, 98%, or 99% identity to the mature polypeptide coding sequence of SEQ ID NO: 5 in WO 2013/148993; and
(iv) a beta-glucosidase encoded by a polynucleotide that hybridizes under at least high stringency conditions, e.g., very high stringency conditions, with the mature polypeptide coding sequence of SEQ ID NO: 5 in WO 2013/148993 or the full-length complement thereof.

In an embodiment the beta-glucosidase is a variant comprises a substitution at one or more (several) positions corresponding to positions 100, 283, 456, and 512 of the mature polypeptide of SEQ ID NO: 23 herein, wherein the variant has beta-glucosidase activity.

In an embodiment the parent beta-glucosidase of the variant is (a) a polypeptide comprising the mature polypeptide of SEQ ID NO: 23 herein; (b) a polypeptide having at least 80% sequence identity to the mature polypeptide of SEQ ID NO: 23 herein; (c) a polypeptide encoded by a polynucleotide that hybridizes under high or very high stringency conditions with (i) the mature polypeptide coding sequence of SEQ ID NO: 5 in WO 2013/148993, (ii) the cDNA sequence contained in the mature polypeptide coding sequence of SEQ ID NO: 5 in WO 2013/148993, or (iii) the full-length complementary strand of (i) or (ii); (d) a polypeptide encoded by a polynucleotide having at least 80% identity to the mature polypeptide coding sequence of SEQ ID NO: 5 in WO 2013/148993 or the cDNA sequence thereof; or (e) a fragment of the mature polypeptide of SEQ ID NO: 23 herein, which has beta-glucosidase activity.

In an embodiment the beta-glucosidase variant has at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, but less than 100%, sequence identity to the amino acid sequence of the parent beta-glucosidase.

In an embodiment the variant has at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, but less than 100% sequence identity to the mature polypeptide of SEQ ID NO: 23 herein.

In an embodiment the beta-glucosidase is from a strain of Aspergillus, such as a strain of Aspergillus fumigatus, such as Aspergillus fumigatus beta-glucosidase (SEQ ID NO: 23 herein), which comprises one or more substitutions selected from the group consisting of L89M, G91L, F100D, 1140V, 1186V, S283G, N456E, and F512Y; such as a variant thereof with the following substitutions:
F100D+S283G+N456E+F512Y;
L89M+G91L+1186V+1140V;
1186V+L89M+G91L+1140V+F100D+S283G+N456E+F512Y.

In an embodiment the number of substitutions is between 1 and 4, such as 1, 2, 3, or 4 substitutions.

In an embodiment the variant comprises a substitution at a position corresponding to position 100, a substitution at a position corresponding to position 283, a substitution at a position corresponding to position 456, and/or a substitution at a position corresponding to position 512.

In a preferred embodiment the beta-glucosidase variant comprises the following substitutions: Phe100Asp, Ser283Gly, Asn456Glu, Phe512Tyr in SEQ ID NO: 23 herein.

In a preferred embodiment the beta-glucosidase has a Relative ED50 loading value of less than 1.00, preferably less than 0.80, such as preferably less than 0.60, such as between 0.1-0.9, such as between 0.2-0.8, such as 0.30-0.70.

### GH61 Polypeptide Having Cellulolytic Enhancing Activity

The cellulolytic composition used according to the invention may in one embodiment comprise one or more GH61 polypeptide having cellulolytic enhancing activity. In one embodiment the enzyme composition comprises a GH61 polypeptide having cellulolytic enhancing activity, such as one derived from the genus Thermoascus, such as a strain of Thermoascus aurantiacus, such as the one described in WO 2005/074656 as SEQ ID NO: 2; or one derived from the genus Thielavia, such as a strain of Thielavia terrestris, such as the one described in WO 2005/074647 as SEQ ID NO: 7 and SEQ ID NO: 8; or one derived from a strain of Aspergillus, such as a strain of Aspergillus fumigatus, such as the one described in WO 2010/138754 as SEQ ID NO: 2; or one derived from a strain derived from Penicillium, such as a strain of Penicillium emersonii, such as the one disclosed in WO 2011/041397 or SEQ ID NO: 24 herein.

In an embodiment the Penicillium sp. GH61 polypeptide having cellulolytic enhancing activity or homolog thereof is selected from the group consisting of:
(i) a GH61 polypeptide having cellulolytic enhancing activity comprising the mature polypeptide of SEQ ID NO: 24 herein;
(ii) a GH61 polypeptide having cellulolytic enhancing activity comprising an amino acid sequence having at least 70%, e.g., 75%, 80%, 85%, 90%, 91%, 92%, 93%, 94%, 95%, 96%, 97%, 98%, or 99% identity to the mature polypeptide of SEQ ID NO: 24 herein;
(iii) a GH61 polypeptide having cellulolytic enhancing activity encoded by a polynucleotide comprising a nucleotide sequence having at least 70%, e.g., 75%, 80%, 85%, 90%, 91%, 92%, 93%, 94%, 95%, 96%, 97%, 98%, or 99% identity to the mature polypeptide coding sequence of SEQ ID NO: 7 in WO 2013/148993; and
(iv) a GH61 polypeptide having cellulolytic enhancing activity encoded by a polynucleotide that hybridizes under at least high stringency conditions, e.g., very high stringency conditions, with the mature polypeptide coding sequence of SEQ ID NO: 7 in WO 2013/148993 or the full-length complement thereof.

### Cellobiohydrolase I

The cellulolytic composition used according to the invention may in one embodiment may comprise one or more CBH I (cellobiohydrolase I). In one embodiment the cellulolytic composition comprises a cellobiohydrolase I (CBHI), such as one derived from a strain of the genus Aspergillus, such as a strain of Aspergillus fumigatus, such as the Ce17A CBHI disclosed in SEQ ID NO: 6 in WO 2011/057140 or SEQ ID NO: 21 herein, or a strain of the genus Trichoderma, such as a strain of Trichoderma reesei.

In an embodiment the Aspergillus fumigatus cellobiohydrolase I or homolog thereof is selected from the group consisting of:
(i) a cellobiohydrolase I comprising the mature polypeptide of SEQ ID NO: 21 herein;
(ii) a cellobiohydrolase I comprising an amino acid sequence having at least 70%, e.g., 75%, 80%, 85%, 90%, 91%, 92%, 93%, 94%, 95%, 96%, 97%, 98%, or 99% identity to the mature polypeptide of SEQ ID NO: 21 herein;
(iii) a cellobiohydrolase I encoded by a polynucleotide comprising a nucleotide sequence having at least 70%, e.g., 75%, 80%, 85%, 90%, 91%, 92%, 93%, 94%, 95%, 96%, 97%, 98%, or 99% identity to the mature polypeptide coding sequence of SEQ ID NO: 1 in WO 2013/148993; and
(iv) a cellobiohydrolase I encoded by a polynucleotide that hybridizes under at least high stringency conditions, e.g., very high stringency conditions, with the mature polypeptide coding sequence of SEQ ID NO: 1 in WO 2013/148993 or the full-length complement thereof.

### Cellobiohydrolase II

The cellulolytic composition used according to the invention may in one embodiment comprise one or more CBH II (cellobiohydrolase II). In one embodiment the cellobiohydrolase II (CBHII), such as one derived from a strain of the genus Aspergillus, such as a strain of Aspergillus fumigatus, such as the one in SEQ ID NO: 22 herein or a strain of the genus Trichoderma, such as Trichoderma reesei, or a strain of the genus Thielavia, such as a strain of Thielavia terrestris, such as cellobiohydrolase II CEL6A from Thielavia terrestris.

In an embodiment the Aspergillus fumigatus cellobiohydrolase II or homolog thereof is selected from the group consisting of:
(i) a cellobiohydrolase II comprising the mature polypeptide of SEQ ID NO: 22 herein;
(ii) a cellobiohydrolase II comprising an amino acid sequence having at least 70%, e.g., 75%, 80%, 85%, 90%, 91%, 92%, 93%, 94%, 95%, 96%, 97%, 98%, or 99% identity to the mature polypeptide of SEQ ID NO: 22 herein;
(iii) a cellobiohydrolase II encoded by a polynucleotide comprising a nucleotide sequence having at least 70%, e.g., 75%, 80%, 85%, 90%, 91%, 92%, 93%, 94%, 95%, 96%, 97%, 98%, or 99% identity to the mature polypeptide coding sequence of SEQ ID NO: 3 in WO 2013/148993; and
(iv) a cellobiohydrolase II encoded by a polynucleotide that hybridizes under at least high stringency conditions, e.g., very high stringency conditions, with the mature polypeptide coding sequence of SEQ ID NO: 3 in WO 2013/148993 or the full-length complement thereof.

### Cellulolytic Compositions

As mentioned above the cellulolytic composition may comprise a number of difference polypeptides, such as enzymes.

In an embodiment the cellulolytic composition comprises a Trichoderma reesei cellulolytic composition, further comprising Thermoascus aurantiacus GH61A polypeptide having cellulolytic enhancing activity (WO 2005/074656) and Aspergillus oryzae beta-glucosidase fusion protein (WO 2008/057637).

In another embodiment the cellulolytic composition comprises a Trichoderma reesei cellulolytic composition, further comprising Thermoascus aurantiacus GH61A polypeptide having cellulolytic enhancing activity (SEQ ID NO: 2 in WO 2005/074656) and Aspergillus fumigatus beta-glucosidase (SEQ ID NO: 2 of WO 2005/047499).

In another embodiment the cellulolytic composition comprises a Trichoderma reesei cellulolytic composition, further comprising Penicillium emersonii GH61A polypeptide having cellulolytic enhancing activity disclosed in WO 2011/041397, Aspergillus fumigatus beta-glucosidase (SEQ ID NO: 2 of WO 2005/047499) or a variant thereof with the following substitutions: F100D, S283G, N456E, F512Y.

The enzyme composition of the present invention may be in any form suitable for use, such as, for example, a crude fermentation broth with or without cells removed, a cell lysate with or without cellular debris, a semi-purified or purified enzyme composition, or a host cell, e.g., Trichoderma host cell, as a source of the enzymes.

The enzyme composition may be a dry powder or granulate, a non-dusting granulate, a liquid, a stabilized liquid, or a stabilized protected enzyme. Liquid enzyme compositions may, for instance, be stabilized by adding stabilizers such as a sugar, a sugar alcohol or another polyol, and/or lactic acid or another organic acid according to established processes.

In an preferred embodiment the cellulolytic composition comprising a beta-glucosidase having a Relative ED50 loading value of less than 1.00, preferably less than 0.80, such as preferably less than 0.60, such as between 0.1-0.9, such as between 0.2-0.8, such as 0.30-0.70.

In an embodiment, the cellulolytic enzyme composition is dosed (i.e. during saccharification in step ii) and/or fermentation in step iii) or SSF) from 0.0001-3 mg EP/g DS, preferably 0.0005-2 mg EP/g DS, preferably 0.001-1 mg/g DS, more preferred from 0.005-0.5 mg EP/g DS, even more preferred 0.01-0.1 mg EP/g DS.

Alpha-Amylase Present and/or Added During Liquefaction

According to the invention an alpha-amylase is present and/or added in liquefaction optionally together with a hemicellulase, an endoglucanase, a protease, a carbohydrate-source generating enzyme, such as a glucoamylase, a phospholipase, a phytase, and/or pullulanase.

The alpha-amylase added during liquefaction step i) may be any alpha-amylase. Preferred are bacterial alpha-amylases, such as especially Bacillus alpha-amylases, such as Bacillus stearothermophilus alpha-amylases, which are stable at temperature used during liquefaction.

### Bacterial Alpha-Amylase

The term “bacterial alpha-amylase” means any bacterial alpha-amylase classified under EC 3.2.1.1. A bacterial alpha-amylase used according to the invention may, e.g., be derived from a strain of the genus Bacillus, which is sometimes also referred to as the genus Geobacillus. In an embodiment the Bacillus alpha-amylase is derived from a strain of Bacillus amyloliquefaciens, Bacillus licheniformis, Bacillus stearothermophilus, Bacillus sp. TS-23, or Bacillus subtilis, but may also be derived from other Bacillus sp.

Specific examples of bacterial alpha-amylases include the Bacillus stearothermophilus alpha-amylase of SEQ ID NO: 3 in WO 99/19467 or SEQ ID NO: 25 herein, the Bacillus amyloliquefaciens alpha-amylase of SEQ ID NO: 5 in WO 99/19467, and the Bacillus licheniformis alpha-amylase of SEQ ID NO: 4 in WO 99/19467 and the Bacillus sp. TS-23 alpha-amylase disclosed as SEQ ID NO: 1 in WO 2009/061380 (all sequences are hereby incorporated by reference).

In an embodiment the bacterial alpha-amylase may be an enzyme having a degree of identity of at least 60%, e.g., at least 70%, at least 80%, at least 90%, at least 95%, at least 96%, at least 97%, at least 98% or at least 99% to any of the sequences shown in SEQ ID NOS: 3, 4 or 5, respectively, in WO 99/19467 and SEQ ID NO: 1 in WO 2009/061380.

In an embodiment the alpha-amylase may be an enzyme having a degree of identity of at least 60%, e.g., at least 70%, at least 80%, at least 90%, at least 91%, at least 92%, at least 93%, at least 94%, at least 95%, at least 96%, at least 97%, at least 98% or at least 99% to any of the sequences shown in SEQ ID NO: 3 in WO 99/19467 or SEQ ID NO: 25 herein.

In a preferred embodiment the alpha-amylase is derived from Bacillus stearothermophilus. The Bacillus stearothermophilus alpha-amylase may be a mature wild-type or a mature variant thereof. The mature Bacillus stearothermophilus alpha-amylases, or variant thereof, may be naturally truncated during recombinant production. For instance, the mature Bacillus stearothermophilus alpha-amylase may be truncated at the C-terminal so it is around 491 amino acids long (compared to SEQ ID NO: 3 in WO 99/19467 or SEQ ID NO: 25 herein), such as from 480-495 amino acids long.

The Bacillus alpha-amylase may also be a variant and/or hybrid. Examples of such a variant can be found in any of WO 96/23873, WO 96/23874, WO 97/41213, WO 99/19467, WO 00/60059, WO 02/10355 and WO2009/061380 (all documents are hereby incorporated by reference). Specific alpha-amylase variants are disclosed in U.S. Pat. Nos. 6,093,562, 6,187,576, 6,297,038, and 7,713,723 (hereby incorporated by reference) and include Bacillus stearothermophilus alpha-amylase (often referred to as BSG alpha-amylase) variants having a deletion of one or two amino acids at any of positions R179, G180, 1181 and/or G182, preferably the double deletion disclosed in WO 96/23873—see, e.g., page 20, lines 1-10 (hereby incorporated by reference), preferably corresponding to deletion of positions 1181 and G182 compared to the amino acid sequence of Bacillus stearothermophilus alpha-amylase set forth in SEQ ID NO: 3 disclosed in WO 99/19467 or SEQ ID NO:25 herein or the deletion of amino acids R179 and G180 using SEQ ID NO: 3 in WO 99/19467 or SEQ ID NO: 25 herein. Even more preferred are Bacillus alpha-amylases, especially Bacillus stearothermophilus (BSG) alpha-amylases, which have at one or two amino acid deletions corresponding to positions R179, G180, 1181 and G182, preferably which have a double deletion corresponding to R179 and G180, or preferably a deletion of positions 181 and 182 (denoted 1181*+G182*), and optionally further comprises a N193F substitution (denoted 1181*+G182*+N193F) compared to the wild-type BSG alpha-amylase amino acid sequence set forth in SEQ ID NO: 3 disclosed in WO 99/19467 or SEQ ID NO: 25 herein. The bacterial alpha-amylase may also have a substitution in a position corresponding to S239 in the Bacillus licheniformis alpha-amylase shown in SEQ ID NO: 4 in WO 99/19467, or a S242 variant in the Bacillus stearothermophilus alpha-amylase of SEQ ID NO: 3 in WO 99/19467 or SEQ ID NO: 25 herein.

In an embodiment the variant is a S242A, E or Q variant, preferably a S242Q or A variant, of the Bacillus stearothermophilus alpha-amylase (using SEQ ID NO: 25 herein for numbering).

In an embodiment the variant is a position E188 variant, preferably E188P variant of the Bacillus stearothermophilus alpha-amylase (using SEQ ID NO: 25 herein for numbering).

Other contemplated variant are Bacillus sp. TS-23 variant disclosed in WO2009/061380, especially variants defined in claim 1 of WO2009/061380 (hereby incorporated by reference).

### Bacterial Hybrid Alpha-Amylases

The bacterial alpha-amylase may also be a hybrid bacterial alpha-amylase, e.g., an alpha-amylase comprising 445 C-terminal amino acid residues of the Bacillus licheniformis alpha-amylase (shown in SEQ ID NO: 4 of WO 99/19467) and the 37 N-terminal amino acid residues of the alpha-amylase derived from Bacillus amyloliquefaciens (shown in SEQ ID NO: 5 of WO 99/19467). In a preferred embodiment this hybrid has one or more, especially all, of the following substitutions:
G48A+T491+G107A+H156Y+A181T+N190F+1201F+A209V+Q264S (using the Bacillus licheniformis numbering in SEQ ID NO: 4 of WO 99/19467). Also preferred are variants having one or more of the following mutations (or corresponding mutations in other Bacillus alpha-amylases): H154Y, A181T, N190F, A209V and Q264S and/or the deletion of two residues between positions 176 and 179, preferably the deletion of E178 and G179 (using SEQ ID NO: 5 of WO 99/19467 for position numbering).

In an embodiment the bacterial alpha-amylase is the mature part of the chimeric alpha-amylase disclosed in Richardson et al., 2002, The Journal of Biological Chemistry 277(29):. 267501-26507, referred to as BD5088 or a variant thereof. This alpha-amylase is the same as the one shown in SEQ ID NO: 2 in WO 2007134207. The mature enzyme sequence starts after the initial “Met” amino acid in position 1.

### Thermostable Alpha-Amylase

According to the invention the alpha-amylase is optionally used in combination with a hemicellulase, preferably xylanase, having a Melting Point (DSC) above 80 °C. Optionally an endoglucanase having a Melting Point (DSC) above 70 °C, such as above 75 °C, in particular above 80 °C may be included. The thermostable alpha-amylase, such as a bacterial an alpha-amylase, is preferably derived from Bacillus stearothermophilus or Bacillus sp. TS-23. In an embodiment the alpha-amylase has a T1/2 (min) at pH 4.5, 85 °C, 0.12 mM CaCl₂ of at least 10. In an embodiment the alpha-amylase has a T1/2 (min) at pH 4.5, 85 °C, 0.12 mM CaCl₂, of at least 15. In an embodiment the alpha-amylase has a T1/2 (min) at pH 4.5, 85 °C, 0.12 mM CaCl₂, of at least 20. In an embodiment the alpha-amylase has a T1/2 (min) at pH 4.5, 85 °C, 0.12 mM CaCl₂, of at least 25. In an embodiment the alpha-amylase has a T1/2 (min) at pH 4.5, 85 °C, 0.12 mM CaCl₂, of at least 30. In an embodiment the alpha-amylase has a T1/2 (min) at pH 4.5, 85 °C, 0.12 mM CaCl₂, of at least 40. In an embodiment the alpha-amylase has a T1/2 (min) at pH 4.5, 85 °C, 0.12 mM CaCl₂, of at least 50. In an embodiment the alpha-amylase has a T1/2 (min) at pH 4.5, 85 °C, 0.12 mM CaCl₂, of at least 60. In an embodiment the alpha-amylase has a T1/2 (min) at pH 4.5, 85 °C, 0.12 mM CaCl₂, between 10-70. In an embodiment the alpha-amylase has a T1/2 (min) at pH 4.5, 85 °C, 0.12 mM CaCl₂, between 15-70. In an embodiment the alpha-amylase has a T1/2 (min) at pH 4.5, 85 °C, 0.12 mM CaCl₂, between 20-70. In an embodiment the alpha-amylase has a T1/2 (min) at pH 4.5, 85 °C, 0.12 mM CaCl₂, between 25-70. In an embodiment the alpha-amylase has a T1/2 (min) at pH 4.5, 85 °C, 0.12 mM CaCl₂, between 30-70. In an embodiment the alpha-amylase has a T1/2 (min) at pH 4.5, 85 °C, 0.12 mM CaCl₂, between 40-70. In an embodiment the alpha-amylase has a T1/2 (min) at pH 4.5, 85 °C, 0.12 mM CaCl₂, between 50-70. In an embodiment the alpha-amylase has a T1/2 (min) at pH 4.5, 85 °C, 0.12 mM CaCl₂, between 60-70.

In an embodiment the alpha-amylase is a bacterial alpha-amylase, preferably derived from the genus Bacillus, especially a strain of Bacillus stearothermophilus, in particular the Bacillus stearothermophilus as disclosed in WO 99/19467 as SEQ ID NO: 3 or SEQ ID NO: 25 herein with one or two amino acids deleted at positions R179, G180, 1181 and/or G182, in particular with R179 and G180 deleted, or with 1181 and G182 deleted, with mutations in below list of mutations. In preferred embodiments the Bacillus stearothermophilus alpha-amylases have double deletion 1181+G182, and optional substitution N193F, optionally further comprising mutations selected from below list:

V59A + Q89R + G112D + E129V + K177L + R179E +
K220P + N224L + Q254S;
V59A + Q89R + E129V + K177L + R179E + H208Y +
K220P + N224L + Q254S;
V59A + Q89R + E129V + K177L + R179E + K220P +
N224L + Q254S + D269E + D281N;
V59A + Q89R + E129V + K177L + R179E + K220P +
N224L + Q254S + I270L;
V59A + Q89R + E129V + K177L + R179E + K220P +
N224L + Q254S + H274K;
V59A + Q89R + E129V + K177L + R179E + K220P +
N224L + Q254S + Y276F;
V59A + E129V + R157Y + K177L + R179E +
K220P + N224L + S242Q + Q254S;
V59A + E129V + K177L + R179E + H208Y + K220P +
N224L + S242Q + Q254S;
V59A + E129V + K177L + R179E + K220P +
N224L + S242Q + Q254S;
V59A + E129V + K177L + R179E + K220P + N224L +
S242Q + Q254S + H274K;
V59A + E129V + K177L + R179E + K220P + N224L +
S242Q + Q254S + Y276F;
V59A + E129V + K177L + R179E + K220P + N224L +
S242Q + Q254S + D281N;
V59A + E129V + K177L + R179E + K220P + N224L +
S242Q + Q254S + M284T;
V59A + E129V + K177L + R179E + K220P + N224L +
S242Q + Q254S + G416V;
V59A + E129V + K177L + R179E + K220P + N224L +
Q254S;
V59A + E129V + K177L + R179E + K220P + N224L +
Q254S + M284T;
A91L + M96I + E129V + K177L + R179E + K220P +
N224L + S242Q + Q254S;
E129V + K177L + R179E;
E129V + K177L + R179E + K220P + N224L + S242Q +
Q254S;
E129V + K177L + R179E + K220P + N224L + S242Q +
Q254S + Y276F + L427M;
E129V + K177L + R179E + K220P + N224L + S242Q +
Q254S + M284T;
E129V + K177L + R179E + K220P + N224L + S242Q +
Q254S + N376* + I377*;
E129V + K177L + R179E + K220P + N224L + Q254S;
E129V + K177L + R179E + K220P + N224L + Q254S +
M284T;
E129V + K177L + R179E + S242Q;
E129V + K177L + R179V + K220P + N224L + S242Q +
Q254S;
K220P + N224L + S242Q + Q254S;
M284V;
V59A + Q89R + E129V + K177L + R179E + Q254S +
M284V.

In an embodiment the alpha-amylase is selected from the group of Bacillus stearothermophilus alpha-amylase variants:
I181*+G182*;
I181*+G182*+N193F;
   preferably
I181*+G182*+E129V+K177L+R179E;
I181*+G182*+E129V+K177L+R179S;
I181*+G182*+N193F+E129V+K177L+R179E;
I181*+G182*+N193F+E129V+K177L+R179S;
181*+G182*+N193F+V59A+Q89R+E129V+K177L+R179E+H208Y+K220P+N224L+Q254S;
181*+G182*+N193F+V59A+Q89R+E129V+K177L+R179S+H208Y+K220P+N224L+Q254S;
I181*+G182*+N193F+V59A+Q89R+E129V+K177L+R179E+Q254S+M284V;
I181*+G182*+N193F+V59A+Q89R+E129V+K177L+R179S+Q254S+M284V; and
I181*+G182*+N193F+E129V+K177L+R179E+K220P+N224L+S242Q+Q254S (using SEQ ID NO: 25 herein for numbering).

In an embodiment the bacterial alpha-amylase, such as Bacillus alpha-amylase, such as Bacillus stearothermophilus alpha-amylase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO:25 herein.

In an embodiment the bacterial alpha-amylase variant, such as Bacillus alpha-amylase variant, such as Bacillus stearothermophilus alpha-amylase variant has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, but less than 100% identity to the mature part of the polypeptide of SEQ ID NO: 25 herein.

It should be understood that when referring to Bacillus stearothermophilus alpha-amylase and variants thereof they are normally produced naturally in truncated form. In particular, the truncation may be so that the Bacillus stearothermophilus alpha-amylase shown in SEQ ID NO: 3 in WO 99/19467 or SEQ ID NO: 25 herein, or variants thereof, are truncated in the C-terminal and are typically around 491 amino acids long, such as from 480-495 amino acids long.

Thermostable Hemicellulase Present and/or Added During Liquefaction

According to the invention an optional hemicellulase, preferably xylanase, having a Melting Point (DSC) above 80 °C is present and/or added to liquefaction step i) in combination with an alpha-amylase, such as a bacterial alpha-amylase (described above).

The thermostability of a hemicellulase, preferably xylanase may be determined as described in the “Materials & Methods”-section of WO2017/112540 (which is incorporated herein by reference in its entirety for the teachings pertaining to thermostable hemicellulases and endoglucanases) under the headings “Determination of T_{d} by Differential Scanning Calorimetry for Endoglucanases and Hemicellulases”.

In an embodiment the hemicellulase, in particular xylanase, especially GH10 or GH11 xylanase has a Melting Point (DSC) above 82 °C, such as above 84 °C, such as above 86 °C, such as above 88 °C, such as above 88 °C, such as above 90 °C, such as above 92 °C, such as above 94 °C, such as above 96 °C, such as above 98 °C, such as above 100 °C, such as between 80 °C and 110 °C, such as between 82 °C and 110 °C, such as between 84 °C and 110 °C.

In a preferred embodiment the hemicellulase, in particular xylanase, especially GH10 xylanase has at least 60%, such as at least 70%, such as at least 75%, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 26 herein, preferably derived from a strain of the genus Dictyoglomus, such as a strain of Dictyoglomus thermophilum.

In a preferred embodiment the hemicellulase, in particular xylanase, especially GH11 xylanase has at least 60%, such as at least 70%, such as at least 75%, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 27 herein, preferably derived from a strain of the genus Dictyoglomus, such as a strain of Dictyoglomus thermophilum.

In a preferred embodiment the hemicellulase, in particular xylanase, especially GH10 xylanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 28 herein, preferably derived from a strain of the genus Rasamsonia, such as a strain of Rasomsonia byssochlamydoides.

In a preferred embodiment the hemicellulase, in particular xylanase, especially GH10 xylanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 29 herein, preferably derived from a strain of the genus Talaromyces, such as a strain of Talaromyces leycettanus.

In a preferred embodiment the hemicellulase, in particular xylanase, especially GH10 xylanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 30 herein, preferably derived from a strain of the genus Aspergillus, such as a strain of Aspergillus fumigatus.

In a preferred embodiment the hemicellulase, in particular xylanase, especially GH10 xylanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the amino acids 20 to 407 of SEQ ID NO: 45 herein, preferably derived from a strain of the genus Penicillium, such as a strain of Penicillium funiculosum.

Thermostable Endoglucanase Present and/or Added During Liquefaction

According to the invention an optional endoglucanase (“E”) having a Melting Point (DSC) above 70 °C, such as between 70 °C and 95 °C may be present and/or added in liquefaction step i) in combination with an alpha-amylase, such as a thermostable bacterial alpha-amylase and an optional hemicellulase, preferably xylanase, having a Melting Point (DSC) above 80 °C.

The thermostability of an endoglucanase may be determined as described in the “Materials & Methods”-section of WO 2017/112540 (incorporated herein by reference in its entirety) under the heading “Determination of T_{d} by Differential Scanning Calorimetry for Endoglucanases and Hemicellulases”.

In an embodiment the endoglucanase has a Melting Point (DSC) above 72 °C, such as above 74 °C, such as above 76 °C, such as above 78 °C, such as above 80 °C, such as above 82 °C, such as above 84 °C, such as above 86 °C, such as above 88 °C, such as between 70 °C and 95 °C, such as between 76 °C and 94 °C, such as between 78 °C and 93 °C, such as between 80 °C and 92 °C, such as between 82 °C and 91 °C, such as between 84 °C and 90 °C.

In a preferred embodiment the endogluconase used in a process of the invention or comprised in a composition of the invention is a Glycoside Hydrolase Family 5 endoglucanase or GH5 endoglucanase (see the CAZy database on the “www.cazy.org” webpage.

In an embodiment the GH5 endoglucanase is from family EG II, such as the Talaromyces leycettanus endoglucanase shown in SEQ ID NO: 31 herein; Penicillium capsulatum endoglucanase shown in SEQ ID NO: 32 herein, and Trichophaea saccata endoglucanase shown in SEQ ID NO: 33 herein.

In an embodiment the endoglucanase is a family GH45 endoglucanase. In an embodiment the GH45 endoglucanase is from family EG V, such as the Sordaria fimicola shown in SEQ ID NO: 34 herein or the Thielavia terrestris endoglucanase shown in SEQ ID NO: 35 herein.

In an embodiment the endoglucanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 31 herein. In an embodiment the endoglucanase is derived from a strain of the genus Talaromyces, such as a strain of Talaromyces leycettanus.

In an embodiment the endoglucanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 32 herein, preferably derived from a strain of the genus Penicillium, such as a strain of Penicillium capsulatum.

In an embodiment the endoglucanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 33 herein, preferably derived from a strain of the genus Trichophaea, such as a strain of Trichophaea saccata.

In an embodiment the endoglucanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 34 herein, preferably derived from a strain of the genus Sordaria, such as a strain of Sordaria fimicola.

In an embodiment the endoglucanase has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, such as 100% identity to the mature part of the polypeptide of SEQ ID NO: 35 herein, preferably derived from a strain of the genus Thielavia, such as a strain of Thielavia terrestris.

In an embodiment the endoglucanase is added in liquefaction step i) at a dose from 1-10,000 μg EP (Enzymes Protein)/g DS), such as 10-1,000 μg EP/g DS.

Carbohydrate-Source Generating Enzyme Present and/or Added During Liquefaction

According to the invention an optional carbohydrate-source generating enzyme, in particular a glucoamylase, preferably a thermostable glucoamylase, may be present and/or added in liquefaction together with an alpha-amylase and optional hemicellulase, preferably xylanase, having a Melting Point (DSC) above 80 °C, and an optional endoglucanase having a Melting Point (DSC) above 70 °C, and an optional a pullulanase and/or optional phytase.

The term “carbohydrate-source generating enzyme” includes any enzymes generating fermentable sugars. A carbohydrate-source generating enzyme is capable of producing a carbohydrate that can be used as an energy-source by the fermenting organism(s) in question, for instance, when used in a process of the invention for producing a fermentation product, such as ethanol. The generated carbohydrates may be converted directly or indirectly to the desired fermentation product, preferably ethanol. According to the invention a mixture of carbohydrate-source generating enzymes may be used. Specific examples include glucoamylase (being glucose generators), beta-amylase and maltogenic amylase (being maltose generators).

In a preferred embodiment the carbohydrate-source generating enzyme is thermostable. The carbohydrate-source generating enzyme, in particular thermostable glucoamylase, may be added together with or separately from the alpha-amylase and the thermostable protease.

In a specific and preferred embodiment the carbohydrate-source generating enzyme is a thermostable glucoamylase, preferably of fungal origin, preferably a filamentous fungi, such as from a strain of the genus Penicillium, especially a strain of Penicillium oxalicum, in particular the Penicillium oxalicum glucoamylase disclosed as SEQ ID NO: 2 in WO 2011/127802 (which is hereby incorporated by reference) and shown in SEQ ID NO: 36 herein.

In an embodiment the thermostable glucoamylase has at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99% or 100% identity to the mature polypeptide shown in SEQ ID NO: 2 in WO 2011/127802 or SEQ ID NOs: 23 herein.

In an embodiment the carbohydrate-source generating enzyme, in particular thermostable glucoamylase, is the Penicillium oxalicum glucoamylase shown in SEQ ID NO: 36 herein.

In a preferred embodiment the carbohydrate-source generating enzyme is a variant of the Penicillium oxalicum glucoamylase disclosed as SEQ ID NO: 2 in WO 2011/127802 and shown in SEQ ID NO: 36 herein, having a K79V substitution (referred to as “PE001”) (using the mature sequence shown in SEQ ID NO: 8 for numbering). The K79V glucoamylase variant has reduced sensitivity to protease degradation relative to the parent as disclosed in WO 2013/036526 (which is hereby incorporated by reference).

Contemplated Penicillium oxalicum glucoamylase variants are disclosed in WO 2013/053801 (which is hereby incorporated by reference).

In an embodiment these variants have reduced sensitivity to protease degradation.

In an embodiment these variant have improved thermostability compared to the parent.

More specifically, in an embodiment the glucoamylase has a K79V substitution (using SEQ ID NO: 36 herein for numbering), corresponding to the PE001 variant, and further comprises at least one of the following substitutions or combination of substitutions: T65A; Q327F; E501V; Y504T; Y504*; T65A+Q327F; T65A+E501V; T65A+Y504T; T65A+Y504*; Q327F+E501V; Q327F+Y504T; Q327F+Y504*; E501V+Y504T; E501V+Y504*; T65A+Q327F+E501V; T65A+Q327F+Y504T; T65A+E501V+Y504T; Q327F+E501V+Y504T; T65A+Q327F+Y504*; T65A+E501V+Y504*; Q327F+E501V+Y504*; T65A+Q327F+E501V+Y504T; T65A+Q327F+E501V+Y504*; E501V+Y504T; T65A+K161S; T65A+Q405T; T65A+Q327W; T65A+Q327F; T65A+Q327Y; P11F+T65A+Q327F; R1K+D3W+K5Q+G7V+N8S+T10K+P11S+T65A+Q327F; P2N+P4S+P11F+T65A+Q327F; P11F+D26C+K33C+T65A+Q327F; P2N+P4S+P11F+T65A+Q327W+E501V+Y504T; R1E+D3N+P4G+G6R+G7A+N8A+T10D+P11D+T65A+Q327F; P11F+T65A+Q327W; P2N+P4S+P11F+T65A+Q327F+E501V+Y504T; P11F+T65A+Q327W+E501V+Y504T; T65A+Q327F+E501V+Y504T; T65A+S105P+Q327W; T65A+S105P+Q327F; T65A+Q327W+S364P; T65A+Q327F+S364P; T65A+S103N+Q327F; P2N+P4S+P11F+K34Y+T65A+Q327F; P2N+P4S+P11F+T65A+Q327F+D445N+V447S; P2N+P4S+P11F+T65A+1172V+Q327F; P2N+P4S+P11F+T65A+Q327F+N502*; P2N+P4S+P11F+T65A+Q327F+N502T+P563S+K571E; P2N+P4S+P11F+R31S+K33V+T65A+Q327F+N564D+K571S; P2N+P4S+P11F+T65A+Q327F+S377T; P2N+P4S+P11F+T65A+V325T+Q327W; P2N+P4S+P11F+T65A+Q327F+D445N+V447S+E501V+Y504T; P2N+P4S+P11F+T65A+1172V+Q327F+E501V+Y504T; P2N+P4S+P11F+T65A+Q327F+S377T+E501V+Y504T; P2N+P4S+P11F+D26N+K34Y+T65A+Q327F; P2N+P4S+P11F+T65A+Q327F+1375A+E501V+Y504T; P2N+P4S+P11F+T65A+K218A+K221D+Q327F+E501V+Y504T; P2N+P4S+P11F+T65A+S103N+Q327F+E501V+Y504T; P2N+P4S+T10D+T65A+Q327F+E501V+Y504T; P2N+P4S+F12Y+T65A+Q327F+E501V+Y504T; K5A+P11F+T65A+Q327F+E501V+Y504T; P2N+P4S+T10E+E18N+T65A+Q327F+E501V+Y504T; P2N+T10E+E18N+T65A+Q327F+E501V+Y504T; P2N+P4S+P11F+T65A+Q327F+E501V+Y504T+T568N; P2N+P4S+P11F+T65A+Q327F+E501V+Y504T+K524T+G526A; P2N+P4S+P11F+K34Y+T65A+Q327F+D445N+V447S+E501V+Y504T; P2N+P4S+P11F+R31S+K33V+T65A+Q327F+D445N+V447S+E501V+Y504T; P2N+P4S+P11F+D26N+K34Y+T65A+Q327F+E501V+Y504T; P2N+P4S+P11F+T65A+F80*+Q327F+E501V+Y504T; P2N+P4S+P11F+T65A+K112S+Q327F+E501V+Y504T; P2N+P4S+P11F+T65A+Q327F+E501V+Y504T+T516P+K524T+G526A; P2N+P4S+P11F+T65A+Q327F+E501V+N502T+Y504*; P2N+P4S+P11F+T65A+Q327F+E501V+Y504T; P2N+P4S+P11F+T65A+S103N+Q327F+E501V+Y504T; K5A+P11F+T65A+Q327F+E501V+Y504T; P2N+P4S+P11F+T65A+Q327F+E501V+Y504T+T516P+K524T+G526A; P2N+P4S+P11F+T65A+V79A+Q327F+E501V+Y504T; P2N+P4S+P11F+T65A+V79G+Q327F+E501V+Y504T; P2N+P4S+P11F+T65A+V791+Q327F+E501V+Y504T; P2N+P4S+P11F+T65A+V79L+Q327F+E501V+Y504T; P2N+P4S+P11F+T65A+V79S+Q327F+E501V+Y504T; P2N+P4S+P11F+T65A+L72V+Q327F+E501V+Y504T; S255N+Q327F+E501V+Y504T; P2N+P4S+P11F+T65A+E74N+Q327F+E501V+Y504T; P2N+P4S+P11F+T65A+G220N+Q327F+E501V+Y504T; P2N+P4S+P11F+T65A+Y245N+Q327F+E501V+Y504T; P2N+P4S+P11F+T65A+Q253N+Q327F+E501V+Y504T; P2N+P4S+P11F+T65A+D279N+Q327F+E501V+Y504T; P2N+P4S+P11F+T65A+Q327F+S359N+E501V+Y504T; P2N+P4S+P11F+T65A+Q327F+D370N+E501V+Y504T; P2N+P4S+P11F+T65A+Q327F+V460S+E501V+Y504T; P2N+P4S+P11F+T65A+Q327F+V460T+P468T+E501V+Y504T; P2N+P4S+P11F+T65A+Q327F+T463N+E501V+Y504T; P2N+P4S+P11F+T65A+Q327F+S465N+E501V+Y504T; or P2N+P4S+P11F+T65A+Q327F+T477N+E501V+Y504T.

In a preferred embodiment the Penicillium oxalicum glucoamylase variant has a K79V substitution using SEQ ID NO: 23 herein for numbering (PE001 variant), and further comprises one of the following mutations:
P11F+T65A+Q327F;
P2N+P4S+P11F+T65A+Q327F;
P11F+D26C+K33C+T65A+Q327F;
P2N+P4S+P11F+T65A+Q327W+E501V+Y504T;
P2N+P4S+P11F+T65A+Q327F+E501V+Y504T; or
P11F+T65A+Q327W+E501V+Y504T.

In an embodiment the glucoamylase variant, such as Penicillium oxalicum glucoamylase variant has at least 60%, such as at least 70%, such as at least 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, but less than 100% identity to the mature polypeptide of SEQ ID NO: 36 herein.

The carbohydrate-source generating enzyme, in particular glucoamylase, may be added in amounts from 0.1-100 micrograms EP/g DS, such as 0.5-50 micrograms EP/g DS, such as 1-25 micrograms EP/g DS, such as 2-12 micrograms EP/g DS.

Pullulanase Present and/or Added During Liquefaction

Optionally a pullulanase may be present and/or added during liquefaction step i) together with an alpha-amylase and an optional hemicellulase, preferably xylanase, having a melting point (DSC) above 80 °C. As mentioned above a protease, a carbohydrate-source generating enzyme, preferably a thermostable glucoamylase, may also optionally be present and/or added during liquefaction step i).

The pullulanase may be present and/or added during liquefaction step i) and/or saccharification step ii) or simultaneous saccharification and fermentation.

Pullulanases (E.C. 3.2.1.41, pullulan 6-glucano-hydrolase), are debranching enzymes characterized by their ability to hydrolyze the alpha-1,6-glycosidic bonds in, for example, amylopectin and pullulan.

Contemplated pullulanases according to the present invention include the pullulanases from Bacillus amyloderamificans disclosed in U.S. Pat. No. 4,560,651 (hereby incorporated by reference), the pullulanase disclosed as SEQ ID NO: 2 in WO 01/151620 (hereby incorporated by reference), the Bacillus deramificans disclosed as SEQ ID NO: 4 in WO 01/151620 (hereby incorporated by reference), and the pullulanase from Bacillus acidopullulyticus disclosed as SEQ ID NO: 25 in WO 01/151620 (hereby incorporated by reference) and also described in FEMS Mic. Let. (1994) 115, 97-106.

Additional pullulanases contemplated according to the present invention included the pullulanases from Pyrococcus woesei, specifically from Pyrococcus woesei DSM No. 3773 disclosed in WO 92/02614.

In an embodiment the pullulanase is a family GH57 pullulanase. In an embodiment the pullulanase includes an X47 domain as disclosed in WO 2011/087836 (which are hereby incorporated by reference). More specifically the pullulanase may be derived from a strain of the genus Thermococcus, including Thermococcus litoralis and Thermococcus hydrothermalis, such as the Thermococcus hydrothermalis pullulanase shown WO 2011/087836 truncated at the X4 site right after the X47 domain. The pullulanase may also be a hybrid of the Thermococcus litoralis and Thermococcus hydrothermalis pullulanases or a T. hydrothermalis/T. litoralis hybrid enzyme with truncation site X4 disclosed in WO 2011/087836 (which is hereby incorporated by reference).

In another embodiment the pullulanase is one comprising an X46 domain disclosed in WO 2011/076123 (Novozymes).

The pullulanase may according to the invention be added in an effective amount which include the preferred amount of about 0.0001-10 mg enzyme protein per gram DS, preferably 0.0001-0.10 mg enzyme protein per gram DS, more preferably 0.0001-0.010 mg enzyme protein per gram DS. Pullulanase activity may be determined as NPUN. An Assay for determination of NPUN is described in the “Materials & Methods”-section below.

Suitable commercially available pullulanase products include PROMOZYME 400L, PROMOZYME™ D2 (Novozymes A/S, Denmark), OPTIMAX L-300 (Genencor Int., USA), and AMANO 8 (Amano, Japan).

Phytase Present and/or Added During Liquefaction

Optionally a phytase may be present and/or added in liquefaction in combination with an alpha-amylase and optional hemicellulase, preferably xylanase, having a melting point (DSC) above 80 °C.

A phytase used according to the invention may be any enzyme capable of effecting the liberation of inorganic phosphate from phytic acid (myo-inositol hexakisphosphate) or from any salt thereof (phytates). Phytases can be classified according to their specificity in the initial hydrolysis step, viz. according to which phosphate-ester group is hydrolyzed first. The phytase to be used in the invention may have any specificity, e.g., be a 3-phytase (EC 3.1.3.8), a 6-phytase (EC 3.1.3.26) or a 5-phytase (no EC number). In an embodiment the phytase has a temperature optimum above 50 °C, such as in the range from 50-90 °C.

The phytase may be derived from plants or microorganisms, such as bacteria or fungi, e.g., yeast or filamentous fungi.

A plant phytase may be from wheat-bran, maize, soy bean or lily pollen. Suitable plant phytases are described in Thomlinson et al, Biochemistry, 1 (1962), 166-171; Barrientos et al, Plant. Physiol., 106 (1994), 1489-1495; WO 98/05785; WO 98/20139.

A bacterial phytase may be from genus Bacillus, Citrobacter, Hafnia, Pseudomonas, Buttiauxella or Escherichia, specifically the species Bacillus subtilis, Citrobacter braakii, Citrobacter freundii, Hafnia alvei, Buttiauxella gaviniae, Buttiauxella agrestis, Buttiauxella noackies and E. coli. Suitable bacterial phytases are described in Paver and Jagannathan, 1982, Journal of Bacteriology 151:1102-1108; Cosgrove, 1970, Australian Journal of Biological Sciences 23:1207-1220; Greiner et al, Arch. Biochem. Biophys., 303, 107-113, 1993; WO 1997/33976; WO 1997/48812, WO 1998/06856, WO 1998/028408, WO 2004/085638, WO 2006/037327, WO 2006/038062, WO 2006/063588, WO 2008/092901, WO 2008/116878, and WO 2010/034835.

A yeast phytase may be derived from genus Saccharomyces or Schwanniomyces, specifically species Saccharomyces cerevisiae or Schwanniomyces occidentalis. The former enzyme has been described as a Suitable yeast phytases are described in Nayini et al, 1984, Lebensmittel Wissenschaft und Technologie 17:24-26; Wodzinski et al, Adv. Appl. Microbiol., 42, 263-303; AU-A-24840/95; Phytases from filamentous fungi may be derived from the fungal phylum of Ascomycota (ascomycetes) or the phylum Basidiomycota, e.g., the genus Aspergillus, Thermomyces (also called Humicola), Myceliophthora, Manascus, Penicillium, Peniophora, Agrocybe, Paxillus, or Trametes, specifically the species Aspergillus terreus, Aspergillus niger, Aspergillus niger var. awamori, Aspergillus ficuum, Aspergillus fumigatus, Aspergillus oryzae, T. lanuginosus (also known as H. lanuginosa), Myceliophthora thermophila, Peniophora lycii, Agrocybe pediades, Manascus anka, Paxillus involtus, or Trametes pubescens. Suitable fungal phytases are described in Yamada et al., 1986, Agric. Biol. Chem. 322:1275-1282; Piddington et al., 1993, Gene 133:55-62; EP 684,313; EP 0 420 358; EP 0 684 313; WO 1998/28408; WO 1998/28409; JP 7-67635; WO 1998/44125; WO 1997/38096; WO 1998/13480.

In a preferred embodiment the phytase is derived from Buttiauxella, such as Buttiauxella gaviniae, Buttiauxella agrestis, or Buttiauxella noackies, such as the ones disclosed as SEQ ID NO: 2, SEQ ID NO: 4 and SEQ ID NO: 6, respectively, in WO 2008/092901 (hereby incorporated by reference).

In a preferred embodiment the phytase is derived from Citrobacter, such as Citrobacter braakii, such as one disclosed in WO 2006/037328 (hereby incorporated by reference).

Modified phytases or phytase variants are obtainable by methods known in the art, in particular by the methods disclosed in EP 897010; EP 897985; WO 99/49022; WO 99/48330, WO 2003/066847, WO 2007/112739, WO 2009/129489, and WO 2010/034835.

Commercially available phytase containing products include BIO-FEED PHYTASE™ PHYTASE NOVO™ CT or L (all from Novozymes), LIQMAX (DuPont) or RONOZYME™ NP, RONOZYME® HiPhos, RONOZYME® P5000 (CT), NATUPHOS™ NG 5000 (from DSM).

Carbohydrate-Source Generating Enzyme Present and/or Added During Saccharification and/or Fermentation

According to the invention a carbohydrate-source generating enzyme, preferably a glucoamylase, is present and/or added during saccharification and/or fermentation.

In a preferred embodiment the carbohydrate-source generating enzyme is a glucoamylase, of fungal origin, preferably from a stain of Aspergillus, preferably A. niger, A. awamori, or A. oryzae; or a strain of Trichoderma, preferably T. reesei; or a strain of Talaromyces, preferably T. emersonii,

### Glucoamylase

According to the invention the glucoamylase present and/or added during saccharification and/or fermentation may be derived from any suitable source, e.g., derived from a microorganism or a plant. Preferred glucoamylases are of fungal or bacterial origin, selected from the group consisting of Aspergillus glucoamylases, in particular Aspergillus niger G1 or G2 glucoamylase (Boel et al. (1984), EMBO J. 3 (5), p. 1097-1102), or variants thereof, such as those disclosed in WO 92/00381, WO 00/04136 and WO 01/04273 (from Novozymes, Denmark); the A. awamori glucoamylase disclosed in WO 84/02921, Aspergillus oryzae glucoamylase (Agric. Biol. Chem. (1991), 55 (4), p. 941-949), or variants or fragments thereof. Other Aspergillus glucoamylase variants include variants with enhanced thermal stability: G137A and G139A (Chen et al. (1996), Prot. Eng. 9, 499-505); D257E and D293E/Q (Chen et al. (1995), Prot. Eng. 8, 575-582); N182 (Chen et al. (1994), Biochem. J. 301, 275-281); disulphide bonds, A246C (Fierobe et al. (1996), Biochemistry, 35, 8698-8704; and introduction of Pro residues in position A435 and S436 (Li et al. (1997), Protein Eng. 10, 1199-1204.

Other glucoamylases include Athelia rolfsii (previously denoted Corticium rolfsii) glucoamylase (see U.S. Pat. No. 4,727,026 and (Nagasaka et al. (1998) “Purification and properties of the raw-starch-degrading glucoamylases from Corticium rolfsii, Appl Microbiol Biotechnol 50:323-330), Talaromyces glucoamylases, in particular derived from Talaromyces emersonii (WO 99/28448), Talaromyces leycettanus (US patent no. Re. 32,153), Talaromyces duponti, Talaromyces thermophilus (U.S. Pat. No. 4,587,215). In a preferred embodiment the glucoamylase used during saccharification and/or fermentation is the Talaromyces emersonii glucoamylase disclosed in WO 99/28448.

Contemplated fungal glucoamylases include particularly glucoamylases derived from Talaromyces, preferably T. emersonii, or a strain of Trametes, preferably Trametes cingulata, or a strain of Pycnoporus, or a strain of Gloeophyllum, such as a strain of Gloeophyllum sepiarium or Gloeophyllum trabeum or a strain of the Nigrofomes.

In one embodiment the glucoamylase is derived from a strain of the genus Trametes, in particular a strain of Trametes cingulata, disclosed in WO 2006/069289 or in SEQ ID NO: 48 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity.

In one embodiment the glucoamylase is derived from a strain of the genus Talaromyces, in particular a strain of Talaromyces emersonii disclosed in SEQ ID NO: 49 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity.

In another embodiment the glucoamylase is derived from a strain of the genus Pycnoporus, in particular a strain of Pycnoporus sanguineus as described in WO 2011/066576 (SEQ ID NOs 2, 4 or 6) or SEQ ID NO: 50 herein, or from a strain of the genus Gloeophyllum, such as a strain of Gloeophyllum sepiarium or Gloeophyllum trabeum, in particular a strain of Gloeophyllum as described in WO 2011/068803 (SEQ ID NO: 2, 4, 6, 8, 10, 12, 14 or 16).

In an embodiment, the glucoamylase is the Pycnoporus sanguineus glucoamylase of SEQ ID NO: 50 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 50, which has glucoamylase activity.

In an embodiment, the glucoamylase is the Gloeophyllum sepiarium glucoamylase of SEQ ID NO: 51 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 51, which has glucoamylase activity.

In an embodiment, the glucoamylase is the Gloeophyllum trabeum glucoamylase of SEQ ID NO: 52 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 52, which has glucoamylase activity.

In an embodiment the glucoamylase is derived from a strain of the genus Nigrofomes, in particular a strain of Nigrofomes sp. disclosed in WO 2012/064351 as SEQ ID NO: 2. Contemplated are also glucoamylases which exhibit a high identity to any of the above mentioned glucoamylases, i.e., at least 70%, at least 75%, at least 80%, at least 85%, at least 90%, at least 95%, at least 96%, at least 97%, at least 98%, at least 99% or even 100% identity to any one of the mature parts of the enzyme sequences mentioned above, such as any of SEQ ID NOs: 48, 49, 50, 51, or 52 herein.

Glucoamylases may in an embodiment be added to the saccharification and/or fermentation in an amount of 0.0001-20 AGU/g DS, preferably 0.001-10 AGU/g DS, especially between 0.01-5 AGU/g DS, such as 0.1-2 AGU/g DS.

In an embodiment the glucoamylase is added as a blend further comprising an alpha-amylase. In a preferred embodiment the alpha-amylase is a fungal alpha-amylase, especially an acid fungal alpha-amylase. The alpha-amylase is typically a side activity.

In an embodiment the glucoamylase is a blend comprising Talaromyces emersonii glucoamylase disclosed in WO 99/28448 as SEQ ID NO: 7 or SEQ ID NO: 49 herein and Trametes cingulata glucoamylase disclosed in WO 06/069289 and SEQ ID NO: 48 herein.

In an embodiment the glucoamylase is a blend comprising: (i) the Talaromyces emersonii glucoamylase of SEQ ID NO: 49 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity; and (ii) the Trametes cingulata glucoamylase of SEQ ID NO: 48 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity.

In an embodiment the glucoamylase is a blend comprising Talaromyces emersonii glucoamylase disclosed SEQ ID NO: 49, Trametes cingulata glucoamylase disclosed as SEQ ID NO: 48, and Rhizomucor pusillus alpha-amylase with Aspergillus niger glucoamylase linker and SBD disclosed as V039 in Table 5 in WO 2006/069290 and as SEQ ID NO: 39 herein, preferably with the following substitutions: G128D+D143N.

In an embodiment the glucoamylase is a blend comprising: (i) the Talaromyces emersonii glucoamylase of SEQ ID NO: 49 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity; (ii) the Trametes cingulata glucoamylase of SEQ ID NO: 48 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity; and (iii) the Rhizomucor pusillus alpha-amylase with Aspergillus niger glucoamylase linker and SBD of SEQ ID NO: 39 herein, preferably with the following substitutions: G128D+D143N, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.

In an embodiment the glucoamylase is a blend comprising Gloeophyllum sepiarium glucoamylase shown as SEQ ID NO: 2 in WO 2011/068803 (SEQ ID NO: 51 herein) and Rhizomucor pusillus with an Aspergillus niger glucoamylase linker and starch-binding domain (SBD), disclosed SEQ ID NO: 3 in WO 2013/006756 (SEQ ID NO: 39 herein) with the following substitutions: G128D+D143N.

In an embodiment, the glucoamylase is a blend comprising: (i) the Gloeophyllum sepiarium glucoamylase of SEQ ID NO: 51 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 51, which has glucoamylase activity; and (ii) the Rhizomucor pusillus alpha-amylase with Aspergillus niger glucoamylase linker and SBD of SEQ ID NO: 39 herein, preferably with the following substitutions: G128D+D143N, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.

In an embodiment the Rhizomucor pusillus alpha-amylase or the Rhizomucor pusillus alpha-amylase with an Aspergillus niger glucoamylase linker and starch-binding domain (SBD) has at least one of the following substitutions or combinations of substitutions: D165M; Y141W; Y141R; K136F; K192R; P224A; P224R; S123H+Y141W; G20S+Y141W; A76G+Y141W; G128D+Y141W; G128D+D143N; P219C+Y141W; N142D+D143N; Y141W+K192R; Y141W+D143N; Y141W+N383R; Y141W+P219C+A265C; Y141W+N142D+D143N; Y141W+K192R V410A; G128D+Y141W+D143N; Y141W+D143N+P219C; Y141W+D143N+K192R; G128D+D143N+K192R; Y141W+D143N+K192R+P219C; G128D+Y141W+D143N+K192R; or G128D+Y141W+D143N+K192R+P219C (using SEQ ID NO: 3 in WO 2013/006756 for numbering).

Commercially available compositions comprising glucoamylase include AMG 200L; AMG 300 L; SAN™ SUPER, SAN™ EXTRA L, SPIRIZYME™ PLUS, SPIRIZYME™ FUEL, SPIRIZYME™ B4U, SPIRIZYME™ ULTRA, SPIRIZYME™ EXCEL, SPIRIZYME ACHIEVE and AMG™ E (from Novozymes A/S); OPTIDEX™ 300, GC480, GC417 (from DuPont-Genencor); AMIGASE™ and AMIGASE™ PLUS (from DSM); G-ZYME™ G900, G-ZYME™ and G990 ZR (from DuPont-Genencor).

### Maltogenic Amylase

The carbohydrate-source generating enzyme present and/or added during saccharification and/or fermentation may also be a maltogenic alpha-amylase. A “maltogenic alpha-amylase” (glucan 1,4-alpha-maltohydrolase, E.C. 3.2.1.133) is able to hydrolyze amylose and amylopectin to maltose in the alpha-configuration. A maltogenic amylase from Bacillus stearothermophilus strain NCIB 11837 is commercially available from Novozymes A/S. Maltogenic alpha-amylases are described in U.S. Pat. Nos. 4,598,048, 4,604,355 and 6,162,628, which are hereby incorporated by reference. The maltogenic amylase may in a preferred embodiment be added in an amount of 0.05-5 mg total protein/gram DS or 0.05-5 MANU/g DS.

Protease Present and/or Added During Liquefaction

In an embodiment of the invention an optional protease, such as a thermostable protease, may be present and/or added in liquefaction together with an alpha-amylase, such as a thermostable alpha-amylase, and a hemicellulase, preferably xylanase, having a melting point (DSC) above 80 °C, and optionally an endoglucanase, a carbohydrate-source generating enzyme, in particular a glucoamylase, optionally a pullulanase and/or optionally a phytase.

Proteases are classified on the basis of their catalytic mechanism into the following groups: Serine proteases (S), Cysteine proteases (C), Aspartic proteases (A), Metallo proteases (M), and Unknown, or as yet unclassified, proteases (U), see Handbook of Proteolytic Enzymes, A. J. Barrett, N. D. Rawlings, J. F. Woessner (eds), Academic Press (1998), in particular the general introduction part.

In a preferred embodiment the thermostable protease used according to the invention is a “metallo protease” defined as a protease belonging to EC 3.4.24 (metalloendopeptidases); preferably EC 3.4.24.39 (acid metallo proteinases).

To determine whether a given protease is a metallo protease or not, reference is made to the above “Handbook of Proteolytic Enzymes” and the principles indicated therein. Such determination can be carried out for all types of proteases, be it naturally occurring or wild-type proteases; or genetically engineered or synthetic proteases.

Protease activity can be measured using any suitable assay, in which a substrate is employed, that includes peptide bonds relevant for the specificity of the protease in question. Assay-pH and assay-temperature are likewise to be adapted to the protease in question. Examples of assay-pH-values are pH 6, 7, 8, 9, 10, or 11. Examples of assay-temperatures are 30, 35, 37, 40, 45, 50, 55, 60, 65, 70 or 80 °C.

Examples of protease substrates are casein, such as Azurine-Crosslinked Casein (AZCL-casein). Two protease assays are described below in the “Materials & Methods”-section of WO 2017/112540 (incorporated herein by reference), of which the so-called “AZCL-Casein Assay” is the preferred assay.

In an embodiment the thermostable protease has at least 20%, such as at least 30%, such as at least 40%, such as at least 50%, such as at least 60%, such as at least 70%, such as at least 80%, such as at least 90%, such as at least 95%, such as at least 100% of the protease activity of the JTP196 variant (Example 2 from WO 2017/112540) or Protease Pfu (SEQ ID NO: 37 herein) determined by the AZCL-casein assay described in the “Materials & Methods”-section in WO 2017/112540.

There are no limitations on the origin of the thermostable protease used in a process or composition of the invention as long as it fulfills the thermostability properties defined below.

In one embodiment the protease is of fungal origin.

In a preferred embodiment the thermostable protease is a variant of a metallo protease as defined above. In an embodiment the thermostable protease used in a process or composition of the invention is of fungal origin, such as a fungal metallo protease, such as a fungal metallo protease derived from a strain of the genus Thermoascus, preferably a strain of Thermoascus aurantiacus, especially Thermoascus aurantiacus CGMCC No. 0670 (classified as EC 3.4.24.39).

In an embodiment the thermostable protease is a variant of the mature part of the metallo protease shown in SEQ ID NO: 2 disclosed in WO 2003/048353 or the mature part of SEQ ID NO: 1 in WO 2010/008841 and shown as SEQ ID NO: 38 herein further with mutations selected from below list:
S5*+D79L+S87P+A112P+D142L;
D79L+S87P+A112P+T124V+D142L;
S5*+N26R+D79L+S87P+A112P+D142L;
N26R+T46R+D79L+S87P+A112P+D142L;
T46R+D79L+S87P+T116V+D142L;
D79L+P81R+S87P+A112P+D142L;
A27K+D79L+S87P+A112P+T124V+D142L;
D79L+Y82F+S87P+A112P+T124V+D142L;
D79L+Y82F+S87P+A112P+T124V+D142L;
D79L+S87P+A112P+T124V+A126V+D142L;
D79L+S87P+A112P+D142L;
D79L+Y82F+S87P+A112P+D142L;
S38T+D79L+S87P+A112P+A126V+D142L;
D79L+Y82F+S87P+A112P+A126V+D142L;
A27K+D79L+S87P+A112P+A126V+D142L;
D79L+S87P+N98C+A112P+G135C+D142L;
D79L+S87P+A112P+D142L+T141C+M161C;
S36P+D79L+S87P+A112P+D142L;
A37P+D79L+S87P+A112P+D142L;
S49P+D79L+S87P+A112P+D142L;
S50P+D79L+S87P+A112P+D142L;
D79L+S87P+D104P+A112P+D142L;
D79L+Y82F+S87G+A112P+D142L;
S70V+D79L+Y82F+S87G+Y97W+A112P+D142L;
D79L+Y82F+S87G+Y97W+D104P+A112P+D142L;
S70V+D79L+Y82F+S87G+A112P+D142L;
D79L+Y82F+S87G+D104P+A112P+D142L;
D79L+Y82F+S87G+A112P+A126V+D142L;
Y82F+S87G+S70V+D79L+D104P+A112P+D142L;
Y82F+S87G+D79L+D104P+A112P+A126V+D142L;
A27K+D79L+Y82F+S87G+D104P+A112P+A126V+D142L;
A27K+Y82F+S87G+D104P+A112P+A126V+D142L;
A27K+D79L+Y82F+D104P+A112P+A126V+D142L;
A27K+Y82F+D104P+A112P+A126V+D142L;
A27K+D79L+S87P+A112P+D142L;
D79L+S87P+D142L.

In a preferred embodiment the thermostable protease is a variant of the mature metallo protease disclosed as the mature part of SEQ ID NO: 2 disclosed in WO 2003/048353 or the mature part of SEQ ID NO: 1 in WO 2010/008841 or SEQ ID NO: 38 herein with the following mutations:
D79L+S87P+A112P+D142L;
D79L+S87P+D142L; or
A27K+D79L+Y82F+S87G+D104P+A112P+A126V+D142L.

In an embodiment the protease variant has at least 75% identity preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, at least 99%, but less than 100% identity to the mature part of the polypeptide of SEQ ID NO: 2 disclosed in WO 2003/048353 or the mature part of SEQ ID NO: 1 in WO 2010/008841 or SEQ ID NO: 38 herein.

The thermostable protease may also be derived from any bacterium as long as the protease has the thermostability properties defined according to the invention.

In an embodiment the thermostable protease is derived from a strain of the bacterium Pyrococcus, such as a strain of Pyrococcus furiosus (pfu protease).

In an embodiment the protease is one shown as SEQ ID NO: 1 in U.S. Pat. No. 6,358,726-1 (Takara Shuzo Company) and SEQ ID NO: 37 herein.

In an embodiment the thermostable protease is one disclosed in SEQ ID NO: 37 herein or a protease having at least 80% identity, such as at least 85%, such as at least 90%, such as at least 95%, such as at least 96%, such as at least 97%, such as at least 98%, such as at least 99% identity to SEQ ID NO: 1 in U.S. Pat. No. 6,358,726-1 or SEQ ID NO: 37 herein. The Pyroccus furiosus protease can be purchased from Takara Bio, Japan.

The Pyrococcus furiosus protease is a thermostable protease according to the invention. The commercial product Pyrococcus furiosus protease (Pfu S) was found (see Example 5 of) to have a thermostability of 110% (80 °C/70 °C) and 103% (90 °C/70 °C) at pH 4.5 determined as described in Example 2 of WO 2017/112540.

In one embodiment a thermostable protease has a thermostability value of more than 20% determined as Relative Activity at 80 °C/70 °C determined as described in Example 2.

In an embodiment the protease has a thermostability of more than 30%, more than 40%, more than 50%, more than 60%, more than 70%, more than 80%, more than 90%, more than 100%, such as more than 105%, such as more than 110%, such as more than 115%, such as more than 120% determined as Relative Activity at 80 °C/70 °C.

In an embodiment protease has a thermostability of between 20 and 50%, such as between 20 and 40%, such as 20 and 30% determined as Relative Activity at 80 °C/70 °C.

In an embodiment the protease has a thermostability between 50 and 115%, such as between 50 and 70%, such as between 50 and 60%, such as between 100 and 120%, such as between 105 and 115% determined as Relative Activity at 80 °C/70 °C.

In an embodiment the protease has a thermostability value of more than 10% determined as Relative Activity at 85 °C/70 °C determined as described in Example 2 of WO 2017/112540.

In an embodiment the protease has a thermostability of more than 10%, such as more than 12%, more than 14%, more than 16%, more than 18%, more than 20%, more than 30%, more than 40%, more that 50%, more than 60%, more than 70%, more than 80%, more than 90%, more than 100%, more than 110% determined as Relative Activity at 85 °C/70 °C.

In an embodiment the protease has a thermostability of between 10 and 50%, such as between 10 and 30%, such as between 10 and 25% determined as Relative Activity at 85 °C/70 °C.

In an embodiment the protease has more than 20%, more than 30%, more than 40%, more than 50%, more than 60%, more than 70%, more than 80%, more than 90% determined as Remaining Activity at 80 °C; and/or

In an embodiment the protease has more than 20%, more than 30%, more than 40%, more than 50%, more than 60%, more than 70%, more than 80%, more than 90% determined as Remaining Activity at 84 °C.

Determination of “Relative Activity” and “Remaining Activity” is done as described in Example 2 of WO 2017/112540.

In an embodiment the protease may have a thermostability for above 90, such as above 100 at 85 °C as determined using the Zein-BCA assay as disclosed in Example 3 of WO 2017/112540.

In an embodiment the protease has a thermostability above 60%, such as above 90%, such as above 100%, such as above 110% at 85 °C as determined using the Zein-BCA assay.

In an embodiment protease has a thermostability between 60-120, such as between 70-120%, such as between 80-120%, such as between 90-120%, such as between 100-120%, such as 110-120% at 85 °C as determined using the Zein-BCA assay.

In an embodiment the thermostable protease has at least 20%, such as at least 30%, such as at least 40%, such as at least 50%, such as at least 60%, such as at least 70%, such as at least 80%, such as at least 90%, such as at least 95%, such as at least 100% of the activity of the JTP196 protease variant or Protease Pfu determined by the AZCL-casein assay described in the “Materials & Methods”-section of WO 2017/112540.

In an embodiment, the protease is a Thermobifida cellulosilytica protease of SEQ ID NO: 40 herein (referred to as SEQ ID NO: 3 in WO2018/118815 A1, which is incorporated herein by reference in its entirety), or a variant thereof having at least 60%, 65%, 70%, or 75% identity, preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, or at least 99%, identity thereto.

In an embodiment, the protease is a Thermobifida fusca protease of SEQ ID NO: 41 herein (referred to as SEQ ID NO: 8 in WO2018/118815 A1, which is incorporated herein by reference in its entirety), or a variant thereof having at least 60%, 65%, 70%, or 75% identity preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, or at least 99%, identity thereto.

In an embodiment, the protease is a Thermobifida halotolerans protease of SEQ ID NO: 42 herein (referred to as SEQ ID NO: 10 in WO2018/118815 A1, which is incorporated herein by reference in its entirety), or a variant thereof having at least 60%, 65%, 70%, or 75% identity preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, or at least 99%, identity thereto.

In an embodiment, the protease is a Thermococcus nautili protease of SEQ ID NO: 43 (referred to as SEQ ID NO: 3 in WO2018/169780A1, which is incorporated herein by reference in its entirety), or a variant thereof having at least at least 60%, 65%, 70%, or 75% identity preferably at least 80%, more preferably at least 85%, more preferably at least 90%, more preferably at least 91%, more preferably at least 92%, even more preferably at least 93%, most preferably at least 94%, and even most preferably at least 95%, such as even at least 96%, at least 97%, at least 98%, or at least 99%, identity thereto.

### V. Compositions

An aspect of the present invention relates to a composition comprising at least one hemicellulase and/or at least one beta-glucanase, and/or a cellulolytic composition, and a recombinant host cell or fermenting organism comprising at least one heterologous polynucleotide (e.g., a recombinant yeast host cell or fermenting organism engineered to optimize production of the fermentation product or a byproduct or co-product of the process for producing the fermentation product). As used in this section, “composition” encompasses process streams within processes for producing a fermentation product, such as ethanol, from a starch-containing material or cellulosic-containing material, such as a fermenting mash or fermented mash composition, or a whole stillage composition.

As used herein, “fermenting mash or fermented mash composition” refers to the composition formed by the constituent parts of the mash which are present during fermentation (fermenting mash composition) or after fermentation (fermented mash composition) fermentation, including any compounds (e.g., enzymes) or microorganisms (e.g., fermenting organism, such as a recombinant yeast host cell comprising at least one heterologous polynucleotide) that are exogenously added to a process stream for producing a fermentation product (e.g., enzymes added upstream from the fermentation step, e.g., during the liquefaction step of a conventional process for producing a fermentation product from a starch-containing material, during the pretreatment step of a process for producing a fermentation product from a cellulosic-containing material, or during the saccharification step of any process for producing a fermentation product, such as process for producing a fermentation product from a starch-containing material, a raw starch hydrolysis (RSH) process, and a process for producing a fermentation product from a cellulosic-containing material, chemical inputs (e.g., urea), etc.), and any compounds or microorganisms that are generated in situ in the process stream for producing a fermentation product (e.g., reaction products of enzymes and their substrates in the mash, enzymes secreted from the fermenting organism, etc.). Those skilled in the art will appreciate that the constituent parts of the fermenting mash or fermented mash composition, on a percent basis of the entire fermenting mash or fermented mash composition, may include: (i) total dried solids content in an amount ranging from 5% to 25%, from 8% to 22%, from 10% to 20%, or from 11% to 18%; (ii) total oil content in an amount ranging from 0%-8%, from 0.2% to 7%, from 0.4% to 6%, from 0.6% to 5%, from 0.8 to 4%, or from 1% to 2%; (iii) total protein content in an amount ranging from 1% to 8%, from 1.5% to 7%, from 2% to 6%, or from 2.5% to 5%; (iv) total fiber content in an amount ranging from 1% to 8%, from 1.5% to 7%, from 2% to 6%, or from 2.5% to 5%; and (v) total liquids content (e.g., ethanol) in an amount ranging from 79% to 92%, from 80% to 91%, from 81% to 90%, or from 82% to 89%.

As used herein, “whole stillage composition” refers to the composition formed by the constituent parts of the whole stillage byproduct that is produced after recovery of liquid products from the fermented mash, e.g., such as ethanol by distillation, including any compounds (e.g., enzymes) or microorganisms (e.g., fermenting organism, such as a recombinant yeast host.

Those skilled in the art will appreciate that the constituent parts of the whole stillage composition, on a percent basis of the entire whole stillage composition, may include: (i) total dried solids content in an amount ranging from 5% to 25%, from 8% to 22%, from 10% to 20%, or from 11% to 18%; (ii) total oil content in an amount ranging from 0%-8%, from 0.2% to 7%, from 0.4% to 6%, from 0.6% to 5%, from 0.8 to 4%, or from 1% to 2%; (iii) total protein content in an amount ranging from 1% to 8%, from 1.5% to 7%, from 2% to 6%, or from 2.5% to 5%; (iv) total fiber content in an amount ranging from 1% to 8%, from 1.5% to 7%, from 2% to 6%, or from 2.5% to 5%; and (v) total liquids content (e.g., water) in an amount ranging from 79% to 92%, from 80% to 91%, from 81% to 90%, or from 82% to 89%. The at least one heterologous polynucleotide may encode polypeptides that are expressed intracellularly to enhance performance of the yeast or fermenting organism itself, polypeptides that are secreted into the fermenting or fermented mash composition to exert their effects on the mash or components of the mash to improve fermentation results, or both.

In some embodiments, the recombinant yeast host cell or fermenting organism comprises nucleotide sequences encoding the hemicellulases and/or beta-glucanases of the present invention, in addition to at least one other heterologous polynucleotide that optimizes production of the fermentation product or a byproduct or co-product of the process for producing the fermentation product. In other embodiments, the recombinant yeast host cell or fermenting organism comprises nucleotides sequences encoding such at least one heterologous polynucleotide other than the hemiceullases and/or beta-glucanases, such as a fermentation alpha-amylase (e.g., fungal alpha-amylase), carbohydrate-source generating organism (e.g., glucoamylase), and/or protease.

Accordingly, in one aspect, the present invention relates to a composition comprising:
(a) a recombinant yeast host cell or fermenting organism; and
(b) at least one hemicellulase and/or at least one beta-glucanase of the present invention,
wherein the yeast host cell or fermenting organism comprises a heterologous polynucleotide encoding a glucoamylase, an alpha-amylase, protease, and/or cellulase.

The present invention contemplates the use of any viable recombinant yeast host cell or fermenting organism in the compositions described herein. Examples of suitable recombinant yeast host cells or fermenting organisms can be found herein in the “Fermenting Organisms” section.

The present invention contemplates the use of any hemicellulase and/or beta-glucanase in the compositions described in this section. Those skilled in the art will appreciate that any of the hemicellulase, beta-glucanase, or enzyme blends described in Section I above, Section IV above, or otherwise described herein, can be used in a composition of the invention.

The present invention contemplates the use of any glucoamylase, alpha-amylase, protease, and/or cellulase. Examples of suitable such enzymes can be found under the heading “Enzymes”.

In one embodiment, the composition is a fermenting or fermented mash composition comprising the recombinant yeast host cell or fermenting organism and the at least one hemicellulase and/or at least one beta-glucanase. In another embodiment, the composition is a whole stillage composition comprising the recombinant yeast host cell and the at least one hemicellulase and/or at least one beta-glucanase.

In an embodiment, the fermenting or fermented mash composition or the whole stillage composition comprises:
(a) a recombinant yeast host cell or fermenting organism; and
(b) at least one hemicellulase and/or at least one beta-glucanase,
wherein the yeast host cell comprises a heterologous polynucleotide encoding a glucoamylase, an alpha-amylase, protease, and/or cellulase;
wherein the at least one hemicellulase is selected from the group consisting of the mature polypeptide of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, SEQ ID NO: 59, and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, or SEQ ID NO: 59; and
wherein the at least one beta-glucanase is selected from the group consisting of the mature polypeptide of SEQ ID NO: 14, SEQ ID NO: 15, SEQ ID NO: 16, SEQ ID NO: 17, SEQ ID NO: 18, SEQ ID NO: 19, SEQ ID NO: 20, and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 14, SEQ ID NO: 15, SEQ ID NO: 16, SEQ ID NO: 17, SEQ ID NO: 18, SEQ ID NO: 19, or SEQ ID NO: 20.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity; and
(c) a cellulolytic composition (e.g., derived from a strain of Trichoderma, such as Trichoderma reesei) comprising:
   (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
   (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
(c) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
(d) a cellulolytic composition (e.g., derived from a strain of Trichoderma, such as Trichoderma reesei) comprising:
   (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
   (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
(c) a cellulolytic composition (e.g., derived from a strain of Trichoderma, such as Trichoderma reesei) comprising:
   (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
   (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
(c) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
(d) a cellulolytic composition (e.g., derived from a strain of Trichoderma, such as Trichoderma reesei) comprising:
   (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
   (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
(c) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
(d) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
(e) a cellulolytic composition (e.g., derived from a strain of Trichoderma, such as Trichoderma reesei) comprising:
   (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
   (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity; and
(c) a cellulolytic composition (e.g., derived from a strain of Trichoderma, such as Trichoderma reesei) comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
(c) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
(d) a cellulolytic composition (e.g., derived from a strain of Trichoderma, such as Trichoderma reesei) comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
(c) a cellulolytic composition (e.g., derived from a strain of Trichoderma, such as Trichoderma reesei) comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
(c) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
(d) a cellulolytic composition (e.g., derived from a strain of Trichoderma, such as Trichoderma reesei) comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

In an embodiment, the fermenting or fermented mash composition or the whole stillage composition comprises:
(a) a recombinant yeast host cell comprising a heterologous polynucleotide encoding a glucoamylase, an alpha-amylase, and/or protease;
(b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
(c) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
(d) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
(e) a cellulolytic composition (e.g., derived from a strain of Trichoderma, such as Trichoderma reesei) comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.

### VI. Further Aspects of the Invention

In a further aspect of the invention it relates to the use of a hemicellulase or enzyme blend comprising a hemicellulase for producing a high protein feed ingredient from a whole stillage byproduct produced in a starch-containing grain dry milling process for producing a fermentation product.

In still a further aspect of the invention it relates to the use of a hemicellulase or enzyme blend comprising a hemicellulase for increasing the amount of initial protein from the whole stillage byproduct that is partitioned to the high protein fraction.

In still a further aspect of the invention it relates to the use of a hemicellulase or enzyme blend comprising a hemicellulase for decreasing the amount of initial protein from the whole stillage byproduct that is retained in the wet cake fraction.

Any enzyme blend disclosed in Section I herein can be used in this manner. In various embodiments of this aspect, an additional enzyme, such as an enzyme or enzyme composition described under the “Enzymes” section can be used in combination together with an enzyme blend of the present invention.

In an embodiment, the hemicellulase or enzyme blend comprising hemicellulase increases the amount of initial protein from the whole stillage byproduct that is partitioned to the high protein fraction by at least 5%, at least 6%, at least 7%, at least 8%, at least 9%, at least 9%, at least 10%, at least 11%, at least 12%, at least 13%, at least 14%, at least 15%, at least 16%, at least 17%, at least 18%, at least 19%, at least 20%, at least 25%, at least 26%, at least 27%, at least 28%, at least 29%, at least 30%, at least 33%, at least 34%, at least 35%, at least 36% at least 37%, at least 38%, at least 39%, or at least 40% as compared to the amount of initial protein from the whole stillage byproduct that is partitioned to the high protein fraction when not using a presently disclosed hemicellulase or enzyme blend.

In an embodiment, the hemicellulase or enzyme blend comprising hemicellulase decreases the amount of initial protein from the whole stillage byproduct that is retained in the wet cake fraction by at least 5%, at least 6%, at least 7%, at least 8%, at least 9%, at least 9%, at least 10%, at least 11%, at least 12%, at least 13%, at least 14%, at least 15%, at least 16%, at least 17%, at least 18%, at least 19%, at least 20%, at least 25%, at least 26%, at least 27%, at least 28%, at least 29%, at least 30%, at least 33%, at least 34%, at least 35%, at least 36% at least 37%, at least 38%, at least 39%, or at least 40% as compared to the amount of initial protein from the whole stillage byproduct that is retained in the wet cake fraction not using a presently disclosed hemicellulase or enzyme blend.

The invention is further summarized in the following paragraphs:
1. A method for producing a high protein feed ingredient from a whole stillage byproduct produced in a starch-containing grain dry milling process for producing a fermentation product, the method comprising:
   a) optionally performing a starch-containing grain dry milling process for producing a fermentation product to produce a fermentation product and a whole stillage byproduct;
   b) separating a whole stillage byproduct into an insoluble solids portion and a thin stillage portion;
   c) separating the thin stillage portion into at least a first separated water-soluble solids portion, and at least a first separated protein portion;
   d) optionally separating at least the first separated protein portion into at least a second separated water-soluble solids portion, and at least a second separated protein portion;
   e) drying at least the first separated protein portion, and/or optionally at least the second separated protein portion, to define a protein product, wherein the protein product is a high protein feed ingredient;
   wherein a hemicellulase, a beta-glucanase, or an enzyme blend comprising a hemicellulase and/or beta-glucanase is added prior to or during production of the whole stillage byproduct and/or separating the whole stillage byproduct.
2. The method of paragraph 1, wherein separating step b) is performed by subjecting the whole stillage byproduct to a centrifuge or a screen.
3. The method of paragraphs 1 or 2, wherein separating step b) is performed by subjecting the whole stillage byproduct to a filtration centrifuge, a decanter centrifuge, a pressure screen, or a paddle screen.
4. The method of any one of paragraphs 1-3, wherein separating step c) is performed by subjecting the thin stillage portion to a centrifuge or a cyclone apparatus.
5. The method of any one of paragraphs 1-4, wherein optional separating step d) is performed by subjecting the first separated protein portion to a centrifuge or a cyclone apparatus.
6. The method of any one of paragraphs 1-5, wherein the high protein feed ingredient includes at least 40 wt percent protein on a dry basis.
7. The method of any one of paragraphs 1-6, wherein the starch-containing grain comprises maize, corn, wheat, rye, barley, triticale, sorghum, switchgrass, millet, pearl millet, foxtail millet.
8. The method of any one of paragraphs 1-7, wherein the high protein feed ingredient is a high protein corn-based animal feed.
9. The method of any one of paragraphs 1-8, further comprising, after separating the whole stillage byproduct into an insoluble solids portion and a thin stillage portion and before separating the thin stillage portion into a first separated protein portion and a first separated water-soluble solids portion, separating fine fiber from the thin stillage portion.
10. The method of any one of paragraphs 1-9, wherein separating fine fiber from the thin stillage portion comprises separating the fine fiber via a pressure screen, paddle screen, decanter, or filtration centrifuge.
11. The method of any one of paragraphs 1-10, further comprising separating soluble solids from the first separated water-soluble solids portion to provide a first soluble solids portion, and optionally separating soluble solids from the second separated water-soluble solids portion to provide a second soluble solids portion.
12. The method of any one of paragraphs 1-11, further comprising separating free oil from the first separated water-soluble solids portion to provide a first oil portion, and optionally separating free oil from the second separated water-soluble solids portion to provide a second oil portion.
13. The method of any one of paragraphs 1-12 wherein the hemicellulase, beta-glucanase, or the enzyme blend comprising the hemicellulase and/or beta-glucanase is added prior to separation of the whole stillage into insoluble solids and thin stillage.
14. The method of any one of paragraphs 1-13, wherein the hemicellulase, beta-glucanase or the enzyme blend comprising the hemicellulase and/or beta-glucanase is added during the separation of the whole stillage byproduct into the insoluble solids portion and the thin stillage portion.
15. The method of any one of paragraphs 1-14, wherein performing step a) comprises:
   (i) saccharifying a starch-containing grain at a temperature below the initial gelatinization temperature with an alpha-amylase and a glucoamylase; and
   (ii) fermenting using a fermentation organism to produce the fermentation product.
16. The method of any one of paragraphs 1-14, wherein performing step a) comprises:
   (i) liquefying a starch-containing grain with an alpha-amylase;
   (ii) saccharifying the liquefied material obtained in step (a) with a glucoamylase; and
   (iii) fermenting using a fermenting organism.
17. The method of paragraphs 15 or 16, wherein the hemicellulase, beta-glucanase or enzyme blend comprising the hemicellulase and/or beta-glucanase is added during saccharifying step (i) and/or fermenting step (ii).
18. The method of any one of paragraphs 15-17, wherein saccharification and fermentation is performed simultaneously.
19. The method of any one of paragraphs 1-18, wherein the fermentation product is alcohol, particularly ethanol, more particularly fuel ethanol.
20. The method of any one of paragraphs 1-19, wherein the fermenting organism is yeast, particularly Saccharomyces sp., more particularly Saccharomyces cerevisiae.
21. The method of any one of paragraphs 1-20, wherein the hemicellulase is selected from the group consisting of an acetylxylan esterase, a α-glucuronidases, a α-L-arabinofuranosidases, a α-L-galactosidase, a beta-xylosidase, a feruloyl esterase, a α-D-galactosidase, a pectin-degrading enzyme, a xylanase, and any combination thereof.
22. The method of any one of paragraphs 1-21, wherein the xylanase is from a glycoside hydrolase family selected from the group consisting of a GH3 family xylanase, GH5 family xylanase, a GH8 family xylanase, a GH10 family xylanase, a GH11 family xylanase, a GH30 family xylanase. a GH43 family xylanase, and a GH98 family xylanase.
23. The method of any one of paragraphs 1-22, wherein the GH10 xylanase is the method of any one of paragraphs 1-22, wherein the xylanase is from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1.
24. The method of any one of paragraphs 1-23, wherein the GH10 family xylanase is from the genus Talaromyces, for example Talaromyces leycettanus, such as the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2.
25. The method of any one of paragraphs 1-24, wherein the GH30 family xylanase is a GH30_8 family xylanase.
26. The method of any one of paragraphs 1-25, wherein the GH30_8 family xylanase is from the genus Bacillus, for example Bacillus subtilis, such as the xylanase shown in amino acids 28 to 417 of SEQ ID NO: 3 or amino acids 28 to 417 of SEQ ID NO: 4, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4.
27. The method of any one of paragraphs 1-26, wherein the GH5 family xylanase is selected from the group consisting of GH5_21, GH5_34 and GH5_35.
28. The method of any one of paragraphs 1-27, wherein the GH5_21 xylanase is from the genus Chryseobacterium, for example Chryseobacterium sp-10696, such as the xylanase shown in amino acids 25 to 551 of SEQ ID NO: 5 or amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 or amino acids 25 to 551 of SEQ ID NO: 6.
29. The method of any one of paragraphs 1-28, wherein the G5_34 xylanase is from the genus Acetivibrio, for example Acetivibrio cellulyticus, such as the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7.
30. The method of any one of paragraphs 1-29, wherein the G5_34 xylanase is from the genus Clostridium, for example Clostridium thermocellum, such as the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8, or is from the genus Gonapodya, for example Gonapodya prolifera, such as the xylanase shown in SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 53 or the mature polypeptide thereof.
31. The method of any one of paragraphs 1-30, wherein the GH5_35 xylanase is from the genus genus Paenibacillus, for example Paenibacillus illinoisensis, such as the xylanase shown in amino acids 37 to 573 of SEQ ID NO: 9, or for example Paenibacillus sp., such as the xylanase shown in amino acids 36 to 582 of SEQ ID NO: 10, or for example Paenibacillus favisporus, such as the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9, amino acids 36 to 582 of SEQ ID NO: 10, or amino acids 1 to 536 of SEQ ID NO: 54.
32. The method of any one of paragraphs 1-31, wherein the α-L-arabinofuranosidase is from a glycoside hydrolase family selected from the group consisting of GH43, GH51 and GH62.
33. The method of any one of paragraphs 1-32, wherein the GH43 α-L-arabinofuranosidase is from a subfamily selected from the group consisting of 1, 10, 11, 12, 19 21, 26, 27, 29, 35 and 36.
34. The method of any one of paragraphs 1-33, wherein the GH62 family α-L-arabinofuranosidase is a GH62_1 α-L-arabinofuranosidase.
35. The method of any one of paragraphs 34, wherein the GH62_1 α-L-arabinofuranosidase is from the genus Talaromyces, for example Talaromyces pinophilus, such as the α-L-arabinofuranosidase shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or the one shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55.
36. The method of any one of paragraphs 1-35, wherein the beta-xylosidase is from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12, or wherein the beta-xylosidase is from the genus Trichoderma, for example Trichoderma reesei, such as the beta-xylosidase shown in amino acids 20 to 780 of SEQ ID NO: 13.
37. The method of any one of paragraphs 1-36, wherein the α-glucuronidase is selected from the group consisting of a GH115 α-glucuronidase having xylan α-1,2-glucuronidase activity, a GH4 α-glucuronidase having α-glucuronidase activity, and a GH67 α-glucuronidase having xylan α-1,2-glucuronidase activity.
38. The method of any one of paragraphs 1-37, wherein the acetylxylan esterase is from a family selected from the group consisting of CE1, CE2, CE3, CE4, CE5, CE6, CE7, CE12, CE15 and PF05448.
39. The method of any one of paragraphs 1-38, wherein the α-D-galactosidase and/or α-L-galactosidase are from a glycoside hydrolase family selected from the group consisting of GH27, GH36, GH4 and GH57_A.
40. The method of any one of paragraphs 1-39, wherein the pectin-degrading enzyme is selected from the group consisting of an arabinase (e.g., GH43 family), a galactanase (e.g., GH53 family), a pectin acetylesterase/rhamnogalacturonan acetylesterase (e.g., CE12 family), a pectate lyase (e.g., PL1 family), a pectin lyase (e.g., PL1 family), a pectin metylesterase (e.g., CE12 family), a polygalacturonase (e.g., GH28 family), a rhamnogalacturonan hydrolase (e.g., GH28 family), a rhamnogalacturonan lyase (e.g., PL4 family), a xylogalacturonan hydrolase (e.g., GH28 family), and any combination thereof.
41. The method of any one of paragraphs 1-40, wherein the enzyme blend comprises at least two hemicellulases.
42. The method of any one of paragraphs 1-41, wherein the at least two hemicellulases comprises at least two xylanases.
43. The method any one of paragraphs 1-42, wherein the at least two xylanases comprises a GH30 family xylanase and a GH5 family xylanase.
44. The method of any one of paragraphs 1-43, wherein the at least two xylanases comprises a GH30_8 xylanase and a GH5_21 family xylanase.
45. The method of any one of paragraphs 1-44, wherein the at GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH5_21 xylanase is selected from the group consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6.
46. The method of any one of paragraphs 1-45, wherein the at least two xylanases are present in the blend in a ratio of 1:1, 1.1:1, 1.2:1, 1.3:1, 1.4:1, 1.5:1, 1:1.5, 1:1.4, 1:1.3, 1:1.2, or 1:1.1 of GH30_8 xylanase to GH521 xylanase.
47. The method of any one of paragraphs 1-46, wherein the xylanase(s) increase the mass fraction of the high protein feed ingredient compared to the mass of the high protein feed ingredient in the absence of the xylanase(s).
48. The method of any one of paragraphs 1-47, wherein the at least two hemicellulases comprises at least one xylanase and at least one α-L-arabinofuranosidase.
49. The method of any one of paragraphs 1-48, wherein the at least two hemicellulases comprises at least one xylanase from a family selected from the group consisting of a GH3 family xylanase, GH5 family xylanase, a GH8 family xylanase, a GH10 family xylanase, a GH11 family xylanase, a GH30 family xylanase, a GH43 family xylanase, and a GH98 family xylanase, and at least one α-L-arabinofuranosidase from a GH family selected from the group consisting of GH43, GH51 and GH62.
50. The method of any one of paragraphs 1-49, wherein the least two hemicellulases comprises a GH5_21 xylanase and an α-L-arabinofuranosidase selected from a GH family selected the group consisting of GH43, GH51 and GH62.
51. The method of any one of paragraphs 1-50, wherein the at least two hemicellulases comprises a GH5_21 xylanase and a GH62 α-L-arabinofuranosidase.
52. The method of any one of paragraphs 1-51, wherein the GH5_21 xylanase is selected from the group consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6, and wherein the GH62 α-L-arabinofuranosidase is the one shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or the one shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55.
52. The method of any one of paragraphs 1-51, wherein the at least two hemicellulases comprises a GH30_8 xylanase and an α-L-arabinofuranosidase selected from a GH family selected the group consisting of GH43, GH51 and GH62.
53. The method of any one of paragraphs 1-52, wherein:
   (i) the at least two hemicellulases comprise a GH30_8 xylanase and a GH43 arabinofuranosidase;
   (ii) the at least two hemicellulases comprise a GH30_8 xylanase and a GH51 arabinofuranosidase; or
   (iii) the at least two hemicellulases comprises a GH30_8 xylanase and a GH62 α-L-arabinofuranosidase.
54. The method of any one of paragraphs 1-53, wherein:
   (i) the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH43 arabinofuranosidase is from the genus Humicola, for example Humicola insolens, such as the arabinofuranosidase shown in amino acids 19 to 558 of SEQ ID NO: 56 or the arabinofuranosidase shown in amino acids 24 to 575 of SEQ ID NO: 57, or one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57;
   (ii) the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH51 arabinofuranosidase is from the genus Colletotrichum, for example Colletotrichum graminicola, such as the arabinofuranosidase shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58, or the GH51 arainofuranosidase is from the genus Trametes, for example Trametes hirsuta, such as the arabinofuranosidase shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59; or
   (iii) the GH30_8 xylanase is selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4, and wherein the GH62 α-L-arabinofuranosidase is the one shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or the one shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55.
55. The method of any one of paragraphs 1-54, wherein the at least two hemicellulases comprises a GH10 xylanase and an α-L-arabinofuranosidase selected from a GH family selected the group consisting of GH43, GH51 and GH62.
56. The method of any one of paragraphs 1-55, wherein:
   (i) the at least two hemicellulases comprise a GH10 xylanase and a GH43 arabinofuranosidase;
   (ii) the at least two hemicellulases comprise a GH10 xylanase and a GH51 arabinofuranosidase; or
   (iii) the at least two hemicellulases comprises a GH10 xylanase and GH62 α-L-arabinofuranosidase.
57. The method of any one of paragraphs 1-56, wherein:
   (i) the GH10 xylanase is selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1 and amino acids 21 to 405 of SEQ ID NO: 2 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2, wherein the GH43 arabinofuranosidase is from the genus Humicola, for example Humicola insolens, such as the arabinofuranosidase shown in amino acids 19 to 558 of SEQ ID NO: 56 or the arabinofuranosidase shown in amino acids 24 to 575 of SEQ ID NO: 57, or one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57;
   (ii) the GH10 xylanase is selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1 and amino acids 21 to 405 of SEQ ID NO: 2 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2, and wherein the GH51 arabinofuranosidase is from the genus Colletotrichum, for example Colletotrichum graminicola, such as the arabinofuranosidase shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58, or the GH51 arainofuranosidase is from the genus Trametes, for example Trametes hirsuta, such as the arabinofuranosidase shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59; or
   (iii) the GH10 xylanase is selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1 and amino acids 21 to 405 of SEQ ID NO: 2 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2, and wherein the GH62 α-L-arabinofuranosidase is the one shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11, or the one shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55.
58. The method of any one of paragraphs 1-57, wherein the GH10 xylanase is the one shown in amino acids 21 to 405 of SEQ ID NO: 2 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2, and wherein the GH62 α-L-arabinofuranosidase is the one shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11.
59. The method of any one of paragraphs 1-58, wherein the at least one xylanase and the at least one α-L-arabinofuranosidase increases the mass fraction of the high protein feed ingredient.
60. The method of any one of paragraphs 1-59, wherein the mixture of at least two hemicellulases comprises a xylanase and a beta-xylosidase.
61. The method of any one of paragraphs 1-60, wherein the mixture of at least two hemicellulases comprises:
   (i) a xylanase from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; and
   (ii) a beta-xylosidase from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12.
62. The method of any one of paragraphs 1-61, wherein the at least one xylanase and at least one beta-xylosidase increases the mass fraction of the high protein feed ingredient.
63. The method of any one of paragraphs 1-62, wherein the beta-glucanase is from a glycoside hydrolase family selected from the group consisting of a GH5_15 family beta-glucanase, a GH16 family beta-glucanase, and a GH64 family beta-glucanase.
64. The method of any one of paragraphs 1-63, wherein the GH5_15 family beta-glucanase is from the genus Rasamsonia, for example Rasamsonia byssochlamydoides, such as the beta-glucanase shown in amino acids 20 to 413 of SEQ ID NO: 13, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 13.
65. The method of any one of paragraphs 1-64, wherein the GH5_15 family beta-glucanase is from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17.
66. The method of any one of paragraphs 1-65, wherein the GH16 family beta-glucanase is from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19.
67. The method of any one of paragraphs 1-66, wherein the GH64 beta-glucanase is from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20.
68. The method of any one of paragraphs 1-67, wherein the beta-glucanase increases the percent protein on a dry basis of the high protein feed ingredient.
69. The method of any one of paragraphs 1-69, wherein the enzyme blend further comprises a cellulolytic composition.
70. The method of any one of paragraphs 1-69, wherein the cellulolytic composition is present in the blend in a ratio of hemicellulase and cellulolytic composition from about 5:95 to about 95:5, such as from 5:95, 10:90, 20:80, 25:75, 50:50, 80:20, 75:25, 90:10, and 95:5.
71. The method of any one of paragraphs 1-70, wherein the cellulolytic composition is present in the blend in a ratio of beta-glucanase and cellulolytic composition from about 5:95 to about 95:5, such as from 5:95, 10:90, 20:80, 25:75, 50:50, 80:20, 75:25, 90:10, and 95:5.
72. The method of any one of paragraphs 1-71, wherein the cellulolytic composition is present in the blend in a ratio of cellulolytic composition, beta-glucanase, and hemicellulase from about 80:10:10 to about 40:30:30, such as from 80:10:10, 75:20:5, 75:15:10, 75:13:12, 75:12:13, 75:10:15, 75:5:20, 70:25:5, 70:20:10, 70:15:15, 70:10:20, 70:5:25, 65:30:5, 65:25:10, 65:20:15, 65:18:17, 65:17:18, 65:15:20, 65:10:25, 65:5:35, 60:35:5, 60:30:10, 60:25:15, 60:20:20, 60:15:25, 60:10:30, 60:5:35, 55:40:5, 55:35:10, 55:30:15, 55:25:20, 55:23:22, 55:22:23, 55:20:25, 55:15:30, 55:10:35, 55:5:40; 50:45:5, 50:40:10, 50:35:15, 50:30:20, 50:25:25, 50:20:30, 50:15:35, 50:10:40, 50:5:45, 45:50:5, 45:45:10, 45:40:15, 45:35:20, 45:30:25, 45:28:27, 45:27:28, 45:25:30, 45:20:35, 45:15:40, 45:10:45, 45:5:40, 40:55:5, 40:50:10, 40:45:15, 40:40:20, 40:35:25, 40:30:30, 40:25:35, 40:20:40, 40:15:45, 40:10:50, and 40: 5:55, preferably from about 50-70:15-25:15-25, or most preferably about 55-60:18-23:18-23.
73. The method of any one of paragraphs 1-72, wherein the cellulolytic composition is present in the blend in a ratio of cellulolytic composition, beta-glucanase, and xylanase from about 80:10:10 to about 40:30:30, such as from 80:10:10, 75:20:5, 75:15:10, 75:13:12, 75:12:13, 75:10:15, 75:5:20, 70:25:5, 70:20:10, 70:15:15, 70:10:20, 70:5:25, 65:30:5, 65:25:10, 65:20:15, 65:18:17, 65:17:18, 65:15:20, 65:10:25, 65:5:35, 60:35:5, 60:30:10, 60:25:15, 60:20:20, 60:15:25, 60:10:30, 60:5:35, 55:40:5, 55:35:10, 55:30:15, 55:25:20, 55:23:22, 55:22:23, 55:20:25, 55:15:30, 55:10:35, 55:5:40; 50:45:5, 50:40:10, 50:35:15, 50:30:20, 50:25:25, 50:20:30, 50:15:35, 50:10:40, 50:5:45, 45:50:5, 45:45:10, 45:40:15, 45:35:20, 45:30:25, 45:28:27, 45:27:28, 45:25:30, 45:20:35, 45:15:40, 45:10:45, 45:5:40, 40:55:5, 40:50:10, 40:45:15, 40:40:20, 40:35:25, 40:30:30, 40:25:35, 40:20:40, 40:15:45, 40:10:50, and 40: 5:55, preferably from about 50-70:15-25:15-25, or most preferably about 55-60:18-23:18-23.
74. The method of any one of paragraphs 1-73, wherein the cellulolytic composition comprises at least one, at least two, at least three, or at least four enzymes selected from the group consisting of:
   (i) a cellobiohydrolase I;
   (ii) a cellobiohydrolase II;
   (iii) a beta-glucosidase; and
   (iv) a GH61 polypeptide having cellulolytic enhancing activity.
75. The method of any one of paragraphs 1-74, wherein the cellulolytic composition comprises at least one, at least two, at least three, or at least four enzymes selected from the group consisting of:
   (i) an Aspergillus fumigatus cellobiohydrolase I;
   (ii) an Aspergillus fumigatus cellobiohydrolase II;
   (iii) an Aspergillus fumigatus beta-glucosidase; and
   (iv) a Penicillium emersonii GH61A polypeptide having cellulolytic enhancing activity.
76. The method of any one of paragraphs 1-75, wherein the cellulolytic composition comprises:
   (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or
   (iv) a GH61A polypeptide having cellulolytic enhancing activity comprising amino acids 26 to 253 of SEQ ID NO: 24 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
77. The method of any one of paragraphs 1-76, wherein the cellulolytic composition further comprises an endoglucanase.
78. The method of any one of paragraphs 1-77, wherein the cellulolytic composition comprises a cellobiohydrolase, a beta-glucosidase, and an endoglucanase.
79. The method of any one of paragraphs 1-78, wherein the cellulolytic composition comprises:
   (i) a cellobiohydrolase I;
   (ii) a beta-glucosidase; and
   (iii) an endoglucanase I.
80. The method of any one of paragraphs 1-79, wherein the cellulolytic composition comprises:
   (i) an Aspergillus cellobiohydrolase I;
   (ii) an Aspergillus beta-glucosidase; and
   (iii) a Trichoderma endoglucanase I.
81. The method of any one of paragraphs 1-80, wherein the cellulolytic composition comprises:
   (i) an Aspergillus fumigatus cellobiohydrolase I;
   (ii) an Aspergillus fumigatus beta-glucosidase; and
   (iii) a Trichoderma reesei endoglucanase I.
82. The method of any one of paragraphs 1-81, wherein the cellulolytic composition comprises:
   (i) a cellobiohydrolase I comprising amino acids 27 to 532 of SEQ ID NO: 21 or a variant thereof having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 4 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 4; and/or
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids to 23 to 459 of SEQ ID NO: 44.
83. The method of any one of paragraphs 1-82, wherein the enzyme blend comprises at least one hemicellulase and a cellulolytic composition, wherein:
   (i) the at least one hemicellulase is selected from the group consisting of an acetylxylan esterase, a α-glucuronidases, a α-L-arabinofuranosidases, a α-L-galactosidase, a beta-xylosidase, a feruloyl esterase, a α-D-galactosidase, a pectin-degrading enzyme, a xylanase, and any combination thereof; and
   (ii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I.
84. The method of any one of paragraphs 1-83, wherein the enzyme blend comprises at least one hemicellulase and a cellulolytic composition, wherein:
   (i) the at least one hemicellulase is at least one xylanase selected from the group consisting of a GH3 xylanase, a GH5 xylanase, a GH8 xylanase, GH10 xylanase, a GH11 xylanase, a GH30 xylanase, a GH43 xylanase, and a GH 98 xylanase; and
   (ii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I.
85. The method of any one of paragraphs 1-83, wherein the enzyme blend comprises at least one xylanase and a cellulolytic composition, wherein:
   (i) the at least one xylanase is selected from the group consisting of an Aspergillus GH10 xylanase, a Talaromyces GH10 xylanase, a Bacillus GH30_8 xylanase, a Chryseobacterium GH5_21 xylanase, an Acetivibrio GH5_34 xylanase, a Clostridium GH5_34 xylanase, a Gonapodya prolifera GH5_34 xylanase, a Paenibacillus GH5_35 xylanase, and any combination of at least two, at least three, at least four, at least five or at least six thereof; and
   (ii) the cellulolytic composition comprises at least three enzymes selected from the group consisting of an Aspergillus cellobiohydrolase I, an Aspergillus cellobiohydrolase II, an Aspergillus beta-glucosidase, a Penicillium GH61 polypeptide having cellulolytic enhancing activity, and a Trichoderma endoglucanase I.
85. The method of any one of paragraphs 1-83, wherein the enzyme blend comprises at least one xylanase and a cellulolytic composition, wherein:
   (i) the at least one xylanase is selected from the group consisting of an Aspergillus fumigatus GH10 xylanase, a Talaromyces leycettanus GH10 xylanase, a Bacillus subtilis GH30_8 xylanase, a Chryseobacterium sp-10696 GH5_21 xylanase, an Acetivibrio cellulyticusGH5_34 xylanase, a Clostridium thermocellum GH5_34 xylanase, a Gonapodya prolifera GH5_34 xylanase, a Paenibacillus illinoisensis, Paenibacillus favisporus, or Paenibacillus sp. GH5_35 xylanase, and any combination of at least two, at least three, at least four, at least five or at least six thereof; and
   (ii) the cellulolytic composition comprises at least three enzymes selected from the group consisting of an Aspergillus fumigatus cellobiohydrolase I, an Aspergillus fumigatus cellobiohydrolase II, an Aspergillus fumigatus beta-glucosidase, a Penicillium emersonii GH61 polypeptide having cellulolytic enhancing activity, and a Trichoderma reesei endoglucanase I.
85. The method of any one of paragraphs 1-84, wherein the enzyme blend comprises at least one xylanase and a cellulolytic composition, wherein the at least one xylanase is selected from the group consisting of:
   (i) the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1;
   (ii) the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2;
   (iii) the xylanase shown in amino acids 28 to 417 of SEQ ID NO: 3, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4;
   (iv) the xylanase shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4;
   (v) the xylanase shown in amino acids 25 to 551 of SEQ ID NO: 5, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5;
   (vi) the xylanase shown in amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6;
   (vii) the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7;
   (viii) the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8;
   (ix) the xylanase shown in amino acids 37 to 573 of SEQ ID NO: 9, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9;
   (x) the xylanase shown in amino acids 36 to 582 of SEQ ID NO: 10 or one having at least 60%, at least 65%, at least 70%, at least 75%, at least 80%, at least 85%, at least 90%, at least 95%, at least 96%, at least 97%, at least 98%, or at least 99% sequence identity to amino acids 36 to 582 of SEQ ID NO: 10;
   (xi) the xylanase shown in amino acids 24 to 337 of SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to amino acids 24 to 337 of SEQ ID NO: 53;
   (xii) the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 536 of SEQ ID NO: 54; and
   wherein the cellulolytic composition comprises at least three enzymes selected from the group consisting of:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24; and
   (v) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 to of SEQ ID NO: 44.
86. The method of any one of paragraphs 1-85, wherein the enzyme blend comprises:
   (a) a GH30_8 xylanase selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4;
   (b) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and
   (c) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
87. The method of any one of paragraphs 1-86, wherein the enzyme blend comprises:
   (a) a GH30_8 xylanase selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4;
   (b) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and
   (c) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
88. The method of paragraphs 86 or 87, wherein the GH30_8 xylanase and the GH5_21 xylanase are present in the blend in a ratio of 1:1, 1.1:1, 1.2:1, 1.3:1, 1.4:1, 1.5:1, 1:1.5, 1:1.4, 1:1.3, 1:1.2, or 1:1.1 of GH30_8 xylanase to GH5_21 xylanase.
89. The method of any one of paragraphs 1-88, wherein the enzyme blend comprises:
   (a) at least one xylanase from a family selected from the group consisting of a GH3 family xylanase, GH5 family xylanase, a GH8 family xylanase, a GH10 family xylanase, a GH11 family xylanase, a GH30 family xylanase, a GH43 family xylanase, and a GH98 family xylanase;
   (b) at least one α-L-arabinofuranosidase from a GH family selected from the group consisting of GH43, GH51 and GH62; and;
   (c) a cellulolytic composition comprising at least three enzymes selected from the group consisting of a cellobiohydrolase I, cellobiohydrolase II, a beta-glucosidase, a GH61A polypeptide having cellulolytic enhancing activity, and an endoglucanase I.
90. The method of any one of paragraphs 1-89, wherein the enzyme blend comprises:
   (a) at least one GH10 xylanase selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1 and amino acids 21 to 405 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 21;
   (b) an arabinofuranosidase selected from the group consisting of:
   (i) a GH43 arabinofuranosidase selected from the group consisting of the arabinofuranosidase shown in amino acids 19 to 558 of SEQ ID NO: 56, the arabinofuranosidase shown in amino acids 24 to 575 of SEQ ID NO: 57, and one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57.
   (ii) a GH51 arabinofuranosidase selected from the group consisting of the arabinofuranosidase shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58, and the arabinofuranosidase shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59;
   (iii) a GH62 α-L-arabinofuranosidase selected from the group consisting of the shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11 and the one shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55; and
   (c) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
91. The method of any one of paragraphs 1-90, wherein the enzyme blend comprises:
   (a) at least one GH10 xylanase selected from the group consisting of the one shown in amino acids 20 to 397 of SEQ ID NO: 1 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1 and amino acids 21 to 405 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 21;
   (b) an arabinofuranosidase selected from the group consisting of:
   (i) a GH43 arabinofuranosidase selected from the group consisting of the arabinofuranosidase shown in amino acids 19 to 558 of SEQ ID NO: 56, the arabinofuranosidase shown in amino acids 24 to 575 of SEQ ID NO: 57, and one having at least 60%, at least 65%, at least 70%, at least 75%, at least 80%, at least 85%, at least 90%, at least 95%, at least 96%, at least 97%, at least 98%, or at least 99% sequence identity to amino acids 19 to 558 of SEQ ID NO: 56 or amino acids 24 to 575 of SEQ ID NO: 57.
   (ii) a GH51 arabinofuranosidase selected from the group consisting of the arabinofuranosidase shown in amino acids 20 to 663 of SEQ ID NO: 58 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 663 of SEQ ID NO: 58, and the arabinofuranosidase shown in amino acids 17 to 643 of SEQ ID NO: 59 or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 643 of SEQ ID NO: 59;
   (iii) a GH62 α-L-arabinofuranosidase selected from the group consisting of the shown in amino acids 17 to 325 of SEQ ID NO: 11, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 325 of SEQ ID NO: 11 and the one shown in amino acids 18 to 335 of SEQ ID NO: 55, or one having at least 60%, at least 65%, at least 70%, at least 75%, at least 80%, at least 85%, at least 90%, at least 95%, at least 96%, at least 97%, at least 98%, or at least 99% sequence identity to amino acids 18 to 335 of SEQ ID NO: 55; and
   (c) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
92. The method of any one of paragraphs 1-91, wherein the enzyme blend comprises:
   (a) a xylanase selected from the group consisting of: (i) a xylanase from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; and
(ii) a xylanase from the genus Talaromyces, for example Talaromyces leycettanus, such as the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2;
   (b) a beta-xylosidase from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12; and
   (c) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
93. The method of any one of paragraphs 1-92, wherein the enzyme blend comprises:
   (a) a xylanase selected from the group consisting of: (i) a xylanase from the genus Aspergillus, for example Aspergillus fumigatus, such as the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1; and
   (ii) a xylanase from the genus Talaromyces, for example Talaromyces leycettanus, such as the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2;
   (b) a beta-xylosidase from the genus Aspergillus, for example Aspergillus fumigatus, such as the beta-xylosidase shown in amino acids 21 to 792 of SEQ ID NO: 12, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 792 of SEQ ID NO: 12; and
   (c) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
94. The method of any one of paragraphs 1-93, wherein the enzyme blend comprises at least one beta-glucanase and a cellulolytic composition, wherein:
   (i) the at least one beta-glucanase is from a glycoside hydrolase family selected from the group consisting of a GH5_15 family beta-glucanase, a GH16 family beta-glucanase, and a GH64 family beta-glucanase.
   (ii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I.
95. The method of any one of paragraphs 1-94, wherein the enzyme blend comprises:
   (a) at least one beta-glucanase from the genus Rasamsonia, for example Rasamsonia byssochlamydoides, such as the beta-glucanase shown in amino acids 20 to 413 of SEQ ID NO: 13, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 13; and
   (b) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
96. The method of any one of paragraphs 1-95, wherein the enzyme blend comprises:
   (a) at least one beta-glucanase from the genus Rasamsonia, for example Rasamsonia byssochlamydoides, such as the beta-glucanase shown in amino acids 20 to 413 of SEQ ID NO: 13, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 13; and
   (b) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
97. The method of any one of paragraphs 1-96, wherein the enzyme blend comprises:
   (a) at least one beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; and
   (b) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
98. The method of any one of paragraphs 1-97, wherein the enzyme blend comprises:
   (a) at least one beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17; and
   (b) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
99. The method of any one of paragraphs 1-98, wherein the enzyme blend comprises:
   (a) at least one beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (b) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
100. The method of any one of paragraphs 1-99, wherein the enzyme blend comprises:
   (a) at least one beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (b) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
101. The method of any one of paragraphs 1-100, wherein the enzyme blend comprises:
   (a) at least one beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (b) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
102. The method of any one of paragraphs 1-101, wherein the enzyme blend comprises:
   (a) at least one beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (b) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
103. The method of any one of paragraphs 1-102, wherein the enzyme blend comprises at least one hemicellulase, at least one beta-glucanase, and a cellulolytic composition, wherein:
   (i) the at least one hemicellulase is selected from the group consisting of an acetylxylan esterase, a α-glucuronidases, a α-L-arabinofuranosidases, a α-L-galactosidase, a beta-xylosidase, a feruloyl esterase, a α-D-galactosidase, a pectin-degrading enzyme, a xylanase, and any combination thereof;
   (ii) the at least one beta-glucanase is from a glycoside hydrolase family selected from the group consisting of a GH5_15 family beta-glucanase, a GH16 family beta-glucanase, and a GH64 family beta-glucanase.
   (iii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I.
104. The method of any one of paragraphs 1-103, wherein the enzyme blend comprises at least one hemicellulase, at least one beta-glucanase, and a cellulolytic composition, wherein:
   (i) the at least one hemicellulase is at least one xylanase selected from the group consisting of a GH3 xylanase, a GH5 xylanase, a GH8 xylanase, GH10 xylanase, a GH11 xylanase, a GH30 xylanase, a GH43 xylanase, and a GH 98 xylanase;
   (ii) the at least one beta-glucanase is from a glycoside hydrolase family selected from the group consisting of a GH5_15 family beta-glucanase, a GH16 family beta-glucanase, and a GH64 family beta-glucanase; and
   (ii) the cellulolytic composition comprises at least three enzymes selected from the group consisting of a cellobiohydrolase I, a cellobiohydrolase II, a beta-glucosidase, a GH61 polypeptide having cellulolytic enhancing activity, and an endoglucanase I.
105. The method of any one of paragraphs 1-104, wherein the enzyme blend comprises at least one xylanase, at least one beta-glucanase, and a cellulolytic composition, wherein:
   (i) the at least one xylanase is selected from the group consisting of an Aspergillus GH10 xylanase, a Talaromyces GH10 xylanase, a Bacillus GH30_8 xylanase, a Chryseobacterium GH5_21 xylanase, an Acetivibrio GH5_34 xylanase, a Clostridium GH5_34 xylanase, a Gonapodya prolifera GH5_34 xylanase, a Paenibacillus GH5_35 xylanase, and any combination of at least two, at least three, at least four, at least five or at least six thereof;
   (ii) the at least one beta-glucanase is selected from the group consisting of a Rasamsonia GH5_15 beta-glucanase, a Trichoderma GH5_15 beta-glucanase, an Albifimbria GH16 beta-glucanase, a Lecanicillium GH16 beta-glucanase, and a Trichoderma GH64 family beta-glucanase; and
   (iii) the cellulolytic composition comprises at least three enzymes selected from the group consisting of an Aspergillus cellobiohydrolase I, an Aspergillus cellobiohydrolase II, an Aspergillus beta-glucosidase, a Penicillium GH61 polypeptide having cellulolytic enhancing activity, and a Trichoderma endoglucanase I.
106. The method of any one of paragraphs 1-105, wherein the enzyme blend comprises at least one xylanase, at least one beta-glucanase, and a cellulolytic composition, wherein:
   (i) the at least one xylanase is selected from the group consisting of an Aspergillus fumigatus GH10 xylanase, a Talaromyces leycettanus GH10 xylanase, a Bacillus subtilis GH30_8 xylanase, a Chryseobacterium sp-10696 GH5_21 xylanase, an Acetivibrio cellulyticusGH5_34 xylanase, a Clostridium thermocellum GH5_34 xylanase, a Gonapodya prolifera GH5_34 xylanase, a Paenibacillus genus GH5_35 xylanase (e.g., Paenibacillus favisporus, Paenibacillus illinoisensis or Paenibacillus sp. GH5_35 xylanase), and any combination of at least two, at least three, at least four, at least five or at least six thereof; and
   (ii) the at least one beta-glucanase is selected from the group consisting of a Rasamsonia byssochlamydoides GH5_15 beta-glucanase, a Trichoderma atroviride GH5_15 beta-glucanase, a Trichoderma harzianum GH5_15 beta-glucanase, an Albifimbria verrucaria GH16 beta-glucanase, a Lecanicillium sp. WMM742 GH16 beta-glucanase, and a Trichoderma harzianum GH64 family beta-glucanase;
   (iii) the cellulolytic composition comprises at least three enzymes selected from the group consisting of an Aspergillus fumigatus cellobiohydrolase I, an Aspergillus fumigatus cellobiohydrolase II, an Aspergillus fumigatus beta-glucosidase, a Penicillium emersonii GH61 polypeptide having cellulolytic enhancing activity, and a Trichoderma reesei endoglucanase I.
107. The method of any one of paragraphs 1-106, wherein the enzyme blend comprises:
   (a) at least one xylanase selected from the group consisting of:
   (i) the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO:1;
   (ii) the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2;
   (iii) the xylanase shown in amino acids 28 to 417 of SEQ ID NO: 3, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4;
   (iv) the xylanase shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4;
   (v) the xylanase shown in amino acids 25 to 551 of SEQ ID NO: 5, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5;
   (vi) the xylanase shown in amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6;
   (vii) the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7;
   (viii) the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8;
   (ix) the xylanase shown in amino acids 37 to 573 of SEQ ID NO: 9, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9;
   (x) the xylanase shown in amino acids 36 to 582 of SEQ ID NO: 10 or one having at least 60%, at least 65%, at least 70%, at least 75%, at least 80%, at least 85%, at least 90%, at least 95%, at least 96%, at least 97%, at least 98%, or at least 99% sequence identity to amino acids 36 to 582 of SEQ ID NO: 10;
   (xi) the xylanase shown in amino acids 24 to 337 of SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to amino acids 24 to 337 of SEQ ID NO: 53;
   (xii) the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 536 of SEQ ID NO: 54;
   (b) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (c) and a cellulolytic composition comprising at least three enzymes selected from the group consisting of:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and/or
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24; and (v) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
108. The method of any one of paragraphs 1-107, wherein the enzyme blend comprises:
   (a) at least one xylanase selected from the group consisting of:
   (i) the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1;
   (ii) the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2;
   (iii) the xylanase shown in amino acids 28 to 417 of SEQ ID NO: 3, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4;
   (iv) the xylanase shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4;
   (v) the xylanase shown in amino acids 25 to 551 of SEQ ID NO: 5, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5;
   (vi) the xylanase shown in amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6;
   (vii) the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7;
   (viii) the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8;
   (ix) the xylanase shown in amino acids 37 to 573 of SEQ ID NO: 9, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9;
   (x) the xylanase shown in amino acids 36 to 582 of SEQ ID NO: 10 or one having at least 60%, at least 65%, at least 70%, at least 75%, at least 80%, at least 85%, at least 90%, at least 95%, at least 96%, at least 97%, at least 98%, or at least 99% sequence identity to amino acids 36 to 582 of SEQ ID NO: 10;
   (xi) the xylanase shown in amino acids 24 to 337 of SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to amino acids 24 to 337 of SEQ ID NO: 53;
   (xii) the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 536 of SEQ ID NO: 54;
   (b) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (c) a cellulolytic composition comprising:
(i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
108. The method of any one of paragraphs 1-107, wherein the enzyme blend comprises:
   (a) at least one xylanase selected from the group consisting of:
   (i) the xylanase shown in amino acids 20 to 397 of SEQ ID NO: 1, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 397 of SEQ ID NO: 1;
   (ii) the xylanase shown in amino acids 21 to 404 of SEQ ID NO: 2, or one having at least 60%, at least 65%, at least 70%, at least 75%, at least 80%, at least 85%, at least 90%, at least 95%, at least 96%, at least 97%, at least 98%, or at least 99% sequence identity to amino acids 21 to 405 of SEQ ID NO: 2;
   (iii) the xylanase shown in amino acids 28 to 417 of SEQ ID NO: 3, or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4;
   (iv) the xylanase shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4;
   (v) the xylanase shown in amino acids 25 to 551 of SEQ ID NO: 5, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5;
   (vi) the xylanase shown in amino acids 25 to 551 of SEQ ID NO: 6, or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6;
   (vii) the xylanase shown in SEQ ID NO: 7, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 7;
   (viii) the xylanase shown in SEQ ID NO: 8, or one having at least 60%, at least 65%, at least 70%, at least 75%, at least 80%, at least 85%, at least 90%, at least 95%, at least 96%, at least 97%, at least 98%, or at least 99% sequence identity to SEQ ID NO: 8;
   (ix) the xylanase shown in amino acids 37 to 573 of SEQ ID NO: 9, or one having at least 60%, at least 65%, at least 70%, at least 75%, at least 80%, at least 85%, at least 90%, at least 95%, at least 96%, at least 97%, at least 98%, or at least 99% sequence identity to amino acids 37 to 573 of SEQ ID NO: 9;
   (x) the xylanase shown in amino acids 36 to 582 of SEQ ID NO: 10 or one having at least 60%, at least 65%, at least 70%, at least 75%, at least 80%, at least 85%, at least 90%, at least 95%, at least 96%, at least 97%, at least 98%, or at least 99% sequence identity to amino acids 36 to 582 of SEQ ID NO: 10;
   (xi) the xylanase shown in amino acids 24 to 337 of SEQ ID NO: 53 or one having at least 60%, at least 65%, at least 70%, at least 75%, at least 80%, at least 85%, at least 90%, at least 95%, at least 96%, at least 97%, at least 98%, or at least 99% sequence identity to amino acids 24 to 337 of SEQ ID NO: 53;
   (xii) the xylanase shown in amino acids 1 to 536 of SEQ ID NO: 54, or one having at least 60%, at least 65%, at least 70%, at least 75%, at least 80%, at least 85%, at least 90%, at least 95%, at least 96%, at least 97%, at least 98%, or at least 99% sequence identity to amino acids 1 to 536 of SEQ ID NO: 54;
   (b) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (c) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
109. The method of any one of paragraphs 1-108, wherein the enzyme blend comprises:
   (a) a GH30_8 xylanase selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; and/or
   (b) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and
   (c) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (d) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
   (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
110. The method of any one of paragraphs 1-109, wherein the enzyme blend comprises:
   (a) a GH30_8 xylanase selected from the group consisting of the one shown in amino acids 28 to 417 of SEQ ID NO: 3 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 and the one shown in amino acids 28 to 417 of SEQ ID NO: 4 or one having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 4; and/or
   (b) a GH5_21 xylanase selected from the group consisting of comprising, consisting essentially of, or consisting of the one shown in amino acids 25 to 551 of SEQ ID NO: 5 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 5 and the one shown in amino acids 25 to 551 of SEQ ID NO: 6 or one having at least 60%, at least 65%, at least 70%, at least 75%, at least 80%, at least 85%, at least 90%, at least 95%, at least 96%, at least 97%, at least 98%, or at least 99% sequence identity to amino acids 25 to 551 of SEQ ID NO: 6; and
   (c) at least one beta-glucanase selected from the group consisting of:
   (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
   (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
   (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
   (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (d) a cellulolytic composition comprising:
   (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
   (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
   (iii) an endoglucanase I comprising amino acids 23 to 459 of SEQ ID NO: 44 or one having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44.
111. The method of any one of paragraphs 1-110, wherein the cellulolytic composition is derived from a strain selected from the group consisting of Aspergillus, Penicilium, Talaromyces, and Trichoderma, optionally wherein: (i) the Aspergillus strain is selected from the group consisting of Aspergillus aurantiacus, Aspergillus niger and Aspergillus oryzae; (ii) the Penicilium strain is selected from the group consisting of Penicilium emersonii and Penicilium oxalicum; (iii) the Talaromyces strain is selected from the group consisting of Talaromyces aurantiacus and Talaromyces emersonii; and (iv) the Trichoderma strain is Trichoderma reesei.
112. The method of any one of paragraphs 1-111, wherein the cellulolytic composition comprises a Trichoderma reesei cellulolytic composition.
113. The method of any one of paragraphs 1-112, wherein the hemicellulase(s) and/or beta-glucanase(s) are exogenously added during saccharification, fermentation, or simultaneous saccharification and fermentation.
114. The method of any one of paragraphs 1-113, wherein the hemicellulases(s) and/or beta-glucanase(s) are expressed in situ by the fermenting organism during fermentation and/or simultaneous saccharification and fermentation.
115. The method of any one of paragraphs 1-114, wherein at least some the hemicellulase and/or beta-glucanase is exogenously added during saccharification, fermentation, or simultaneous saccharification and fermentation and at least some of the hemicellulase and/or beta-glucanase is expressed in situ by the fermenting organism during fermentation and/or simultaneous saccharification and fermentation.
116. The method of any one of paragraphs 1-115, wherein the fermenting organism is a recombinant host cell comprising a heterologous polynucleotide encoding the hemicellulase(s) and/or beta-glucanase(s).
117. The method of any one of paragraphs 1-116, wherein the recombinant host cell further comprises a heterologous polynucleotide encoding a glucoamylase.
118. The method of paragraph 117, wherein the heterologous polynucleotide encoding the glucoamylase is operably linked to a promoter that is foreign to the polynucleotide.
119. The method of any of paragraphs 1-118, wherein the recombinant host cell further comprises a heterologous polynucleotide encoding an alpha-amylase.
120. The method of paragraph 119, wherein the heterologous polynucleotide encoding the alpha-amylase is operably linked to a promoter that is foreign to the polynucleotide.
121. The method of any of paragraphs 74-86, wherein the cell further comprises a heterologous polynucleotide encoding a protease.
122. The method of paragraph 121, wherein the heterologous polynucleotide encoding the protease is operably linked to a promoter that is foreign to the polynucleotide.
123. The method of any of paragraphs 1-122, wherein the cell further comprises a disruption to an endogenous gene encoding a glycerol 3-phosphate dehydrogenase (GPD).
124. The method of any of paragraphs 1-123, wherein the cell further comprises a disruption to an endogenous gene encoding a glycerol 3-phosphatase (GPP).
125. The method of any of paragraphs 1-124, wherein the recombinant host cell is a yeast cell.
126. The method of any of paragraphs 1-125, wherein the recombinant host cell is a Saccharomyces, Rhodotorula, Schizosaccharomyces, Kluyveromyces, Pichia, Hansenula, Rhodosporidium, Candida, Yarrowia, Lipomyces, Cryptococcus, or Dekkera sp. cell.
127. The method of any of paragraphs 1-126, wherein the recombinant host cell is a Saccharomyces cerevisiae cell.
128. A composition comprising;
   (a) a recombinant yeast host cell; and
   (b) at least one hemicellulase according to any of paragraphs 1-127 and/or at least one beta-glucanase according to any of paragraphs 1-127,
   wherein the yeast host cell comprises a heterologous polynucleotide encoding a glucoamylase, an alpha-amylase, protease, and/or cellulase.
129. The composition of paragraph 128, which is a fermenting or fermented mash composition comprising the recombinant yeast host cell and the at least one hemicellulase and/or at least one beta-glucanase.
129. The composition of paragraph 128, which is a whole stillage composition comprising the recombinant yeast host cell and the at least one hemicellulase and/or at least one beta-glucanase.
130. A composition comprising:
   (a) a recombinant yeast host cell; and
   (b) at least one hemicellulase and/or at least one beta-glucanase,
   wherein the yeast host cell comprises a heterologous polynucleotide encoding a glucoamylase, an alpha-amylase, protease, and/or cellulase;
   wherein the at least one hemicellulase is selected from the group consisting of the mature polypeptide of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, SEQ ID NO: 59, and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, or SEQ ID NO: 59; and
   wherein the at least one beta-glucanase is selected from the group consisting of the mature polypeptide of SEQ ID NO: 14, SEQ ID NO: 15, SEQ ID NO: 16, SEQ ID NO: 17, SEQ ID NO: 18, SEQ ID NO: 19, SEQ ID NO: 20, and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 14, SEQ ID NO: 15, SEQ ID NO: 16, SEQ ID NO: 17, SEQ ID NO: 18, SEQ ID NO: 19, or SEQ ID NO: 20.
131. A composition comprising:
   (a) a recombinant yeast host cell comprising a heterologous polynucleotide encoding a glucoamylase, an alpha-amylase, and/or protease;
   (b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity; and
   (c) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
132. A composition comprising:
   (a) a recombinant yeast host cell comprising a heterologous polynucleotide encoding a glucoamylase, an alpha-amylase, and/or protease;
   (b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (c) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
   (d) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
133. A composition comprising:
   (a) a recombinant yeast host cell comprising a heterologous polynucleotide encoding a glucoamylase, an alpha-amylase, and/or protease;
   (b) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (c) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
134. A composition comprising:
   (a) a recombinant yeast host cell comprising a heterologous polynucleotide encoding a glucoamylase, an alpha-amylase, and/or protease;
   (b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (c) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (d) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
135. A composition comprising:
   (a) a recombinant yeast host cell comprising a heterologous polynucleotide encoding a glucoamylase, an alpha-amylase, and/or protease;
   (b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (c) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
   (d) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (e) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
136. A composition comprising:
   (a) a recombinant yeast host cell comprising a heterologous polynucleotide encoding a glucoamylase, an alpha-amylase, and/or protease;
   (b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity; and
   (c) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
137. A composition comprising:
   (a) a recombinant yeast host cell comprising a heterologous polynucleotide encoding a glucoamylase, an alpha-amylase, and/or protease;
   (b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (c) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
   (d) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
138. A composition comprising:
   (a) a recombinant yeast host cell comprising a heterologous polynucleotide encoding a glucoamylase, an alpha-amylase, and/or protease;
   (b) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (c) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
139. A composition comprising:
   (a) a recombinant yeast host cell comprising a heterologous polynucleotide encoding a glucoamylase, an alpha-amylase, and/or protease;
   (b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (c) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (d) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
140. A composition comprising:
   (a) a recombinant yeast host cell comprising a heterologous polynucleotide encoding a glucoamylase, an alpha-amylase, and/or protease;
   (b) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (c) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
   (d) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (e) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
141. The composition of any one of paragraphs 128-140, further comprising a glucoamylase.
142. The composition of any one of paragraphs 128-141, further comprising a glucoamylase selected from the group consisting of:
   (i) the glucoamylase of SEQ ID NO: 48 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity;
   (ii) the glucoamylase of SEQ ID NO: 49 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity.
   (iii) the glucoamylase of SEQ ID NO: 50 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 50, which has glucoamylase activity;
   (iv) the glucoamylase of SEQ ID NO: 51 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 51, which has glucoamylase activity; and
   (v) the glucoamylase of SEQ ID NO: 52 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 52, which has glucoamylase activity.
143. The composition of any one of paragraphs 128 to 142, further comprising a glucoamylase, wherein the glucoamylase is a blend comprising: (i) the Talaromyces emersonii glucoamylase of SEQ ID NO: 49 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity; and (ii) the Trametes cingulata glucoamylase of SEQ ID NO: 48 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity.
144. The composition of any one of paragraphs 128 to 142, further comprising a glucoamylase, wherein the glucoamylase is a blend comprising: (i) the Talaromyces emersonii glucoamylase of SEQ ID NO: 49 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity; (ii) the Trametes cingulata glucoamylase of SEQ ID NO: 48 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity; and (iii) the Rhizomucor pusillus alpha-amylase with Aspergillus niger glucoamylase linker and SBD of SEQ ID NO: 39 herein, preferably with the following substitutions: G128D+D143N, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.
145. The composition of any one of paragraphs 128 to 142, further comprising a glucoamylase, wherein the glucoamylase is a blend comprising:
   (i) the Gloeophyllum sepiarium glucoamylase of SEQ ID NO: 51 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 51, which has glucoamylase activity; and (ii) the Rhizomucor pusillus alpha-amylase with Aspergillus niger glucoamylase linker and SBD of SEQ ID NO: 39 herein, preferably with the following substitutions: G128D+D143N, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.
146. The composition of any one of paragraphs 128 to 145, further comprising a trehalase.
147. The composition of any one of paragraphs 128 to 147, further comprising a trehalase selected from the group consisting of:
   (i) the Myceliophthora sepedonium trehalase disclosed herein as SEQ ID NO: 46 or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 46, which has trehalase activity; and
   (ii) the Talaromyces funiculosus trehalase disclosed herein as SEQ ID NO: 47, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 47, which has trehalase activity.
148. An enzyme blend according to any one of paragraphs 1 to 147.
149. An enzyme blend comprising at least one hemicellulase according to any one of paragraphs 1 to 148 and/or at least one beta-glucanase according to any one of paragraphs 1 to 148.
150. The enzyme blend of paragraphs 148 or 149, wherein the at least one hemicellulase is selected from the group consisting of the mature polypeptide of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, SEQ ID NO: 59, and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 53, SEQ ID NO: 54, SEQ ID NO: 55, SEQ ID NO: 56, SEQ ID NO: 57, SEQ ID NO: 58, or SEQ ID NO: 59; and
   wherein the at least one beta-glucanase is selected from the group consisting of the mature polypeptide of SEQ ID NO: 14, SEQ ID NO: 15, SEQ ID NO: 16, SEQ ID NO: 17, SEQ ID NO: 18, SEQ ID NO: 19, SEQ ID NO: 20, and polypeptides having at least 60%, at least 65%, at least 70%, at least 75%, at least 80%, at least 85%, at least 90%, at least 95%, at least 96%, at least 97%, at least 98%, or at least 99% amino acid sequence identity to SEQ ID NO: 14, SEQ ID NO: 15, SEQ ID NO: 16, SEQ ID NO: 17, SEQ ID NO: 18, SEQ ID NO: 19, or SEQ ID NO: 20.
151. The enzyme blend of any one of paragraphs 148 to 150, comprising:
   (a) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity; and
   (b) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
152. The enzyme blend of any one of paragraphs 148 to 151, comprising:
   (a) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (b) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
   (c) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
153. The enzyme blend of any one of paragraphs 148 to 152, comprising:
   (a) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (b) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
154. The enzyme blend of any one of paragraphs 148 to 153, comprising:
   (a) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (b) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (c) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
155. The enzyme blend of any one of paragraphs 148 to 154, comprising:
   (a) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (b) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4;
   (c) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (d) a cellulolytic composition (e.g., derived from a strain of Trichoderma, such as Trichoderma reesei) comprising:
      (i) a cellobiohydrolase I comprising amino acids 27 to 532 of SEQ ID NO: 21 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21, which has cellobiohydrolase activity;
      (ii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23, and which has beta-glucosidase activity; and
      (iii) an endoglucanase I comprising amino acids 23 to 459 of SEQ ID NO: 44 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 23 to 459 of SEQ ID NO: 44, which has endoglucanase activity.
156. The enzyme blend of any one of paragraphs 148 to 155, comprising:
   (a) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity; and
   (b) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
157. The enzyme blend of any one of paragraphs 148 to 156, comprising:
   (a) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (b) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4; and
   (c) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
158. The enzyme blend of any one of paragraphs 148 to 157, comprising:
   (a) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (b) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
159. The enzyme blend of any one of paragraphs 148 to 158, comprising:
   (a) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (b) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (c) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
160. The enzyme blend of any one of paragraphs 148 to 159, comprising:
   (a) a xylanase comprising amino acids 25 to 551 of SEQ ID NO: 5 or amino acids 25 to 551 of SEQ ID NO: 6, or a polypeptide having at least 60%, at least 65%, at least 70%, at least 75%, at least 80%, at least 85%, at least 90%, at least 95%, at least 96%, at least 97%, at least 98%, or at least 99% amino acid sequence identity to amino acids 25 to 551 of SEQ ID NO: 5 or amino acids 25 to 551 of SEQ ID NO: 6, which has xylanase activity;
   (b) a xylanase comprising amino acids 28 to 417 of SEQ ID NO: 3 or amino acids 28 to 417 of SEQ ID NO: 4 or a polypeptide having at least 60%, at least 65%, at least 70%, at least 75%, at least 80%, at least 85%, at least 90%, at least 95%, at least 96%, at least 97%, at least 98%, or at least 99% sequence identity to amino acids 28 to 417 of SEQ ID NO: 3 or amino acids 28 to 417 of SEQ ID NO: 4;
   (c) at least one beta-glucanase selected from the group consisting of:
      (i) at least one GH5_15 beta-glucanase from the genus Rasamsonia, for example Rasamsonia byssochlamydoides, such as the beta-glucanase shown in amino acids 20 to 413 of SEQ ID NO: 14, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 413 of SEQ ID NO: 14;
      (ii) at least one GH5_15 beta-glucanase from the genus Trichoderma, for example Trichoderma atroviride, such as the one shown in amino acids 17 to 408 of SEQ ID NO: 15 or amino acids 18 to 429 of SEQ ID NO: 16, or for example Trichoderma harzianum, such as the one shown in amino acids 18 to 429 of SEQ ID NO: 17, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 408 of SEQ ID NO: 15, amino acids 18 to 429 of SEQ ID NO: 16, or amino acids 18 to 429 of SEQ ID NO: 17;
      (iii) at least one GH16 family beta-glucanase from the genus Albifimbria, for example Albifimbria verrucaria, such as the one shown in amino acids 20 to 286 of SEQ ID NO: 18, or from the genus Lecanicillium, for example Lecanicillium sp. WMM742, such as the one shown in amino acids 20 to 284 of SEQ ID NO: 19, or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 286 of SEQ ID NO: 18, or amino acids 20 to 284 of SEQ ID NO: 19; and
      (iv) at least one GH64 beta-glucanase from the genus Trichoderma, for example Trichoderma harzianum, such as the one shown in amino acids 17 to 447 or amino acids 64 to 447 of SEQ ID NO: 20, or one having at least 60%, at least 65%, at least 70%, at least 75%, at least 80%, at least 85%, at least 90%, at least 95%, at least 96%, at least 97%, at least 98%, or at least 99% sequence identity to amino acids 17 to 447 or 64 to 447 of SEQ ID NO: 20; and
   (d) a cellulolytic composition (e.g., derived from a strain of Trichoderma, such as Trichoderma reesei) comprising:
      (i) a cellobiohydrolase I comprising amino acids 27 to 532 of SEQ ID NO: 21 or one having at least 60%, at least 65%, at least 70%, at least 75%, at least 80%, at least 85%, at least 90%, at least 95%, at least 96%, at least 97%, at least 98%, or at least 99% sequence identity to amino acids 27 to 532 of SEQ ID NO: 21;
      (ii) a cellobiohydrolase II comprising amino acids 20 to 454 of SEQ ID NO: 22 or one having at least 60%, at least 65%, at least 70%, at least 75%, at least 80%, at least 85%, at least 90%, at least 95%, at least 96%, at least 97%, at least 98%, or at least 99% sequence identity to amino acids 20 to 454 of SEQ ID NO: 22;
      (iii) a beta-glucosidase comprising amino acids 20 to 863 of SEQ ID NO: 23 or a variant thereof having at least one substitution selected from the group consisting of F100D, S283G, N456E, and F512Y and at least 60%, at least 65%, at least 70%, at least 75%, at least 80%, at least 85%, at least 90%, at least 95%, at least 96%, at least 97%, at least 98%, or at least 99% sequence identity to amino acids 20 to 863 of SEQ ID NO: 23; and
      (iv) a GH61A polypeptide having cellulolytic enhancing activity comprising amino acids 26 to 253 of SEQ ID NO: 24 or one having at least 60%, at least 65%, at least 70%, at least 75%, at least 80%, at least 85%, at least 90%, at least 95%, at least 96%, at least 97%, at least 98%, or at least 99% sequence identity to amino acids 26 to 253 of SEQ ID NO: 24.
161. The enzyme blend of any one of paragraphs 148 to 160, further comprising a glucoamylase.
162. The enzyme blend of any one of paragraphs 148 to 161, further comprising a glucoamylase selected from the group consisting of:
   (i) the glucoamylase of SEQ ID NO: 48 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity;
   (ii) the glucoamylase of SEQ ID NO: 49 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity.
   (iii) the glucoamylase of SEQ ID NO: 50 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 50, which has glucoamylase activity;
   (iv) the glucoamylase of SEQ ID NO: 51 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 51, which has glucoamylase activity; and
   (v) the glucoamylase of SEQ ID NO: 52 herein or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 52, which has glucoamylase activity.
163. The enzyme blend of any one of paragraphs 148 to 162, further comprising a glucoamylase, wherein the glucoamylase is a blend comprising: (i) the Talaromyces emersonii glucoamylase of SEQ ID NO: 49 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity; and (ii) the Trametes cingulata glucoamylase of SEQ ID NO: 48 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity.
164. The enzyme blend of any one of paragraphs 148 to 163, further comprising a glucoamylase, wherein the glucoamylase is a blend comprising: (i) the Talaromyces emersonii glucoamylase of SEQ ID NO: 49 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 49, which has glucoamylase activity; (ii) the Trametes cingulata glucoamylase of SEQ ID NO: 48 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity; and (iii) the Rhizomucor pusillus alpha-amylase with Aspergillus niger glucoamylase linker and SBD of SEQ ID NO: 39 herein, preferably with the following substitutions: G128D+D143N, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.
165. The enzyme blend of any one of paragraphs 148 to 164, further comprising a glucoamylase, wherein the glucoamylase is a blend comprising:
   (i) the Gloeophyllum sepiarium glucoamylase of SEQ ID NO: 51 herein, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 51, which has glucoamylase activity; and (ii) the Rhizomucor pusillus alpha-amylase with Aspergillus niger glucoamylase linker and SBD of SEQ ID NO: 39 herein, preferably with the following substitutions: G128D+D143N, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.
166. The enzyme blend of any one of paragraphs 148 to 165, further comprising a trehalase.
167. The enzyme blend of any one of paragraphs 148 to 166, further comprising a trehalase selected from the group consisting of:
   (i) the Myceliophthora sepedonium trehalase disclosed herein as SEQ ID NO: 46 or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 46, which has trehalase activity; and
   (ii) the Talaromyces funiculosus trehalase disclosed herein as SEQ ID NO: 47, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 47, which has trehalase activity.
168. The process, enzyme blend, or composition of any of the precending paragraphs, further comprising an amylase blend.
169. The process, enzyme blend, or composition of any of the preceding paragraphs, further comprising an amylase blend, wherein the amylase blend comprises:
   (i) the Trametes cingulate glucoamylase disclosed herein as SEQ ID NO: 48, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 48, which has glucoamylase activity; and
   (ii) a hybrid of the Rhizomucor pusillus alpha-amylase and Aspergillus niger glucoamylase linker and starch binding domain disclosed herein as SEQ ID NO: 39, or a polypeptide having at least 70% identity, at least 71% identity, at least 72% identity, at least 73% identity, at least 74% identity, at least 75% identity, at least 76% identity, at least 77% identity, at least 78% identity, at least 79% identity, at least 80% identity, at least 81% identity, at least 82% identity, at least 83% identity, at least 84% identity, at least 85% identity, at least 86% identity, at least 87% identity, at least 88% identity, at least 89% identity, at least 90% identity, at least 91% identity, at least 92% identity, at least 93% identity, at least 94% identity, at least 95% identity, at least 96% identity, at least 97% identity, at least 98% identity, or at least 99% identity to the mature polypeptide of SEQ ID NO: 39, which has alpha-amylase activity.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control. Various references are cited herein, the disclosures of which are incorporated herein by reference in their entireties. The present invention is further described by the following examples which should not be construed as limiting the scope of the invention.

### Materials & Methods

GH62: GH62 family arabinofuranosidase from Talaromyces pinophilus disclosed in SEQ ID NO: 55.

GH43A: GH43 arabinofuranosidase from Humicola insolens disclosed in SEQ ID NO: 56.

GH43B: GH43 arabinofuranosidase from Humicola insolens disclosed in SEQ ID NO: 57.

GH51A: GH51 arabinofuranosidase from Colletotrichum graminicola disclosed in SEQ ID NO: 58.

GH51B: GH51 arabinofuranosidase from Trametes hirsuta disclosed in SEQ ID NO: 59.

Hemicellulase: Hemicellulase comprising the Aspergillus fumigatus xylanase of SEQ ID NO: 1 and the Aspergillus fumigatus beta-xylosidase of SEQ ID NO: 12.

Cellulase 1: Cellulolytic composition derived from Trichoderma reesei comprising: Aspergillus fumigatus CeI7A CBH1 disclosed as SEQ ID NO: 6 in WO2011/057140 and SEQ ID NO: 21 herein; Aspergillus fumigatus CBH II disclosed as SEQ ID NO: 18 in WO 2011/057140 and as SEQ ID NO: 22 herein; Aspergillus fumigatus beta-glucosidase (SEQ ID NO: 2 in WO 2005/047499 or SEQ ID NO: 23 herein) variant F100D, S283G, N456E, F512Y) disclosed in WO 2012/044915 or co-pending PCT application PCT/US11/054185; and GH61A polypeptide having cellulolytic enhancing activity derived from a strain of Penicillium emersonii (SEQ ID NO: 2 in WO 2011/041397 or SEQ ID NO: 24 herein).

Cellulase 2: Cellulolytic composition derived from Trichoderma reesei comprising: Aspergillus fumigatus CeI7A CBH1 disclosed as SEQ ID NO: 6 in WO2011/057140 and SEQ ID NO: 21 herein; Aspergillus fumigatus beta-glucosidase (SEQ ID NO: 2 in WO 2005/047499 or SEQ ID NO: 23 herein) variant F100D, S283G, N456E, F512Y) disclosed in WO 2012/044915 or co-pending PCT application PCT/US11/054185; and Trichoderma reesei endoglucanase/disclosed as SEQ ID NO: 44 herein).

Glucoamylase SA (GSA): Blend comprising Talaromyces emersonii glucoamylase disclosed as SEQ ID NO: 34 in WO99/28448 or SEQ ID NO: 49 herein, Trametes cingulate glucoamylase disclosed as SEQ ID NO: 2 in WO 06/69289 or SEQ ID NO: 48 herein, and Rhizomucor pusillus alpha-amylase with Aspergillus niger glucoamylase linker and starch binding domain (SBD) disclosed in SEQ ID NO: 39 herein having the following substitutions G128D+D143N (activity ratio in AGU:AGU:FAU-F is about 20:5:1).

Amylase Blend A (ABA): a blend of a glucoamylase from Trametes cingulate disclosed herein as SEQ ID NO: 48 and a hybrid of the Rhizomucor pusillus alpha-amylase and Aspergillus niger glucoamylase linker and starch binding domain, which is disclosed in WO 2006/069290 or as SEQ ID NO: 39 herein.

Xylanase (Xyl): GH5_21 xylanase from Chryseobacterium sp-10696 disclosed in SEQ ID NO: 5 (or 6) herein.

Xylanase (VT): GH10 xylanase from Talaromyces leycettanus disclosed in SEQ ID NO: 2.

GH5 21a: GH5_21 xylanase from Chryseobacterium sp-10696 disclosed in SEQ ID NO: 5 herein.

GH5 21b: GH5_21 xylanase from Chryseobacterium sp-10696 disclosed in SEQ ID NO: 6 herein.

GH5 34: GH5_34 xylanase from Gonapodya prolifera disclosed in SEQ ID NO: 53 herein.

GH5 35: Gh5_35 xylanase from Paenibacillus favisporus disclosed in SEQ ID NO: 54 herein.

GH30 8: GH30_8 xylanase from Bacillus subtilis disclosed in SEQ ID NO: 4 herein.

AvGH16: Albifimbria verrucaria GH16 family beta-glucanase disclosed in SEQ ID NO: 18 herein.

LsGH16: Lecanicillium sp. VMM742 GH16 family beta-glucanase disclosed in SEQ ID NO: 19 herein.

TaGH5 15a: Trichoderma atroviride GH5_15 family beta-glucanase disclosed in SEQ ID NO: 15 herein.

TaGH5 15c: Trichoderma atroviride GH5_15 family beta-glucanase disclosed in SEQ ID NO: 16 herein.

RbGH5 15: Rasamsonia byssochlamydoides GH5_15 family beta-glucanase disclosed in SEQ ID NO: 14 herein.

ThGH5 15: Trichoderma harzianum GH5_15 family beta-glucanase disclosed in SEQ ID NO: 17 herein.

ThGH64: Trichoderma harzianum GH64 family beta-glucanase disclosed in SEQ ID NO: 20 herein.

### Beta-Glucanase Activity Assays

### Beta-Glucanase Activity

Beta-glucanase activity is determined by measuring concentration of reducing sugars (RS) released by a beta-glucanase after hydrolysis of appropriate beta-glucan substrate. Activity of GH16 beta-1,3(4)-glucanases and GH64 beta-1,3-glucanases is determined using CM-Pachyman (beta-1,3-glucan, P-CMPAC, Megazyme). Activity of GH5_15 beta-1,6-glucanases and GH30_3 beta-1,6-glucanases is determined using Pustulan (beta-1,6-glucan, YP15423, Carbosynth). The RS concentration is measured using p-hydroxybenzoic acid hydrazide (PHBAH) assay adapted to a 96-well microplate format. In the assay, the reaction between reducing ends of C6 and C5 sugars and PHBAH results in a formation of hydrazones, which have intense yellow color and can be detected by absorbance measurement at 410 nm.

### Enzymatic Hydrolysis of Beta-Glucan Substrate

Enzymatic hydrolysis is initiated by combining 80 ul of 2.5 g/L beta-glucan substrate, 10 ul of appropriately diluted enzyme sample, and 10 ul of 50 mM Glucono-Delta-Lactone (GDL) in a hard-shell 96-well PCR plate (HSP-9631, Bio-Rad). GDL is added to inhibit beta-glucosidase activity in an expression host background. Each incubation mixture (total volume 100 ul) includes 2 g/L substrate, enzyme, and 5 mM GDL in 50 mM Na-Acetate buffer, pH 5.0. The plate is sealed with an aluminum sealing tape (Costar #6570, Corning Inc.), and incubated in a thermocycler (Mastercycler Pro S, Eppendorf) at 50 °C for 10 min, followed by cooling down to 10 °C.

Each enzyme sample is serially diluted 2-fold eight times in 50 mM sodium acetate buffer, pH 5.0 to generate protein dose profile, and each enzyme dose is typically assayed in triplicate. Each plate includes two sets of glucose standards, 0.0625-1 mM and 0.3125-5 mM. Glucose standards are prepared by diluting 10 mM stock glucose solution in 50 mM sodium acetate buffer, pH 5.0. Each glucose standard (100 ul) is treated similarly to the samples.

### PHBAH Assay.

Upon completion of the enzymatic hydrolysis step, 50 ul of freshly prepared PHBAH reagent is added to each well of a microplate, bringing the total volume in each well to 150 ul. The PHBAH reagent is prepared just prior to use by dissolving 1.5% PHBAH in 2% NaOH/50 g/L Na, K Tartrate Tetrahydrate stock solution. The plate is sealed with an aluminum sealing tape (Costar #6570, Corning Inc.), and incubated in a thermocycler (Mastercycler pro S, Eppendorf) at 80 °C for 10 min, followed by cooling down to 4 °C.

After the incubation, 100 ul of each well is transferred to a 96-well flat-bottom microplate (Costar #9017, Corning Inc.) using Liquidator 96 pipetting system (Rainin) or appropriate robot protocol. The absorption at 410 nm (A410) is measured using SpectraMax M5 plate reader (Molecular Devices). If any of the A410 values are greater than 2.5, the plate is additionally diluted with DDI water (typically by a factor of 5), and the A410 is read again.

RS concentration in each well (mM) is calculated using a standard glucose curve. Only A410 values that fall within the 0.05-2.5 range are included in the calculations. Specific activity of each beta-glucanase (umol RS/(min*mg protein)) is calculated from the initial slope of each protein dose response curve (mmol RS/mg protein). Only the data within a linear range of each dose response curve are included in the calculations.

### Xylose Solubilization Assay

Xylanase activity, i.e., the activity of a xylanase towards defatted destrached Maize (DFDSM), can be measured by High-Performance Anion-Exchange Chromatography with Pulsed Amperometric Detection (HPAE-PAD). 2% (w/w) DFDSM suspension can be prepared in 100 mM sodium acetate, 5 mM CaCl₂, pH 5 and allowed to hydrate for 30 minutes at room temperature under gentle stirring. After hydration, 200 μl substrate suspension can be pipetted into a 96 well plate and mixed with 20 μl enzyme solution to obtain a final enzyme concentration of 20 PPM relative to substrate (20 μg enzyme/g substrate). The enzyme/substrate mixtures can then be left for hydrolysis in 2.5 hours at 40 °C under gentle agitation (500 RPM) in a plate incubator (Biosan PST-100 HL). After enzymatic hydrolysis, the enzyme/substrate plates can be centrifuged for 10 minutes at 3000 RPM and 50 μl supernatant (hydrolysate) is mixed with 100 μl 1.6 M HCl and transferred to 300 μl PCR tubes and left for acid hydrolysis for 40 minutes at 90 °C in a PCR machine. The purpose of the acid hydrolysis is to convert soluble polysaccharides, released by the xylanase, into mono-saccharides, which can be quantified using HPAE-PAD. Samples are neutralized with 125 μl 1.4 M NAOH after acid hydrolysis and mounted on the HPAE-PAD for mono-saccharide analysis (xylose, arabinose and glucose) (Dionex ICS-3000 using a CarboPac PA1 column). Appropriate calibration curves are made using mono-saccharides stock solutions which are subjected to the same procedure of acid hydrolysis as the samples. The percentage xylose solubilized is calculated according to the equation:

$$\% Xylose solubilized = \frac{[ Xylose ] * V * MW}{Xxyl * Msub}$$

where [xylose] denotes the concentration of xylose in the supernatant measured by HPAE-PAD, V the volume of the sample, MW, the molecular weight of internal xylose in arabino-xylan (132 g/mol), Xxyl, the fraction of xylose in DFDSM (0.102) and Msub, the mass of DFDSM in the sample.

### Protease Assays

### AZCL-Casein Assay

A solution of 0.2% of the blue substrate AZCL-casein is suspended in Borax/NaH₂PO₄ buffer pH9 while stirring. The solution is distributed while stirring to microtiter plate (100 microL to each well), 30 microL enzyme sample is added and the plates are incubated in an Eppendorf Thermomixer for 30 minutes at 45 °C and 600 rpm. Denatured enzyme sample (100 °C boiling for 20 min) is used as a blank. After incubation the reaction is stopped by transferring the microtiter plate onto ice and the coloured solution is separated from the solid by centrifugation at 3000 rpm for 5 minutes at 4 °C. 60 microL of supernatant is transferred to a microtiter plate and the absorbance at 595 nm is measured using a BioRad Microplate Reader.

pNA-Assay

50 microL protease-containing sample is added to a microtiter plate and the assay is started by adding 100 microL 1 mM pNA substrate (5 mg dissolved in 100 microL DMSO and further diluted to 10 mL with Borax/NaH₂PO₄ buffer pH 9.0). The increase in OD₄₀₅ at room temperature is monitored as a measure of the protease activity.

### Glucoamylase Activity (AGU)

Glucoamylase activity may be measured in Glucoamylase Units (AGU).

The Novo Glucoamylase Unit (AGU) is defined as the amount of enzyme, which hydrolyzes 1 micromole maltose per minute under the standard conditions 37 °C, pH 4.3, substrate: maltose 23.2 mM, buffer: acetate 0.1 M, reaction time 5 minutes.

An autoanalyzer system may be used. Mutarotase is added to the glucose dehydrogenase reagent so that any alpha-D-glucose present is turned into beta-D-glucose. Glucose dehydrogenase reacts specifically with beta-D-glucose in the reaction mentioned above, forming NADH which is determined using a photometer at 340 nm as a measure of the original glucose concentration.

AMG incubation:

| | |
|---|---|
| Substrate: | maltose 23.2 mM |
| Buffer: | acetate 0.1M |
| pH: | 4.30 ± 0.05 |
| Incubation temperature: | 37 °C ± 1 |
| Reaction time: | 5 minutes |
| Enzyme working range: | 0.5-4.0 AGU/mL |

Color reaction:

| GlucDH: | 430 | U/L |
|---|---|---|
| Mutarotase: | 9 | U/L |
| NAD: | 0.21 | mM |
| Buffer: | phosphate 0.12M; 0.15M NaCl | |
| pH: | 7.60 ± 0.05 | |
| Incubation temperature: | 37 °C ± 1 | |
| Reaction time: | 5 minutes | |
| Wavelength: | 340 | nm |

A folder JEB-SM-0131.02/01) describing this analytical method in more detail is available on request from Novozymes A/S, Denmark, which folder is hereby included by reference.

### Acid Alpha-Amylase Activity (AFAU)

Acid alpha-amylase activity may be measured in AFAU (Acid Fungal Alpha-amylase Units), which are determined relative to an enzyme standard. 1 AFAU is defined as the amount of enzyme which degrades 5.260 mg starch dry matter per hour under the below mentioned standard conditions.

Acid alpha-amylase, an endo-alpha-amylase (1,4-alpha-D-glucan-glucanohydrolase, E.C. 3.2.1.1) hydrolyzes alpha-1,4-glucosidic bonds in the inner regions of the starch molecule to form dextrins and oligosaccharides with different chain lengths. The intensity of color formed with iodine is directly proportional to the concentration of starch. Amylase activity is determined using reverse colorimetry as a reduction in the concentration of starch under the specified analytical conditions.

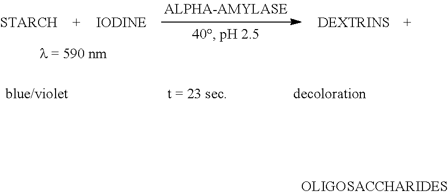

### Standard Conditions/Reaction Conditions:

Substrate: Soluble starch, approx. 0.17 g/L
Buffer: Citrate, approx. 0.03 M
Iodine (12): 0.03 g/L
CaCl₂): 1.85 mM
pH: 2.50±0.05
Incubation temperature: 40 °C
Reaction time: 23 seconds
Wavelength: 590 nm
Enzyme concentration: 0.025 AFAU/mL
Enzyme working range: 0.01-0.04 AFAU/mL

A folder EB-SM-0259.02/01 describing this analytical method in more detail is available upon request to Novozymes A/S, Denmark, which folder is hereby included by reference.

### Alpha-Amylase Activity (KNU)

The alpha-amylase activity may be determined using potato starch as substrate. This method is based on the break-down of modified potato starch by the enzyme, and the reaction is followed by mixing samples of the starch/enzyme solution with an iodine solution. Initially, a blackish-blue color is formed, but during the break-down of the starch the blue color gets weaker and gradually turns into a reddish-brown, which is compared to a colored glass standard.

One Kilo Novo alpha amylase Unit (KNU) is defined as the amount of enzyme which, under standard conditions (i.e., at 37 °C+/−0.05; 0.0003 M Ca²⁺; and pH 5.6) dextrinizes 5260 mg starch dry substance Merck Amylum soluble.

A folder EB-SM-0009.02/01 describing this analytical method in more detail is available upon request to Novozymes A/S, Denmark, which folder is hereby included by reference.

### Determination of FAU(F)

FAU(F) Fungal Alpha-Amylase Units (Fungamyl) is measured relative to an enzyme standard of a declared strength.

Reaction conditions

| Temperature | 37 | °C |
|---|---|---|
| pH | 7.15 | |
| Wavelength | 405 | nm |
| Reaction time | 5 | min |
| Measuring time | 2 | min |

A folder (EB-SM-0216.02) describing this standard method in more detail is available on request from Novozymes A/S, Denmark, which folder is hereby included by reference.

### Determination of Pullulanase Activity (NPUN)

Endo-pullulanase activity in NPUN is measured relative to a Novozymes pullulanase standard. One pullulanase unit (NPUN) is defined as the amount of enzyme that releases 1 micro mol glucose per minute under the standard conditions (0.7% red pullulan (Megazyme), pH 5, 40 °C, 20 minutes). The activity is measured in NPUN/ml using red pullulan.

1 mL diluted sample or standard is incubated at 40 °C for2 minutes. 0.5 mL 2% red pullulan, 0.5 M KCl, 50 mM citric acid, pH 5 are added and mixed. The tubes are incubated at 40 °C for 20 minutes and stopped by adding 2.5 ml 80% ethanol. The tubes are left standing at room temperature for 10-60 minutes followed by centrifugation 10 minutes at 4000 rpm. OD of the supernatants is then measured at 510 nm and the activity calculated using a standard curve.

The present invention is described in further detail in the following examples which are offered to illustrate the present invention, but not in any way intended to limit the scope of the invention as claimed. All references cited herein are specifically incorporated by reference for that which is described therein.

### EXAMPLES

### Example 1

### Stability of Alpha-Amylase Variants

The stability of a reference alpha-amylase (Bacillus stearothermophilus alpha-amylase with the mutations 1181*+G182*+N193F truncated to 491 amino acids (using SEQ ID NO: 126 for numbering)) and alpha-amylase variants thereof was determined by incubating the reference alpha-amylase and variants at pH 4.5 and 5.5 and temperatures of 75 °C and 85 °C with 0.12 mM CaCl₂ followed by residual activity determination using the EnzChek® substrate (EnzChek® Ultra Amylase assay kit, E33651, Molecular Probes).

Polypeptide enzyme samples were diluted to working concentrations of 0.5 and 1 or 5 and 10 ppm (micrograms/ml) in enzyme dilution buffer (10 mM acetate, 0.01% Triton X100, 0.12 mM CaCl₂, pH 5.0). Twenty microliters enzyme sample was transferred to 48-well PCR MTP and 180 microliters stability buffer (150 mM acetate, 150 mM MES, 0.01% Triton X100, 0.12 mM CaCl₂, pH 4.5 or 5.5) was added to each well and mixed. The assay was performed using two concentrations of enzyme in duplicates. Before incubation at 75 °C or 85 °C, 20 microliters was withdrawn and stored on ice as control samples. Incubation was performed in a PCR machine at 75 °C and 85 °C. After incubation samples were diluted to 15 ng/mL in residual activity buffer (100 mM Acetate, 0.01% Triton X100, 0.12 mM CaCl₂, pH 5.5) and 25 microliters diluted enzyme was transferred to black 384-MTP. Residual activity was determined using the EnzChek substrate by adding 25 microliters substrate solution (100 micrograms/ml) to each well. Fluorescence was determined every minute for 15 minutes using excitation filter at 485-P nm and emission filter at 555 nm (fluorescence reader is Polarstar, BMG). The residual activity was normalized to control samples for each setup.

Assuming logarithmic decay half life time (T1/2(min)) was calculated using the equation: T1/2(min)=T(min)*LN(0.5)/LN(% RA/100), where T is assay incubation time in minutes, and % RA is % residual activity determined in assay.

Using this assay setup the half life time was determined for the reference alpha-amylase and variant thereof as shown in Table 1.

TABLE 1

| | T½ (min) | T½ (min) | T½ (min) |
|---|---|---|---|
| | (pH 4.5, | (pH 4.5, | (pH 5.5, |
| | 75 °C, | 85 °C, | 85 °C, |
| | 0.12 mM | 0.12 mM | 0.12 mM |
| Mutations | CaCl₂) | CaCl₂) | CaCl₂) |
| Reference Alpha-Amylase A | 21 | 4 | 111 |
| Reference Alpha-Amylase A | 32 | 6 | 301 |
| with the substitution V59A | | | |
| Reference Alpha-Amylase A | 28 | 5 | 230 |
| with the substitution V59E | | | |
| Reference Alpha-Amylase A | 28 | 5 | 210 |
| with the substitution V59I | | | |
| Reference Alpha-Amylase A | 30 | 6 | 250 |
| with the substitution V59Q | | | |
| Reference Alpha-Amylase A | 149 | 22 | ND |
| with the substitutions | | | |
| V59A + Q89R + G112D + | | | |
| E129V + K177L + R179E + | | | |
| K220P + N224L + Q254S | | | |
| Reference Alpha-Amylase A | >180 | 28 | ND |
| with the substitutions | | | |
| V59A + Q89R + E129V + | | | |
| K177L + R179E + H208Y + | | | |
| K220P + N224L + Q254S | | | |
| Reference Alpha-Amylase A | 112 | 16 | ND |
| with the substitutions V59A + | | | |
| Q89R + E129V +K177L + | | | |
| R179E + K220P + N224L + | | | |
| Q254S + D269E + D281N | | | |
| Reference Alpha-Amylase A | 168 | 21 | ND |
| with the substitutions | | | |
| V59A + Q89R + E129V + | | | |
| K177L + R179E + K220P + | | | |
| N224L + Q254S + I270L | | | |
| Reference Alpha-Amylase A | >180 | 24 | ND |
| with the substitutions | | | |
| V59A + Q89R + E129V + | | | |
| K177L + R179E + K220P + | | | |
| N224L + Q254S + H274K | | | |
| Reference Alpha-Amylase A | 91 | 15 | ND |
| with the substitutions | | | |
| V59A + Q89R + E129V + | | | |
| K177L + R179E + K220P + | | | |
| N224L + Q254S + Y276F | | | |
| Reference Alpha-Amylase A | 141 | 41 | ND |
| with the substitutions | | | |
| V59A + E129V + R157Y + | | | |
| K177L + R179E + K220P + | | | |
| N224L + S242Q + Q254S | | | |
| Reference Alpha-Amylase A | >180 | 62 | ND |
| with the substitutions | | | |
| V59A + E129V + K177L + | | | |
| R179E + H208Y + K220P + | | | |
| N224L + S242Q + Q254S | | | |
| Reference Alpha-Amylase A | >180 | 49 | >480 |
| with the substitutions | | | |
| V59A + E129V + K177L + | | | |
| R179E + K220P + N224L + | | | |
| S242Q + Q254S | | | |
| Reference Alpha-Amylase A | >180 | 53 | ND |
| with the substitutions | | | |
| V59A + E129V + K177L + | | | |
| R179E + K220P + N224L + | | | |
| S242Q + Q254S + H274K | | | |
| Reference Alpha-Amylase A | >180 | 57 | ND |
| with the substitutions | | | |
| V59A + E129V + K177L + | | | |
| R179E + K220P + N224L + | | | |
| S242Q + Q254S + Y276F | | | |
| Reference Alpha-Amylase A | >180 | 37 | ND |
| with the substitutions | | | |
| V59A + E129V + K177L + | | | |
| R179E + K220P + N224L + | | | |
| S242Q + Q254S + D281N | | | |
| Reference Alpha-Amylase A | >180 | 51 | ND |
| with the substitutions | | | |
| V59A + E129V + K177L + | | | |
| R179E + K220P + N224L + | | | |
| S242Q + Q254S + M284T | | | |
| Reference Alpha-Amylase A | >180 | 45 | ND |
| with the substitutions | | | |
| V59A + E129V + K177L + | | | |
| R179E + K220P + N224L + | | | |
| S242Q + Q254S + G416V | | | |
| Reference Alpha-Amylase A | 143 | 21 | >480 |
| with the substitutions | | | |
| V59A + E129V + K177L + | | | |
| R179E + K220P + N224L + | | | |
| Q254S | | | |
| Reference Alpha-Amylase A | >180 | 22 | ND |
| with the substitutions | | | |
| V59A + E129V + K177L + | | | |
| R179E + K220P + N224L + | | | |
| Q254S + M284T | | | |
| Reference Alpha-Amylase A | >180 | 38 | ND |
| with the substitutions | | | |
| A91L + M96I + E129V + | | | |
| K177L + R179E + K220P + | | | |
| N224L + S242Q + Q254S | | | |
| Reference Alpha-Amylase A | 57 | 11 | 402 |
| with the substitutions | | | |
| E129V + K177L + R179E | | | |
| Reference Alpha-Amylase A | 174 | 44 | >480 |
| with the substitutions | | | |
| E129V + K177L + R179E + | | | |
| K220P + N224L + S242Q + | | | |
| Q254S | | | |
| Reference Alpha-Amylase A | >180 | 49 | >480 |
| with the substitutions | | | |
| E129V + K177L + R179E + | | | |
| K220P + N224L + S242Q + | | | |
| Q254S + Y276F + L427M | | | |
| Reference Alpha-Amylase A | >180 | 49 | >480 |
| with the substitutions | | | |
| E129V + K177L + R179E + | | | |
| K220P + N224L + S242Q + | | | |
| Q254S + M284T | | | |
| Reference Alpha-Amylase A | 177 | 36 | >480 |
| with the substitutions | | | |
| E129V + K177L + R179E + | | | |
| K220P + N224L + S242Q + | | | |
| Q254S + N376* + I377* | | | |
| Reference Alpha-Amylase A | 94 | 13 | >480 |
| with the substitutions | | | |
| E129V + K177L + R179E + | | | |
| K220P + N224L + Q254S | | | |
| Reference Alpha-Amylase A | 129 | 24 | >480 |
| with the substitutions | | | |
| E129V + K177L + R179E + | | | |
| K220P + N224L + Q254S + | | | |
| M284T | | | |
| Reference Alpha-Amylase A | 148 | 30 | >480 |
| with the substitutions | | | |
| E129V + K177L + R179E + | | | |
| S242Q | | | |
| Reference Alpha-Amylase A | 78 | 9 | >480 |
| with the substitutions | | | |
| E129V + K177L + R179V | | | |
| Reference Alpha-Amylase A | 178 | 31 | >480 |
| with the substitutions | | | |
| E129V + K177L + R179V + | | | |
| K220P + N224L + S242Q + | | | |
| Q254S | | | |
| Reference Alpha-Amylase A | 66 | 17 | >480 |
| with the substitutions | | | |
| K220P + N224L + S242Q + | | | |
| Q254S | | | |
| Reference Alpha-Amylase A | 30 | 6 | 159 |
| with the substitutions | | | |
| K220P + N224L + Q254S | | | |
| Reference Alpha-Amylase A | 35 | 7 | 278 |
| with the substitution M284T | | | |
| Reference Alpha-Amylase A | 59 | 13 | ND |
| with the substitutions M284V | | | |

ND not determined

The results demonstrate that the alpha-amylase variants have a significantly greater half-life and stability than the reference alpha-amylase.

### Example 2

### Preparation of Protease Variants and Test of Thermostability

### Strains and Plasmids

E. coli DH12S (available from Gibco BRL) was used for yeast plasmid rescue. pJTP000 is a S. cerevisiae and E. coli shuttle vector under the control of TPI promoter, constructed from pJC039 described in WO 01/92502, in which the Thermoascus aurantiacus M35 protease gene (WO 03048353) has been inserted.

Saccharomyces cerevisiae YNG318 competent cells: MATa Dpep4[cir+]ura3-52, leu2-D2, his 4-539 was used for protease variants expression. It is described in J. Biol. Chem. 272 (15), pp 9720-9727, 1997.

### Media and Substrates

10× Basal solution: Yeast nitrogen base w/o amino acids (DIFCO) 66.8 g/l, succinate 100 g/l, NaOH 60 g/l.

SC-glucose: 20% glucose (i.e., a final concentration of 2%=2 g/100 ml)) 100 ml/l, 5% threonine 4 ml/l, 1% tryptophan10 ml/l, 20% casamino acids 25 ml/l, 10× basal solution 100 ml/l. The solution is sterilized using a filter of a pore size of 0.20 micrometer. Agar (2%) and H₂O (approx. 761 ml) is autoclaved together, and the separately sterilized SC-glucose solution is added to the agar solution.

YPD: Bacto peptone 20 g/l, yeast extract 10 g/l, 20% glucose 100 ml/l.

YPD+Zn: YPD+0.25 mM ZnSO₄.

PEG/LiAc solution: 40% PEG4000 50 ml, 5 M Lithium Acetate 1 ml.

96 well Zein micro titre plate:

Each well contains 200 microL of 0.05-0.1% of zein (Sigma), 0.25 mM ZnSO₄ and 1% of agar in 20 mM sodium acetate buffer, pH 4.5.

### DNA Manipulations

Unless otherwise stated, DNA manipulations and transformations were performed using standard methods of molecular biology as described in Sambrook et al. (1989) Molecular cloning: A laboratory manual, Cold Spring Harbor lab. Cold Spring Harbor, NY; Ausubel, F. M. et al. (eds.) “Current protocols in Molecular Biology”, John Wiley and Sons, 1995; Harwood, C. R. and Cutting, S. M. (Eds.).

### Yeast Transformation

Yeast transformation was performed using the lithium acetate method. 0.5 microL of vector (digested by restriction endonucleases) and 1 microL of PCR fragments is mixed. The DNA mixture, 100 microL of YNG318 competent cells, and 10 microL of YEAST MAKER carrier DNA (Clontech) is added to a 12 ml polypropylene tube (Falcon 2059). Add 0.6 ml PEG/LiAc solution and mix gently. Incubate for 30 min at 30 °C, and 200 rpm followed by 30 min at 42 °C (heat shock). Transfer to an eppendorf tube and centrifuge for 5 sec. Remove the supernatant and resolve in 3 ml of YPD. Incubate the cell suspension for 45 min at 200 rpm at 30 °C. Pour the suspension to SC-glucose plates and incubate 30 °C for 3 days to grow colonies. Yeast total DNA are extracted by Zymoprep Yeast Plasmid Miniprep Kit (ZYMO research).

### DNA Sequencing

E. coli transformation for DNA sequencing was carried out by electroporation (BIO-RAD Gene Pulser). DNA Plasmids were prepared by alkaline method (Molecular Cloning, Cold Spring Harbor) or with the Qiagen® Plasmid Kit. DNA fragments were recovered from agarose gel by the Qiagen gel extraction Kit. PCR was performed using a PTC-200 DNA Engine. The ABI PRISM™ 310 Genetic Analyzer was used for determination of all DNA sequences.

### Construction of Protease Expression Vector

The Thermoascus M35 protease gene was amplified with the primer pair Prot F and Prot R. The resulting PCR fragments were introduced into S. cerevisiae YNG318 together with the pJC039 vector (described in WO 2001/92502) digested with restriction enzymes to remove the Humicola insolens cutinase gene.

The Plasmid in yeast clones on SC-glucose plates was recovered to confirm the internal sequence and termed as pJTP001.

### Construction of Yeast Library and Site-Directed Variants

Library in yeast and site-directed variants were constructed by SOE PCR method (Splicing by Overlap Extension, see “PCR: A practical approach”, p. 207-209, Oxford University press, eds. McPherson, Quirke, Taylor), followed by yeast in vivo recombination.

### General Primers for Amplification and Sequencing

The primers AM34 and AM35 were used to make DNA fragments containing any mutated fragments by the SOE method together with degenerated primers (AM34+Reverse primer and AM35+forward primer) or just to amplify a whole protease gene (AM34+AM35).

| PCR reaction system: | Conditions: | |
|---|---|---|
| 48.5 microL H₂O | 1 | 94 °C 2 min |
| 2 beads puRe Taq Ready-To-Go PCR | 2 | 94 °C 30 sec |
| (Amersham Biosciences) | | |
| 0.5 micro L × 2 100 pmole/microL of primers | 3 | 55 °C 30 sec |
| 0.5 microL template DNA | 4 | 72 °C 90 sec |
| | 2-4 | 25 cycles |
| | 5 | 72 °C 10 min |

DNA fragments were recovered from agarose gel by the Qiagen gel extraction Kit. The resulting polypeptide fragments were mixed with the vector digest. The mixed solution was introduced into Saccharomyces cerevisiae to construct libraries or site-directed variants by in vivo recombination.

### Relative Activity Assay

Yeast clones on SC-glucose were inoculated to a well of a 96-well micro titre plate containing YPD+Zn medium and cultivated at 28 °C for 3 days. The culture supernatants were applied to a 96-well zein micro titer plate and incubated at at least 2 temperatures (ex. 60 °C and 65 °C, 70 °C and 75 °C, 70 °C and 80 °C) for more than 4 hours or overnight. The turbidity of zein in the plate was measured as A630 and the relative activity (higher/lower temperatures) was determined as an indicator of thermoactivity improvement. The clones with higher relative activity than the parental variant were selected and the sequence was determined.

### Remaining Activity Assay

Yeast clones on SC-glucose were inoculated to a well of a 96-well micro titre plate and cultivated at 28 °C for 3 days. Protease activity was measured at 65 °C using azo-casein (Megazyme) after incubating the culture supernatant in 20 mM sodium acetate buffer, pH 4.5, for 10 min at a certain temperature (80 °C or 84 °C with 4 °C as a reference) to determine the remaining activity. The clones with higher remaining activity than the parental variant were selected and the sequence was determined.

### Azo-Casein Assay

20 microL of samples were mixed with 150 microL of substrate solution (4 ml of 12.5% azo-casein in ethanol in 96 ml of 20 mM sodium acetate, pH 4.5, containing 0.01% triton-100 and 0.25 mM ZnSO₄) and incubated for 4 hours or longer.

After adding 20 microL/well of 100% trichloroacetic acid (TCA) solution, the plate was centrifuge and 100 microL of supernatants were pipette out to measure A440.

Expression of Protease Variants in Aspergillus oryzae

The constructs comprising the protease variant genes were used to construct expression vectors for Aspergillus. The Aspergillus expression vectors consist of an expression cassette based on the Aspergillus niger neutral amylase II promoterfused to the Aspergillus nidulans triose phosphate isomerase non translated leader sequence (Pna2/tpi) and the Aspergillus niger amyloglucosidase terminator (Tamg). Also present on the plasmid was the Aspergillus selective marker amdS from Aspergillus nidulans enabling growth on acetamide as sole nitrogen source. The expression plasmids for protease variants were transformed into Aspergillus as described in Lassen et al. (2001), Appl. Environ. Microbiol. 67, 4701-4707. For each of the constructs 10-20 strains were isolated, polypeptide and cultivated in shake flasks.

### Purification of Expressed Variants

1. Adjust pH of the 0.22 μm filtered fermentation sample to 4.0.
2. Put the sample on an ice bath with magnetic stirring. Add (NH4)2SO4 in small aliquots (corresponding to approx. 2.0-2.2 M (NH4)2SO4 not taking the volume increase into account when adding the compound).
3. After the final addition of (NH4)2SO4, incubate the sample on the ice bath with gentle magnetic stirring for min. 45 min.
4. Centrifugation: Hitachi himac CR20G High-Speed Refrigerated Centrifuge equipped with R20A2 rotor head, 5 °C, 20,000 rpm, 30 min.
5. Dissolve the formed precipitate in 200 ml 50 mM Na-acetate pH 4.0.
6. Filter the sample by vacuum suction using a 0.22 μm PES PLUS membrane (IWAKI).
7. Desalt/buffer-exchange the sample to 50 mM Na-acetate pH 4.0 using ultrafiltration (Vivacell 250 from Vivascience equipped with 5 kDa MWCO PES membrane) overnight in a cold room. Dilute the retentate sample to 200 ml using 50 mM Na-acetate pH 4.0. The conductivity of sample is preferably less than 5 mS/cm.
8. Load the sample onto a cation-exchange column equilibrated with 50 mM Na-acetate pH 4.0. Wash unbound sample out of the column using 3 column volumes of binding buffer (50 mM Na-acetate pH 4.0), and elute the sample using a linear gradient, 0-100% elution buffer (50 mM Na-acetate+1 M NaCl pH 4.0) in 10 column volumes.
9. The collected fractions are assayed by an endo-protease assay (cf. below) followed by standard SDS-PAGE (reducing conditions) on selected fractions. Fractions are pooled based on the endo-protease assay and SDS-PAGE.

### Endo-Protease Assay

1. Protazyme OL tablet/5 ml 250 mM Na-acetate pH 5.0 is dissolved by magnetic stirring (substrate: endo-protease Protazyme AK tablet from Megazyme—cat. #PRAK 11/08).
2. With stirring, 250 microL of substrate solution is transferred to a 1.5 ml Eppendorf tube.
3. 25 microL of sample is added to each tube (blank is sample buffer).
4. The tubes are incubated on a Thermomixer with shaking (1000 rpm) at 50 °C for 15 minutes.
5. 250 microL of 1 M NaOH is added to each tube, followed by vortexing.
6. Centrifugation for 3 min. at 16,100×G and 25 °C.
7. 200 microL of the supernatant is transferred to a MTP, and the absorbance at 590 nm is recorded.

### Results

TABLE 2
Relative activity of protease variants. Numbering of
substitution(s) starts from N-terminal of the mature
peptide in amino acids 1 to 177 of SEQ ID NO: 127.

| | | Relative activity |
|---|---|---|
| Variant | Substitution(s) | 65 °C/60 °C |
| WT | none | 31% |
| JTP004 | S87P | 45% |
| JTP005 | A112P | 43% |
| JTP008 | R2P | 71% |
| JTP009 | D79K | 69% |
| JTP010 | D79L | 75% |
| JTP011 | D79M | 73% |
| JTP012 | D79L/S87P | 86% |
| JTP013 | D79L/S87P/A112P | 90% |
| JTP014 | D79L/S87P/A112P | 88% |
| JTP016 | A73C | 52% |
| JTP019 | A126V | 69% |
| JTP021 | M152R | 59% |

TABLE 3
Relative activity of protease variants. Numbering of substitution(s)
starts from N-terminal of the mature peptide in amino acids 1
to 177 of SEQ ID NO: 127.

| | | Relative activity | | |
|---|---|---|---|---|
| | Substitution(s) and/ | 70 °C/ | 75 °C/ | 75 °C/ |
| Variant | or deletion (S) | 65 °C | 65 °C | 70 °C |
| WT | none | 59% | 17% | |
| JTP036 | D79L/S87P/D142L | 73% | 73% | |
| JTP040 | T54R/D79L/S87P | | 71% | |
| JTP042 | Q53K/D79L/S87P/I173V | | 108% | |
| JTP043 | Q53R/D79L/S87P | | 80% | |
| JTP045 | S41R/D79L/S87P | | 82% | |
| JTP046 | D79L/S87P/Q158W | | 96% | |
| JTP047 | D79L/S87P/S157K | | 85% | |
| JTP048 | D79L/S87P/D104R | | 88% | |
| JTP050 | D79L/S87P/A112P/D142L | | 88% | |
| JTP051 | S41R/D79L/S87P/ | | | 102% |
| | A112P/D142L | | | |
| JTP052 | D79L/S87P/A112P/ | | | 111% |
| | D142L/S157K | | | |
| JTP053 | S41R/D79L/S87P/A112P/ | | | 113% |
| | D142L/S157K | | | |
| JTP054 | ΔS5/D79L/S87P | | | 92% |
| JTP055 | ΔG8/D79L/S87P | | | 95% |
| JTP059 | C6R/D79L/S87P | | | 92% |
| JTP061 | T46R/D79L/S87P | | | 111% |
| JTP063 | S49R/D79L/S87P | | | 94% |
| JTP064 | D79L/S87P/N88R | | | 92% |
| JTP068 | D79L/S87P/T114P | | | 99% |
| JTP069 | D79L/S87P/S115R | | | 103% |
| JTP071 | D79L/S87P/T116V | | | 105% |
| JTP072 | N26R/D79L/S87P | | 92% | |
| JTP077 | A27K/D79L/S87P/ | | 106% | |
| | A112P/D142L | | | |
| JTP078 | A27V/D79L/S87P/ | | 100% | |
| | A112P/D142L | | | |
| JTP079 | A27G/D79L/S87P/ | | 104% | |
| | A112P/D142L | | | |

TABLE 4
Relative activity of protease variants. Numbering of substitution(s)
starts from N-terminal of the mature peptide in amino acids
1 to 177 of SEQ ID NO: 127.

| | | Relative | | |
|---|---|---|---|---|
| | | activity | Remaining | |
| | | 75 °C/ | activity | |
| Variant | Substitution(s) and/or deletion(s) | 65 °C | 80 °C | 84 °C |
| JTP082 | ΔS5/D79L/S87P/A112P/D142L | 129% | | 53% |
| JTP083 | T46R/D79L/S87P/A112P/D142L | 126% | | |
| JTP088 | Y43F/D79L/S87P/A112P/D142L | 119% | | |
| JTP090 | D79L/S87P/A112P/T124L/D142L | 141% | | |
| JTP091 | D79L/S87P/A112P/T124V/D142L | 154% | 43% | |
| JTP092 | ΔS5/N26R/D79L/S87P/ | | | 60% |
| | A112P/D142L | | | |
| JTP095 | N26R/T46R/D79L/S87P/ | | | 62% |
| | A112P/D142L | | | |
| JTP096 | T46R/D79L/S87P/T116V/D142L | | | 67% |
| JTP099 | D79L/P81R/S87P/A112P/D142L | | | 80% |
| JTP101 | A27K/D79L/S87P/A112P/ | | 81% | |
| | T124V/D142L | | | |
| JTP116 | D79L/Y82F/S87P/A112P/ | | 59% | |
| | T124V/D142L | | | |
| JTP117 | D79L/Y82F/S87P/A112P/ | | 94% | |
| | T124V/D142L | | | |
| JTP127 | D79L/S87P/A112P/T124V/ | | 53% | |
| | A126V/D142L | | | |

TABLE 5
Relative activity of protease variants. Numbering of substitution(s)
starts from N-terminal of the mature peptide in amino acids
1 to 177 of SEQ ID NO: 127.

| | | Relative activity | | |
|---|---|---|---|---|
| | | 75 °C/ | 80 °C/ | 85 °C/ |
| Variant | Substitutions | 70 °C | 70 °C | 70 °C |
| JTP050 | D79L S87P A112P D142L | 55% | 23% | 9% |
| JTP134 | D79L Y82F S87P A112P D142L | | 40% | |
| JTP135 | S38T D79L S87P A112P A126V | | 62% | |
| | D142L | | | |
| JTP136 | D79L Y82F S87P A112P A126V | | 59% | |
| | D142L | | | |
| JTP137 | A27K D79L S87P A112P A126V | | 54% | |
| | D142L | | | |
| JTP140 | D79L S87P N98C A112P G135C | 81% | | |
| | D142L | | | |
| JTP141 | D79L S87P A112P D142L T141C | 68% | | |
| | M161C | | | |
| JTP143 | S36P D79L S87P A112P D142L | 69% | | |
| JTP144 | A37P D79L S87P A112P D142L | 57% | | |
| JTP145 | S49P D79L S87P A112P D142L | 82% | 59% | |
| JTP146 | S50P D79L S87P A112P D142L | 83% | 63% | |
| JTP148 | D79L S87P D104P A112P D142L | 76% | 64% | |
| JTP161 | D79L Y82F S87G A112P D142L | | 30% | 12% |
| JTP180 | S70V D79L Y82F S87G Y97W | | 52% | |
| | A112P D142L | | | |
| JTP181 | D79L Y82F S87G Y97W D104P | | 45% | |
| | A112P D142L | | | |
| JTP187 | S70V D79L Y82F S87G A112P | | 45% | |
| | D142L | | | |
| JTP188 | D79L Y82F S87G D104P A112P | | 43% | |
| | D142L | | | |
| JTP189 | D79L Y82F S87G A112P A126V | | 46% | |
| | D142L | | | |
| JTP193 | Y82F S87G S70V D79L D104P | | | 15% |
| | A112P D142L | | | |
| JTP194 | Y82F S87G D79L D104P A112P | | | 22% |
| | A126V D142L | | | |
| JTP196 | A27K D79L Y82F S87G D104P | | | 18% |
| | A112P A126V D142L | | | |

TABLE 6
Relative activity of protease variants. Numbering of substitution(s)
starts from N-terminal of the mature peptide in amino acids
1 to 177 of SEQ ID NO: 127.

| | | Relative activity | |
|---|---|---|---|
| Variant | Substitutions | 75 °C/70 °C | 80 °C/70 °C |
| JTP196 | A27K D79L Y82F | 102% | 55% |
| | S87G D104P A112P | | |
| | A126V D142L | | |
| JTP210 | A27K Y82F S87G | 107% | 36% |
| | D104P A112P A126V | | |
| | D142L | | |
| JTP211 | A27K D79L Y82F | 94% | 44% |
| | D104P A112P A126V | | |
| | D142L | | |
| JTP213 | A27K Y82F D104P | 103% | 37% |
| | A112P A126V D142L | | |

### Example 3

### Temperature Profile of Selected Variants Using Polypeptide Enzymes

Selected variants showing good thermo-stability were polypeptide and the polypeptide enzymes were used in a zein-BCA assay as described below. The remaining protease activity was determined at 60 °C after incubation of the enzyme at elevated temperatures as indicated for 60 min.

### Zein-BCA Assay:

Zein-BCA assay was performed to detect soluble protein quantification released from zein by variant proteases at various temperatures.

### Protocol:

1) Mix 10 ul of 10 μg/ml enzyme solutions and 100 ul of 0.025% zein solution in a micro titer plate (MTP).
2) Incubate at various temperatures for 60 min.
3) Add 10 ul of 100% trichloroacetic acid (TCA) solution.
4) Centrifuge MTP at 3500 rpm for 5 min.
5) Take out 15 ul to a new MTP containing 100 ul of BCA assay solution (Pierce Cat #:23225, BCA Protein Assay Kit).
6) Incubate for 30 min. at 60 °C.
7) Measure A562.

The results are shown in Table 7. All of the tested variants showed an improved thermo-stability as compared to the wt protease.

TABLE 7
Zein-BCA assay

| | Sample incubated 60 min at indicated temperatures | | | | | | |
|---|---|---|---|---|---|---|---|
| | (°C) (μg/ml Bovine serum albumin equivalent | | | | | | |
| WT/ | peptide released) | | | | | | |
| Variant | 60 °C | 70 °C | 75 °C | 80 °C | 85 °C | 90 °C | 95 °C |
| WT | 94 | 103 | 107 | 93 | 58 | 38 | |
| JTP050 | 86 | 101 | 107 | 107 | 104 | 63 | 36 |
| JTP077 | 82 | 94 | 104 | 105 | 99 | 56 | 31 |
| JTP188 | 71 | 83 | 86 | 93 | 100 | 75 | 53 |
| JTP196 | 87 | 99 | 103 | 106 | 117 | 90 | 38 |

### Example 4

### Thermostability of Protease Pfu.

The thermostability of the Pyrococcus furiosus protease (Pfu S) purchased from Takara Bio Inc, (Japan) was tested using the same methods as in Example 2. It was found that the thermostability (Relative Activity) was 110% at (80 °C/70 °C) and 103% (90 °C/70 °C) at pH 4.5.

### Example 5

This example illustrates that hemicellulases, for instance an enzyme blend comprising a hemicellulase, enhances a mechanical fractionation process designed to produce a high protein feed ingredient from whole stillage in an ethanol plant. The overall goal is to increase the protein content of the high protein fraction and ideally to also increase the quantity of the high protein fraction. The specific goal of this testing was to determine whether dose impacts the quality and quantity of the high protein fraction. The substrate used in this testing was whole stillage from an ethanol plant. The enzyme blend comprised Hemicellulase and Cellulase 1 (ratio of 40%:60%) dosed at three different levels. All treatments included amylase blend ABA to hydrolyze any residual starch in the whole stillage to maximize fiber-degrading enzyme accessibility. The control was treated only with the amylase blend ABA. The enzymatic hydrolysis conditions were 50 °C and a 48-hour treatment time at a total solids of 11.7%.

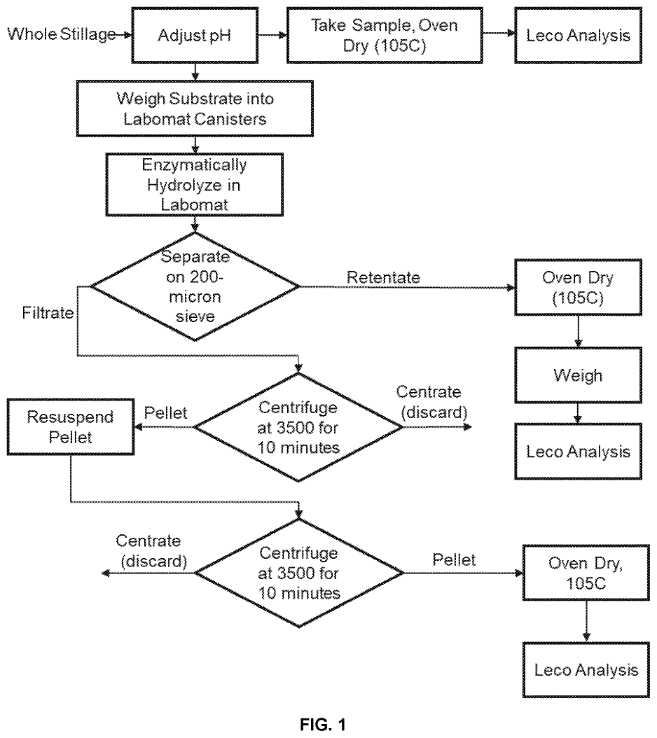

The test procedure, as diagrammed in FIG. 1, was as follows:
1. The whole stillage was analyzed for protein content so that a protein mass balance could be performed.
2. The whole stillage was then aliquoted into canisters for enzyme treatment and dosed with the fiber-degrading and glucoamylase enzymes in accordance with the experimental design.
3. The canisters were placed in a piece of equipment in which the time/temperature profile can be controlled.
4. The whole stillage was enzyme-treated at 50 °C for 48 hours.
5. The whole stillage was then separated on a 200-micron vibrating screen.
6. The retentate from this initial separation was dried and analyzed for protein content.
7. The filtrate from this initial separation was centrifuged at 3500 rpm for 10 minutes. The centrate was discarded.
8. The pellet resulting from centrifugation was resuspended in tap water and centrifuged at 3500 rpm for 10 minutes.
9. The pellet resulting from this second centrifugation, which represents the high protein fraction, was dried and analyzed for protein content.

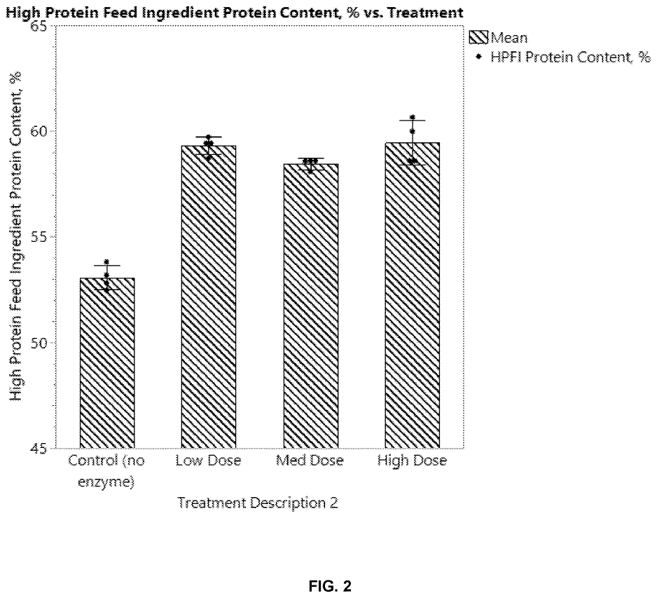

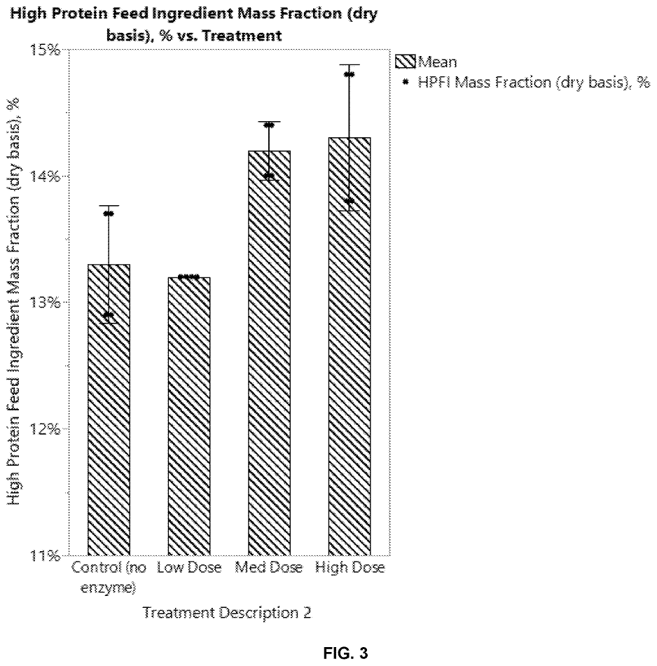

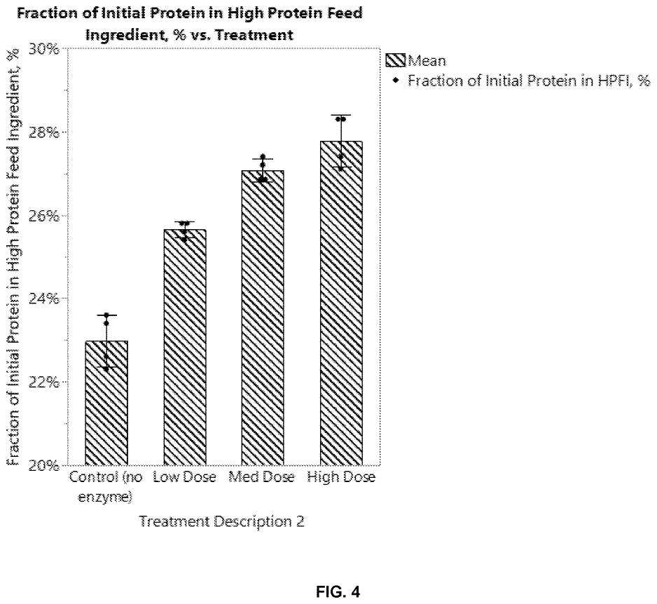

The results of the testing are shown in FIG. 2, FIG. 3, and FIG. 4. As can be seen in FIG. 2, the protein content of the high protein feed ingredient increases significantly with the cellulase/hemicellulase treatment. The cellulase/hemicellulase dose does not impact protein content, the three doses cannot be distinguished statistically. As shown in FIG. 3, the amount of mass (on a dry basis) partitioned into the high protein feed ingredient also increases significantly with cellulase/hemicellulase treatment at the medium and high dose. The increased protein content and the increased mass fraction both contribute to a higher proportion of the initial protein in the thin stillage to be portioned in the high protein feed ingredient, as seen in FIG. 4.

### Example 6

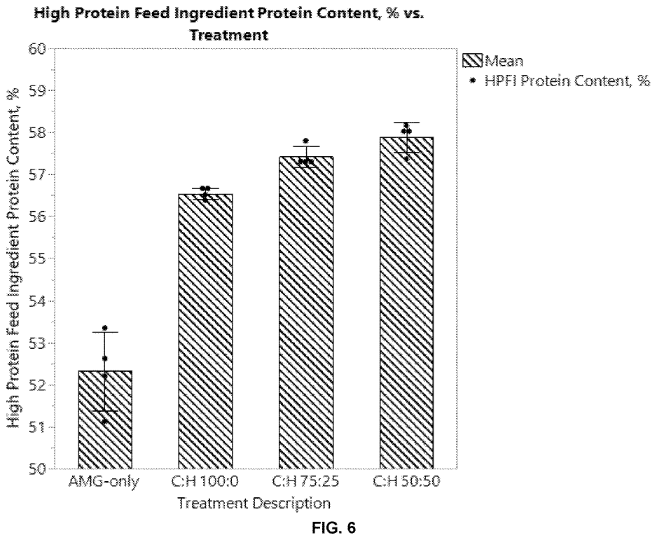

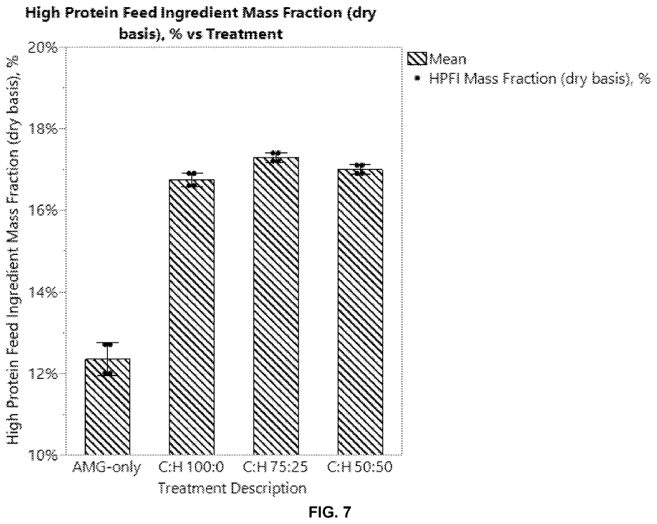

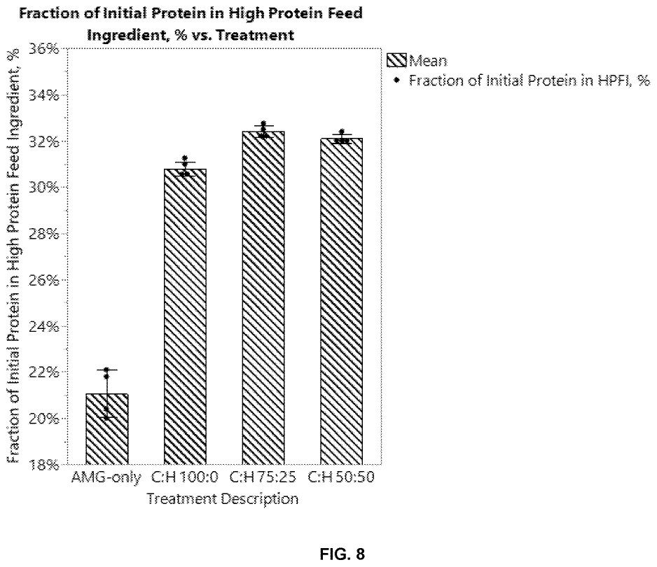

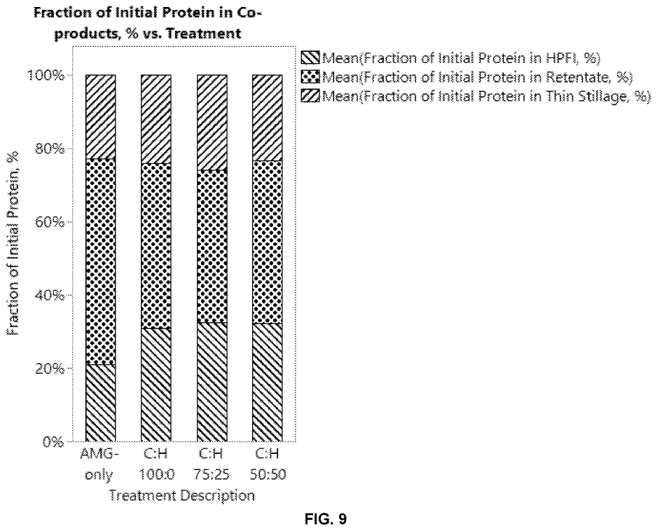

This example illustrates that hemicellulases, for instance an enzyme blend comprising a hemicellulase, can be used to enhance a mechanical fractionation process designed to produce a high protein co-product from whole stillage in an ethanol plant. The overall goal is to increase the protein content of the high protein fraction and ideally to also increase the quantity of the high protein fraction. The specific goal of this testing was to determine if the ratio of cellulase to hemicellulase affects the protein quality and quantity in the high protein fraction. The substrate used in this testing was whole stillage from an ethanol plant. Three different ratios of Cellulase 1 to Hemicellulase were used (100% cellulase, 75%:25% cellulase:hemicellulase, and 50%:50% cellulase:hemicellulase. All treatments included amylase blend ABA (referred to in FIG. 6, FIG. 7, FIG. 8 and FIG. 9 as AMG) to hydrolyze any residual starch in the whole stillage so as to maximize fiber-degrading enzyme accessibility. The control was treated only with amylase blend ABA. The enzymatic hydrolysis conditions were 32C, and a 64-hour treatment time at a total solids of 11.8%.

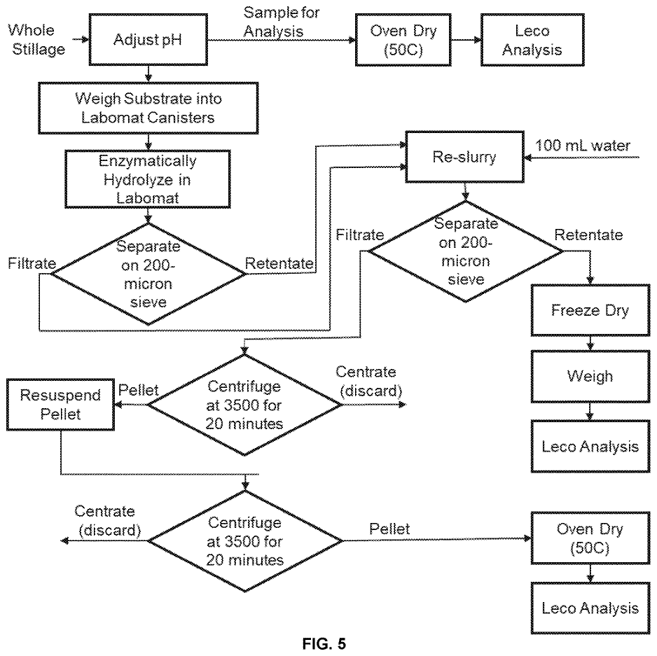

The test procedure, as diagrammed in FIG. 5, was as follows:
1. The whole stillage was analyzed for protein content so that a protein mass balance could be performed.
2. The whole stillage was then aliquoted into canisters for enzyme treatment and dosed with the enzymes in accordance with the experimental design.
3. The canisters were placed in a piece of equipment in which the time/temperature profile can be controlled. The whole stillage was enzyme-treated at 32C for 64 hours.
4. The whole stillage was then separated on a 200-micron vibrating screen.
5. To simulate a washing step, the filtrate plus approximately an equal volume of water was used to re-slurry the retentate and the resulting slurry was separated again on a 200-micron vibrating screen.
6. The retentate was dried and analyzed for protein content.
7. The filtrate from was centrifuged at 3500 rpm for 10 minutes. The centrate was discarded.
8. The pellet resulting from centrifugation was resuspended in tap water and centrifuged at 3500 rpm for 10 minutes.
9. The pellet resulting from this second centrifugation, which represents the high protein fraction, was dried and analyzed for protein content.

The results of the testing are shown in FIG. 6, FIG. 7, FIG. 8 and FIG. 9. As can be seen in FIG. 6, the protein content of the high protein feed ingredient increases significantly with the cellulase-only treatment. The protein content is further enhanced with increasing hemicellulase percentage in the enzyme blend. As shown in FIG. 7, the amount of mass (on a dry basis) partitioned into the high protein feed ingredient is greater for all three cellulase:hemicellulase ratios. By a small margin, the 75%:25% cellulase:hemicellulase ratio results in the highest high protein feed ingredient mass fraction. As can be seen in FIG. 8, both the 75%:25% cellulase:hemicellulase ratio and the 50%:50% cellulase:hemicellulase ratio result in a statistically greater amount of the initial protein portioned in the high protein feed ingredient than the cellulase-only treatment. FIG. 9 shows that the increased protein in the high protein feed ingredient is drawn primarily from the wet cake. In other words, the cellulase/hemicellulase treatments result in a diversion of protein from the wet cake to the high protein feed ingredient.

### Example 7

This example illustrates that beta-glucanases, for instance an enzyme blend comprising a cellulase, xylanase, and beta-glucanase, enhance a mechanical fractionation process designed to produce a high protein feed ingredient from whole stillage in an ethanol plant. The overall goal is to increase the protein content of the high protein fraction, as well as to increase the quantity of the high protein fraction. Testing was done to determine whether beta-glucanases can increase the protein content of the high protein fraction. The substrate used in this testing was whole stillage from an ethanol plant. Testing was done with six enzyme blends each comprising the same cellulose and a xylanase blend comprising a GH5_21 xylanase and a GH30_8 xylanase and a GH5_21 xylanase, and a different beta-glucanase. Each enzyme blend comprised Cellulase 1, Xyl (GH30_8 and GH5_21a xylanases), and beta-glucanase (a different one of AvGH16, LsGH16, TaGH5_15a, RbGH5_15, ThGH5_15, and ThGH64) in a ratio of 6:2:1, respectively, on an enzyme protein basis. The control was treated only with a blend of cellulase and xylanase at the same ratio found in the experimental treatments and at a total enzyme protein dose equivalent to the experimental treatments. The enzymatic hydrolysis conditions were 32 °C and a 72-hour treatment time at a total solids of 12.7%.

The test procedure, was as follows:
1. The pH of the whole stillage was adjusted to pH 5
2. Approximately 14 g of the whole stillage substrate was added to Nalgene™ Oak Ridge High-Speed Centrifuge Tubes
3. Enzymes, water and penicillin were added to the tubes in accordance with the experimental design
4. The tubes were placed in an oven and incubated at 32 °C for 72 hours
5. After incubation, the tubes were heated to 85 C and the fiber-rich particles were separated out with a cell strainer with a mesh opening size of 200 microns
6. The fiber-rich retentate was rinsed with an additional 20 mL of water
7. The filtrate was centrifuged at 3500 rpm for 10 minutes to separate out a protein-rich pellet (the high protein feed ingredient)
8. The centrate was decanted and the pellet resuspend in 25 mL of water
9. The resuspended pellet was again centrifuged at 3500 rpm for 10 minutes
10. The centrate was decanted and the pellet placed in a freeze dryer
11. Once dry, the pellets were ground and homogenized
12. The protein content of the ground, homogenized pellets were measured with a Leco nitrogen/protein analyzer.

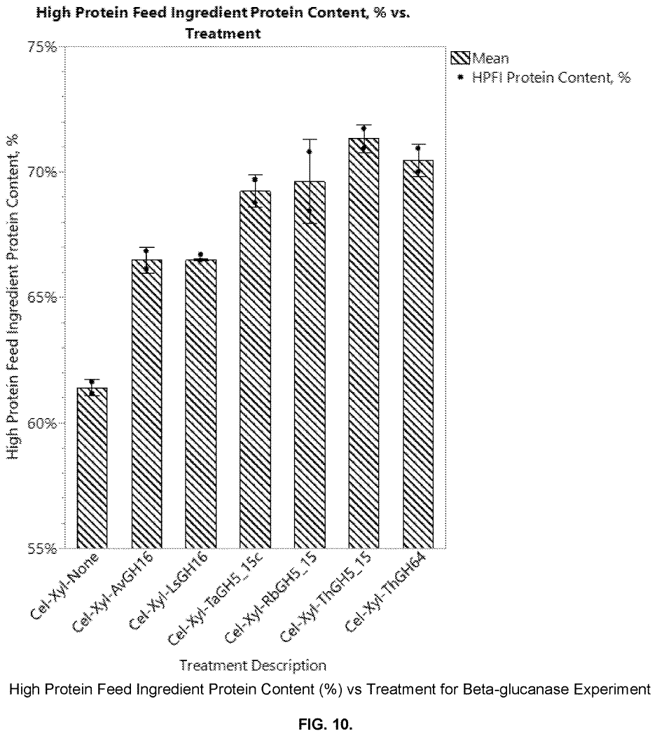

The results of the testing are shown in FIG. 10. As can be seen in FIG. 10, the addition of beta-glucanases to the enzyme blend results in a significantly higher protein content in the high protein feed ingredient than the control (blend of only cellulase and xylanase). All the beta-glucanases tested in this experiment significantly improved the protein content of the high protein feed ingredient.

### Example 8

This example illustrates that xylanases, for instance an enzyme blend comprising a cellulase and xylanase, enhance a mechanical fractionation process designed to produce a high protein feed ingredient from whole stillage in an ethanol plant. The overall goal is to increase the protein content of the high protein fraction, as well as to increase the quantity of the high protein fraction. Testing was done to determine whether xylanases can increase the protein content of the high protein fraction. The substrate used in this test was mash from an ethanol plant. Unlike tests where the enzymes were applied to whole stillage, in this experiment, the cellulases and xylanases were added to the fermentation process. The enzyme blend comprised Cellulase 1 and Xyl (GH5_21b) in a 3:1 ratio on an enzyme protein basis on top of glucoamylase blend GSA. Two controls were used in this experiment, a Cellulase 1-only control on top of glucoamylase blend GSA, and a control with neither cellulase nor xylanase, just glucoamylase blend GSA. The cellulase-only control was dosed at the same enzyme protein loading as that of the blend of cellulase and xylanase. The fermentation conditions were 32 °C and a 72-hour treatment time at a total solids of 33.4%.

The test procedure, was as follows:
1. Mash pH was adjusted to pH 5
2. Urea and penicillin were added to bulk mash in accordance with experimental design
3. 75 g of mash was added to each 250 mL fermentation bottle
4. Water, the enzymes, and yeast were added to fermentation bottles in accordance with experimental design
5. Fermentation bottles were capped using lids with holes
6. Fermentation bottles were placed in an environmental chamber with shaking at 32C for 72 hours
7. Bottles were heated to 85 °C
8. Contents of bottles were poured into a 3″ diameter, 212-micron opening sieve to separate out the fiber-rich particles and collect the filtrate
9. Fiber-rich particles were washed by re-slurrying twice with 20 mL of water and collecting the additional filtrate
10. Filtrate was centrifuged at 3500 rpm for 10 minutes
11. Pellets were resuspended in water and centrifuged again at 3500 rpm for 10 minutes
12. Pellets were place in freeze dryer
13. Once dry, the pellets were ground and homogenized
14. The protein content of the ground, homogenized pellets were measured with a Leco nitrogen/protein analyzer.

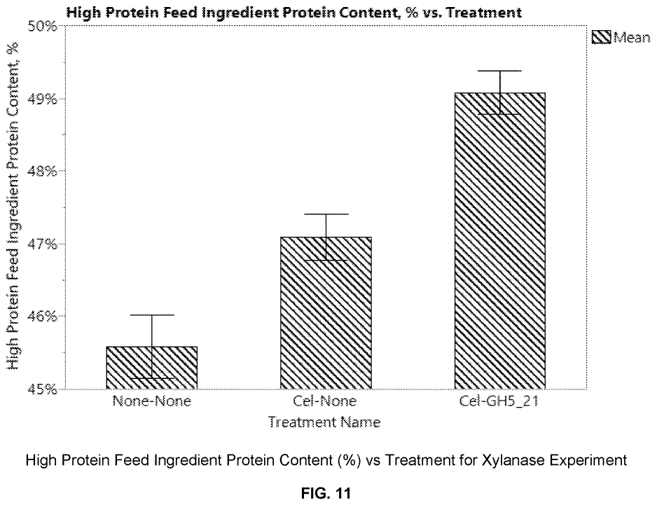

The results of the testing are shown in FIG. 11. As can be seen in FIG. 11, the addition of xylanase, for example a GH5_21 xylanase, to a background of cellulase results in a significantly higher protein content in the high protein feed ingredient than the cellulase-only control. The treatment with cellulase-only and the treatment with the blend of cellulase and xylanase both outperformed the second control, which was treated with neither cellulase nor xylanase.

### Example 9

This example illustrates that arabinofuranosidases, for instance an enzyme blend comprising a cellulase, xylanase, beta-glucanase, and arabinofuranosidase enhance a mechanical fractionation process designed to produce a high protein feed ingredient from whole stillage in an ethanol plant. The overall goal is to increase the protein content of the high protein fraction, as well as to increase the quantity of the high protein fraction. Testing was to determine whether arabinofuranosidases can increase the protein content of the high protein fraction. The substrate used in this testing was whole stillage from an ethanol plant. Each enzyme blend comprised the arabinofuranosidase (GH43A or GH51A) to be evaluated in a background of Cellulase 1, Xyl (GH5_21b), and TaGH5_15a. The control was a blend of cellulase, xylanase, and beta-glucanase but without the arabinofuranosidase. The control was dosed at the same enzyme protein loading as that of the experimental treatment blend of cellulase, xylanase, beta-glucanase, and arabinofuranosidase. The enzymatic hydrolysis conditions were 32 °C and a 72-hour treatment time at a total solids of 12.7%.

The test procedure, was as follows:
1. The pH of the whole stillage was adjusted to pH 5
2. Approximately 14 g of the whole stillage substrate was added to Nalgene™ Oak Ridge High-Speed Centrifuge Tubes
3. Enzymes, water and penicillin were added to the tubes in accordance with the experimental design
4. The tubes were placed in an oven and incubated at 32 °C for 72 hours
5. After incubation, the tubes were heated to 85 C and the fiber-rich particles were separated out with a cell strainer with a mesh opening size of 200 microns
6. The fiber-rich retentate was rinsed with an additional 20 mL of water
7. The filtrate was centrifuged at 3500 rpm for 10 minutes to separate out a protein-rich pellet (the high protein feed ingredient)
8. The centrate was decanted and the pellet resuspend in 25 mL of water
9. The resuspended pellet was again centrifuged at 3500 rpm for 10 minutes
10. The centrate was decanted and the pellet placed in a freeze dryer
11. Once dry, the pellets were ground and homogenized
12. The protein content of the ground, homogenized pellets were measured with a Leco nitrogen/protein analyzer.

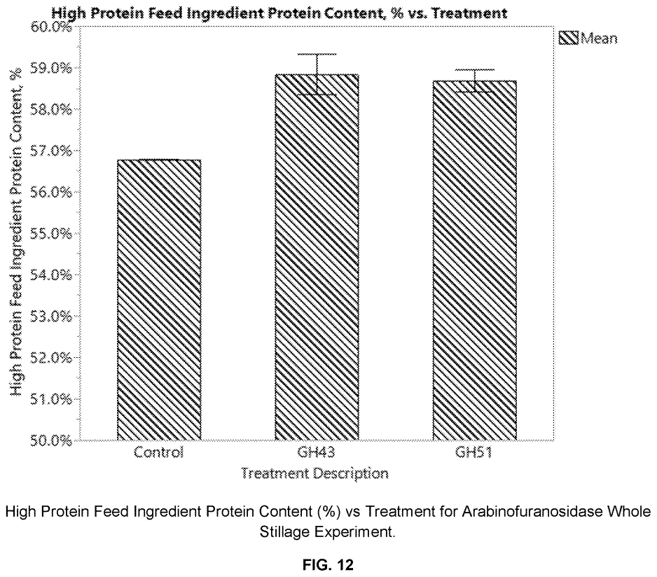

The results of the testing are shown in FIG. 12. As can be seen in FIG. 12, the addition of a GH43 or GH51 arabinofuranosidase to a background of cellulase, xylanase, and beta-glucanase results in a significantly higher protein content in the high protein feed ingredient than the control with only cellulase, xylanase, and beta-glucanase.

### Example 10

This example illustrates that different cellulases can be used to enhance a mechanical fractionation process designed to produce a high protein feed ingredient from whole stillage in an ethanol plant. The overall goal is to increase the protein content of the high protein fraction, as well as to increase the quantity of the high protein fraction. Testing was to determine whether Cellulase 2 can increase the mass fraction and protein content of the high protein fraction. The substrate used in this testing was whole stillage from an ethanol plant. The control was not enzymatically treated. The enzymatic hydrolysis conditions were 32 °C and a 72-hour treatment time at a total solids of 12.7%.

The test procedure, was as follows:
1. The pH of the whole stillage was adjusted to pH 5
2. Approximately 14 g of the whole stillage substrate was added to Nalgene™ Oak Ridge High-Speed Centrifuge Tubes
3. Enzymes, water and penicillin were added to the tubes in accordance with the experimental design
4. The tubes were placed in an oven and incubated at 32 °C for 72 hours
5. After incubation, the tubes were heated to 85 C and the fiber-rich particles were separated out with a cell strainer with a mesh opening size of 200 microns
6. The fiber-rich retentate was rinsed with an additional 20 mL of water
7. The filtrate was centrifuged at 3500 rpm for 10 minutes to separate out a protein-rich pellet (the high protein feed ingredient)
8. The centrate was decanted and the pellet resuspend in 25 mL of water
9. The resuspended pellet was again centrifuged at 3500 rpm for 10 minutes
10. The centrate was decanted and the pellet placed in a freeze dryer
11. Once dry, the pellets were ground and homogenized
12. The protein content of the ground, homogenized pellets were measured with a Leco nitrogen/protein analyzer.

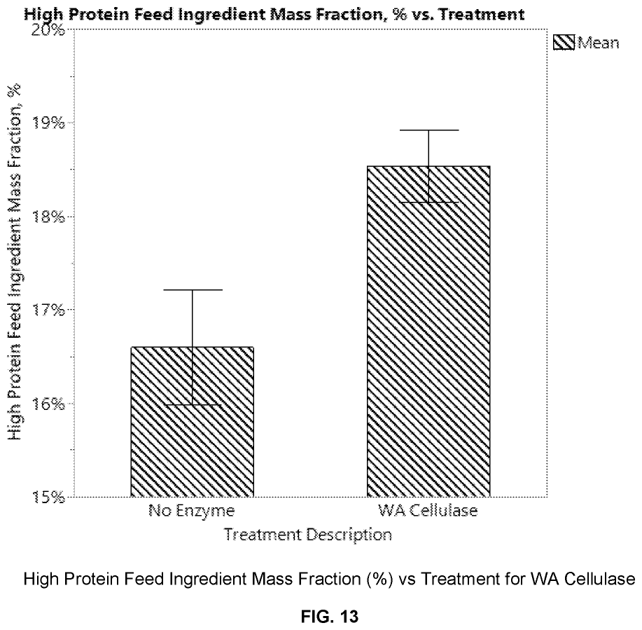

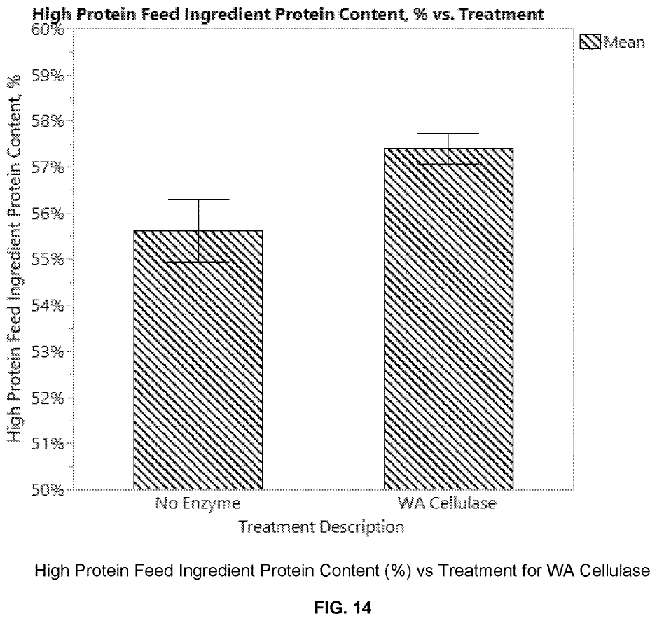

The results of the testing are shown in FIG. 13 and FIG. 14. As can be seen in FIG. 13, treatment with Cellulase 2 results in a significantly higher fraction of the mass diverted to the high protein feed ingredient as compared to the control (no enzyme treatment). As can be seen in FIG. 14, enzyme treatment with Cellulase 2 results in a significantly higher protein content in the high protein feed ingredient as compared to the control (no enzyme treatment).

### Example 11

This example illustrates that a variety of GH5 family xylanases, for instance an enzyme blend comprising a cellulase and a GH5 family xylanase, enhance a mechanical fractionation process designed to produce a high protein feed ingredient from whole stillage in an ethanol plant. The overall goal is to increase the protein content of the high protein fraction, as well as to increase the quantity of the high protein fraction. Testing was to demonstrate that a variety of GH5 family xylanases, such as GH5_21, GH5_34 and GH5_35, can increase the mass fraction and protein content of the high protein feed ingredient. The substrate used in this test was mash from an ethanol plant. In this experiment, three different enzyme blends, each comprising Cellulase 2 and a different one of GH5_21b xylanase, GH5_34 xylanase, or GH5_35 xylanase, were added to the fermentation process along with glucoamylase blend GSA. The enzyme blend comprised the cellulase and xylanase in a 3:1 ratio on an enzyme protein basis. The control was a cellulase-only enzyme treatment along with glucoamylase blend GSA. The cellulase-only control was dosed at the same enzyme protein loading as that of the blend of cellulase and xylanase. The fermentation conditions were 32 °C and a 72-hour treatment time at a total solids of 32.9%.

The test procedure, was as follows:
1. Mash pH was adjusted to pH 5
2. Urea and penicillin were added to bulk mash in accordance with experimental design
3. 75 g of mash was added to each 250 mL fermentation bottle
4. Water, enzymes, and yeast were added to fermentation bottles in accordance with experimental design
5. Fermentation bottles were capped using lids with holes
6. Fermentation bottles were placed in an environmental chamber with shaking at
32 °C for 72 hours
7. Bottles were heated to 85 °C
8. Contents of bottles were poured into a 3″ sieve pan to separate out the fiber-rich particles and collect the filtrate
9. Fiber-rich particles were washed by re-slurrying twice with 20 mL of water and collecting the additional filtrate
10. Filtrate was centrifuged at 3500 rpm for 10 minutes
11. Pellets were resuspended in water and centrifuged again at 3500 rpm for 10 minutes
12. Pellets were placed in a freeze dryer
13. Once dry, the pellets were ground and homogenized
14. The protein content of the ground, homogenized pellets were measured with a Leco nitrogen/protein analyzer.

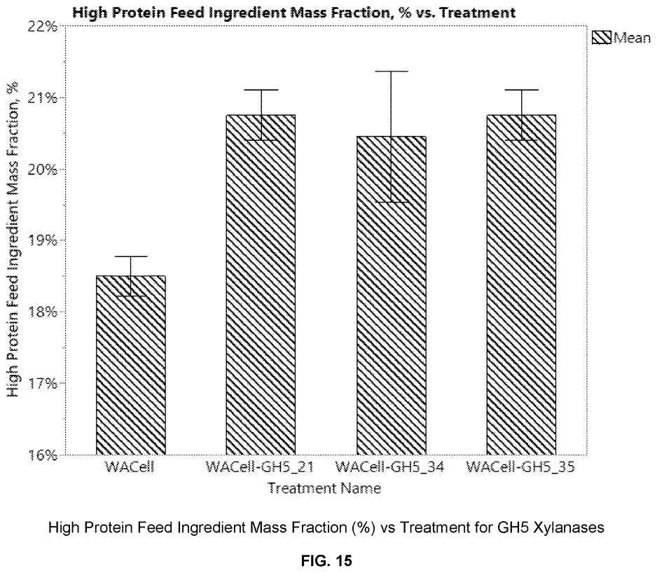

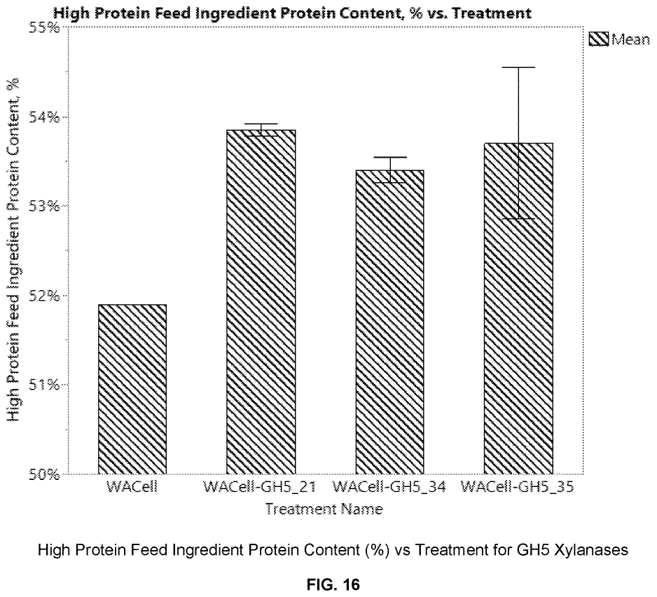

The results of the testing are shown in FIG. 15 and FIG. 16. As can be seen in FIG. 15, the addition of GH5 family xylanases to a background of cellulase results in a significantly higher diversion of mass (designated as the mass fraction in the figure) to the high protein feed ingredient than the cellulase-only control. As can be seen in FIG. 16, the addition of GH5 family xylanases to a background of cellulase results in a significantly higher protein content in the high protein feed ingredient than the cellulase-only control.

### Example 12

This example illustrates that a variety of arabinofuranosidases, for instance an enzyme blend comprising a cellulase, a hemicellulase (e.g., GH10 xylanase), and an arabinofuranosidase, enhance a mechanical fractionation process designed to produce a high protein feed ingredient from whole stillage in an ethanol plant. The overall goal is to increase the protein content of the high protein fraction, as well as to increase the quantity of the high protein fraction. Testing was to determine whether arabinofuranosidases can increase the mass fraction and protein content of the high protein feed ingredient when the enzymes are dosed in fermentation. The substrate used in this test was mash from an ethanol plant. In this experiment, along with glucoamylase blend GSA, the enzyme blends were added to the fermentation process. Each enzyme blend comprised Cellulase 2, Xylanase VT, and a different arabinofuranosidase selected from GH43A, GH43B, GH51A, GH51B and GH62 in a 6:1:1 ratio on an enzyme protein basis. The control comprised a cellulase, Xylanase VT blend, along with glucoamylase blend GSA. The fermentation conditions were 32 °C and a 72-hour treatment time at a total solids of 32.9%.

The test procedure, was as follows:
1. Mash pH was adjusted to pH 5
2. Urea and penicillin were added to bulk mash in accordance with experimental design
3. 75 g of mash was added to each 250 mL fermentation bottle
4. Water, enzymes, and yeast were added to fermentation bottles in accordance with experimental design
5. Fermentation bottles were capped using lids with holes
6. Fermentation bottles were placed in an environmental chamber with shaking at
32C for 72 hours
7. Bottles were heated to 85 C
8. Contents of bottles were poured into a 3″ sieve pan to separate out the fiber-rich particles and collect the filtrate
9. Fiber-rich particles were washed by re-slurrying twice with 20 mL of water and collecting the additional filtrate
10. Filtrate was centrifuged at 3500 rpm for 10 minutes
11. Pellets were resuspended in water and centrifuged again at 3500 rpm for 10 minutes
12. Pellets were placed in a freeze dryer
13. Once dry, the pellets were ground and homogenized
14. The protein content of the ground, homogenized pellets were measured with a Leco nitrogen/protein analyzer.

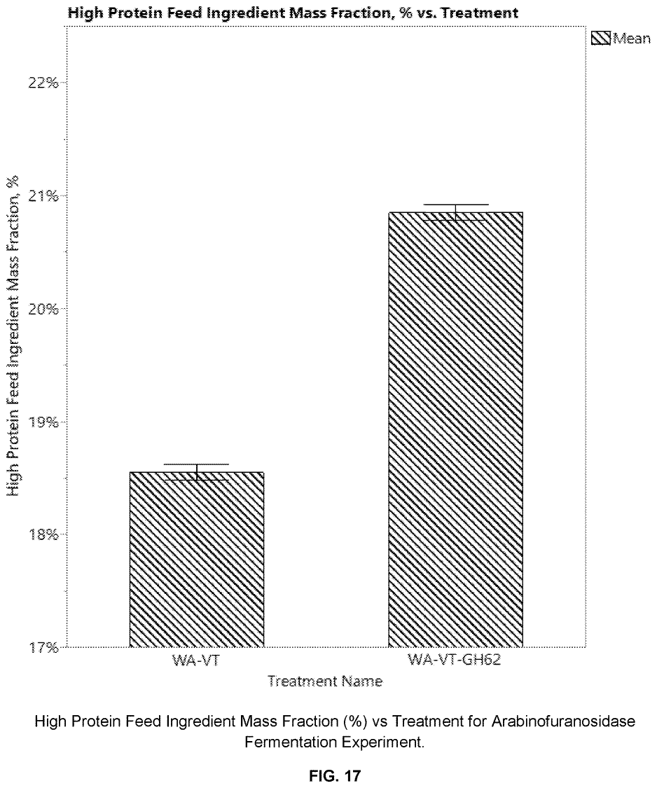

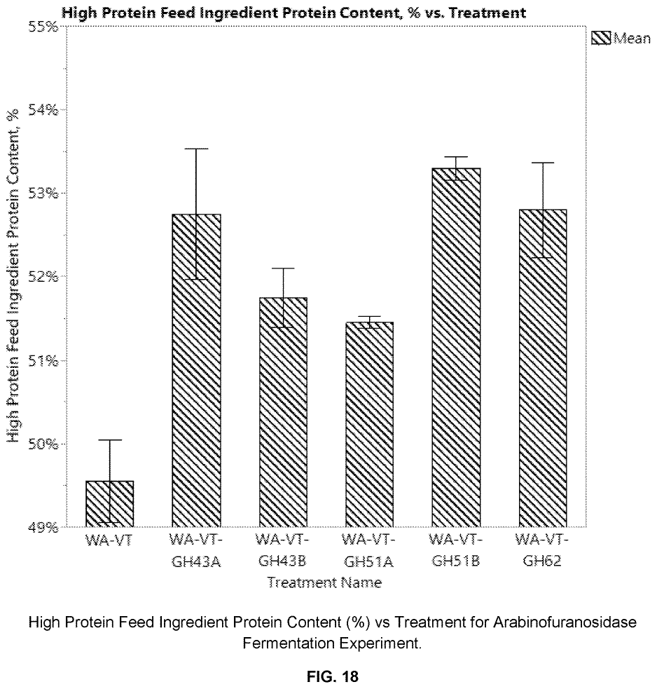

The results of the testing are shown in FIG. 17 and FIG. 18. As can be seen in FIG. 17, the addition of GH62 arabinofuranosidase to a background of cellulase and GH10 xylanase results in a significantly higher diversion of mass (designated as the mass fraction in the figure) to the high protein feed ingredient than the control (blend of cellulase and GH10 xylanase). As can be seen in FIG. 18, the addition of GH43, GH51, and GH62 arabinofuranosidases result in a significantly higher protein content in the high protein feed ingredient than the control (blend of cellulase and GH10 xylanase).

1. A method for producing a high protein feed ingredient from a whole stillage byproduct produced in a starch-containing grain dry milling process for producing a fermentation product, the method comprising:
a) optionally performing a starch-containing grain dry milling process for producing a fermentation product to produce a fermentation product and a whole stillage byproduct;
b) separating the whole stillage byproduct into an insoluble solids portion and a thin stillage portion;
c) separating the thin stillage portion into at least a first separated water-soluble solids portion, and at least a first separated protein portion;
d) optionally separating at least the first separated protein portion into at least a second separated water-soluble solids portion, and at least a second separated protein portion;
e) drying at least the first separated protein portion, and/or optionally at least the second separated protein portion, to define a protein product, wherein the protein product is a high protein feed ingredient;
wherein a hemicellulase, a beta-glucanase, or an enzyme blend comprising a hemicellulase and/or beta-glucanase is added prior to or during production of the whole stillage byproduct and/or separating the whole stillage byproduct.

2. (canceled)

3. (canceled)

4. (canceled)

5. (canceled)

6. The method of claim 1, wherein the high protein feed ingredient includes at least 40 wt percent protein on a dry basis.

7. (canceled)

8. The method of claim 1, wherein the high protein feed ingredient is a high protein corn-based animal feed.

9. The method of claim 1, further comprising, after separating the whole stillage byproduct into an insoluble solids portion and a thin stillage portion and before separating the thin stillage portion into a first separated protein portion and a first separated water-soluble solids portion, separating fine fiber from the thin stillage portion.

10. (canceled)

11. The method of claim 1, further comprising separating soluble solids from the first separated water-soluble solids portion to provide a first soluble solids portion, and optionally separating soluble solids from the second separated water-soluble solids portion to provide a second soluble solids portion.

12. The method of claim 1, further comprising separating free oil from the first separated water-soluble solids portion to provide a first oil portion, and optionally separating free oil from the second separated water-soluble solids portion to provide a second oil portion.

13. The method of claim 1 wherein the hemicellulase, beta-glucanase, or the enzyme blend comprising the hemicellulase and/or beta-glucanase is added prior to separation of the whole stillage into insoluble solids and thin stillage.

14. The method of claim 1, wherein the hemicellulase, beta-glucanase or the enzyme blend comprising the hemicellulase and/or beta-glucanase is added during the separation of the whole stillage byproduct into the insoluble solids portion and the thin stillage portion.

15. The method of claim 1, wherein step a) is performed and performing step a) comprises:
(i) saccharifying a starch-containing grain at a temperature below the initial gelatinization temperature with an alpha-amylase and a glucoamylase; and
(ii) fermenting using a fermentation organism to produce the fermentation product.

16. The method of claim 1, wherein step a) is performed and performing step a) comprises:
(i) liquefying a starch-containing grain with an alpha-amylase;
(ii) saccharifying the liquefied material obtained in step (a) with a glucoamylase; and
(iii) fermenting using a fermenting organism.

17. The method of claim 16, wherein the hemicellulase, beta-glucanase or enzyme blend comprising the hemicellulase and/or beta-glucanase is added during saccharifying step (i) and/or fermenting step (ii).

18. The method of claim 16, wherein saccharification and fermentation is performed simultaneously.

19. The method of any one of claims 1-18, wherein the fermentation product is alcohol particularly ethanol more particularly fuel ethanol.

20. The method of any one of claims 1-19, wherein the fermenting organism is yeast.

21. The method of claim 1, wherein:
(i) the hemicellulase increases the mass fraction of the high protein feed ingredient compared to the mass of the high protein feed ingredient in the absence of the hemicellulase; and/or
(ii) the beta-glucanase increases the percent protein on a dry basis of the high protein feed ingredient compared to the percent protein on a dry basis of the high protein feed ingredient in the absence of the beta-glucanase.

22. (canceled)

23. (canceled)

24. (canceled)

25. The method of claim 1, wherein the fermenting organism is a recombinant yeast host cell comprising a heterologous polynucleotide encoding the hemicellulase(s) and/or beta-glucanase(s).

26. The method of claim 1, wherein the recombinant host cell further comprises a heterologous polynucleotide encoding a glucoamylase, an alpha-amylase, and/or protease.

27. (canceled)

28. (canceled)

29. (canceled)

30. A composition comprising:
(a) a recombinant yeast host cell; and
(b) at least one hemicellulase and/or at least one beta-glucanase,
wherein the yeast host cell comprises a heterologous polynucleotide encoding a glucoamylase, an alpha-amylase, protease, and/or cellulase;
